(19) United States
(12) Patent Application Publication
(10) Pub. No.: US 2026/0360764 A1
(43) Pub. Date: Nov. 12, 2026

(54) SOLID OXIDE FUEL CELLS AND SYSTEMS

(71) Applicant: Hypanode Ltd, Westhill, Scotland (GB)

(72) Inventors: Gerald Daniel Agnew, Staffordshire (GB); Benjamin Adam Haberman, Toronto (CA)

(21) Appl. No.: 19/486,833

(22) PCT Filed: May 24, 2024
(86) PCT No.: PCT/GB2024/051349

§ 371 Date: Nov. 21, 2025

(30) Foreign Application Priority Data
May 24, 2023 (GB) 2307791.0

(51) Int. Cl. H01M 4/86; H01M 4/02; H01M 8/04701; H01M 8/12

(52) U.S. Cl. CPC H01M 4/8657; H01M 8/04731; H01M 2004/021; H01M 2004/027; H01M 2008/1293; H01M 2300/0071

(57) ABSTRACT

Examples relate to multi-layered structures for a fuel cell. Such a multi-layered structure comprises an electrolyte; a permeable electrode; an inert permeable barrier; the permeable electrode and electrolyte having a common interface to form a reaction region; the permeable electrode providing a permeable electrode reactant pathway through the electrode to present a reactant at the common interface; the permeable electrode reactant pathway being fed by a permeable reactant pathway, and the inert permeable barrier comprises an inert permeable barrier reactant pathway providing a convectively dominant reactant flow regime within the inert permeable barrier, wherein the convectively dominant reactant flow regime of the inert permeable barrier reactant pathway feeds the permeable reactant pathway.

### BACKGROUND

Given climate change, the world is looking for alternative sources of energy for powering vehicles such as, for example, cars, aeroplanes, etc as well as alternative sources of generating green electricity.

A fuel cell is an electrochemical device for efficient, clean power generation. Solid oxide fuel cells (SOFCs) are a core enabling technology for future sustainable energy systems, in particular, so-called green energy systems.

However, realising fuel cells for certain industries has been challenging. For example, fuel cells for the aviation industry presently have insufficient performance to provide commercially viable alternatives to present aviation engines such as the aircraft or aeroengine, which is the major power component of an aircraft propulsion system. The majority of aircraft engines are either piston engines or gas turbines that use petroleum-based fuels or petroleum and synthetic fuel blends, that are kerosine-based for gas turbine powered aircraft and gasoline and diesel for piston-engine aircraft. The environmental impact of aviation fuel combustion is well understood.

SOFCs have yet to be realised that provide commercially viable alternatives to the above.

### BRIEF INTRODUCTION OF THE DRAWINGS

Example fuel cells and systems will be described with reference to the accompanying drawings in which

FIG. 1 shows a hierarchy of components of fuel cells and systems;

FIG. 2 illustrates a legend relating to the entities shown in FIG. 1;

FIGS. 3A to 3F depict a number of symmetric laminated sheets;

FIG. 4 illustrates a symmetric laminated sheets of FIG. 3;

FIG. 5 shows an anode cell, a cathode cell and a pair of chemical coolant cells;

FIG. 6 depicts a view of an expanded stack in different expansion states;

FIG. 7 illustrates a view of further stages in fabricating a stack;

FIG. 8 depicts a view of a further stage of manufacturing a stack;

FIG. 9 illustrates a view of a stack;

FIG. 10 shows a view of a stack assembly;

FIG. 11 depicts a view of a further stack;

FIG. 12 illustrates a set of sectional views through the further stack shown in FIG. 11;

FIG. 13 depicts a stack assembly using the further stack;

FIGS. 14A and 14B illustrate arrays of stack assemblies in plan view;

FIG. 15 shows a methanation stack:

FIG. 16 depicts a methanator assembly comprising a number of such methanation stacks;

FIG. 17 illustrates a pair of sectional views through part of the methanator assembly of FIG. 16;

FIG. 18 depicts a view of a combustor or oxidant preheater;

FIG. 19 shows a first example of a fuel cell system using ammonia or hydrogen as the fuel cell reactant;

FIG. 20 illustrates a second example of a fuel cell system using natural gas, methanol, hydrogen or ammonia as the fuel cell reactant;

FIG. 21 depicts a third example of a fuel cell system using ammonia or hydrogen as a fuel reactant;

FIG. 22 illustrates a graph of variation of heat-to-power ratio with current density;

FIG. 23 shows a graph of variation of power density with cell size;

FIG. 24 depicts a graph of variation of thermal Biot number with cell size;

FIG. 25 illustrates a graph of variation of thermal Peclet number for flow through a permeable electrode with cell size;

FIG. 26A shows a graph of variation of single cell thickness with cell size for a predetermined pressure drop;

FIG. 26B shows the graph of variation of single cell thickness with cell size for a predetermined pressure drop of FIG. 26A together with graph values;

FIG. 27A depicts a graph of variation of the ratio of convective velocity to mass transfer coefficient with cell size; and

FIG. 27B depicts the graph of variation of the ratio of convective velocity to mass transfer coefficient with cell size of FIG. 27A together with graph values.

### DETAILED DESCRIPTION

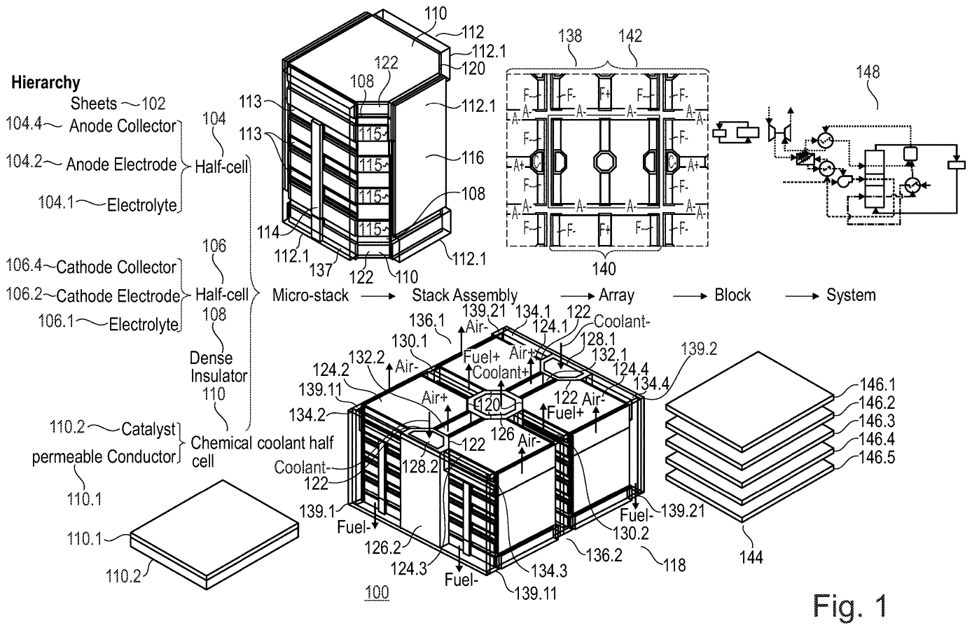

Referring to FIG. 1, there is shown a view 100 of a hierarchy for fuel cells and systems according to examples. The hierarchy comprises a number of solid oxide sheets 102. The sheets 102 relate to an anode half-cell 104, a cathode half-cell 106, a dense insulator 108 and a chemical coolant half-cell 110. The anode half-cell 104 comprises an anode electrolyte 104.1, a permeable anode electrode 104.2 and a permeable anode current collector 104.4. The cathode half-cell 106 comprises a cathode electrolyte 106.1, a permeable cathode electrode 106.2 and a cathode current collector 106.4. The dense insulator 108 comprises a dense insulating material such as Alumina or Magnesium Aluminate (spinel), Magnesia and Magnesia with Magnesium Aluminate Spinel (MMA), as well as Aluminium Nitride. The chemical coolant half-cell 110 comprises a chemical coolant half-cell permeable conductor 110.1 and a permeable coolant cell catalyst 110.2.

Each of the above are examples of multi-layered structures for a fuel cell. Each of the multi-layered structures can comprise substantially planar layers. Although the examples described herein use layers in the form of sheets, that is, substantially planar, material, examples are not limited thereto. Examples can be realised in which material shaped other than substantially planar such as, for example, planar material that is curved in at least one dimension and, optionally, in two dimensions to present an arcuate surface or a curved surface. Furthermore, the material can be shaped as strips.

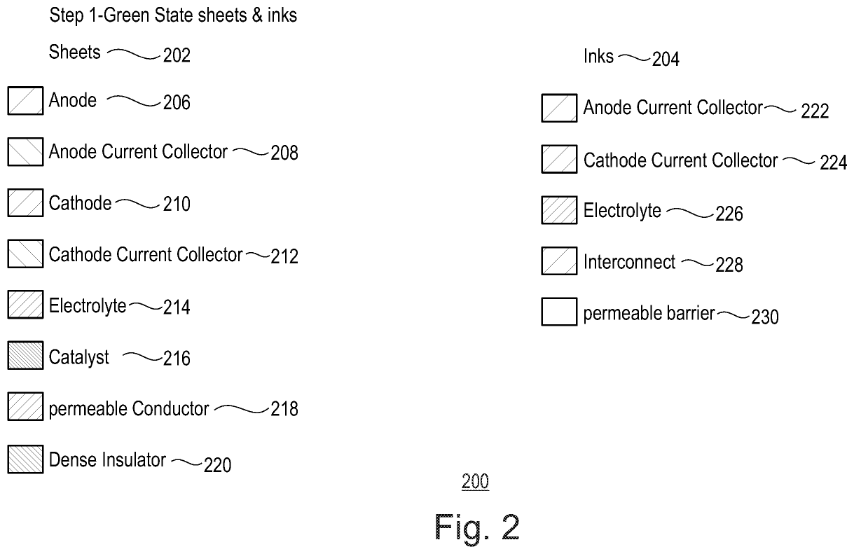

Pairs of anode half-cells 104 can be combined to produce an anode cell, which will be described with reference to FIG. 2 below.

Similarly, pairs of cathode half-cells 106 can be combined to produce a cathode cell, which will also be described below with reference to FIG. 2.

Also, pairs of chemical coolant half-cells 110 can be combined to produce a chemical coolant cell, which will be described below with reference to FIG. 2.

A fuel cell comprises a set of anode cells comprising at least one anode cell and a set of cathode cells comprising at least one cathode cell. Examples can be realised in which a fuel cell stack comprises a set of anode cells comprising at least one anode cell, a set of cathode cells comprising at least one cathode cell, and a set of chemical coolant cells comprising at least one chemical coolant cell.

FIG. 1 also shows, within the hierarchy, a stack 112. The stack 112 comprises a set of anode cells, a set of cathode cells, a set of dense insulator layers 108 and a set of chemical coolant cells. Each of the sets can comprise at least one layer or cell within their respective sets of a respective cell type. Examples can be realised in which the set of anode cells comprises a number of anode cells, the set of cathode cells comprises a number of cathode cells, the set of dense insulator layers comprises a number of dense insulator layers, and the set of chemical coolant cells comprises a number of chemical coolant cells. In the example shown in FIG. 1, the set of chemical coolant cells comprises at least one, preferably two, chemical coolant cells and the set of dense insulator layers comprises at least one, preferably two dense insulator layers according to how many chemical coolant cells are within the set of chemical coolant cells.

Herein the terms “convection” and other terms derived from that stem such as, for example, “convectively”, refer to, or comprise the bulk motion of a fluid mixture at a respective mean mixture velocity. This can be contrasted with diffusion which describes the difference between the velocity of a respective gas species and the mixture velocity such as, the respective mean mixture velocity.

Convective heat transfer refers to heat transfer by forced convection which can be, or is, defined as transport of heat from one point to another in a fluid as a result of macroscopic motions of the fluid resulting from an applied external force such as, for example, a fan, pump, mixer, or the like. In the examples described herein, the surface is defined as, or comprises, the interior surface presented by pores within permeable materials. Furthermore, as used herein, the term “pathway” refers to a gas species pathway within a porous material. Still further, the terms “dense layer” and “impermeable dense layer” are used synonymously to mean impermeable to the gas species used or encountered such as, for example, at least one, or more than one, of the following taken jointly and severally in any and all permutations: air, hydrogen, steam and possibly other unreacted fuel species or reaction products. The term “dense insulator layer” refers to such a “dense layer” or “impermeable dense layer” that is also an electrical insulator.

Therefore, examples of a multi-layered structure for a fuel cell can be realised. The multi-layered structure can comprise:
an electrolyte; such as, for example, a planar electrolyte
a permeable electrode; such as, for example, a planar permeable electrode;
an inert permeable barrier;
the electrode and electrolyte having a common interface to form a reaction region; the common interface can be a planar common interface;
the permeable electrode providing a permeable electrode reactant pathway through the electrode to present a reactant at the common interface; the permeable electrode reactant pathway being fed by a permeable reactant pathway, and
the inert permeable barrier comprising an inert permeable barrier reactant pathway to at least one, or both, of:
provide an effective depth greater than a physical depth of the inert permeable barrier to at least reduce, preferably, eliminate, diffusion of any gas species within the inert permeable barrier reactant pathway to form a convectively dominant reactant flow regime within the inert permeable barrier, or
host a convectively dominant reactant flow regime within the inert permeable barrier;
wherein the inert permeable barrier reactant pathway is coupled to the permeable reactant pathway.

At least one, or both, of: the permeable anode electrode and the permeable cathode electrode are examples of such a permeable electrode. At least one, or both, of: the anode electrolyte 104.1 and cathode electrolyte 106.1 are examples of such an electrolyte.

The example stack 112 depicted in FIG. 1 comprises four cathode cells and three anode cells. The anode cells are disposed between respective cathode cells. Examples can be realised in which the anode cells are interdigitated with the cathode cells.

Examples can be realised in which the stack 112 also comprises a set of two dense insulator layers 108 having the sets of anode cells and cathode cells positioned in between the dense insulator layers 108 and a pair of chemical coolant cells 110 positioned adjacent to respective dense insulator layers.

The stack 112 comprises a set of barrier layers 112.1. In the example depicted in FIG. 1, the stack comprises at least a barrier layer over respective inlets 113 to the anode cells. Each barrier layer in the set of barrier layers 112.1 is formed from an inert permeable oxide or material. An “inert permeable barrier layer” and an “inert permeable barrier” are each examples of a barrier layer or of a barrier. The terms barrier and barrier layer are used synonymously. It will be appreciated that the inert permeable barriers are perpendicular relative to the other layers.

Each anode cell has an anode cell inlet 113 and an anode cell outlet (not shown in FIG. 1). The anode current collectors of each anode cell are electrically coupled to one another via a further anode current collector 114. The anode current collectors of each cell can be arranged to provide the permeable anode reactant pathways.

Each cathode cell has a respective cathode cell inlet 115 and a respective cathode cell outlet (not shown in FIG. 1). The cathode current collectors of each cathode cell are coupled to a further cathode current collector 116. The cathode current collectors of each cell can be arranged to provide the permeable cathode reactant pathways.

Examples can be realised in which the inert permeable barrier layer 112.1 also extends to cover one or more sides of any chemical coolant cells within the set of chemical coolant cells, which can follow from facilitating ease of assembly or fabrication.

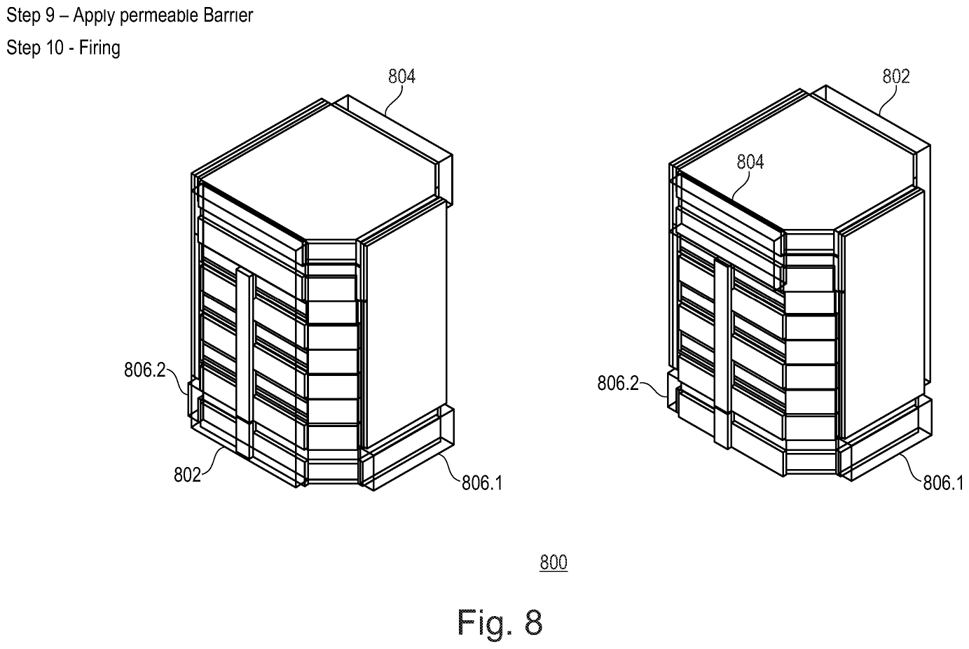

Examples can be realised in which the stack additionally comprises a set of at least one further barrier layer. In the example depicted in FIG. 8, the set of at least one additional barrier layer comprises a plurality of additional barrier layers. Examples can be realised in which the set of additional barrier layers comprises one or more than one, taken jointly and severally in any and all permutations, of:
an upper barrier layer 804 associated with at least one, or both, of the upper chemical coolant cell and the upper most cathode cell within the core of the stack,
a barrier layer 806.1 disposed adjacent to the lower most chemical coolant cell inlet and outlet, and
a barrier layer 806.2 disposed on the opposite side of the chemical coolant cell relative to barrier layer 806.1. The set of at least one further barrier layer is arranged to at least reduce, or prevent, creepage electrical discharge.

It can be seen that each chemical coolant cell has an inlet 120. Each chemical coolant cell also has a respective outlet 122.

Next in the hierarchy 100 shown in FIG. 1 is a stack assembly 118. The stack assembly comprises a set of stacks 112. In the example shown, the set of stacks comprises four instances 124.1 to 124.4 of the above-described stack 112. The stacks 124.1 to 124.4 are positioned adjacent to one another and oriented so that respective chemical coolant cell inlets 120 are fed by a centrally disposed chemical coolant channel 126.

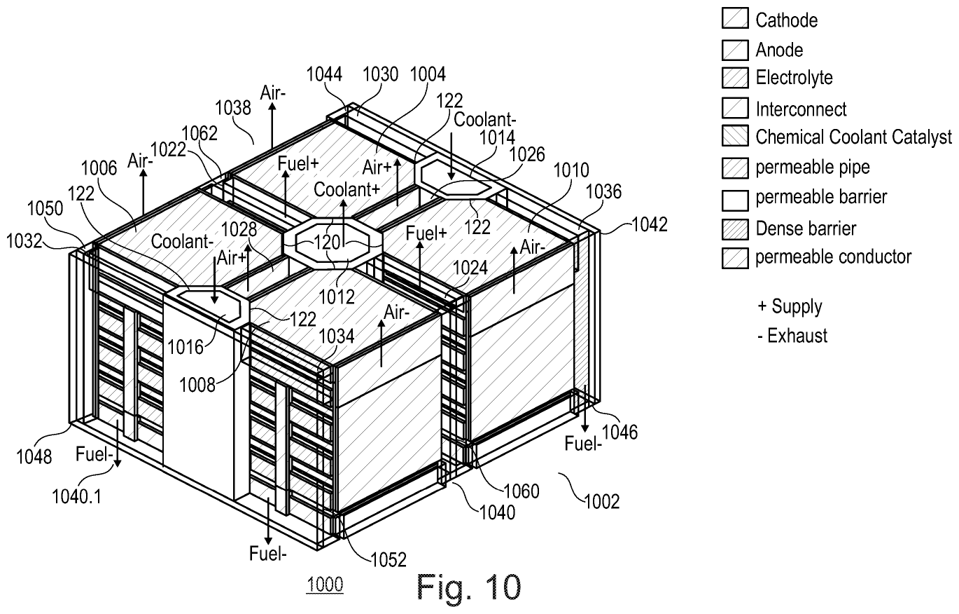

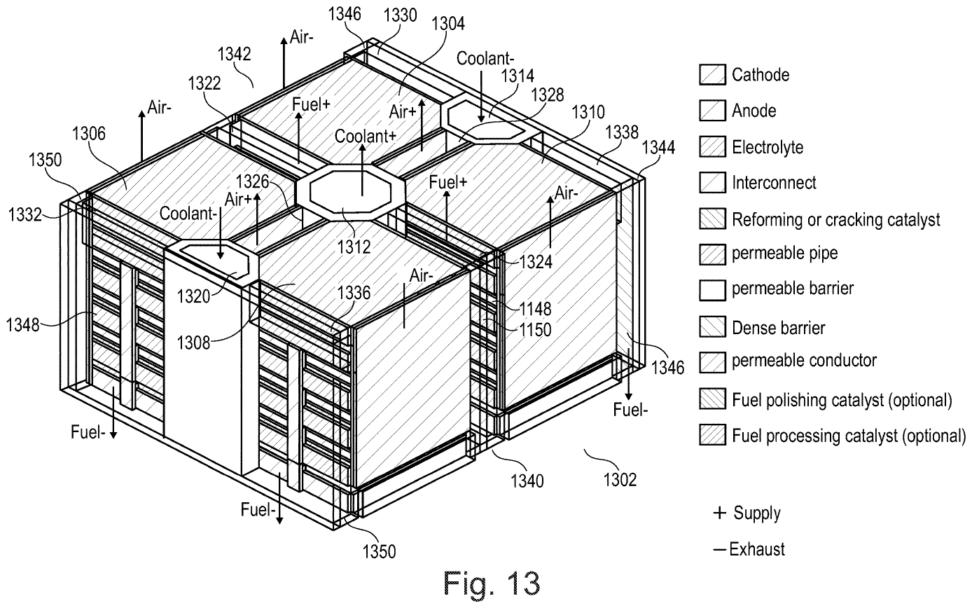

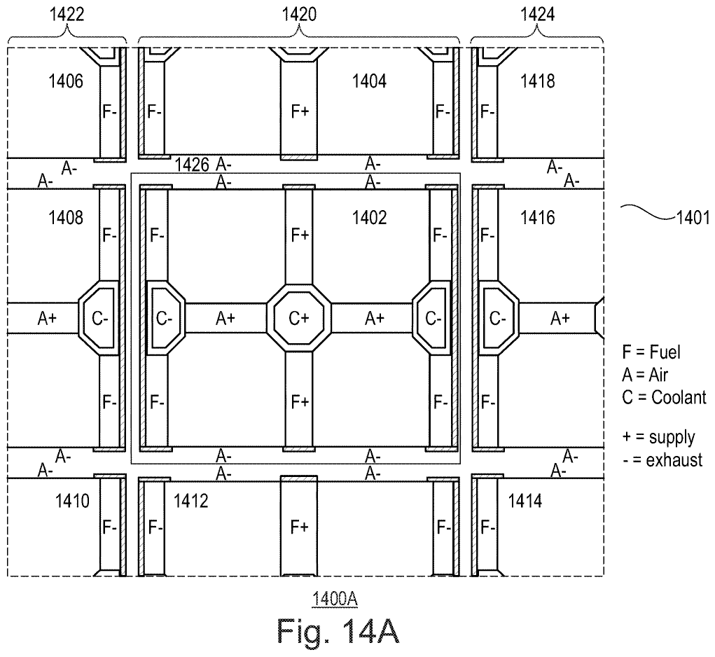

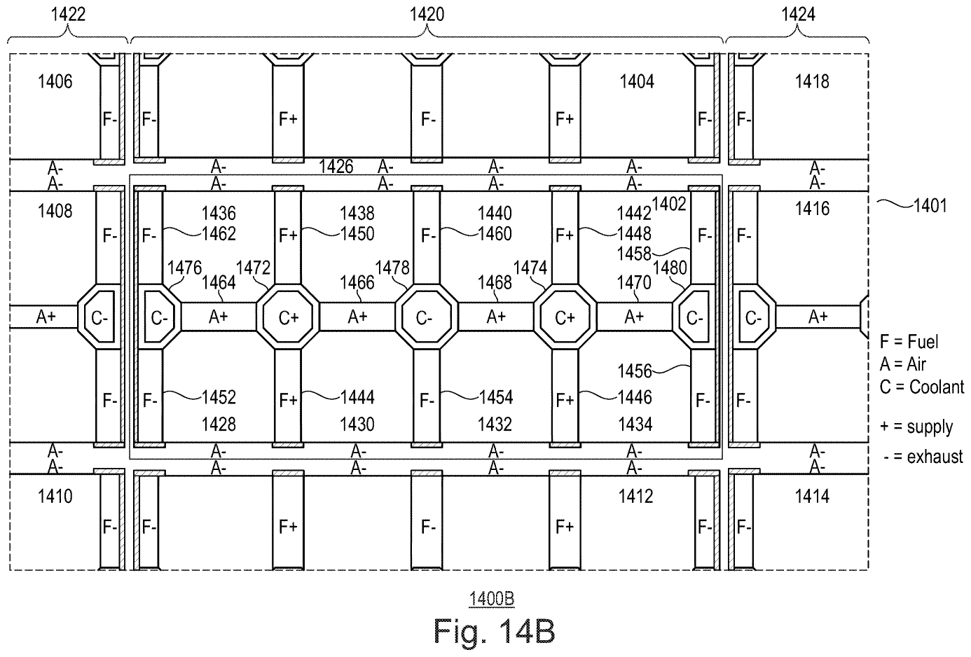

Disposed at each outlet 122 of each chemical coolant cell of each stack 124.1 to 124.4 is a respective chemical coolant exhaust channel. In the example depicted, two chemical coolant exhaust channels 128.1 and 128.2 are provided. The chemical coolant exhaust channels 128.1 to 128.2 are used to carry at least one, or both, of excess chemical coolant or chemical coolant reformate associated with or otherwise derived from the chemical coolant. ‘The chemical coolant reformate is produced as a consequence of a cooling chemical reaction involving the chemical coolant (not shown) flowing through the set of chemical coolant cells that absorb heat generated by the electrochemical reactions within the adjacent anode and cathode cells of the core of the stack. Examples can be realised in which the chemical coolant can comprise at least one, or both, of: methane or a methane and steam mixture, and in which the cooling is a reforming reaction. Although the examples depicted in FIG. 1, and in FIGS. 10, 13 and/or 14 below, show a particular arrangement of chemical coolant supply flow channels and chemical coolant exhaust flow channels, examples are not limited to such an arrangement. Examples can be realised in which some other arrangement of chemical coolant supply flow channels and chemical coolant exhaust flow channels is realised. For instance, examples can be realised in which the roles of the chemical coolant supply flow channels and the chemical coolant exhaust flow channels are reversed such that the centrally disposed channel 126/1012 forms a chemical coolant exhaust flow channel and the outwardly disposed channels 128.1/1014 to 128.2/1016 form chemical coolant supply flow channels. Still further examples can be realised in which the chemical coolant supply flow and chemical coolant exhaust flow channels are disposed diagonally opposite one another at respective corners or edges of a chemical coolant cell. Other chemical coolant channel arrangements will be described with reference to FIG. 14 below. The chemical coolant supply flow channel 126/1012 and chemical coolant exhaust flow channels 128.1/1014 to 128.2/1016 are permeable to supply the chemical coolant to, and to allow the chemical coolant reformate and chemical coolant to egress from, the respective channels. Therefore, other than in regions supporting such supply and egress, the chemical coolant supply flow channel and chemical coolant exhaust flow channels are sealed, that is, are rendered impermeable to the chemical coolant ingress or egress, as well as being impermeable to other gas flows.

The notation used for flows depicted herein is a name followed by a plus or minus sign. The name indicates the type of flow and the plus or minus sign indicates whether the flow is supply or exhaust respectively. For example, ‘coolant+’ indicates a supply chemical coolant flow, ‘coolant−’ indicates an exhaust chemical coolant flow, fuel+/reactant+ indicate a fuel/reactant supply flow, fuel−/reactant− indicate an exhaust fuel/reactant flow, air+/oxidant+ indicate an air/oxidant supply flow and air−/oxidant− indicate air/oxidant exhaust flow.

Still referring to the stack assembly, a set of pairs of adjacent stacks share a fuel supply channel. As indicated, adjacent stacks share common fuel supply channels. In the example stack assembly 118 shown in FIG. 1, a first set of adjacent stacks 124.1 and 124.2 share a common fuel supply channel 130.1. A second set of adjacent stacks 124.3 and 124.4 also share a common fuel supply channel 130.2.

Additionally, adjacent sets of stacks share an air or oxidant supply channel. In the example stack assembly 118 shown in FIG. 1, a first set of stacks 124.1 and 124.4 share a common air or oxidant supply channel 132.1. A second set of stacks comprising stacks 124.2 and 124.3 also share a common air supply channel 132.2.

Also visible in the stack assembly 118 of FIG. 1 are a set of respective fuel exhaust channels 134.1 to 134.4 and a set of air or oxidant exhaust channels 136.1 and 136.2. Each air or oxidant exhaust channel accommodates a set of air exhaust flows. In the example depicted, a first air or oxidant exhaust channel 136.1 carries two air or oxidant exhaust flows and a second air or oxidant exhaust channel 136.2 carries two air or oxidant exhaust flows.

The fuel exhaust flow is carried by respective fuel exhaust flow channels 134.1 to 134.4 that are defined by a set of fuel impermeable barriers. In the example depicted, two sets of such fuel impermeable barriers are indicated. A first set of fuel impermeable barriers comprises a substantially planar fuel impermeable barrier 139.1 and a pair of fuel/reactant and oxidant impermeable end barriers 139.11. A second set of fuel impermeable barriers comprises a substantially planer fuel impermeable barrier 139.2 and a pair of fuel/reactant and oxidant impermeable end barriers 139.21.

The stack 112 also comprises a set of one or more than one interconnect 137. An interconnect 137 is used to electrically couple parts of a stack, in particular, an interconnect is used to facilitate an electrical connection between a stack and respective chemical coolant cells such as an electrical connection between a chemical coolant cell and an anode at one end of the stack, such as the bottom of the stack, and a cathode and a chemical coolant cell at the other end of the stack such as, at the top of the stack. The chemical coolant cells form the electrical connections between adjacent stacks, via respective interconnects, such that, for example, longitudinally adjacent cells are connected together electrically in series. It will be appreciated that current flows from the cathodes of one stack, via the chemical coolant cells, into the anodes of an adjacent stack. The stacks can be disposed at least one, or both, of: longitudinally adjacent to one another or transversely adjacent to one another. Although examples have been described in which longitudinally adjacent cells are connected together electrically in series, other electrical arrangements can be realised according to performance requirements. Examples can be realised in which the adjacent cells are connected at least one, or both, of: electrically in series and electrically in parallel. Connecting adjacent cells electrically in series and/or in parallel will influence at least one, or both, of: voltage output and current output performance.

Continuing to refer to FIG. 1, there is shown an array 138 of stack assemblies 118. The array of stack assembles comprises a set of stack assembles 118 arranged in a column 140. Each column 140 of stack assembles can comprise at least one, or more than one, stack assembly 118. The array of stack assembles can comprise a set 142 of columns 140 of stack assembles 118. Examples can be realised in which each column of the set 142 of columns 140 of stack assembles 118 is offset relative to an adjacent column of stack assembles 118, or in which stack assemblies 118 in columns and rows are aligned with one another, as depicted in FIG. 1 and FIG. 14.

It can be appreciated that adjacent stack assembles within the array 138 of stack assemblies 118 share common air or oxidant exhaust channels. In contrast, in the example depicted in FIG. 1, adjacent stack assembles within the same column 140 of stack assemblies do not share reactant fuel exhaust channels with one another.

FIG. 1 also depicts a set or block 144 of arrays 138 of stack assemblies 118. The set or block 144 of stack assemblies 118 can comprise at least one, or more than one, array 138 of stack assemblies 118. In the example shown, the set or block of stack assemblies 144 comprises five arrays 138 of stack assemblies 118; namely arrays 146.1 146.2 146.3 146.4 146.5.

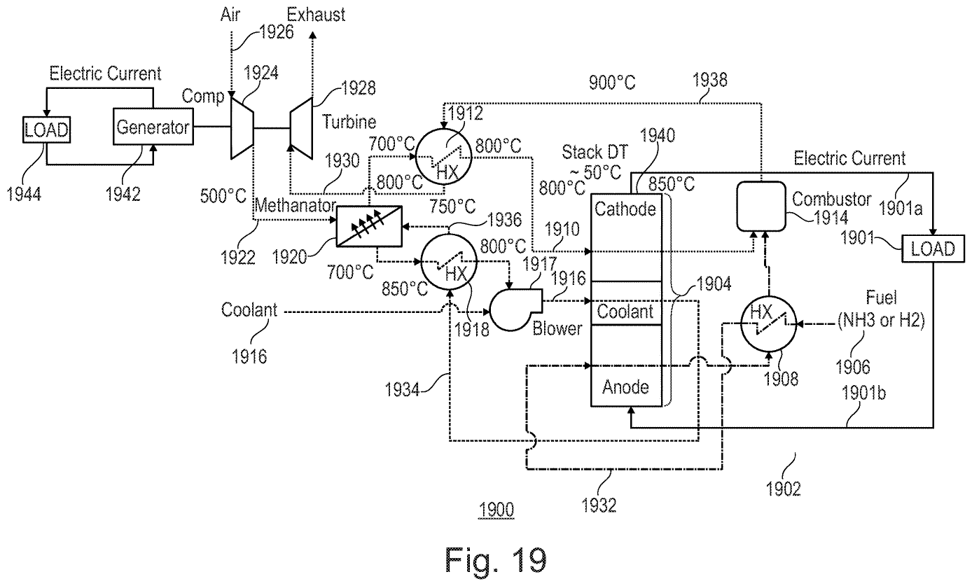

FIG. 1 also shows a system 148 within which such a block or set 144 of stack assemblies can be used. Examples of such a system will be described below with reference to FIGS. 19 to 21.

Referring to FIG. 2, there is shown a view 200 of a legend relating to the entities described above with reference to, and as shown in, FIG. 1.

The stack 112 of FIG. 1 and the sheets are colour coded. The stack is made from a number of green state sheets 202 and a set of inks 204. The set of green state sheets 202 comprises an anode sheet 206, an anode current collector sheet 208, a cathode sheet 210, a cathode current collector sheet 212, an electrolyte sheet 214, a catalyst sheet 216, a permeable conductor sheet 218, and a dense insulator sheet 220. The set of inks 204 comprises an anode current collector ink 222, a cathode current collector ink 224, an electrolyte ink 226, an interconnect ink 228, and an inert permeable barrier ink 230.

The anode sheet 206, anode current collector sheet 208 and electrolyte sheet 214 are used to form the above-described anode half-cell 104. Therefore, the anode green state sheet 206 can be used to form the above-described anode electrode 104.2, the anode current collector green state sheet 208 can be used to form the above-described anode collector 104.4 and the electrolyte green state sheet 214 can be used to form the above-described electrolyte 104.1 of the anode half-cell 104.

The electrolyte green state sheet 214 can be used to form the above-described electrolyte 106.1 of the cathode half-cell 106, the cathode electrode green state sheet 210 can be used to form the above-described cathode electrode 106.2, and the cathode current collector green state sheet 212 can be used to form the above-described cathode current collector 106.4. Examples can be realised in which the cathode electrolyte layer is optional.

The above-described chemical coolant half-cell 110 can be formed from the catalyst green state sheet 216 and a permeable conductor green state sheet 218.

The dense insulator layer 108 can be formed from the dense insulator green state sheet 220.

The anode current collector 114 of the stack can be formed from the anode current collector ink 222.

The cathode current collector 116 of the above-described stack can be formed from the cathode current collector ink 224.

The electrolyte ink 226 can be used to form seals to prevent gas egress in, from, or through, a material. However, alternative examples can be realised using any gas impermeable barrier to constrain gas flows such as, for example, at least one, or more than one, of: reactants, oxidants, dilutants, chemical coolants, taken jointly and severally in any and all permutations. Using the electrolyte ink 226 as such a sealant has the benefit of there being a good or acceptable coefficient of thermal expansion (CTE) match with the materials used to fabricate the layers and stacks according to the examples. Alternatives to the electrolyte ink 226 could be an electrolyte that is doped to become less conducting or non-conducting, or a glass ceramic, or other ceramics that tolerate the operating temperatures of the examples.

The above-described interconnect 137 can be formed using the interconnect ink 228.

The above-described permeable barrier 112.1 can be formed using the inert permeable barrier ink 230.

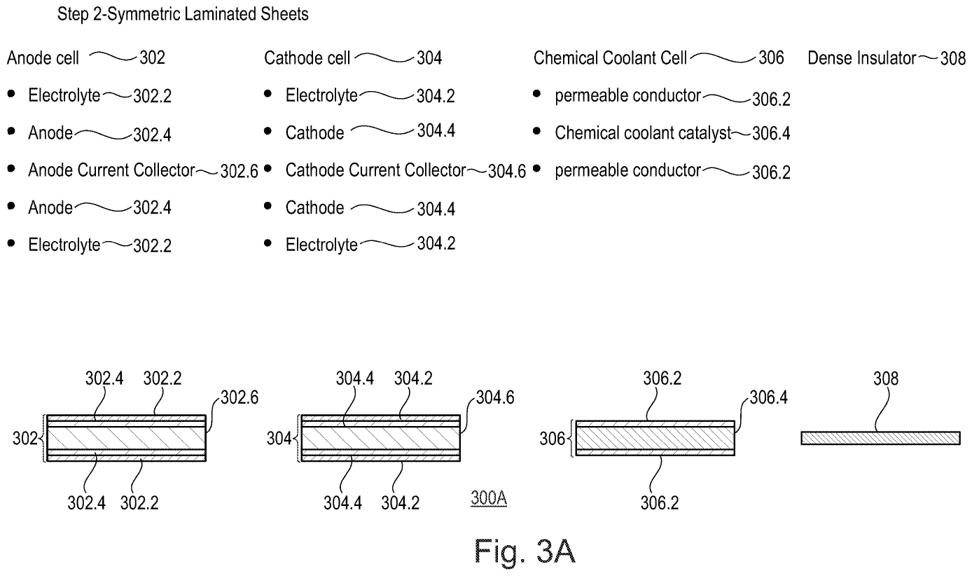

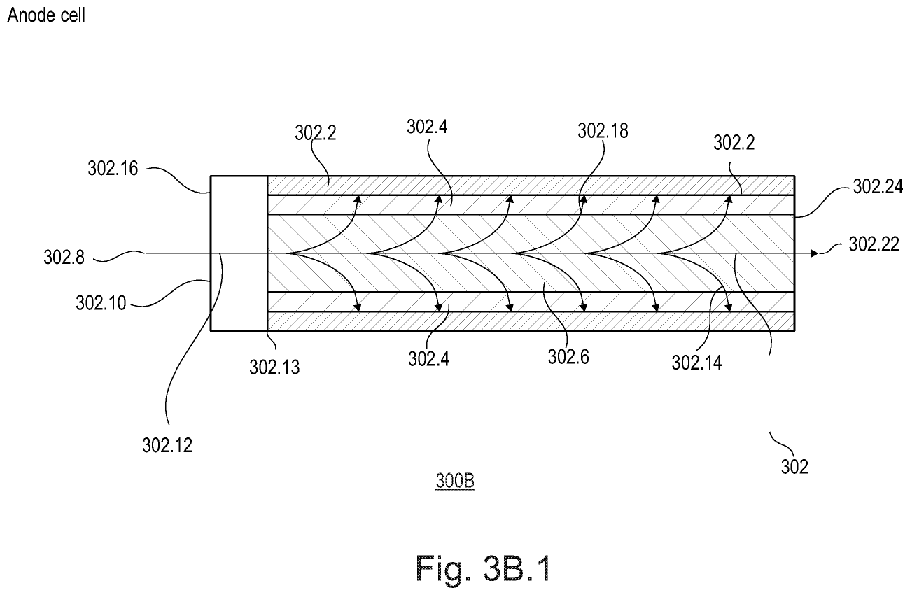

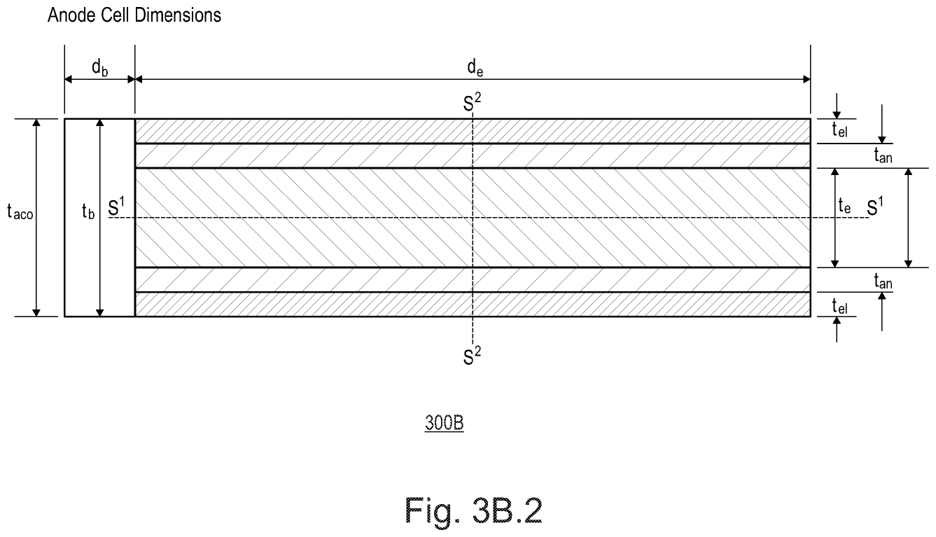

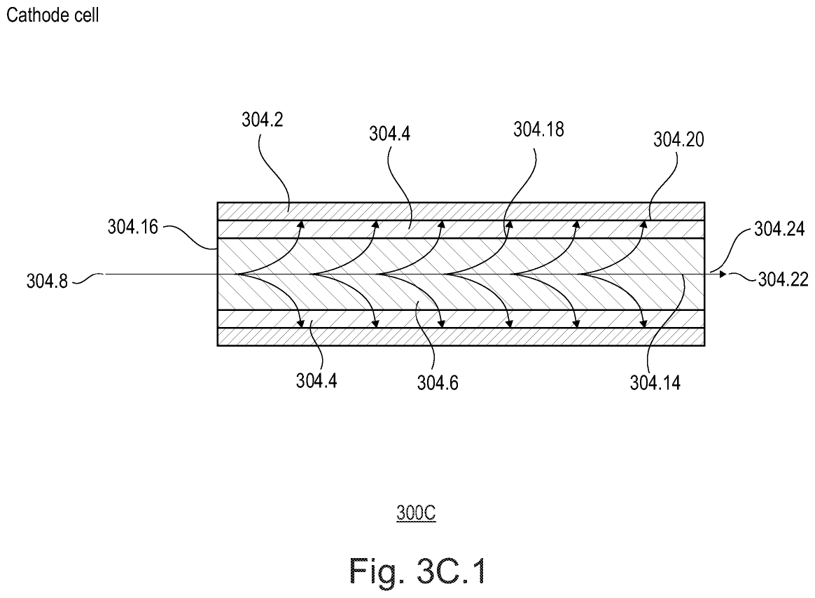

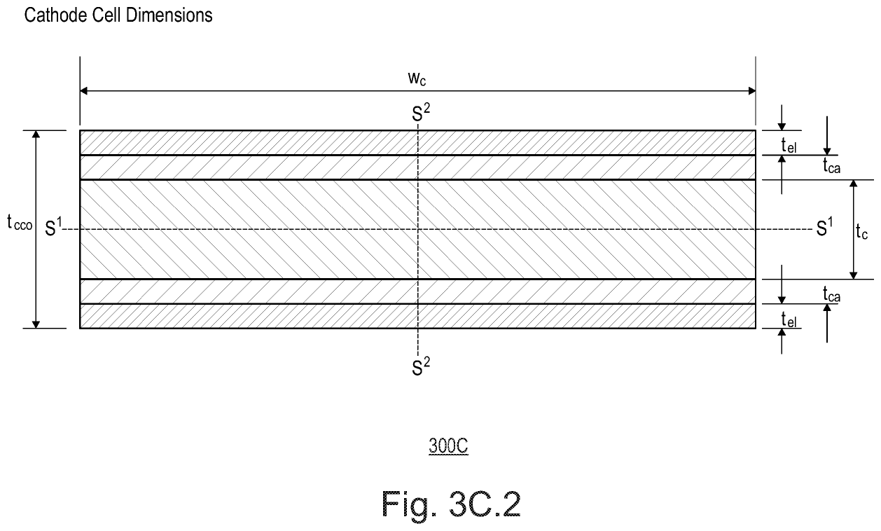

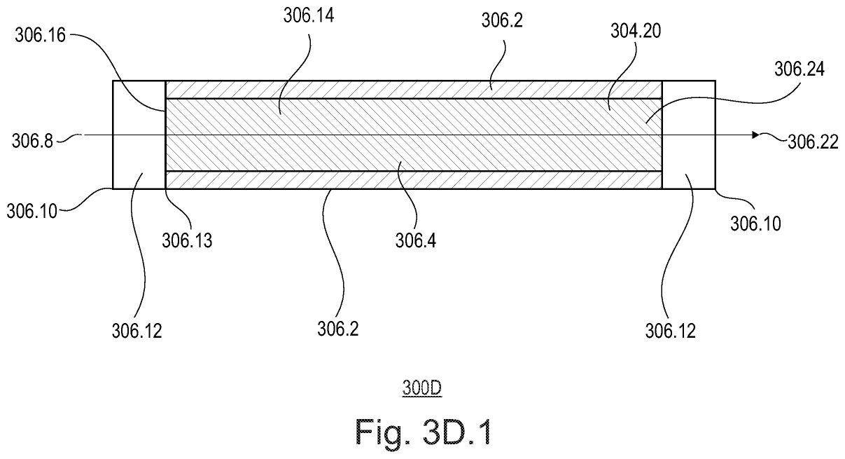

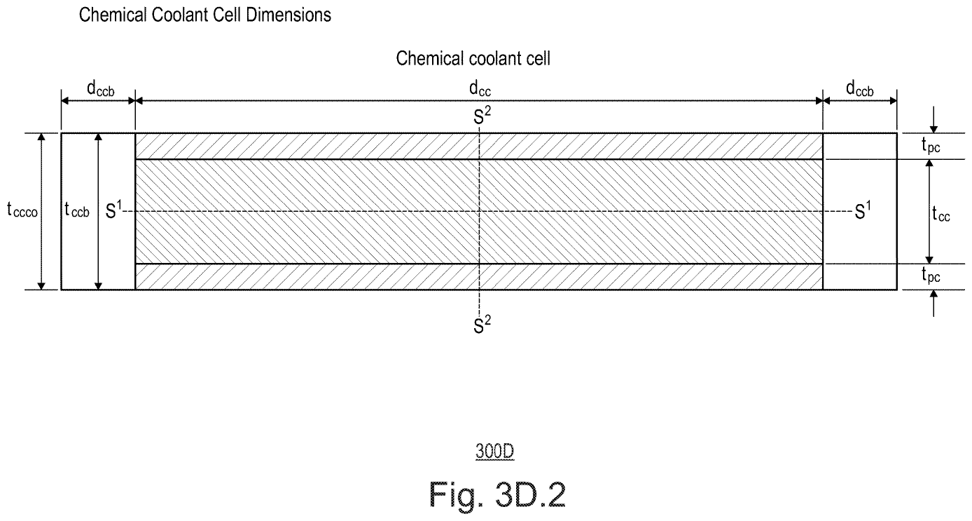

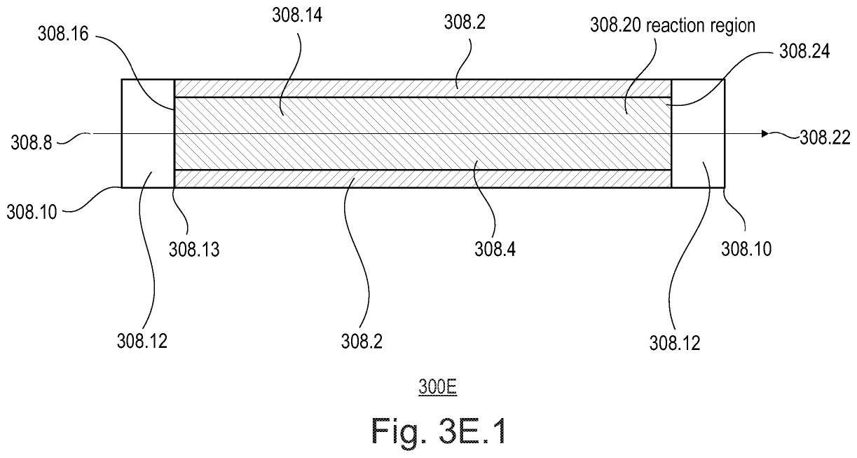

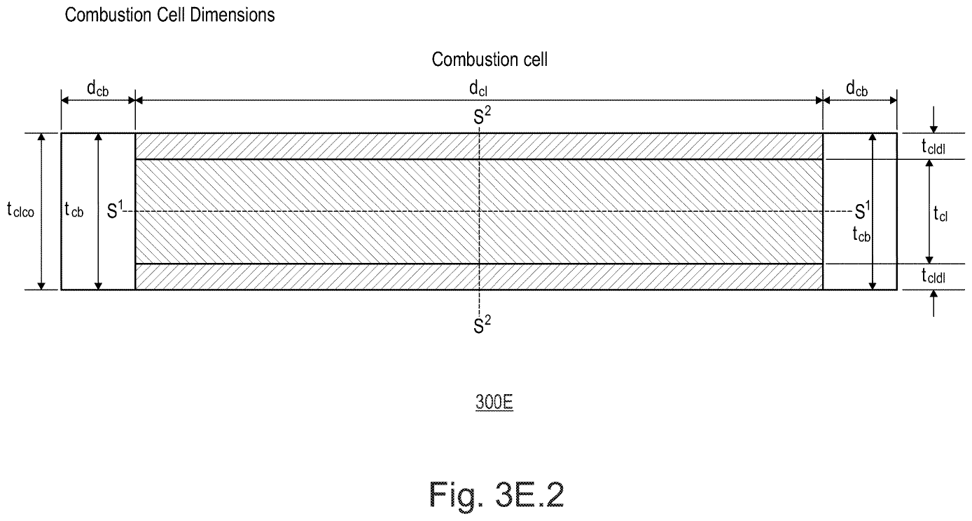

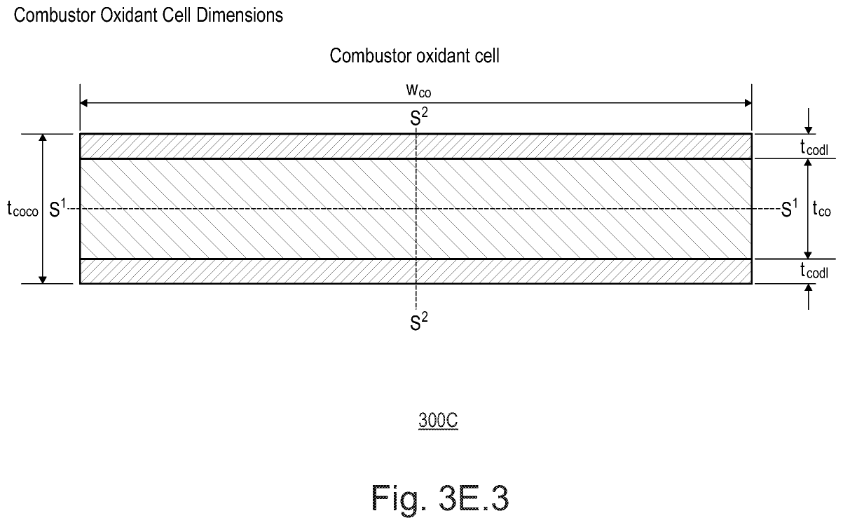

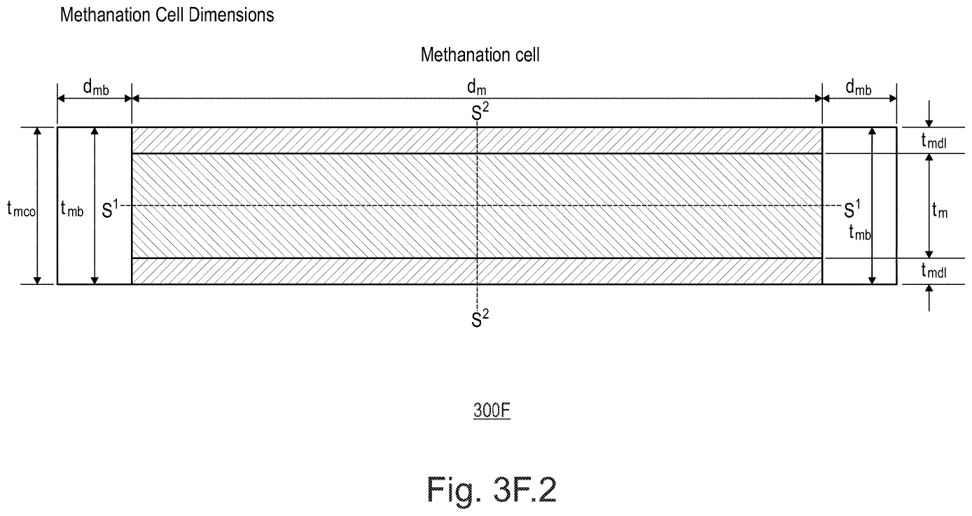

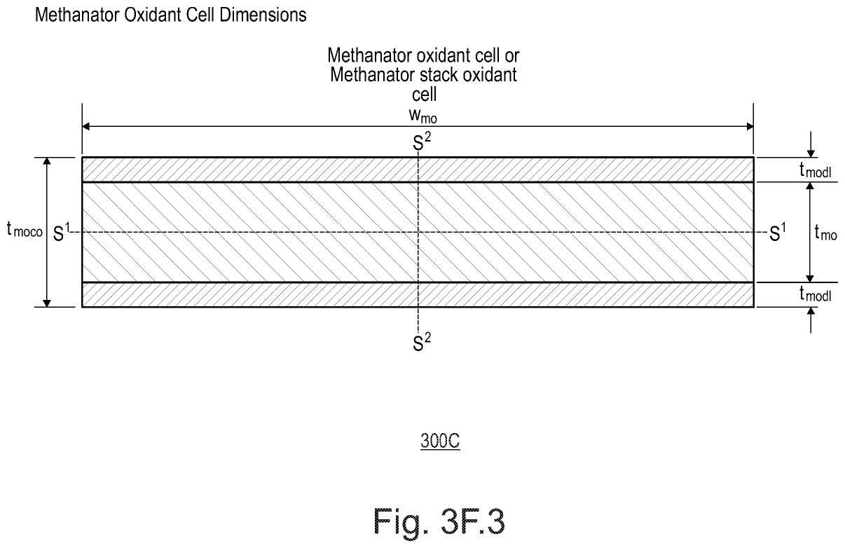

Referring to FIG. 3A, there is shown a view 300A of a number of symmetric laminated sheets. An anode lamination 302 is used to form an anode cell from two anode half-cells. The anode lamination 302 comprises a pair of electrolyte layers 302.2, a pair of anode layers 302.4 and an anode current collector layer 302.6. Although relatively thin layers have been used to fabricate the example half-anode cells and half-cathode cells, examples are not limited to such arrangements. Examples can be realised in which relatively thicker layers are used to realise the layers of the multi-layered structures. Any such relatively thicker layers can be formed using multiple relatively thin layers to provide greater control over manufacturing processes to avoid problems such as, for example, problems during drying, like cracking. Examples of relatively thin layers would comprise layers having a thickness of 100 microns and below.

A cathode lamination 304 is used to form a cathode cell from two cathode half-cells. The two cathode half-cells can be formed using the above-described half-cell 106. The cathode cell lamination 304 comprises a pair of electrolyte layers 304.2, a pair of cathode layers 304.4, and a cathode current collect layer 304.6.

A chemical coolant lamination 306 is used to form a chemical coolant cell from two chemical coolant half-cells. The two chemical coolant half-cells can be formed using the above-described half-cell 110. An example chemical coolant lamination or cell 306 comprises a pair of permeable conductor layers 306.2 and a catalyst layer 306.4 disposed between the permeable conductor layers 306.2. Examples can be realised in which the conductor layers can be solid rather than permeable.

The chemical coolant cell 306 comprises, or provides, at least one permeable (porous, tortuous) chemical coolant catalyst layer (comprising a chemical coolant catalyst to provide a chemical coolant catalyst layer pathway for a chemical coolant flow in a chemical coolant flow direction) which are related, or defined, by

$$\frac{{τ}_{cc}^{2}}{{ε}_{cc}} \frac{{d}_{cc}^{2}}{{f}_{cc}^{2} {t}_{cc}^{3}} ,$$

which relates the geometric parameters of the chemical coolant catalyst and the abovementioned pathway to the operational parameters of the chemical coolant cell, and
a chemical coolant cell inert permeable chemical coolant barrier to host a chemical coolant cell inert permeable barrier chemical coolant pathway, which will be referred to, and is an example, of a “chemical coolant cell inert permeable barrier pathway” herein, over at least one, or both, of: a chemical coolant catalyst layer inlet or outlet; each being defined by

$$\frac{{d}_{ccb} {d}_{cc} {τ}_{ccb}^{2}}{{t}_{cc} {ε}_{ccb}}$$

which relates the geometric parameters of the chemical coolant cell inert permeable barrier and its associated pathway to the operational parameters of the chemical coolant cell and barriers,
where
τ_{cc} is the permeable chemical coolant catalyst layer pathway tortuosity in the chemical coolant flow direction,
   τ_{ccb} is the chemical coolant cell inert permeable barrier pathway tortuosity in the chemical coolant flow direction,
   ε_{cc} is the permeable chemical coolant catalyst layer porosity,
   ε_{ccb} is the chemical coolant cell inert permeable barrier porosity,
d_{ccb} is the chemical coolant cell inert permeable barrier depth in the chemical coolant flow direction,
   d_{cc} is the permeable chemical coolant catalyst layer depth in the chemical coolant flow direction,
   t_{cc} is the permeable chemical coolant catalyst layer thickness,
   f_{cc} is the ratio of permeable chemical coolant catalyst layer pathway pore size to permeable chemical coolant catalyst layer thickness, t_{cc}.

Examples of the relationship between the geometric parameters of both of the permeable chemical coolant catalyst and the abovementioned pathway and the operational parameters of the chemical coolant cell are given in Table 3.

Examples of relationship between the geometric parameters of the chemical coolant cell inert permeable barrier and its associated pathway to the operational parameters of the chemical coolant cell and barriers are given in Table 3.

Examples can be realised in which the chemical coolant cell also comprises at least one, or more than one, of the following characteristics, taken jointly and severally in any and all permutations:
the permeable chemical coolant catalyst layer thickness, t_{cc}, is arranged to provide a balance between reaction time, contact via a catalyst or reaction contact surface, in-plane sheet electrical conductance and in-plane thermal conduction, which follows from increasing the permeable chemical coolant catalyst layer 306.4 thickness, with ensuring a compact design providing power density, which follows from decreasing permeable chemical coolant catalyst layer 306.4 thickness;
the permeable chemical coolant catalyst layer thickness, t_{cc}, has a range of 5 μm to 1000 μm, optionally 5 μm to 700 μm, and, preferably, 10 μm to 300 μm;
the ratio

$$\frac{{τ}_{cc}^{2}}{{ε}_{cc} {f}_{cc}^{2}}$$

influences the balance between an additional, preferably, smallest, flow resistance provided by the permeable chemical coolant catalyst layer material while providing structural strength and in-plane sheet electrical conductance and in-plane thermal conduction;
the ratio

$$\frac{{τ}_{cc}^{2}}{{ε}_{cc} {f}_{cc}^{2}}$$

has a range of 1 to 500, optionally, 2 to 50;
the permeable chemical coolant catalyst layer depth, d_{cc}, is selected according to manufacturing capabilities to balance cell handling capabilities, since below a given lower depth limit handling cells would be difficult, and power density, which influences an upper limit of cell thickness since large cell depths would require cell thickness to increase dramatically to provide in-plane thermal conduction as well as in-plane sheet electrical conductance and manage pressure drops, which would adversely lead to a lower power density overall;
the permeable chemical coolant catalyst layer depth, d_{cc}, has a range of 0.25 mm to 40 mm, optionally, 0.25 mm to 20 mm and, preferably, of 5 mm to 20 mm
the ratio

$$\frac{{d}_{ccb} {τ}_{ccb}^{2}}{{ε}_{ccb}}$$

is associated with a range of effective depths in the flow direction of the chemical coolant cell inert permeable barrier pathway to influence, that is, limit, at least reduce, or eliminate, diffusion effects scribed in paragraphs [00209] to [00251];
the ratio

$$\frac{{d}_{ccb} {τ}_{ccb}^{2}}{{ε}_{ccb}}$$

has a range of 1 to 1000 mm, optionally, 5 to 200 mm and, preferably 5 to 100 mm, and more preferably less than 100 mm;
the ratio, f_{cc}, of permeable chemical coolant catalyst layer pathway pore size to permeable chemical coolant catalyst layer thickness, t_{cc}, is selected to balance flow resistance with providing structural strength and in-plane sheet electrical conductance to influence or constrain electrical resistive losses;
the ratio, f_{cc}, of permeable chemical coolant catalyst layer pathway pore size to permeable chemical coolant catalyst layer thickness, t_{cc}, has a range of 0.02 to 1, and, preferably, 0.25 to 0.75;
the permeable chemical coolant catalyst layer pathway tortuosity, τ_{cc}, is selected to balance flow resistance and catalyst or reaction contact surface against structural strength and in-plane sheet electrical conductance of at least the chemical coolant catalyst;
the permeable chemical coolant catalyst layer pathway tortuosity, τ_{cc}, has a range of 1 to 3, optionally, 1 to 2.5, and, preferably, 1 to 2;
the chemical coolant cell inert permeable barrier pathway tortuosity, τ_{ccb}, is arranged to increase the effective depth of the inert permeable barrier layer to at least reduce, and, preferably, eliminate, diffusion of any gas species present in the inert permeable barrier;
the chemical coolant cell inert permeable barrier pathway tortuosity, τ_{ccb}, has a range of 1 to 10, preferably, 1 to 5;
the permeable chemical coolant catalyst layer porosity, ε_{cc}, is selected balance flow resistance against structural strength and in-plane sheet electrical conductance of the chemical coolant catalyst;
the permeable chemical coolant catalyst layer porosity, ε_{cc}, has a range of 0.1 to 0.9, and, preferably, 0.5 to 0.8;
the chemical coolant cell inert permeable barrier porosity, ε_{ccb}, has a lower bound to accommodate examples that use an orifice plate or foraminate plate and an upper bound to accommodate higher tortuosity materials;
the chemical coolant cell inert permeable barrier porosity, ε_{ccb}, has a range of 0.01 to 0.5, and, preferably, 0.05 to 0.5;
the chemical coolant cell inert permeable barrier depth, d_{ccb}, can be set to achieve a balance, at a lower limit, between an increase in effective depth to limit diffusion, as described with reference to paragraphs [00209] to [00251], and so cannot be too thin, with, at an upper limit, constraining the size of the inert permeable barrier such that it has a volume smaller than an associated fuel cell, which influences overall power density;
the chemical coolant cell inert permeable barrier depth, d_{ccb}, is greater than or equal to 0.01 mm, optionally 0.01 mm to 5 mm and, preferably, 0.1 mm to 2 mm.

The ratio

$$\frac{{τ}_{cc}^{2}}{{ε}_{cc}} \frac{{d}_{cc}^{2}}{{f}_{cc}^{2} {t}_{cc}^{3}} ,$$

which relates the geometric parameters of the permeable chemical coolant catalyst layer and its associated pathway to the operational parameters of the chemical coolant cell, has a range of 1e6/m to 5e12/m, optionally, 1e8/m to 5e11/m and, preferably, 1e9/m to 1e11/m.

The ratio

$$\frac{{d}_{ccb} {d}_{cc} {τ}_{ccb}^{2}}{{t}_{cc} {ε}_{ccb}} ,$$

which relates the geometric parameters of the chemical coolant cell inert permeable barrier and its associated pathway to the operational parameters of the chemical coolant cell and barriers, has a range of 0.1 m to 250 m, optionally, 0.5 m to 50 m and, preferably, 1 m to 25 m.

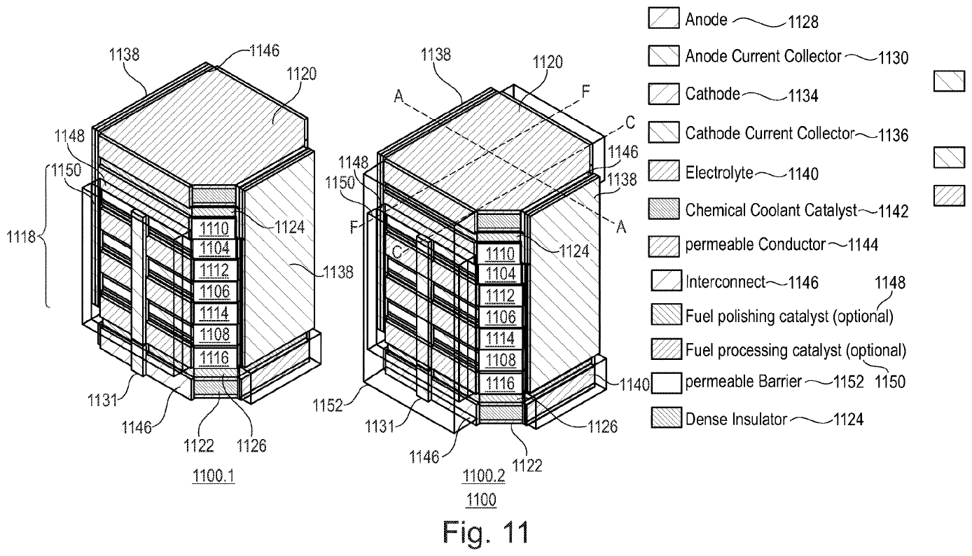

In the examples described herein, the chemical coolant cell inert permeable barrier can be realised using, for example, a permeable wall of at least one, or both, of: a chemical coolant supply channel and a chemical coolant exhaust channel, as described with reference to FIGS. 10 to 11.

A dense insulator layer 308 is formed using a dense insulator material. The dense insulator material can be, for example, Alumina or Magnesium Aluminate (Spinel), Magnesia and Magnesia with Magnesium Aluminate Spinel (MMA), as well as Aluminium Nitride.

Referring to FIG. 3B.1, there is shown a view 300B of an anode cell 302 together with a barrier according to an example. The anode cell is shown as comprising a reactant flow 302.8. The reactant flow 302.8 is fed to the inert permeable barrier 302.10. The inert permeable barrier 302.10 provides an inert permeable barrier reactant pathway 302.12. The inert permeable barrier reactant pathway 302.12 is arranged to at least reduce, and, preferably, eliminate, diffusion effects of any gas species within the inert permeable barrier before the interface 302.13 between the end of the inert permeable barrier 302.12 and anode cell 302. The inert permeable barrier reactant pathway 302.12 is arranged to feed a permeable reactant pathway 302.14 via the permeable reactant pathway inlet 302.16. The permeable reactant pathway 302.14 is carried by a suitably permeable structure 302.6 as described herein. Examples can be realised in which the suitably permeable structure 302.6 is a current collector, such as, for example, an anode current collector. Examples can be realised, however, in which the suitably permeable structure 302.6 is made from the same material as the anode electrode and, therefore, effectively eliminated or replaced. Still further examples can be realised in which the suitably permeable structure is a heterogeneous structure comprising multiple layers or entities, as opposed to being a single homogeneous structure. Yet further examples can be realised in which the suitably permeable structure 302.6 is not primarily intended to conduct current and, therefore, is non-conductive or is minimally conductive with the primary function being to support gas flow. However, providing a permeable gas flow pathway that is also conductive is more space efficient and improves power density. The inert permeable barrier 302.10 ensures that a convectively dominant flow regime prevails within the inert permeable barrier and, therefore, at the permeable reactant pathway inlet 302.16/inert permeable barrier outlet. The permeable reactant pathway 302.14 makes the reactant 302.8 available to the anode electrodes 302.4, which form part of a permeable anode electrode reactant pathway 302.18. The permeable anode electrode reactant pathway 302.18 supplies the reactant 302.8 to the anode cell reaction region 302.20. Unused reactant and reaction product 302.22 are output from the cell 302 via a permeable reactant pathway outlet 302.24.

Although not shown in the view 300B, the additional current collectors 114 are applied over inlet 302.16 and outlet 302.24 of the anode cell 302 prior to applying the inert permeable barrier 302.10. Current is supplied to the anode cell 302 by these additional current collectors 114 and flows horizontally (or in-plane) to supply electrical current to the anode electrodes 302.4 and the reaction regions 302.20 where the electrochemical reactions take place. The resistive or ohmic loss associated with this current flow is, therefore, dependent on the in-plane sheet electrical conductance of the electrodes 302.4 and current collector 302.6 in addition to the horizontal distance over which current travels to reach the electrodes from where it is supplied at the cell inlet 302.16 and outlet 302.24 as well as the magnitude of the current supplied.

Referring to FIG. 3B.2, there is shown a sectional view of the anode cell described above with reference to FIG. 3B.1 showing dimensions of the various layers.

The anode cell has the following characteristics:
the inert permeable barrier 302.10 has a depth of d_{b} in the reactant flow direction,
the permeable anode electrode 302.4 has a depth in the reactant flow direction of dₑ,
the permeable anode current conductor 302.6 has a depth in the reactant flow direction of dₑ,
the pair of electrolytes 302.2 also have a depth in the reactant flow direction of dₑ,
the permeable anode electrode has a thickness denoted by tₐₙ,
the permeable anode current conductor 302.6 has a thickness of tₑ,
the electrolytes 302.2 both have a thickness of tₑₗ, and
the inert permeable barrier layer 302.10 has a thickness of t_{b}, which is the same as the overall anode cell thickness t_{aco}

Referring to FIG. 3C.1, there is shown a view 3000 of a cathode cell 304. The cathode cell is shown as comprising a reactant flow 304.8. The reactant flow 304.8 is fed to a permeable reactant pathway 304.14 via a permeable reactant pathway inlet 304.16. The permeable reactant pathway 304.14 is carried by a suitably permeable structure 304.6 as described herein. Examples can be realised in which the suitably permeable structure 304.6 is a current collector, such as, for example, a cathode current collector. Examples can be realised, however, in which the suitably permeable structure 304.6 is made from the same material as the cathode electrode and, therefore, effectively eliminated or replaced. Still further examples can be realised in which the suitably permeable structure is a heterogeneous structure comprising multiple layers or entities, as opposed to being a single homogeneous structure. Still further examples can be realised in which the suitably permeable structure 304.6 is not electrically conductive or not highly conductive thereby reducing or eliminating its function as a current collector. The permeable reactant pathway 304.14 makes the reactant 304.8 available to the cathode electrodes 304.4, which form part of a permeable cathode electrode reactant pathway 304.18. The permeable cathode electrode reactant pathway 304.18 supplies the reactant 304.8 to the reaction region 304.20. Unused reactant and reaction product 304.22 are output from the cell 304 via a permeable reactant pathway outlet 304.24.

Although not shown in the FIG. 3000, the additional current collectors 116 are applied over the inlet 304.16 and outlet 304.24 of the cathode cell 304. Current is thus collected from the cathode electrodes 304.4 and the reaction regions 304.20 where the electrochemical reactions take place and flows horizontally (or in-plane) toward these additional collectors to be removed from the cathode cell. The resistive or ohmic loss associated with this current flow is therefore dependent on the in-plane sheet electrical conductance of the electrodes 304.4 and current collector 304.6 in addition to the horizontal distance over which current must travel from the electrodes to reach the inlet 304.16 and outlet 304.24 where it is removed from the cell as well as the magnitude of the current collected.

Referring to FIG. 3C.2, there is shown a sectional view of the cathode cell described above with reference to FIG. 3C.1 showing dimensions of the various layers.

The cathode cell has the following characteristics:
the permeable cathode electrode 304.4 has a width in the oxidant flow direction of w_{c},
the permeable cathode current conductor 304.6 has a width in the oxidant flow direction of w_{c},
the pair of electrolytes 304.2 also have a width in the oxidant flow direction of w_{c},
the permeable cathode electrode has a thickness denoted by t_{ca},
the electrolytes 304.2 have a thickness tₑₗ
the permeable cathode current conductor 304.6 has a thickness of t_{c}, and
the overall cell has a thickness of t_{cco}.

Referring to FIG. 3D.1, there is shown a view 300D of a chemical coolant cell 306 together with barriers according to an example. The chemical coolant cell is shown as comprising a chemical coolant flow 306.8. The chemical coolant flow 306.8 is fed to a chemical coolant cell inert permeable barrier 306.10. The inert permeable barrier 306.10 provides a chemical coolant cell inert permeable barrier pathway 306.12. The chemical coolant cell inert permeable barrier pathway 306.12 is arranged to at least reduce, and, preferably, eliminate, diffusion effects of any gas species within the inert permeable barrier before the interface 306.13 between the end of the inert permeable barrier 306.10 and the chemical coolant cell 306. The chemical coolant cell inert permeable barrier pathway 306.12 is arranged to feed a permeable chemical coolant cell pathway 306.14 via a permeable chemical coolant cell pathway inlet 306.16. The permeable chemical coolant cell pathway 306.14 is carried by a suitably permeable structure 306.4 as described herein that forms the reaction region 306.20. Examples can be realised in which the suitably permeable structure 306.4 is a permeable chemical coolant catalyst. Still further examples can be realised in which the suitably permeable structure is a heterogeneous structure comprising multiple layers or entities, as opposed to being a single homogeneous structure. Further examples can be realised in which the permeable conductor 306.2 is solid or almost solid (to support electrical conduction if the chemical coolant catalyst 306.4 does not conduct electricity sufficiently) as it is not involved in supporting chemical reactions. The inert permeable barrier 306.10 ensures that a convectively dominant flow regime prevails both within the inert permeable barrier and at the inlet to the suitably permeable structure 306.4. The chemical coolant enters the chemical coolant cell via the permeable chemical coolant cell pathway inlet 306.16 and leaves the chemical coolant cell via a permeable chemical coolant cell pathway outlet 306.24 where the chemical coolant passes through a second chemical coolant cell inert permeable barrier 306.10 disposed at the permeable chemical coolant cell pathway outlet 306.24. The chemical coolant catalyst supports the reactions shown below in Table 8, which are CH₄+H₂O→3H₂+CO and CO+H₂O→H₂+CO₂. Unused reactant and reaction product 306.22 are output from the cell 306 via the permeable chemical coolant cell pathway outlet 306.24 via a second chemical coolant cell inert permeable barrier pathway 306.12 within the second chemical coolant cell inert permeable barrier 306.10. It will be appreciated the chemical coolant is a reactant and that the chemical coolant reformate is a reaction product.

Although not shown in the FIG. 3D.1, current flows horizontally (or in-plane) through the chemical coolant cell to facilitate the electrical connections between adjacent stacks via respective interconnects. The resistive or ohmic loss associated with this current flow is, therefore, dependent on the in-plane sheet electrical conductance of the permeable chemical coolant catalyst 306.4 and permeable conductor 306.2 in addition to the horizontal distance over which current travels between the respective interconnects as well as the magnitude of the current supplied.

Therefore, examples provide a multi-layered structure for a fuel cell comprising:
an electrolyte;
a permeable anode electrode;
an inert permeable barrier;
the permeable anode electrode and electrolyte having a common interface to form a reaction region;
the permeable anode electrode providing a permeable anode electrode reactant pathway through the electrode to present a reactant at the common interface; the permeable anode electrode reactant pathway being fed by a permeable anode reactant pathway that is hosted by a permeable anode reactant pathway structure, and
the inert permeable barrier comprising an inert permeable barrier reactant pathway to at least one, or both, of:
provide an effective depth greater than a physical depth of the inert permeable barrier to at least reduce, preferably, eliminate, diffusion of any gas species within the inert permeable barrier reactant pathway to form a convectively dominant reactant flow regime within the inert permeable barrier, or
to host a convectively dominant reactant flow regime within the inert permeable barrier,
wherein the inert permeable barrier reactant pathway is coupled to the permeable anode reactant pathway.

The permeable anode reactant pathway and a permeable anode reactant pathway structure are related, or defined, by

$$\frac{{τ}_{e}^{2}}{{ε}_{e}} \frac{{d}_{e}^{2}}{{f}_{e}^{2} {t}_{e}^{3}} ,$$

which relates the geometric parameters of the permeable anode reactant pathway and its associated pathway structure to the fuel cell operating parameters, and
the inert permeable barrier at the anode reactant pathway inlet comprises an inert permeable barrier reactant pathway defined by

$$\frac{{d}_{b} {d}_{e} {τ}_{b}^{2}}{{t}_{e} {ε}_{b}} ,$$

which relates the geometric parameters of the inert permeable barrier and its associated pathway to the fuel cell and associated barrier operating parameters (such as, for example in Table 1),
where
τₑ is the permeable anode reactant pathway tortuosity in the reactant flow direction,
τ_{b} is the inert permeable barrier reactant pathway tortuosity in the reactant flow direction,
εₑ is permeable anode reactant pathway structure porosity,
ε_{b} is the inert permeable barrier porosity,
dₑ is the permeable anode reactant pathway structure depth in the reactant flow direction,
d_{b} is the inert permeable barrier depth in the reactant flow direction,
tₑ is the permeable anode reactant pathway structure thickness,
fₑ is the ratio of permeable anode reactant pathway pore size to permeable anode reactant pathway structure thickness, tₑ.

Examples of the relationship between the geometric parameters of the permeable anode reactant pathway and its associated pathway structure to the fuel cell operating parameters are given in Table 1.

Examples of the relationship between the geometric parameters of the inert permeable barrier and its associated pathway to the fuel cell and associated barrier operating parameters are given in Table 1.

Examples can be realised in which the multi-layered structure also comprises at least one, or more than one, of the following characteristics taken jointly and severally in any and all permutations:
the permeable anode reactant pathway structure thickness, tₑ, has a predetermined thickness arranged to balance cell packing density, or power density, following from a relatively smaller permeable reactant pathway structure thickness, and in-plane electrical sheet conductance, following from a relatively larger permeable reactant pathway structure thickness to reduce resistive losses;
the permeable anode reactant pathway structure thickness, tₑ, has a range of 5 μm to 1000 μm, optionally, 5 μm to 500 μm and, preferably, 10 μm to 150 μm,
the ratio

$$\frac{{τ}_{e}^{2}}{{ε}_{e} {f}_{e}^{2}}$$

influences the balance between an additional, preferably, smallest, flow resistance provided by the permeable reactant pathway structure while providing structural strength and in-plane electrical sheet conductance to balance resistive losses;
the ratio

$$\frac{{τ}_{e}^{2}}{{ε}_{e} {f}_{e}^{2}}$$

has a range of 1 to 500, optionally, 2 to 50, which represents the additional flow resistance through the permeable anode reactant pathway as compared to a straight pipe of diameter tₑ,
the permeable anode reactant pathway structure depth, dₑ, is selected according to manufacturing capabilities to balance cell handling capabilities, since below a given lower depth limit handling cells would be difficult, and power density, which influences an upper limit of cell thickness since large cell depths would require cell thickness to increase dramatically to account for ohmic losses and pressure drops, which would adversely lead to a lower power density overall;
the permeable anode electrode reactant pathway structure depth, dₑ, has a range of 0.25 mm to 40 mm, optionally, 0.25 mm to 20 mm and, preferably, of 5 mm to 20 mm,
the ratio

$$\frac{{d}_{b} {τ}_{b}^{2}}{{ε}_{b}}$$

is associated with a range of effective depths in the flow direction of the inert permeable barrier pathway to influence, that is, to limit, at least to reduce, or to eliminate, diffusion effects, as described below in paragraphs [00209] to [00251];
the ratio

$$\frac{{d}_{b} {τ}_{b}^{2}}{{ε}_{b}}$$

has a range of 2 to 2500 mm, optionally, 10 to 500 mm and, preferably 50 to 250 mm, and more preferably, less than 200 mm,
the ratio, fₑ, of permeable anode reactant pathway pore size to permeable anode reactant pathway structure thickness, tₑ, is selected to balance flow resistance with providing structural strength and in-plane electrical sheet conductance to influence or constrain electrical resistive losses;
the ratio, fₑ, of permeable anode reactant pathway pore size to permeable anode reactant pathway structure thickness, tₑ, has a range of 0.02 to 1, and, preferably, 0.25 to 0.75,
the permeable anode reactant pathway tortuosity, τₑ, is arranged to at least reduce, preferably minimise, flow resistance, and, therefore, pressure drops across the permeable anode reactant pathway;
the permeable anode reactant pathway tortuosity, τₑ, has a range of 1 to 3, optionally, 1 to 2.5, and preferably 1 to 2,
the inert permeable barrier pathway tortuosity, τ_{b}, is arranged to at least reduce, and, preferably, minimize, diffusion effects by increasing the effective diffusion depth;
the inert permeable barrier pathway tortuosity, τ_{b}, has a range of 1 to 10, optionally, 1 to 5,
the permeable anode reactant pathway structure porosity, εₑ, is selected to balance flow resistance against structural strength and in-plane sheet electrical conductance of the permeable anode reactant pathway structure;
the permeable anode reactant pathway structure porosity, εₑ, has a range of 0.1 to 0.9, and, preferably, 0.5 to 0.8,
the inert permeable barrier porosity, ε_{b}, has a lower bound to accommodate an orifice or foraminate plate example and an upper bound to accommodate higher tortuosity materials
the inert permeable barrier porosity, ε_{b}, has a range of 0.01 to 0.5, and preferably, 0.05 to 0.5,
the inert permeable barrier depth, d_{b}, can be set to achieve a balance, at a lower limit, between an increase in effective depth to limit diffusion, as described below with reference to paragraphs [00209] to [00251], and so cannot be too thin, with, at an upper limit, constraining size of the inert permeable barrier such that it has a volume smaller than an associated fuel cell, which influences overall power density; or
the inert permeable barrier depth, d_{b}, is greater or equal to 0.01 mm, optionally 0.01 mm to 5 mm and, preferably, 0.1 mm to 2 mm.

The ratio

$$\frac{{τ}_{e}^{2}}{{ε}_{e}} \frac{{d}_{e}^{2}}{{f}_{e}^{2} {t}_{e}^{3}} ,$$

which relates the geometric parameters of the permeable anode reactant pathway and its associated pathway structure to the fuel cell operating parameters, has a range of 5e6/m to 5e13/m, optionally, 5e8/m to 5e12/m and, preferably 1e10/m to 1e12/m.

The ratio

$$\frac{{d}_{b} {d}_{e} {τ}_{b}^{2}}{{t}_{e} {ε}_{b}} ,$$

which relates the geometric parameters of the inert permeable barrier and its associated pathway to the fuel cell and barrier operating parameters, has a range of 0.2 m to 1000 m, optionally, 1 m to 200 m, and preferably 10 m to 100 m.

The characteristics of the permeable anode or cathode reactant pathways and the characteristics of the inert permeable barriers of the examples described herein are such that the effective depth, in the reactant flow directions, for diffusion for the inert permeable barrier pathway is significantly increased relative to the geometrical depth of the inert permeable barrier layer and, hence, diffusion of gas species into and out of the inlet to the cell is at least reduced, and, preferably, minimised. Consequently, flow splitting between permeable reactant pathways is then primarily influenced through convective flow parameters, which are, in turn, driven by pressure difference and, hence, geometry, resulting in a convectively dominated flow regime that essentially precludes adverse flow splitting caused by variations in species concentrations driven by chemical and electrochemical electrode processes.

The convective flow parameters comprise the relative resistances of the permeable reactant pathway and barrier layers, which are higher than those of an open plenum feeding the gas species to the permeable reactant pathway and barrier layers thereby resulting in substantially uniform gas species flow into the permeable reactant pathways and barriers layers.

Effective depth for diffusion is the physical depth scaled by

$$\frac{{τ}_{x}^{2}}{{ε}_{x}} ,$$

where τₓ is the tortuosity experienced by a gas species within a given structure or material indicated by the subscript, x, and εₓ is the porosity experienced by a gas species within the given structure or material, x, so that it becomes a measure that describes a relative length-based scale factor that reduces diffusion. Permeability is defined as

$$\frac{{ε}_{x}}{{τ}_{x}^{2}} ,$$

that is, as the reciprocal of

$$\frac{{τ}_{x}^{2}}{{ε}_{x}} .$$

As described and used here, the terms “porosity” and “tortuosity” refers to the characteristics of a gas species pathway of or through a material. “Porosity” is defined as the volume fraction of connected void spaces in a porous material, i.e. the volume fraction of the gas pathway relative to the total volume of the material. “Tortuosity” is defined as the ratio of the extended length of the gas pathway pores between two points due to their circuitous paths relative to the straight line distance between those points. References to at least one, or both, of: porosity and tortuosity of a material are references to “porosity” and “tortuosity” defined above.

The porosity and tortuosity characteristics of a pathway through a permeable material are often determined by making comparisons between experimental measurements and the theoretical predictions for the flow of a multi-component gas mixture in idealised geometry, such as for example along a straight capillary tube of fixed pore diameter. Where, as described above, the porosity and tortuosity act as an appropriate scale factor to convert between theoretical predictions and experimental measurement. The effective or mean pore diameter of a permeable material can also be determined experimentally either from flow measurements or by some other means. Accordingly, the term “pore size”, as used herein, is defined as the foregoing “mean pore diameter”. Furthermore, references to the thermal and electrical conductivity of a permeable structure refers to the effective material properties taking into account the volume fraction of gas pathways and solid phases where it is expected that the solid phase makes a more significant contribution. Therefore, for example, at least one, or both, of: thermal conductivity and electrical conductivity of a highly porous material will be less than the thermal conductivity or electrical conductivity of a less porous material.

The Mass Peclet number, Peₘ, describes the ratio of convective mass transport to diffusive mass transport

$${Pe}_{m} = \frac{Lu}{D}$$

where
u is the convective gas velocity
D is a mass diffusion coefficient
L is a suitable length scale over which the diffusion is occurring; the length being a distance or depth in a respective flow direction,

When applied to an inert permeable barrier according to the examples described herein the Mass Peclet number, Peₘ, becomes

$${Pe}_{m} = \frac{{d}_{b} {τ}_{b}^{2}}{{ε}_{b}} \frac{u}{D}$$

which shows that a desired value of Peₘ can be achieved by adjusting the effective depth of the inert permeable barrier

$$\frac{{d}_{b} {τ}_{b}^{2}}{{ε}_{b}}$$

as described above. The examples provided and claimed herein aim to increase the value of Peₘ.

Heat transfer within and between the fuel cell structures of the examples described herein, such as the permeable reactant pathway, is dominated by conduction such that the heat generated by the electrochemical reactions can be absorbed by the cooling reactions within the chemical coolant cells.

The molar rate of reactant (hydrogen) consumption r per unit area of the anode electrode (302.4)/electrolyte (302.2) interface is given by

$$r = \frac{i}{2 F} \qquad Equation ( 1 )$$

where
i is the current density at the interface, and
F is Faraday's constant.

The convective velocity u averaged over the cross-sectional area of the permeable anode reactant pathway and its associated structure required to supply the reactant consumption rate r per unit area for a double sided anode cell with two electrode/electrolyte interfaces is given by

$$u = \frac{{id}_{e}}{{FU}_{f} {ct}_{e}} \qquad Equation ( 2 )$$

where
c is the molar gas density,
dₑ is the permeable anode reactant pathway structure depth in the reactant flow direction,
tₑ is the permeable anode reactant pathway structure thickness, and

U_{f} is a utilization factor indicating the proportion of the supplied reactant flow that is consumed.

The pressure drop Δp across the depth dₑ of the permeable anode reactant pathway structure in the reactant flow direction is given by

$$Δ p = \frac{{τ}_{e}^{2}}{{ε}_{e}} \frac{32 μ}{{t}_{e}^{2} {f}_{e}^{2}} {ud}_{e} \qquad Equation ( 3 )$$

where
fₑ is the ratio of permeable anode reactant pathway pore size to permeable anode reactant pathway structure thickness, tₑ,
μ is the reactant dynamic viscosity,
τₑ is the permeable anode reactant pathway tortuosity in the reactant flow direction, and
εₑ is permeable anode reactant pathway structure porosity.

Substituting for u from above and re-arranging, the geometric properties of the permeable anode reactant pathway and permeable anode reactant pathway structure are related, or defined, by

$$\frac{p}{T} \frac{Δ {pU}_{f}}{i} \frac{F}{32 μ R} = \frac{{τ}_{e}^{2}}{{ε}_{e}} \frac{{d}_{e}^{2}}{{t}_{e}^{3} {f}_{e}^{2}} \qquad Equation ( 4 )$$

which further relates these geometric properties to the operational parameters of the anode cell where in addition to the terms described above
p is the anode cell operating pressure,
T is the anode cell operating temperature, and
R is the universal gas constant.

In the above equation (4), the left-hand side captures the key choices made in operating a fuel cell while the right-hand side describes the geometry with which the fuel cell is constructed. Once the fuel cell has been constructed, the parameters on the left must be traded to maintain the same overall value. For example, if current density were increased, for instance, to support temporary operation such as take-off of an aircraft, other parameters on the left must be adjusted to compensate to maintain the same overall value. On the left-hand side, the first factor captures pressure corrected for temperature to effectively provide a molar density that describes how dense the flows are that are put through the fuel cell on a molar basis that can, in turn, be related to the current. The second factor

$$\frac{Δ {pU}_{f}}{i}$$

describes the pressure drop experienced per unit current density at which the fuel cell is operated noting that fuel utilisation effectively acts as a correction on the pressure drop experienced per unit current density at which the fuel cell is operated that drives increasing the pressure drop if fuel utilisation is decreased. The final factor

$$\frac{F}{32 μ R}$$

scales the combination of the first two factors to be able to relate this to the expression on the right-hand side that captures the key relationships between the geometrical dimensions of the flow path feeding the cell.

It follows that, for example, achieving a high volumetric power density which can be realised by lowering tₑ would also necessitate decreasing the depth of the cell dₑ otherwise unrealistic operating conditions such as, for example, excessive pressure drop will be incurred on the left hand side of equation (4).

Further details and ranges for all the geometric properties and operational parameters used in the expression above are given in Table 1.

Examples also provide a multi-layered structure fuel cell comprising:
an electrolyte;
a permeable cathode electrode;
the permeable cathode electrode and electrolyte having a common interface to form a reaction region;
the permeable cathode electrode providing a permeable cathode electrode reactant pathway through the electrode to present a reactant at the common interface; the permeable cathode electrode reactant pathway being fed by a permeable cathode reactant pathway.

The permeable cathode reactant pathway is hosted by a permeable cathode reactant pathway structure, which are related, or defined, by

$$\frac{{τ}_{c}^{2}}{{ε}_{c}} \frac{{w}_{c}^{2}}{{f}_{c}^{2} {t}_{c}^{3}} ,$$

which relates the geometric parameters of the permeable cathode reactant pathway and its associated pathway structure to the fuel cell operating parameters (such as, for example in Table 2),
where
τ_{c} is the permeable cathode reactant pathway tortuosity in an oxidant flow direction,
ε_{c} is the permeable cathode reactant pathway structure porosity,
w_{c} is the permeable cathode reactant pathway structure width in the oxidant flow direction,
t_{c} is the permeable cathode reactant pathway structure thickness,
f_{c} is the ratio of permeable cathode reactant pathway pore size to permeable cathode reactant pathway structure thickness, t_{c}.

Examples of the relationship between the geometric parameters of the permeable cathode reactant pathway and its associated pathway structure to the fuel cell operating parameters are given in Table 2.

It will be appreciated the cathode reactant comprises an oxidant such as, for example, oxygen. It will be appreciated that the depth of an anode cell and the width of a cathode cell are correlated, as are the width and depth of the other stack components. Examples can be realised in which the depth of an anode cell and the width of a cathode cell are the same.

Examples can be realised in which the multi-layered structure also comprises at least one, or more than one, of the following characteristics taken jointly and severally in any and all permutations:
the permeable cathode reactant pathway structure thickness, t_{c}, has a predetermined thickness arranged to balance cell packing density, or power density, following from a relatively smaller permeable reactant pathway structure thickness, and in-plane sheet electrical conductance, following from a relatively larger permeable reactant pathway structure thickness to reduce electrical resistive losses;
the permeable cathode reactant pathway structure thickness, t_{c}, has a range of 10 μm to 1000 μm, optionally, 10 μm to 600 μm and, preferably, 20 μm to 250 μm; the range of permeable cathode reactant pathway structure thickness, t_{c}, is greater than the range of the permeable anode reactant pathway structure thickness, tₑ, since the cathode provides a greater gas flow capacity and lower material electrical and thermal conductivities;
the ratio

$$\frac{{τ}_{c}^{2}}{{ε}_{c} {f}_{c}^{2}}$$

influences the balance between an additional, preferably, smallest, flow resistance provided by the permeable cathode reactant pathway material while providing structural strength and in-plane sheet electrical conductance to balance electrical resistive losses;
the ratio

$$\frac{{τ}_{c}^{2}}{{ε}_{c} {f}_{c}^{2}}$$

has a range of 1 to 500, optionally, 2 to 50,
the permeable cathode reactant pathway structure width, w_{c}, is selected according to manufacturing capabilities to balance cell handling capabilities, since below a given lower width limit handling cells would be difficult, and power density, which influences an upper limit of cell thickness since large cell widths would require cell thickness to increase dramatically to account for ohmic losses and pressure drops, which would adversely lead to a lower power density overall;
the permeable cathode reactant pathway structure width, w_{c}, has a range of 0.25 mm to 40 mm, optionally, 0.25 mm to 20 mm and, preferably, of 5 mm to 20 mm,
the ratio, f_{c}, of permeable cathode reactant pathway pore size to permeable cathode reactant pathway structure thickness, t_{c}, is selected to balance flow resistance with providing structural strength and in-plane sheet electrical conductance to influence or constrain electrical resistive losses;
the ratio, f_{c}, of permeable cathode reactant pathway pore size to permeable cathode reactant pathway structure thickness, t_{c}, has a range of 0.02 to 1, and, preferably, 0.25 to 0.75,
the permeable cathode reactant pathway tortuosity, τ_{c}, is arranged to at least reduce flow resistance, and, therefore, pressure drops across the permeable cathode reactant pathway;
the permeable cathode reactant pathway tortuosity, τ_{c}, has a range of 1 to 3, optionally, 1 to 2.5 and, preferably, 1 to 2;
the permeable cathode reactant pathway structure porosity, ε_{c}, is selected to balance flow resistance against structural strength and in-plane sheet electrical conductance of the permeable cathode reactant pathway structure;
the permeable cathode reactant pathway structure porosity, ε_{c}, has a range of 0.1 to 0.9, and, preferably, 0.5 to 0.8.

The ratio

$$\frac{{τ}_{c}^{2}}{{ε}_{c}} \frac{{w}_{c}^{2}}{{f}_{c}^{2} {t}_{c}^{3}} ,$$

which relates the geometric parameters of the permeable cathode reactant pathway and its associated pathway structure to the fuel cell operating parameters, has a range of 1e6/m to 5e12/m, optionally, 1e8/m to 5e11/m and, preferably 1e9/m to 2e11/m.

Accordingly, examples can be realised that provide a multi-layered structure for a fuel cell; the multi-layered structure comprising:
a planar electrolyte;
a planar permeable electrode;
an inert permeable barrier;
the electrode and electrolyte having a common planar interface to form a reaction region;
the permeable electrode providing a permeable electrode reactant pathway through the electrode to present a reactant at the common planar interface; the planar permeable electrode reactant pathway being fed by a permeable reactant pathway, and
the inert permeable barrier comprises an inert permeable barrier reactant pathway,
wherein the inert permeable barrier reactant pathway feeds the permeable reactant pathway,
wherein:
the planar permeable reactant pathway is hosted by a permeable reactant pathway structure, which are related, or defined, by

$$\frac{{τ}_{p}^{2}}{{ε}_{p}} \frac{{d}_{p}^{2}}{{f}_{p}^{2} {t}_{p}^{3}} ,$$

and
the inert permeable barrier reactant pathway is defined by

$$\frac{{d}_{b} {d}_{p} {τ}_{b}^{2}}{{t}_{p} {ε}_{b}}$$

where
τₚ is the permeable reactant pathway tortuosity in the reactant flow direction,
τ_{b} is the inert permeable barrier pathway tortuosity in the reactant flow direction,
εₚ is the permeable reactant pathway structure porosity,
ε_{b} is the inert permeable barrier porosity,
dₚ is the permeable reactant pathway structure depth in the reactant flow direction,
d_{b} is the inert permeable barrier depth in the reactant flow direction,
tₚ is the permeable reactant pathway structure thickness,
fₚ is the ratio of permeable reactant pathway pore size to permeable reactant pathway structure thickness, tₚ.

The multi-layered structure can further comprise an electrode current collector to collect current from the planar electrode and to provide the permeable reactant pathway structure. The above-described anode current collector 104.4 and the above-described cathode current collector 106.4 are examples of such an electrode current collector.

Referring to FIG. 3D.2, there is shown a sectional view of the chemical coolant cell described above with reference to FIG. 3D.1 showing dimensions of the various layers.

The chemical coolant cell has the following characteristics:
the pair of permeable conductors 306.2 have a depth of d_{cc},
the permeable chemical coolant catalyst layer 306.4 has a depth in the chemical coolant flow direction of d_{cc},
the chemical coolant cell inert permeable barrier 306.10 has a depth in the chemical coolant flow direction of d_{ccb},
the pair of permeable conductors have a thickness of t_{pc},
the permeable chemical coolant catalyst layer has a thickness denoted by t_{cc}, and
the chemical coolant cell inert permeable barrier 306.10 has a thickness of t_{ccb} which is the same as the overall chemical coolant cell thickness of t_{ccco}.

Referring to FIG. 3E.1, there is shown a view 300E of a combustion cell 308 together with barriers according to an example. The combustion cell is shown as comprising a reactant flow 308.8. The reactant flow 308.8 is fed to an inert permeable barrier 308.10. The inert permeable barrier 308.10 provides a combustion cell inert permeable barrier pathway 308.12. The combustion cell inert permeable barrier pathway 308.12 is arranged to at least reduce, and, preferably, eliminate, diffusion effects before the interface 308.13 between the end of the inert permeable barrier 308.10 and the combustion cell 308. The combustion cell inert permeable barrier pathway 308.12 is arranged to feed a permeable combustion cell pathway 308.14 via a permeable combustion cell pathway inlet 308.16. The permeable combustion cell pathway 308.14 is carried by a suitably permeable structure 308.4 as described herein that forms the reaction region 308.20. Examples can be realised in which the suitably permeable structure 308.4 is a permeable combustion cell catalyst. Still further examples can be realised in which the suitably permeable structure is a heterogeneous structure comprising multiple layers or entities, as opposed to being a single homogeneous structure. The inert permeable barrier 308.10 ensures that a convectively dominant flow regime prevails both within the inert permeable barrier and at the inlet to the suitably permeable structure 308.4. The reactant enters the combustion cell via the combustion cell pathway inlet 308.16 and leaves the combustion cell via a permeable combustion cell pathway outlet 308.24 where the reactant passes through a second combustion cell inert permeable barrier 308.10 disposed at the permeable combustion cell pathway outlet 308.24. The combustion cell catalyst supports the reaction shown below in Table 8, which is 2H₂+O₂→2H₂O. Unused reactant and reaction product 308.22 are output from the cell 308 via the permeable reactant pathway outlet 308.24 via a second combustion cell inert permeable barrier pathway 308.12 within the second inert permeable barrier 308.10.

Referring to FIG. 3E.2, there is shown a sectional view of the combustion cell described above with reference to FIG. 3E.1 showing dimensions of the various layers.

The combustion cell has the following characteristics:
the pair of impermeable dense layers 308.2 have depths of d_{cl},
the permeable combustion catalyst layer 308.4 has a depth in the reactant flow direction of d_{cl},
the combustion cell inert permeable barriers 308.10 have depths in the reactant flow direction of d_{cb},
the pair of impermeable dense layers 308.2 have thicknesses of t_{cldl},
the permeable combustion catalyst layer 308.4 has a thickness of t_{cl}, and
the combustion cell inert permeable barriers 308.10 have thicknesses of t_{cb}, which is the same as the overall combustion cell thickness of t_{clco}.

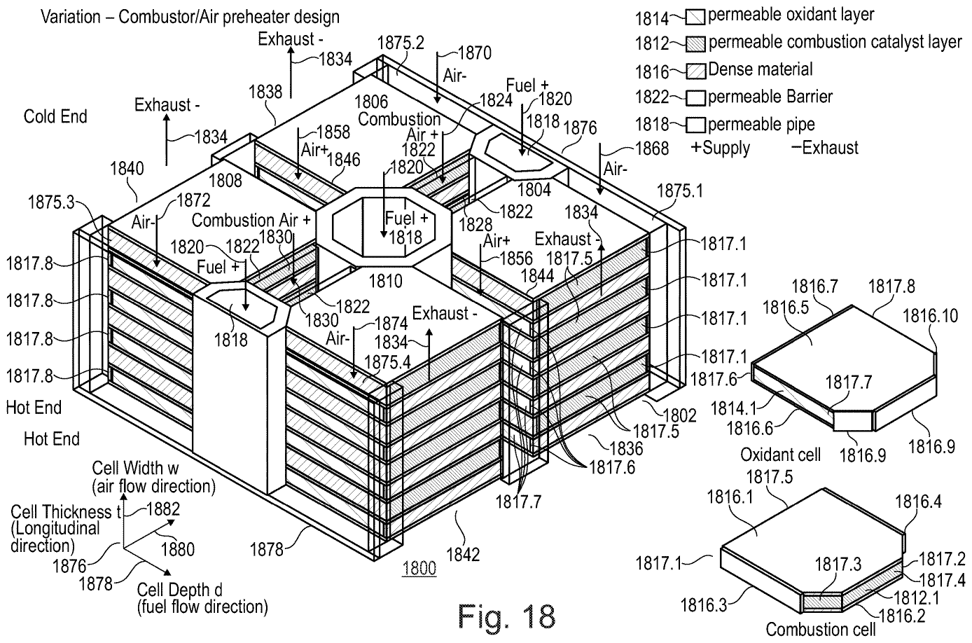

Referring to FIG. 3E.3, there is shown a sectional view of the combustor oxidant cell 1817.6 described with reference to FIG. 18 showing dimensions of the various layers.

The combustor oxidant cell has the following characteristics:
the pair of impermeable dense layers 1816.5 and 1816.6 have widths of w_{co},
the permeable oxidant layer 1814.1 has a width of w_{co} in the oxidant flow direction
the pair of impermeable dense layers have thickness of t_{codl},
the permeable oxidant layer 1814.1 has a thickness of t_{co}, and
the combustor oxidant cell has an overall thickness of t_{coco}.

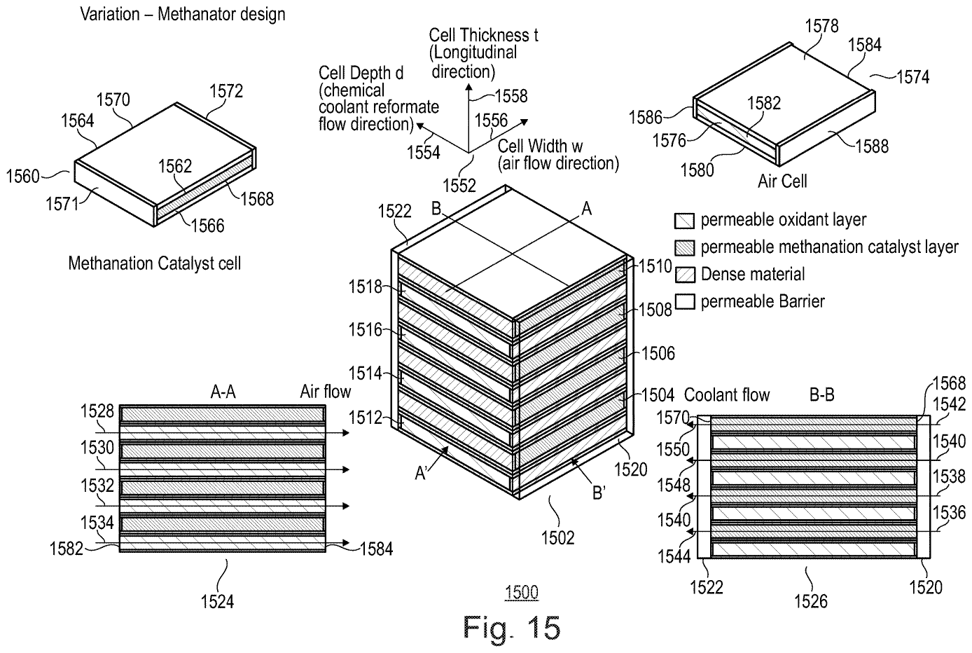

Referring to FIG. 3F.2, there is shown a sectional view of a permeable methanation catalyst cell 1504 to 1510 described with reference to FIG. 15 showing dimensions of the various layers.

The permeable methanation catalyst cell has the following characteristics:
a permeable methanation catalyst layer 1562 having a depth in the reactant flow direction of dₘ,
a pair of impermeable dense layers 1564 and 1566 having depths of dₘ,
a pair of methanator inert permeable barriers 1520 and 1522 having depths in the reactant flow direction of d_{mb},
the permeable methanation catalyst layer 1562 has a thickness of tₘ,
the pair of impermeable dense layers 1564 and 1566 have thicknesses of t_{mdl},
the pair of methanator inert permeable barriers 1520 and 1522 have thicknesses of t_{mb}, which is the same as the overall methanation cell thickness of t_{mco}.

Referring to FIG. 3F.3, there is shown a sectional view of the methanator oxidant cell 1574 described with reference to FIG. 15 showing dimensions of the various layers.

The methanator oxidant cell 1574 has the following characteristics:
the permeable oxidant layer 1576 has a width of wₘₒ, in the oxidant flow direction,
the pair of impermeable dense layers 1578 and 1580 have widths of wₘₒ,
the permeable oxidant layer 1576 has a thickness of tₘₒ,
the pair of impermeable dense layers 1578 and 1580 have thickness of t_{modl}, and
the methanator oxidant cell has an overall thickness of t_{moco}

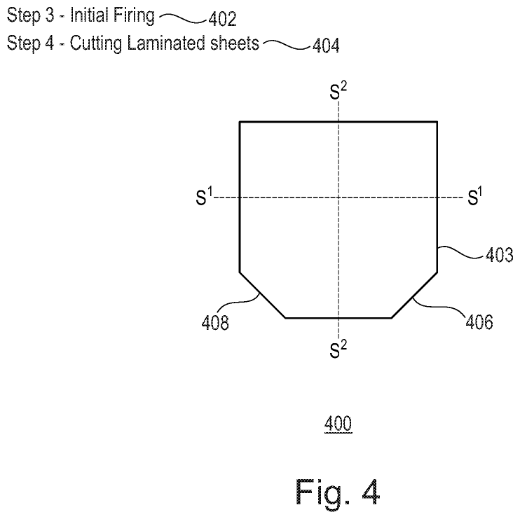

Referring to FIG. 4, there is shown a view 400 of an initial firing 402 of the above-described laminated sheets 403 coupled with cutting 404 of the above-described laminated sheets. It can be appreciated that any, that is, one or more than one, or all, of the above-described laminated sheets 302-308 each have adjacent corners removed. The adjacent removed corners create substantially rectangular facets 406 and 408. The facets 406 and 408 are used to form inlets and outlets for the chemical coolants used with the fuel cell in the chemical coolant cells.

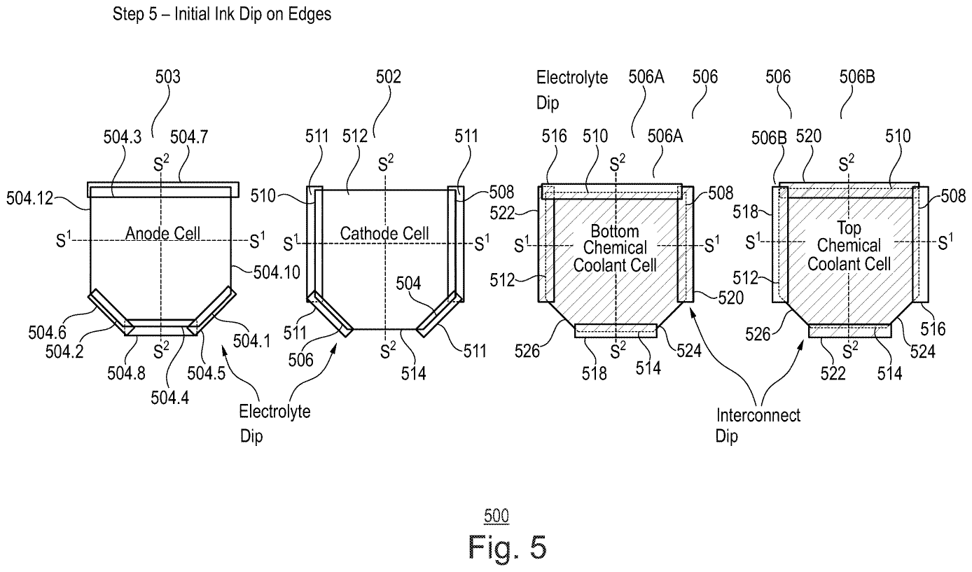

Referring to FIG. 5, there is shown a view 500 of a cathode cell 502, an anode cell 503 and a chemical coolant cell 506. The cathode cell 502 is an example of any cathode cell described herein such as, for example, cathode cell 304. The anode cell 503 is an example of any anode cell described herein such as, for example, anode cell 302. The chemical coolant cell 506 is an example of any chemical coolant cell described herein such as, for example, chemical coolant cell 306.

The cathode cell 502 is formed from an initially fired cut laminated sheet such as the laminated sheet 403 described above with reference to FIG. 4. The facets 406 and 408 presented by the removed corners and their selected adjacent edges 508 and 510 are sealed with an impermeable sealant. The impermeable sealant provides a barrier against oxidant egress from the sealed edges 504, 506, 508 and 510. Examples can be realised in which the edges are sealed using an electrolyte dip or ink 511 that soaks into the edges 504 to 510 of the cathode cell 502. The remaining edges 512, 514 of the cathode cell 502 remain undipped and, therefore, provide edge facets for supporting inlets and outlets for the cathode cell 502. The inlets and outlets are examples of the permeable reactant pathway inlet 304.16 and permeable reactant pathway outlet 304.24. The dip or ink 511 can be realised using for example ink 226.

Similarly, the anode cell 503 has a plurality of sealed edges 504.1 to 504.4 that are impermeable to a reactant intended to be carried within the anode cell 503. Again, facets 504.1 and 504.2 presented by the cut corners and adjacent edges 504.3 and 504.4 are sealed with the same electrolyte dip or ink 504.5 to 504.8. The sealed edges define a pair of edge apertures 504.10, 504.12 to allow ingress and egress of reactant through the anode cell 503. These inlets and outlets are examples of the permeable reactant pathway inlet 302.16 and permeable reactant pathway outlet 302.24.

The chemical coolant cell 506 similarly has four sealed edges 508 to 514. A pair of the sealed edges 510, 514 are sealed using the same electrolyte dip or ink to thereby form chemical coolant impermeable barriers 516 and 518, as described above with reference to the anode cell 503 and the cathode cell 502. A further pair of the sealed edges 508 and 512 are sealed using an interconnect dip or ink 228 to thereby form chemical coolant impermeable barriers 520 and 522. The dipped or inked edges define a pair of apertures 524 and 526. The pair of apertures 524 and 526 are formed from the facets 406 and 408 presented by removing the corners of the initially fired cut laminated sheet described above with reference to FIG. 4. The apertures 524 and 526 define ingress and egress apertures, or inlets and outlets, for a chemical coolant carried by the chemical coolant cell 506. The inlets and outlets are examples of the permeable chemical coolant cell pathway inlet 306.16 and permeable chemical coolant cell pathway outlet 306.24.

It will be noted that two chemical coolant cells are presented; one for the bottom of a stack, labelled Bottom Chemical Coolant Cell 506A, and one for the top of a stack, labelled Top Chemical Coolant Cell 506B. The Top and Bottom Chemical coolant cells are identical, but for the sealants. In the Top Chemical Coolant Cell, a pair of the sealed edges 510, 514 are sealed using the same interconnect dip or ink to thereby form chemical coolant impermeable barriers 520 and 522. A further pair of the sealed edges 508, 512 are sealed using the same electrolyte dip or ink to thereby form a chemical coolant impermeable barriers 516 and 518, as described above with reference to the anode cell 503 and the cathode cell 502. In the Bottom Chemical Coolant Cell, a pair of the sealed edges 508, 512 are sealed using the same interconnect dip or ink to thereby form chemical coolant impermeable barriers 520 and 522. A further pair of the sealed edges 510, 514 are sealed using the same electrolyte dip or ink to thereby form chemical coolant impermeable barriers 516 and 518, as described above with reference to the anode cell 503 and the cathode cell 502.

The electrolyte dip or ink can be realised using the above-described electrolyte ink 226. The interconnect dip or ink used to realise the impermeable barriers 520, 522 can be the above-described interconnect ink 228.

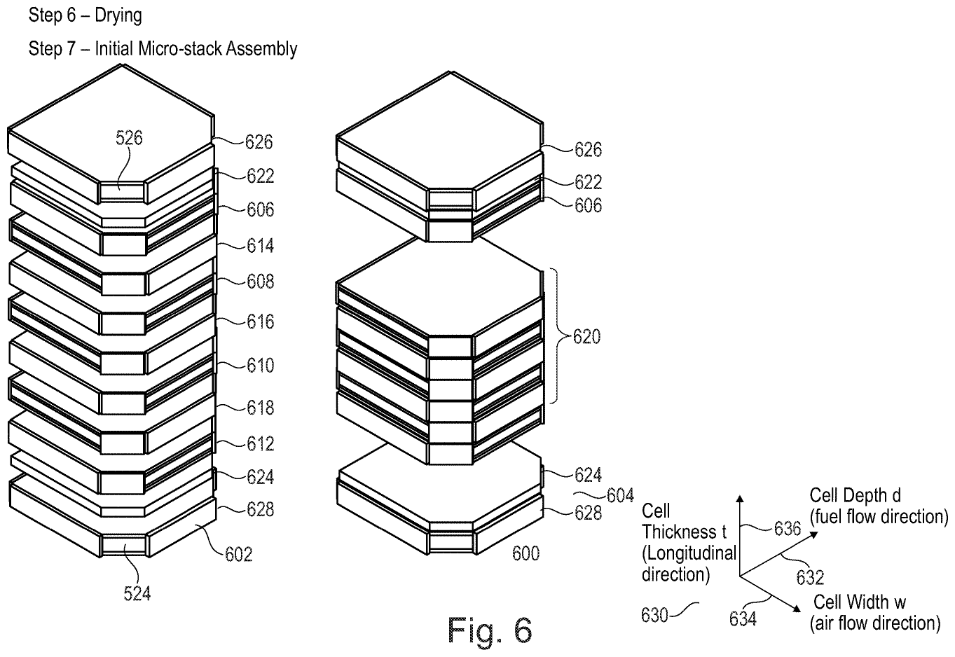

Referring to FIG. 6, there is shown a view 600 of a pair of expanded stacks 602 and 604. The pair 602 and 604 of stacks are identical but are shown in different states of assembly or expansion.

Prior to assembly, the dips or inks applied, as described with reference to FIG. 5, are dried. It can be appreciated that the stacks 602 and 604 comprise a set of chemical coolant cells, a set of anode cells, a set of cathode cells, and a set of dense insulators. Each anode cell of the set of anode cells is formed from a pair of anode half-cells. Each cathode cell of the set of cathode cells is formed from a pair of cathode half-cells. Each chemical coolant cell of the set of chemical coolant cells is formed from a pair of chemical coolant half-cells. In the example illustrated, the set of cathode cells comprises four cathode cells 606 to 612, the set of anode cells comprises three anode cells 614 to 618, and the set of chemical coolant cells comprises two chemical coolant cells 626 to 628. The anode cells are disposed in between respective pairs of cathode cells. Such a cathode/anode/cathode cell configuration aims to ensure that all anodes are double sided. Having such a double-sided arrangement supports establishing a uniform fuel flow regime. The sets of cathode cells 606 to 612 and anode cells 614 to 618 form a core 620 of repeat units. In the example shown, a repeat unit comprises an anode cell/cathode cell pair.

Although the example depicted in FIG. 6 illustrates a central core 620 comprising three repeat units, examples are not limited to such an arrangement. Examples can be realised in which some other number of repeat units is used. For example, a central core 620 comprising one or more than one repeat unit can be realised. Furthermore, examples can be realised in which a plurality of repeat units are used to realise the central core 620. Examples can be implemented in which ten or more repeat units are used to realise the central core 620.

Dense insulator layers 622 and 624 are disposed either side of, and outwardly relative to the outer most cathode cells 606 and 612. The dense insulator layers 622 and 624 can be realised using the above dense insulator green state sheets 220. The set of chemical coolant cells can comprise the pair of chemical coolant cells 626 and 628 that are positioned next to the dense insulator layers 622, 624.

The facets of the anode cells and cathode cells presented by the truncated corners are aligned with one another and are aligned with the apertures 524, 526 of the chemical coolant cells 626, 628. It will also be noted that the corners of the dense insulator layers 622, 624 have been similarly removed.

Referring to the partially assembled/partially expanded righthand view 604 of the stack, it can be appreciated that a tuple is formed that comprises the first cathode cell 606, the dense insulator layer 622 and the upper most coolant cell 626. Similarly, a further tuple is formed that comprises the lower most dense insulator layer 624 and the lower most chemical coolant cell 628. Also shown in FIG. 6 is a set of axes, or coordinate directions, 630. The coordinate directions 630 comprise three axes. A first axis 632 shows cell depth, or a reactant or fuel flow direction. A second axis 634 shows cell width, or an oxidant or air flow direction. A third axis 636 shows a cell thickness. It will be appreciated that the flow directions of the anode and cathode cells are perpendicular relative to one another within respective parallel planes.

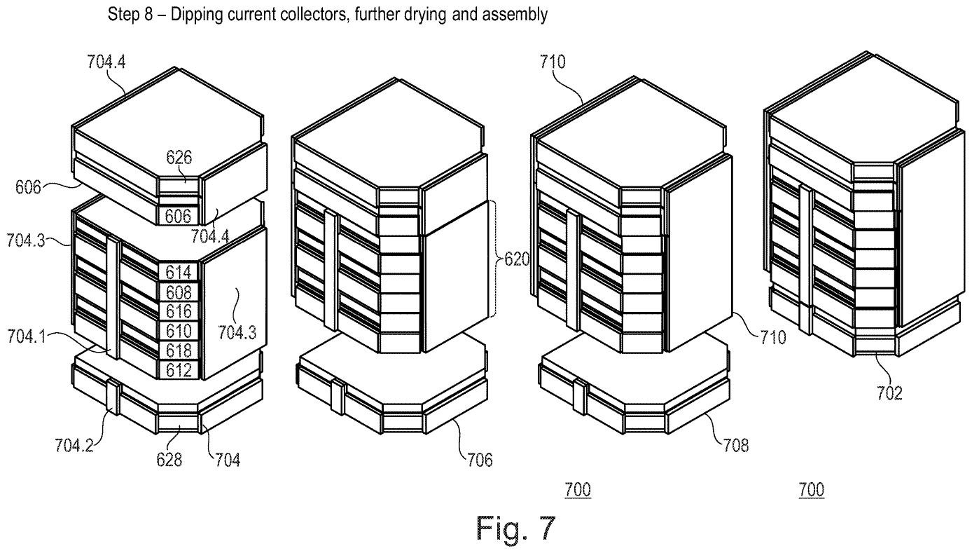

Referring to FIG. 7, there is shown a view 700 of further stages in fabricating a stack 702. The stack 702 is an example of the above-described stack 112, or any other fuel cell stack described herein.

FIG. 7 shows three additional views 704 to 708 of the stack 702 in different states of assembly.

Referring to the first view 704, current collectors are applied to respective portions of the stack. An anode current collector 704.1 is applied using a dip or using an anode current collector dip or ink. The anode current collector dip or ink can be realised using the above-described anode current collector ink 222. The anode current collector dip or ink 704.1 is arranged to span the anode current collectors of each of the anode cells 614, 616, 618, which electrically couples the anode current collectors of the core 620. A second anode current collector, identical to 704.1, is applied to the opposite side of the stack (not shown).

Similarly, respective further anode current collector dips or inks 704.2 are applied to two sides of the lower tuple (only one of which is shown) of the dense insulator layer 624 and chemical coolant cell 628.

The cathode current collectors of each of the cathode cells are electrically coupled by applying a cathode current collector dip or ink 704.3 to the cathode current collectors of each of the cathode cells. The cathode current collector dip or ink can be realised using the above-described cathode current collector ink 224. The cathode current collector dip or ink 704.3 is arranged to span the cathode current collectors of each of the cathode cells 608, 610, 612, which electrically couples the cathode current collectors of the core 620.

Similarly, a further cathode current collector dip or ink 704.4 is applied to the upper tuple comprising the cathode cell 606, the insulating layer 622 and the upper most chemical coolant cell 626 to electrically couple the upper most cathode cell 606 to the interconnect 520, 522 of the Top chemical coolant cell 626.

Referring to the second view 706 of the partially assembled stack, it can be appreciated that the core 620 has been placed adjacent to the upper tuple.

In the third view 708 of the stack, a still further layer of cathode current collector dip or ink 710 has been applied to couple the cathode current collector layers 704.3 and 704.4 of the core 620 and upper tuple respectively.

Similarly, in view 702, the lower tuple has been positioned adjacent to the core 620 to thereby couple the applied anode current collector layers 704.1 and 704.2 and, therefore, couple the anode cells to the interconnects 520 and 522 at the bottom of the chemical coolant cell 628.

Referring to FIG. 8, there is shown a view 800 of the next stage of manufacture of the stack. An inert permeable barrier layer 802 is applied to at least one side of the stack to form an inert permeable barrier over the inlet apertures of the anode cells. The inert permeable barrier layer 802 is an example of any of the above-described barrier layers.

The inert permeable barrier layer 802 can also at least reduce, or prevent, creepage electrical discharge at high altitude following loss of pressure by increasing length of the interface or pathway over which creepage electrical discharge must occur before becoming problematical. The inert permeable barrier layer 802 can be realised using a dip or ink such as the above-described permeable barrier ink 230.

Examples can be realised in which a further inert permeable barrier layer 804 is also added to the upper tuple. The further inert permeable barrier layer 804 can also at least reduce, or prevent, creepage electrical discharge at high altitude.

Similarly, still further permeable barriers 806.1 and 806.2 can be added to both sides of the lower tuple below the cathode current collectors, again, to at least reduce, or prevent, creepage electrical discharge at high altitude.

Therefore, examples can be realised that comprise at least the first permeable barrier layer 802 over the inlets to the anode cells with or without either, or both, of the further permeable barriers 804 and 806.

FIG. 8 also shows an example depicting alternative arrangements of the inert permeable barrier layer 802 for examples in which the inlet and outlets of the anode cells are reversed. The inert permeable barrier layer 802 is in position, again, over the inlets to the anode electrodes.

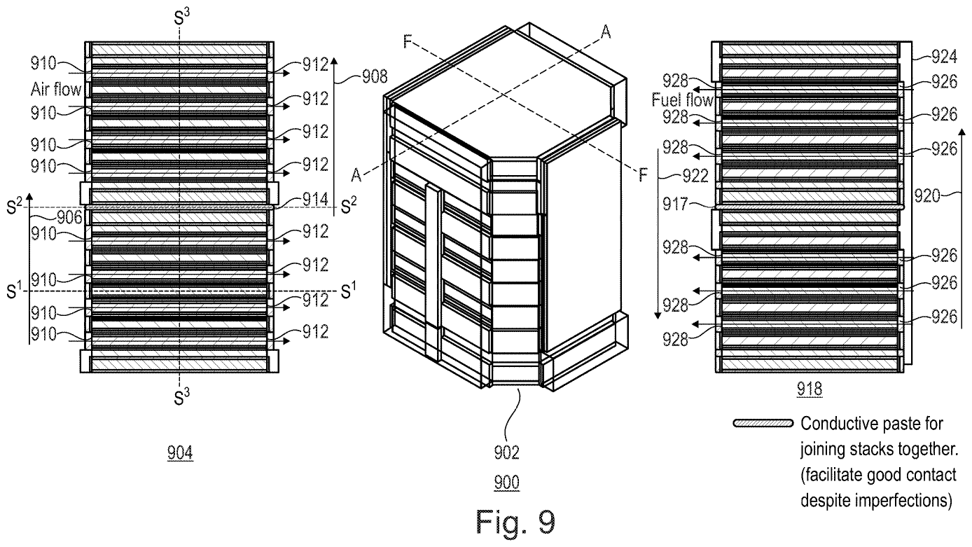

Referring to FIG. 9, there is shown a view 900 of a stack 902. The stack 902 can be any of the fuel cell stacks described and/or claimed herein.

Also shown in FIG. 9 is a first sectional view 904 through the stack along line FF. The first sectional view 904 shows the flow of oxidant through the stack. It will be appreciated that the first sectional view 904 actually depicts sectional views through two stacks 902. The two stacks are longitudinally arranged relative to one another along the same central axis (not shown). The oxidant flow comprises an oxidant supply flow 906 and an oxidant exhaust flow 908. The oxidant supply flow 906 feeds an oxidant such as, for example, oxygen or air, into the inlets 910 of the cathode cells of the stacks. The oxidant flows through the permeable reactant pathway 304.14 of each cathode cell. The oxidant leaves each cathode cell via a respective outlet 912 where any unused oxidant forms part of the oxidant exhaust flow 908.

The oxidant supply 906 and exhaust 908 flows are oriented in the same direction, which is vertically in the example depicted in FIG. 9. Arranging for the oxidant or air flows 906 and 908 to be in the same direction allows the flows to vent without having a manifold or the like as part of a housing, which would otherwise constrain or have to take into account thermal expansion of the stacks. The oxidant supply and exhaust flows being in the same direction facilitate establishing a more uniform temperature regime that has less temperature variation in the longitudinal direction of the stacks. Still further, ensuring that the oxidant is vented at one end of the stack and that reactant is collected at the other end of the stack ensures that the reactant and oxidant are kept separate, which prevents them mixing and combusting. Any such combusting would generate heat that would introduce undesirable local temperature variations.

In realising the examples, it will be appreciated that imperfections in the upper and lower faces of the stacks might need to be accommodated since those faces might not be perfectly flat. An electrically conductive paste 914 can be used to accommodate such imperfections when stacking the stacks. Examples can be realised in which the electrically conductive paste 914 additionally, or alternatively, provides a gas tight seal to seal the outermost permeable conductor layer such as, for example, when the latter is not solid or is otherwise permeable or compromised.

The view 900 of FIG. 9 also shows a further sectional view 918 through the pair of stacks along line AA. The pair of stacks is identical to the stack 902 depicted in FIG. 9.

The further sectional view 918 shows an associated reactant supply flow 920 and a fuel reformate and/or reactant exhaust flow 922. The reactant supply flow 920 passes through an inert permeable barrier layer 924. The inert permeable barrier 924 is an example of the above-described inert permeable barrier layer 302.10 or 802. The reactant then enters and flows through the permeable anode cells via respective permeable reactant pathway inlets 926 and leaves the permeable anode cell via respective permeable reactant pathway outlets 928. The foregoing inlets 926 and outlets 928 are examples of the permeable reactant pathways inlet 302.16 and permeable reactant pathway outlets 302.24. Any spent reactant, fuel reformate and/or unspent reactant is recovered via the reactant exhaust flow 922 where it can be used, for example, in the combustor or in some other way. The reactant exhaust flow 922 is an example of the unused reactant and reaction product exhaust flow 302.22.

Referring to FIG. 10, there is shown a view 1000 of a stack assembly 1002. The stack assembly is an example of the above stack assembly shown in and described with reference to FIG. 1.

The stack assembly 1002 comprises a set of stacks 1004 to 1010. In the example shown, the set of stacks comprises four stacks 1004 to 1010 of any of the above-described stacks such as, for example, stack 112. The stacks 1004 to 1010 are positioned adjacent to one another and oriented so that respective chemical coolant cell catalyst layer inlets are fed by a centrally disposed chemical coolant channel 1012.

Disposed at each outlet of each chemical coolant cell of each stack 1004 to 1010 is a respective chemical coolant exhaust channel 1014 to 1016. The chemical coolant exhaust channels 1014 to 1016 are used to carry at least one, or both, of excess chemical coolant or chemical coolant reformate produced as a consequence of a chemical coolant (not shown) flowing through the set of chemical coolant cells 306.

Still referring to the stack assembly 1002, a set of pairs of adjacent stacks share a fuel supply channel. The notation used for flows depicted herein is a flow name followed by a ‘+’ or ‘−’ sign. The name indicates the type of flow and the ‘+’ or ‘−’ sign indicates whether the flow is a supply flow or an exhaust flow. For example, ‘coolant+’ indicates a supply chemical coolant flow, ‘coolant−’ indicates an exhaust chemical coolant flow, fuel+ indicates a fuel supply flow, fuel-indicates an exhaust fuel flow, air+ indicates an air supply flow and air− indicates air exhaust flow.

As indicated, adjacent stacks share common fuel supply channels. In the example stack assembly 1002 shown in FIG. 10, a first set of adjacent stacks comprising first 1004 and second 1006 stacks share a common fuel supply channel 1022. A second set of adjacent stacks comprising stacks 1008 and 1010 also share a common fuel supply channel 1024. Both fuel supply channels 1022 and 1024 are sealed at one end by the central chemical coolant supply channel 1012 and at the opposite end by dense barriers 1062 and 1060 respectively.

Additionally, adjacent sets of stacks share an air or oxidant supply channel. In the example stack assembly 1002 shown in FIG. 10, a first set of stacks comprising first 1004 and fourth 1010 stacks share a common air supply channel 1026. A second set of stacks comprising second 1006 and third 1008 stacks also share a common air supply channel 1028.

Also visible in the stack assembly 1002 of FIG. 10 are sets of fuel exhaust channels 1030 to 1036 and sets of air exhaust channels 1038 and 1040. The fuel exhaust channels 1030 to 1036 are arranged to carry fuel exhaust flows 1040.1. The fuel exhaust flows 1040.1 are examples of the above-described fuel exhaust flows 922. The fuel exhaust flows can comprise at least one, or more than one, of: excess or unused fuel, a reformate such as, for example, cracked fuel, and one or more other reaction products such as, for example, steam; the foregoing being taken jointly and severally in any and all permutations.

The fuel exhaust flow, fuel-, is carried by respective fuel exhaust flow channels 1030 to 1036 that are defined by a set of fuel impermeable barriers. In the example depicted, two sets of such fuel impermeable barriers are indicated. A first set of fuel impermeable barriers comprises a substantially planar fuel impermeable barrier 1042 and a pair of fuel/reactant and oxidant impermeable barriers 1044 and 1046. A second set of fuel or reactant and oxidant impermeable barriers also comprises a substantially planar fuel impermeable barrier 1048 and a pair of fuel/reactant and oxidant impermeable barriers 1050 and 1052.

Referring to FIG. 11, there is shown a view 1100 of a stack 1102. The stack 1102 can be any of the above-described stacks. The stack 1102 is presented via two views 1100.1 and 1100.2. In common with the above stacks, the stack 1102 depicted in FIG. 11 comprises a set of anode cells 1104 to 1108 and a set of cathode cells 1110 to 1116. The sets of anode cells and cathode cells form a stack core 1118. The stack 1102 also comprises a set of chemical coolant cells 1120 to 1122. The stack core 1118 is separated from the set of chemical coolant cells by a set of dense insulator layers 1124 to 1126.

The anode cells 1104 to 1108 comprise anodes 1128 that have associated anode current collector layers 1130/302.6 as described above with reference to FIG. 3. The anode current collector layers 1130/302.6 are electrically coupled to one another via a further anode current collector 1131. The further anode current collector 1131 is an elongate layer that is appropriately dimensioned to carry the current anticipated as being supplied to the anode cells 1104 to 1108.

The cathode cells 1110 to 1116 comprise cathodes 1134 and associated cathode current collector layers 1136. The cathode current collector layers 1136 are examples of the cathode current collectors 304.6. The cathode current collector layers 1136 are electrically coupled to one another via a planar cathode current collector 1138.

The cells are sealed, and separated, by respective electrolytes 1140, which are examples of the electrolytes 302.2 forming part of the anode cell 302 and 304.2 forming part of the cathode cell 304.

The chemical coolant cells 1120 to 1122 comprise a chemical coolant catalyst 1142 disposed between respective set of permeable conductor layers 1144. The chemical coolant cells are examples of the above-described chemical coolant cell 306.

Respective sets of interconnects 1146 are applied to the set of chemical coolant cells 1120 to 1122.

An optional fuel polishing catalyst layer 1148 is deposited over the inlets to the anode cells 1104 to 1108. Furthermore, a fuel processing catalyst layer 1150 is deposited over the optional fuel polishing layer 1148. The fuel polishing layer 1148 and the fuel processing catalyst layer 1150 reduce, and preferably eliminate, adverse effects within the cells such as, for example, nitriding within the anodes 1128 of the anode cells. For example, the fuel polishing layer 1148 and the fuel processing catalyst layer 1150 are arranged to ensure that a reactant, such as, for example, ammonia, is fully decomposed into hydrogen and nitrogen prior to entering the anodes 1128 of the anode cells 1104 to 1108.

An inert permeable barrier layer 1152 is deposited over at least one, or both where present, of: the fuel polishing catalyst layer 1148 and the fuel processing catalyst layer 1150. The left-hand view 1100.1 is shown without the inert permeable barrier layer 1152 whereas the righthand view 1100.2 is depicted with the inert permeable barrier layer 1152. The inert permeable barrier layer 1152 is an example of the any of the above-described permeable barrier layers such as, for example, permeable barrier layer 112.1 or 924.

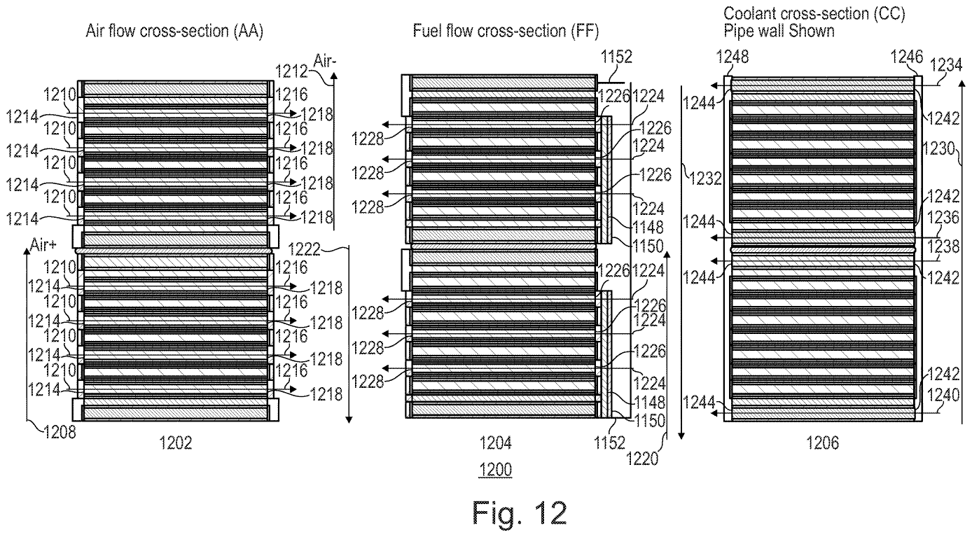

Referring to FIG. 12, there is shown a view 1200 of a set of sectional views 1202, 1204, 1206 through sections defined by sectional lines A-A, F-F and C-C in FIG. 11

The first sectional view 1202 shows a cross-section through the anode and cathode cells together with oxidant flows 1208 to 1212 through the cathode cells of a set of longitudinally adjacent or disposed stacks 1100.2. The oxidant flows comprise an oxidant supply flow 1208 and an oxidant exhaust flow 1212. The oxidant supply flow 1208 feeds the respective oxidant flows 1210 such as, for example, oxygen or air, via the respective oxidant inlets 1214 of the stacks. The oxidant flows through the permeable reactant pathway 304.14 of each cathode cell as indicated by respective oxidant flows 1216. The oxidant flows 1216 leave each cathode cell via respective outlets 1218 where any unused oxidant forms part of the oxidant exhaust flow 1212.

The second sectional view 1204 shows a cross-section through the anode and cathode cells together with reactant, or fuel, flows 1220 to 1224 through permeable barrier 1152, fuel polishing layers 1148, fuel processing layers 1150 and the anode cells of the set of longitudinally adjacent or disposed stacks 1100.2. The reactant flows comprise a reactant supply flow 1220 and a reactant exhaust flow 1222. The reactant supply flow 1220 feeds respective reactant flows 1224 via the respective anode inlets 1226 of the stacks. The reactant flows through the permeable reactant pathway 302.14 of each anode cell as indicated by respective reactant flows 1224. The reactant flows 1224 leave each anode cell via respective outlets 1228 where any unused reactant forms part of the reactant exhaust flow 1222. The reactant exhaust flow 1222 comprises at least one, or more than one, of: an exhaust species, a fuel reformate and unspent reactant, taken jointly and severally in any and all permutations.

The third sectional view 1206 shows the chemical coolant flows through the chemical coolant cells along section CC. The chemical coolant cells are examples of the above-described chemical coolant cells 306. The chemical coolant flows comprise a chemical coolant supply flow 1230 and a chemical coolant exhaust flow 1232. The chemical coolant supply flow 1230 feeds chemical coolant flows 1234 to 1240. The chemical coolant flows 1234 to 1240 enter the chemical coolant cells via respective chemical coolant inlets 1242 and leave the chemical coolant cells via respective chemical coolant outlets 1244. The chemical coolant inlets 1242 and the chemical coolant outlets 1244 have respective chemical coolant cell barriers 1246 and 1248. The respective chemical coolant cell barriers 1246 and 1248 are examples of any of the chemical coolant cell inert permeable barriers described herein. It will be noted that for clarity, the chemical coolant cell barriers have not been shown in FIG. 11. Examples can be realised in which the chemical coolant cell barriers are realised using a permeable portion of at least one, or both, of: the walls defining chemical coolant supply channel and the walls defining the chemical coolant exhaust channel; wherein the permeability of the portions of the walls aligned with the inlets and outlets is realised in a manner to have the characteristics of the inert permeable barriers described and/or claimed herein, with the remaining portions of the walls not intended to function as a barrier being appropriately sealed at least one, or both, of: internally and externally.

Each stack of the pair of stacks is identical to the stack 1100.2 depicted in FIG. 11.

Referring to FIG. 13, there is shown a view 1300 of a stack assembly 1302. The stack assembly is an example of the above stack assembly shown in and described with reference to FIG. 1.

The stack assembly 1302 comprises a set of stacks 1304 to 1310. In the example shown, the set of stacks comprises four stacks 1304 to 1310 of any of the above-described stacks such as, for example, stack 1100.2 described with reference to FIGS. 11 and 12. The stacks 1304 to 1310 are positioned adjacent to one another and oriented so that respective chemical coolant cell inlets are fed by a centrally disposed chemical coolant channel 1312.

Disposed at each outlet of each chemical coolant cell of each stack 1304 to 1310 is a respective chemical coolant exhaust channel 1314 to 1320. The chemical coolant exhaust channels 1314 to 1320 are used to carry at least one, or both, of excess chemical coolant or chemical coolant reformate produced as a consequence of a chemical coolant (not shown) flowing through the set of chemical coolant cells 306.

Still referring to the stack assembly 1302, a set of pairs of adjacent stacks share a fuel supply channel. The fuel supply channel is an example of the reactant supply channel for the reactant supply flow 1220 described above. The notation used for flows depicted herein is a flow name followed by a ‘+’ or ‘−’ sign. The name indicates the type of flow and the ‘+’ or ‘−’ sign indicates whether the flow is a supply flow or an exhaust flow. For example, ‘coolant+’ indicates a supply chemical coolant flow, ‘coolant−’ indicates an exhaust chemical coolant flow, fuel+ indicates a fuel supply flow, fuel− indicates an exhaust fuel flow, air+ indicates an air supply flow and air− indicates air exhaust flow.

As indicated, adjacent stacks share common fuel supply channels. In the example stack assembly 1302 shown in FIG. 13, a first set of adjacent stacks comprising first 1304 and second 1306 stacks share a common fuel supply channel 1322. A second set of adjacent stacks comprising stacks 1308 and 1310 also share a common fuel supply channel 1324.

Additionally, adjacent sets of stacks share an air or oxidant supply channel. In the example stack assembly 1302 shown in FIG. 13, a first set of stacks comprising the stacks second 1306 and third 1308 stacks share a common air supply channel 1326. A second set of stacks comprising the first 1304 and fourth 1310 stacks also share a common air supply channel 1328.

Also visible in the stack assembly 1302 of FIG. 13 are sets of reactant or fuel exhaust channels 1330 to 1338 and sets of air exhaust channels 1340 and 1342.

The fuel exhaust flow, fuel-, is carried by respective fuel exhaust flow channels 1330 to 1338 that are defined by a set of fuel impermeable barriers. In the example depicted, two sets of such fuel impermeable barriers are indicated. A first set of fuel impermeable barriers comprises a centrally disposed fuel or reactant and oxidant impermeable barrier 1344 and a substantially planar fuel impermeable barrier 1346. A second set of fuel or reactant and oxidant impermeable barriers comprises a similarly centrally disposed fuel and reactant and oxidant impermeable barrier 1348 and a substantially planar fuel impermeable barrier 1350. The stack assembly of FIG. 13 shows the two fuel processing layers 1148 and 1150.

Referring to FIG. 14A, there is shown a view 1400A of an array or set 1401 of stack assemblies. Each stack assembly 1402 to 1418 in the array 1401 can be realised using any of the stack assemblies described above, or herein.

The stack assemblies 1402 to 1418 are arranged in an ordered manner relative to one another. Examples can be realised in which stack assemblies of a set of stack assemblies are arranged linearly relative to one another as shown in the central column 1420 of FIG. 14A. Examples can be realised in which such columns of stack assemblies, such as columns 1420 to 1424 are also arranged in an aligned manner, that is, the stack assemblies in rows are aligned and the stack assemblies in columns are aligned. However, examples can also be realised in which stack assemblies of adjacent columns are offset relative to one another. The stack assemblies in the array can be arranged in any manner that aims to improve, that is, increase, the packing density of the stack assemblies that, in turn, improves the power density of the stack assemblies.

The above-described oxidant exhaust channels can be realised as a shared or common oxidant exhaust channel 1426 as depicted in FIG. 14A. The gaps between stack assemblies accommodate thermal expansion of the stack assemblies.

FIG. 14A shows the various flows and flow directions using the following:
reactant or fuel supply and exhaust flows are indicated using ‘F+’ and ‘F−’, which represent flows out of and into the page respectively in this example;
oxidant or air supply and exhaust flows are indicated using ‘A+’ and ‘A−’, which represent flows out of the page respectively in both instance in this example; and
chemical coolant supply and exhaust flows are indicated using ‘C+’ and ‘C−’, which represent flows out of and into the page respectively.

Although examples have been described in which the flow directions are as indicated in FIG. 14A, and any of the other figures, examples can be realised in which other flow directions are used. For instance, examples can be realised in which at least one, or both, of: the flow directions are reversed or in which the flow functions are reversed, that is, supply flows become exhaust flows and visa-versa. Further examples can be realised in which different combinations of supply and exhaust channels can be used. For example, a chemical coolant exhaust channel could be disposed diagonally opposite the central chemical coolant supply channel.

Referring to FIG. 14B, there is shown a view 1400B of an array or set 1401 of stack assemblies. Each stack assembly 1402 to 1418 in the array 1401 can be realised using any of the stack assemblies described above, or herein. Reference numerals common to FIGS. 1400A and 1400B refer to the same entities.

It can be seen that the repeating unit of the stack assemblies comprises a set of stacks 1428 to 1442, a set of fuel supply channels 1444 to 1450, a set of fuel exhaust channels 1452 to 1462, a set of oxidant supply channels 1464 to 1470, a set of oxidant exhaust channels 1426, a set of chemical coolant supply channels 1472 to 1474, and a set of chemical coolant exhaust channels 1476 to 1480. In the example depicted, the set of stacks comprises n×m stacks, where n≥1 and m≥1. In the particular example shown in FIG. 1400B, n=4 and m=2. However, examples are not limited to such values of n and m. Examples can be realised in which other values of n and m are used.

Table 1 below shows a summary of parameters associated with an anode cell according to any of the example anode cells described herein. For each parameter, where appropriate, upper and lower bounds are given together with a typical or mid-point in the form of “Max”, “Min”, and “Mid”.

TABLE 1
Anode Cell Parameters

| | Anode Cell | |
|---|---|---|
| Component | Permeable Anode Reactant pathway | Inert Permeable Barrier and |
| | and structure (e) | pathway (b) |
| Notes | Based on molar flow of H2. All fuels are | Required at inlet only for anode |
| | essentially reformed into H2 so it's the | electrode |
| | correct flow rate to consider | |

| Ratio | $\frac{p Δ {pFU}_{f}}{RT 32 μ i} = \frac{{τ}_{e}^{2}}{{ε}_{e}} \frac{{d}_{e}^{2}}{{f}_{e}^{2} {t}_{e}^{3}} ( {m}^{- 1} )$ | | | $\frac{{Pe}_{m} {FpDU}_{f}}{RTi} = \frac{{d}_{b} {d}_{e} {τ}_{b}^{2}}{{t}_{e} {ε}_{b}} ( m )$ | | |
|---|---|---|---|---|---|---|
| Operational Point | Min | Mid | Max | Min | Mid | Max |
| Pressure p (bar) | 5 | 10 | 25 | 5 | 10 | 25 |
| Pressure Drop Δρ | 20 | 50 | 300 | 5.4 | 9.2 | 6.2 |
| (mbar) | | | | | | |
| Dynamic Viscosity μ | 4e-05 | 3e-05 | 2e-05 | | | |
| (Pa.s) | | | | | | |
| Universal Gas Constant | 8.3145 | | | 8.3145 | | |
| R (J/mol/K) | | | | | | |
| Faraday's constant F | 96485 | | | 96485 | | |
| (C/mol) | | | | | | |
| Current Density i | 0.3 | 0.2 | 0.1 | 0.3 | 0.2 | 0.1 |
| (A/cm2) | | | | | | |
| Temperature T (°C) | 900 | 800 | 580 | 900 | 800 | 580 |
| Fuel Utilization U_{f} | 0.33 | 0.9 | 0.95 | 0.33 | 0.9 | 0.95 |
| Fuel flow rate per cm2 | 9.4e-06 | 2.3e-06 | 1.1e-06 | 9.4e-06 | 2.3e-06 | 1.1e-06 |
| of anode cell area (with | | | | | | |
| 2 electrolyte interfaces) | | | | | | |
| (mol/s/cm2) | | | | | | |
| Mass Peclet Number | | | | 5 | 20 | 50 |
| Peₘ | | | | | | |
| Diffusion Coefficient D | | | | 8e-04 | 4e-4 | 1e-4 |
| (m2/s) | | | | | | |

| Ratio Value | 8.5e8 (1/m) | 2.5e 10(1/m) | 1.5e12 (1/m) | 2.3 (m) | 35 (m) | 156 (m) |
|---|---|---|---|---|---|---|
| Ratio Range | $5 e 8 < \frac{p Δ {pFU}_{f}}{RT 32 μ i} < 5 e 12 ( 1 / m ) ,$ | | | $1 < \frac{{Pe}_{m} {FpDU}_{f}}{RTi} < 200 ( m ) ,$ | | |
| | $optionally 1 e 10 < \frac{p Δ {pFU}_{f}}{RT 32 μ i} < 1 e 12 ( 1 / m )$ | | | $optionally 10 < \frac{{Pe}_{m} {FpDU}_{f}}{RTi} < 100 ( m )$ | | |
| Pathway Tortuosity | 1 < τₑ < 2 | | | 1 < τ_{b} < 5 | | |
| Porosity ε | 0.5 < εₑ < 0.8 | | | 0.05 < ε_{b} < 0.5 | | |
| Depth d | 0.5 < dₑ < 2 (cm) | | | d_{b} see below | | |
| Pathway pore size ratio | 0.25 < fₑ < 0.75 | | | | | |
| fₑ | | | | | | |

| Non-dimensional terms | $1 < \frac{{τ}_{e}^{2}}{{ε}_{e} {f}_{e}^{2}} < 500 , optionally 2 < \frac{{τ}_{e}^{2}}{{ε}_{e} {f}_{e}^{2}} < 50$ | | | $20 < \frac{{τ}_{b}^{2}}{{ε}_{b}} < 500 ,$ | | | | | |
|---|---|---|---|---|---|---|---|---|---|
| | $1.25 < \frac{{τ}_{e}^{2}}{{ε}_{e}} < 8 , optionally 2 < \frac{{τ}_{e}^{2}}{{ε}_{e}} < 8$ | | | $optionally 20 < \frac{{τ}_{b}^{2}}{{ε}_{b}} < 200$ | | | | | |
| | Permeable Reactant Pathway Structure | | | | | | | | |
| | Thickness | | | | | | | | |
| | tₑ(μm) | | | Barrier Depth d_{b} (mm) | | | | | |
| Ratio Value | 8.5e8 (1/m) | 2.5e10 (1/m) | 1.5e1 2(1/m) | 2.3 (m) | | 35 (m) | | 156 (m) | |
| $Non - dimensional term \frac{{τ}_{b}^{2}}{{ε}_{b}}$ | | | | 20 | 500 | 20 | 500 | 20 | 500 |
| ${d}_{e} = 0.5 ( cm ) , \frac{{τ}_{e}^{2}}{{ε}_{e} {f}_{e}^{2}} = 2.22$ | 40 | 13 | 3 | 0.9 | 0.04 | 4.6 | 0.2 | 5.2 | 0.2 |
| ${d}_{e} = 0.5 ( cm ) , \frac{{τ}_{e}^{2}}{{ε}_{e} {f}_{e}^{2}} = 128$ | 156 | 50 | 13 | 3.6 | 0.1 | 17.6 | 0.7 | 20.1 | 0.8 |
| ${d}_{e} = 2 ( cm ) , \frac{{τ}_{e}^{2}}{{ε}_{e} {f}_{e}^{2}} = 2.22$ | 102 | 33 | 8 | 0.6 | 0.02 | 2.9 | 0.1 | 3.3 | 0.1 |
| ${d}_{e} = 2 ( cm ) , \frac{{τ}_{e}^{2}}{{ε}_{e} {f}_{e}^{2}} = 128$ | 392 | 127 | 32 | 2.3 | 0.1 | 11.1 | 0.4 | 12.6 | 0.5 |

| Range | 5 < tₑ < 500 (μm), | | 0.01< d_{b} < 5 (mm), |
|---|---|---|---|
| | optionally 10 < tₑ < 150 (μm) | | optionally 0.1 < db < 2 (mm) |
| Effective Pathway Depth | | $\frac{{d}_{e} {τ}_{e}^{2}}{{ε}_{e}} ( cm )$ | $\frac{{d}_{b} {τ}_{b}^{2}}{{ε}_{b}} ( cm )$ |

| | | | | |
|---|---|---|---|---|
| ${d}_{e} = 0.5 ( cm ) , \frac{{τ}_{e}^{2}}{{ε}_{e}} = 1.25$ | 0.625 | 1.9 | 9.1 | 10.4 |
| ${d}_{e} = 0.5 ( cm ) , \frac{{τ}_{e}^{2}}{{ε}_{e}} = 8$ | 4 | 7.2 | 35.3 | 40.1 |
| ${d}_{e} = 2 ( cm ) , \frac{{τ}_{e}^{2}}{{ε}_{e}} = 1.25$ | 2.5 | 1.2 | 5.8 | 6.5 |
| ${d}_{e} = 2 ( cm ) , \frac{{τ}_{e}^{2}}{{ε}_{e}} = 8$ | 16 | 4.5 | 22.2 | 25.3 |

| Range | $0.5 < \frac{{d}_{e} {τ}_{e}^{2}}{{ε}_{e}} < 15 ( cm ) ,$ | $1 < \frac{{d}_{b} {τ}_{b}^{2}}{{ε}_{b}} < 50 ( cm ) ,$ | | |
|---|---|---|---|---|
| | $optionally 0.5 < \frac{{d}_{e} {τ}_{e}^{2}}{{ε}_{e}} < 10 ( cm ) ,$ | $optionally 5 < \frac{{d}_{b} {τ}_{b}^{2}}{{ε}_{b}} < 25 ( cm )$ | | |
| Barrier to Cell Pathway depth ratio | $\frac{{d}_{b} {τ}_{b}^{2}}{{ε}_{b}} / \frac{{d}_{e} {τ}_{e}^{2}}{{ε}_{e}}$ | | | |
| ${d}_{e} = 0.5 ( cm ) , \frac{{τ}_{e}^{2}}{{ε}_{e}} = 1.25$ | | 3.0 | 14.6 | 16.6 |
| ${d}_{e} = 0.5 ( cm ) , \frac{{τ}_{e}^{2}}{{ε}_{e}} = 8$ | | 1.8 | 8.8 | 10.0 |
| ${d}_{e} = 2 ( cm ) , \frac{{τ}_{e}^{2}}{{ε}_{e}} = 1.25$ | | 0.5 | 2.3 | 2.6 |
| ${d}_{e} = 2 ( cm ) , \frac{{τ}_{e}^{2}}{{ε}_{e}} = 8$ | | 0.3 | 1.4 | 1.6 |

| | |
|---|---|
| Range | $1 < \frac{{d}_{b} {τ}_{b}^{2}}{{ε}_{b}} / \frac{{d}_{e} {τ}_{e}^{2}}{{ε}_{e}} < 20 , optionally 2 < \frac{{d}_{b} {τ}_{b}^{2}}{{ε}_{b}} / \frac{{d}_{e} {τ}_{e}^{2}}{{ε}_{e}} < 10$ |

The inert permeable barrier pressure drops given in the tables herein are calculations and not prescribed operating parameters. These calculations have been provided for illustrative purposes and were obtained for a nominal inert permeable barrier pathway pore size of 100 microns. Neither the inert permeable barrier pressure drop or the inert permeable barrier pathway pore size strongly affect the primary function of any of the inert permeable barriers described herein, which is to at least reduce, or eliminate, diffusion effects. Hence either term can be prescribed independently to meet design specifications or match other requirements as necessary.

The parameter values given in all of the tables described herein are preferred parameter values and/or parameter value ranges. Examples can be realised in which wider parameter value ranges can be used, as described below with respect to the methods of operation and operating parameter spaces.

Table 2 below shows a summary of parameters associated with a permeable cathode reactant pathway and structure, which hosts, for example, the permeable reactant pathway 304.14 according to any of the cathode cells described herein. For each parameter, where appropriate, upper and lower bounds are given together with a typical or mid-point in the form of “Max”, “Mi”, and “Mid”.

TABLE 2
Cathode Cell Parameters

| Component | Permeable Cathode Reactant Pathway and | | |
|---|---|---|---|
| | Structure (c) | | |
| Notes | 1 mole of H2 requires 1/2 mole O2. O2 content or air is | | |
| | 20%. So 1 mol of H2 requires 2.5 moles of air | | |
| Ratio | $\frac{p Δ {pFU}_{a}}{2.5 RT 32 μ i} = \frac{{τ}_{c}^{2}}{{ε}_{c}} \frac{{w}_{c}^{2}}{{f}_{c}^{2} {t}_{c}^{3}} ( {m}^{- 1} )$ | | |
| Operational Point | Min | Mid | Max |
| Pressure p (bar) | 5 | 10 | 25 |
| Pressure Drop Δp (mbar) | 20 | 50 | 300 |
| Dynamic Viscosity μ (Pa.s) | 4.5e-05 | 4.25e-05 | 4?-05 |
| Universal Gas Constant R | 8.3145 | | |
| (J/mol/K) | | | |
| Faraday's constant F (C/mol) | 96485 | | |
| Current Density i (A/cm2) | 0.3 | 0.2 | 0.1 |
| Temperature T (°C) | 900 | 800 | 580 |
| Air Utilization Uₐ | 0.25 | 0.5 | 0.75 |
| Air flow rate per cm2 of cathode | 3.1e-05 | 1e-05 | 3.5e-06 |
| cell area with 2 electrolyte | | | |
| interfaces (mol/s/cm2) | | | |
| Ratio Value | 2.3e8 (1/m) | 4.0e9 (1/m) | 2.4e11 (1/m) |
| Ratio Range | $1 e 8 < \frac{p Δ p F {U}_{a}}{2.5 RT 32 μ i} < 5 e 11 ( 1 / m ) ,$ | | |
| | $optionally 1 e 9 < \frac{p Δ p F {U}_{a}}{2.5 RT 32 μ i} < 2 e 11 ( 1 / m )$ | | |
| Pathway Tortuosity τ_{c} | 1< τ_{c} <2 | | |
| Porosity ε_{c} | 0.5 < ε_{c} < 0.8 | | |
| Width w_{c} | 0.5 < w_{c} < 2 (cm) | | |
| Pathway pore size ratio f_{c} | 0.25 < f_{c} < 0.75 | | |
| Non-dimensional terms | $1 < \frac{{τ}_{c}^{2}}{{ε}_{c} {f}_{c}^{2}} < 500 , optionally 2 < \frac{{τ}_{c}^{2}}{{ε}_{c} {f}_{c}^{2}} < 50$ | | |
| | $1.25 < \frac{{τ}_{c}^{2}}{{ε}_{c}} < 8 , optionally 5 < \frac{{τ}_{c}^{2}}{{ε}_{c}} < 8$ | | |
| | Permeable Cathode Reactant Pathway Thickness t_{c} | | |
| | (μm) | | |
| Ratio Value | 2.3e8 (1/m) | 4.0e9 (1/m) | 2.4e11 (1/m) |
| ${w}_{c} = 0.5 ( cm ) , \frac{{τ}_{c}^{2}}{{ε}_{c} {f}_{c}^{2}} = 2.22$ | 62 | 24 | 6 |
| ${w}_{c} = 0.5 ( cm ) , \frac{{τ}_{c}^{2}}{{ε}_{c} {f}_{c}^{2}} = 128$ | 241 | 93 | 24 |
| ${w}_{c} = 2 ( cm ) , \frac{{τ}_{c}^{2}}{{ε}_{c} {f}_{c}^{2}} = 2.22$ | 157 | 61 | 16 |
| ${w}_{c} = 2 ( cm ) , \frac{{τ}_{c}^{2}}{{ε}_{c} {f}_{c}^{2}} = 128$ | 607 | 235 | 60 |

| | |
|---|---|
| Range | 10 < τ_{c} < 600 (μm), |
| | optionally 20 < τ_{c} < 250 (μm) |

The parameter values given in table 2 described herein are preferred parameter values and/or parameter value ranges. Examples can be realised in which wider parameter value ranges can be used, as described below with respect to the methods of operation and operating parameter spaces.

Table 3 below shows a summary of parameters associated with a chemical coolant cell according to any of the example chemical coolant cells described herein. For each parameter, where appropriate, upper and lower bounds are given together with a typical or mid-point in the form of “Max”, “Min”, and “Mid”.

TABLE 3

| | Chemical Coolant Cell Parameters | | | | | |
|---|---|---|---|---|---|---|
| Component | Permeable chemical coolant | | | Chemical Coolant Cell Inert | | |
| | catalyst layer and pathway (cc) | | | Permeable Barrier and pathway | | |
| | | | | (ccb) | | |
| Notes | Assuming a stack containing 20 | | | Required at inlet and outlet of | | |
| | anode cells that operates at maximum | | | chemical coolant catalyst layer | | |
| | current density of 0.3Acm2, each | | | | | |
| | chemical coolant cell requires | | | | | |
| | approximately the same chemical | | | | | |
| | coolant (20% Ch4, 80% steam) flow | | | | | |
| | rate as the fuel supplied to all 20 | | | | | |
| | anode cells to manage the heat | | | | | |
| | generated by the stack. Chemical | | | | | |
| | coolant utilization U_{c} > 1 when | | | | | |
| | chemical coolant requirement is less | | | | | |
| | than the maximum that could be | | | | | |
| | delivered. | | | | | |
| Ratio | $\frac{p Δ p F {U}_{c}}{20 RT 32 μ i} = \frac{{τ}_{cc}^{2}}{{ε}_{cc}} \frac{{d}_{cc}^{2}}{{f}_{cc}^{2} {t}_{cc}^{3}} ( {m}^{- 1} )$ | | | $\frac{P {e}_{m} F p D {U}_{c}}{20 R T i} = \frac{{d}_{c c b} {d}_{c c} {τ}_{c c b}^{2}}{{t}_{c c} {ε}_{c c b}} ( m )$ | | |
| Operational Point | Min | Mid | Max | Min | Mid | Max |
| Pressure p (bar) | 5 | 10 | 25 | 5 | 10 | 25 |
| Pressure Drop Δp | 20 | 50 | 300 | 5.4 | 9.2 | 6.2 |
| (mbar) | | | | | | |
| Dynamic Viscosity | 4e-05 | 3e-05 | 2e-05 | | | |
| μ (Pa.s) | | | | | | |
| Universal Gas | 8.3145 | | | 8.3145 | | |
| Constant R | | | | | | |
| (J/mol/K) | | | | | | |
| Faraday's | 96485 | | | 96485 | | |
| constant F (C/mol) | | | | | | |
| Current Density i | 0.3 | 0.2 | 0.1 | 0.3 | 0.2 | 0.1 |
| (A/cm2) | | | | | | |
| Temperature T | 900 | 800 | 580 | 900 | 800 | 580 |
| (°C) | | | | | | |
| Chemical coolant | 1 | 2 | 5 | 1 | 2 | 5 |
| Utilization U_{c} | | | | | | |
| Chemical coolant | 6.2e-05 | 2.1e-05 | 4.2e-06 | 6.2e-05 | 2.1e-05 | 4.2e-06 |
| flow rate per cm2 | | | | | | |
| of chemical | | | | | | |
| coolant cell area | | | | | | |
| (mol/s/cm2) | | | | | | |
| Mass Peclet | | | | 5 | 20 | 50 |
| Number Peₘ | | | | | | |
| Diffusion | | | | 8e-04 | 4e-4 | 1e-4 |
| Coefficient D | | | | | | |
| (m2/s) | | | | | | |
| Ratio Value | 1.3e8 (1/m) | 2.8e9 (1/m) | 4.0e11 (1/m) | 0.35 (m) | 3.9 (m) | 41.1 (m) |
| Ratio Range | $1 e 8 < \frac{p Δ p F {U}_{c}}{20 RT 32 μ i} < 5 e 11 ( 1 / m ) ,$ | | | $0.5 < \frac{{Pe}_{m} {FpDU}_{c}}{20 RTi} < 50 ( m ) ,$ | | |
| | $optionally 1 e 9 < \frac{p Δ p F {U}_{c}}{20 RT 32 μ i} < 1 e 11 ( 1 / m )$ | | | $optionally 1 < \frac{{Pe}_{m} {FpDU}_{c}}{20 RTi} < 25 ( m )$ | | |
| Pathway | 1 < τ_{cc} <2 | | | 1 < τ_{ccb} < 5 | | |
| Tortuosity τ | | | | | | |
| Porosity ε | 0.5 < ε_{cc} < 0.8 | | | 0.05 < ε_{ccb} < 0.5 | | |
| Depth d | 0.5 < d_{cc} < 2 (cm) | | | d_{ccb} see below | | |
| Pathway pore size | 0.25 < f_{cc} < 0.75 | | | | | |
| ratio f_{oc} | | | | | | |

| Non-dimensional terms | $1 < \frac{{τ}_{cc}^{2}}{{ε}_{cc} {f}_{cc}^{2}} < 500 ,$ | | | $20 < \frac{{τ}_{ccb}^{2}}{{ε}_{ccb}} < 500 ,$ | | |
|---|---|---|---|---|---|---|
| | $optionally 2 < \frac{{τ}_{cc}^{2}}{{ε}_{cc} {f}_{cc}^{2}} < 50$ | | | $optionally 20 < \frac{{τ}_{ccb}^{2}}{{ε}_{ccb}} < 200$ | | |
| | $1.25 < \frac{{τ}_{cc}^{2}}{{ε}_{cc}} < 8 , optionally 5 < \frac{{τ}_{cc}^{2}}{{ε}_{cc}} < 8$ | | | | | |
| | Permeable chemical coolant catalyst | | | | | |
| | layer thickness t_{cc} (um) | | | Barrier Depth d_{ccb} (mm) | | |
| Ratio Value | 1.3e8 (1/m) | 2.8e9 (1/m) | 4.0e11 (1/m) | 0.35 (m) | 3.9 (m) | 41.1 (m) |

| | | | | | | |
|---|---|---|---|---|---|---|
| Non-dimensional | 20 | 500 | 20 | 500 | 20 | 500 |

$term \frac{{τ}_{ccb}^{2}}{{ε}_{ccb}}$

| | | | | | | | | | |
|---|---|---|---|---|---|---|---|---|---|
| ${d}_{cc} = 0.5 ( cm ) , \frac{{τ}_{cc}^{2}}{{ε}_{cc} {f}_{cc}^{2}} = 2.22$ | 76 | 27 | 5 | 0.26 | 0.01 | 1.06 | 0.04 | 2.13 | 0.09 |
| ${d}_{c c} = 0.5 ( cm ) , \frac{{τ}_{c c}^{2}}{{ε}_{c c} {f}_{cc}^{2}} = 128$ | 292 | 104 | 20 | 1.02 | 0.04 | 4.08 | 0.16 | 8.24 | 0.33 |
| ${d}_{c c} = 2 ( cm ) , \frac{{τ}_{c c}^{2}}{{ε}_{c c} {f}_{c c}^{2}} = 2.22$ | 190 | 68 | 13 | 0.17 | 0.01 | 0.67 | 0.03 | 1.34 | 0.05 |
| | 736 | 263 | 51 | 0.64 | 0.03 | 2.57 | 0.10 | 5.19 | 0.21 |

| Range | 5 < t_{cc} < 700 (μm), | 0.01 < d_{ccb} < 5 (mm), | | |
|---|---|---|---|---|
| | optionally 10 < t_{cc} < 300 (μm) | optionally 0.1 < d_{ccb} < 2 (mm) | | |
| Effective Pathway Depth | $\frac{{d}_{c c} {τ}_{c c}^{2}}{{ε}_{c c}} ( cm )$ | $\frac{{d}_{c c b} {τ}_{c c b}^{2}}{{ε}_{c c b}} ( cm )$ | | |
| ${d}_{cc} = 0.5 ( cm ) , \frac{{τ}_{c c}^{2}}{{ε}_{c c}} = 1.25$ | 0.625 | 0.5 | 2.1 | 4.3 |
| ${d}_{cc} = 0.5 ( cm ) , \frac{{τ}_{c c}^{2}}{{ε}_{c c}} = 8$ | 4 | 2.0 | 8.2 | 16.5 |
| ${d}_{cc} = 2 ( cm ) , \frac{{τ}_{c c}^{2}}{{ε}_{c c}} = 1.25$ | 2.5 | 0.3 | 1.3 | 2.7 |
| ${d}_{c c} = 2 ( cm ) , \frac{{τ}_{c c}^{2}}{{ε}_{c c}} = 8$ | 16 | 1.3 | 5.1 | 10.4 |
| Range | $0.5 < \frac{{d}_{c c} {τ}_{c c}^{2}}{{ε}_{c c}} < 15 ( cm ) ,$ | $0.5 \frac{{d}_{c c b} {τ}_{c c b}^{2}}{{ε}_{c c b}} < 20 ( cm ) ,$ | | |
| | $optionally 0.5 < \frac{{d}_{c c} {τ}_{c c}^{2}}{{ε}_{c c}} < 10 ( cm ) ,$ | $optionally 0.5 < \frac{{d}_{c c b} {τ}_{c c b}^{2}}{{ε}_{c c b}} < 10 ( cm )$ | | |
| Effective Barrier to Cell Pathway depth ratio | $\frac{{d}_{c c b} {τ}_{c c b}^{2}}{{ε}_{c c b}} / \frac{{d}_{cc} {τ}_{c c}^{2}}{{ε}_{c c}}$ | | | |
| ${d}_{cc} = 0.5 ( cm ) , \frac{{τ}_{c c}^{2}}{{ε}_{c c}} = 1.25$ | | 0.8 | 3.4 | 6.8 |
| ${d}_{cc} = 0.5 ( cm ) , \frac{{τ}_{c c}^{2}}{{ε}_{c c}} = 8$ | | 0.5 | 2.0 | 4.1 |
| ${d}_{cc} = 2 ( cm ) , \frac{{τ}_{c c}^{2}}{{ε}_{c c}} = 1.25$ | | 0.1 | 0.5 | 1.1 |
| ${d}_{cc} = 2 ( cm ) , \frac{{τ}_{c c}^{2}}{{ε}_{c c}} = 8$ | | 0.1 | 0.3 | 0.6 |

| | |
|---|---|
| Range | $0.1 < \frac{{d}_{c c b} {τ}_{c c b}^{2}}{{ε}_{c c b}} / \frac{{d}_{c c} {τ}_{c c}^{2}}{{ε}_{c c}} < 7 , optionally 0.5 < \frac{{d}_{c c b} {τ}_{c c b}^{2}}{{ε}_{c c b}} / \frac{{d}_{c c} {τ}_{c c}^{2}}{{ε}_{c c}} < 7$ |

The parameter values given in table 3 described herein are preferred parameter values and/or parameter value ranges. Examples can be realised in which wider parameter value ranges can be used, as described below with respect to the methods of operation and operating parameter spaces.

Referring to FIG. 15, there is shown a view 1500 of a methanation stack 1502. The methanation stack 1502 is arranged to host an exothermic reaction, in particular, to perform at least one, or both, of: producing or recovering the chemical coolant from the chemical coolant reformate output by a chemical cooling cell and controlling the temperature of the chemical coolant, in particular, removing heat from the chemical coolant, for example, so that it can be reused, that is, redirecting heat recovered from the chemical coolant for use elsewhere. Examples of recovering heat from the chemical coolant for use elsewhere will be described with reference to the overall system as shown in, and described with reference to, FIGS. 19 to 21. The chemical coolant can comprise at least one, or both, of: methane and water; the latter in the form of steam.

The methanation stack 1502 comprises a set of permeable methanation catalyst cells each comprising at least one permeable methanation catalyst layer. Examples can be realised in which the set of permeable methanation catalyst layers comprises a plurality of permeable methanation catalyst layers. In the example depicted, the set of permeable methanation catalyst cells comprises four such cells 1504 to 1510. The at least one permeable methanation catalyst cell comprises at least one permeable methanation catalyst layer for processing the chemical coolant reformate to recover methane and steam. Examples are not limited to using four such cells 1504 to 1510. Examples can be realised in which more or fewer such permeable methanation catalyst cells are used.

The methanation stack 1502 also comprises a set of permeable oxidant cells. Examples can be realised in which each permeable oxidant cell each comprises at least one respective permeable oxidant layer. In the example depicted, the set of permeable oxidant cells comprises four cells 1512 to 1518. Examples are not limited to using four such cells 1512 to 1518. Examples can be used in which more or fewer such permeable oxidant cells are used.

The plurality of permeable methanation catalyst cells, which are described below, are interleaved with the permeable oxidant cells. Examples can be realised in which the permeable methanation catalyst cells of the plurality of permeable methanation catalyst cells are interdigitated with the permeable oxidant cells of the plurality of permeable oxidant cells.

The inlets and outlets of the methanation catalyst cells 1504 to 1510 and the oxidant cells 1512 to 1518 are arranged such that the oxidant flows 1534 to 1528 are substantially perpendicular to the chemical coolant reformate flows 1536 to 1542 within respective parallel planes. Therefore, the methanation stack 1502 can be realised in which the first chemical coolant reformate inlet and first chemical coolant reformate outlet of the at least one permeable methanation catalyst cell are orientated perpendicularly, within respective parallel planes, to the first oxidant inlet and a first oxidant outlet of the at least one permeable oxidant cells. Also shown in FIG. 15 is a set of axes, or coordinate directions, 1552. The coordinate directions 1552 comprise three axes. A first axis 1554 shows cell depth, or a chemical coolant reformate flow direction. A second axis 1556 shows cell width, or an oxidant or air flow direction. A third axis 1558 shows a cell thickness, or a longitudinal direction. It will be appreciated that the flow directions of the methanation catalyst layers and the oxidant or air layers are perpendicular within respective parallel planes.

A methanation cell 1560 is formed from a central permeable methanation catalyst layer 1562 positioned between upper and lower dense material layers 1564 and 1566 formed from the same material as any of the dense materials 214 or 220. The dense material layers 1564 and 1566 are used for sealing purposes and are, therefore, relatively thin so as not to unnecessarily increase unneeded volume or bulk. Examples can be realised in which the dense material layers in the examples described herein that are used for sealing purposes have a thickness, t_{mdl}, of 20 μm or less, preferably, 10 μm or less. The methanation cells 1560 are rectangularly shaped, but can be some other shape, such as, for example, square shaped or some other shape such as described above with reference to FIG. 4. The methanation cell 1560 comprises a set of reactant inlets. In the example methanation cell 1560 depicted, the set of reactant inlets comprises at least one reactant inlet such as, for example, reactant inlet 1568. The methanation cell 1560 also comprises a set of exhaust outlets. The set of exhaust outlets can comprise at least one, or more than one, exhaust outlet. In the example shown in FIG. 15, the set of exhaust outlets comprises a single exhaust outlet 1570, which is provided on the rear face of the methanation cell 1560. The methanation cell inlets 1568 and outlets 1570 are only shown in relation to the top methanation cell of view B-B. Each of the methanation cells in the stack 1526 have such inlets and outlets. The methanation cell 1560 also comprises side wall dense material layers 1571 and 1572. The reactant, that is, the chemical coolant reformate, fed into the methanation cell, undergoes a reaction to recover the chemical coolant, which can comprise at least one, or both, of: methane and water; the latter in the form of steam. Examples can be realised in which the reactions are given in tables 8 to 10, that is, 3H₂+CO→CH₄+H₂O and 4H₂+CO₂→CH₄+2H₂O.

FIG. 15 also shows an oxidant or air cell 1574. An oxidant cell 1574 is formed from a central permeable oxidant layer 1576 positioned between upper and lower dense material layers 1578 and 1580 formed from the same material as the dense material 214 or 220. The dense material layers 1578 and 1580 are used for sealing purposes and are, therefore, relatively thin so as not to unnecessarily increase unneeded volume or bulk. Examples can be realised in which the dense material layers in the examples described herein that are used for sealing purposes have a thickness, t_{modl}, of 20 μm or less, preferably, 10 μm or less. The oxidant cell 1574 is rectangularly shaped, but can be some other shape, such as, for example, square shaped or some other shape such as described above with reference to FIG. 4. The oxidant cell 1574 comprises a set of oxidant inlets. In the example oxidant cell 1574 depicted, the set of oxidant inlets comprises at least one oxidant inlet such as, for example, oxidant inlet 1582. The oxidant cell 1574 also comprises a set of exhaust outlets. An exhaust outlet is an example of an oxidant outlet. The set of exhaust outlets can comprise at least one, or more than one, exhaust outlet. In the example shown in FIG. 15, the set of exhaust outlets comprises a single exhaust outlet 1584, which is provided on the rear face of the oxidant cell 1574. The oxidant cell inlets 1582 and outlets 1584 are only shown in relation to the bottom oxidant cell of view A-A. However, each of the oxidant cells in the stack 1524 have such inlets and outlets. The oxidant cell 1574 also comprises side wall dense material layers 1586 and 1588. The oxidant to be thermally conditioned, as will be described below, enters the oxidant inlet 1582, where it accumulates heat from the reaction occurring in an adjacent methanation cell, and leaves via the oxidant outlet 1584.

Therefore, the methanation stack 1502 comprises a number of such methanation cells and oxidant or air cells.

The methanation stack 1502 comprises at least one, or both, of: a methanator inert permeable barrier layer 1520 covering any inlets to the permeable methanation catalyst cells 1504 to 1510 and a methanator inert permeable barrier layer 1522 covering any outlets of the permeable methanation catalyst cells 1504 to 1510. Examples can be realised in which the methanation stack 1502 comprises both of: a methanator inert permeable barrier layer 1520 covering any inlets to the permeable methanation catalyst cells or layers 1504 to 1510 and an inert permeable barrier layer 1522 covering any outlets of the permeable methanation catalyst cells or layers 1504 to 1510. At least one, or both, of the methanator inert permeable barrier layers 1520 and 1522 are inert permeable barrier layers.

The methanator inert permeable barrier layer 1520 covering any inlets to the permeable methanation catalyst cells 1504 to 1510 and the inert permeable barrier layer 1522 covering any outlets to the permeable methanation catalyst cells 1504 to 1510 are examples of first and second inert methanator permeable barriers.

FIG. 15 also shows a pair of sectional views 1524 and 1526 taken through sections AA-A′A′ and BB-B′B′ respectively. Referring the first 1524 of the sectional views, a number of oxidant flows 1528 to 1534 are shown flowing through the permeable oxidant cells 1512 to 1518. Referring the second 1526 of the sectional views, a number of chemical coolant reformate flows 1536 to 1542 are shown flowing through the permeable methanation catalyst cells 1504 to 1510. Also shown in the section sectional view are reactant output flows 1544 to 1550.

Examples can be realised in which the methanation stack 1502, or, more specifically, the methanation catalyst, hosts at least one, or both, of the following reactions:

3H₂+CO→CH₄+H₂O

4H₂+CO₂→CH₄+2H₂O.

The permeable methanation catalyst layer within each methanation cell hosts a permeable methanation catalyst layer chemical coolant reformate pathway, which will be referred to as “a permeable methanation catalyst layer pathway”, and are related, or defined, by the following ratio:

$$\frac{{τ}_{m}^{2}}{{ε}_{m}} \frac{{d}_{m}^{2}}{{f}_{m}^{2} {t}_{m}^{3}} ,$$

which relates the geometric parameters of the permeable methanation catalyst layer and its associated pathway to the operational parameters of the methanation cell, and
each of the methanator inert permeable barriers, at the inlets to the permeable methanation catalyst cells and at the outlets to the permeable methanation catalyst cells 1504 to 1510, provides a methanator inert permeable barrier chemical coolant reformate pathway, which will be referred to here as “a methanator inert permeable barrier pathway”, that are related, or defined, by the following ratio:

$$\frac{{d}_{mb} {d}_{m} {τ}_{mb}^{2}}{{t}_{m} {ε}_{mb}} ,$$

which relates the geometric parameters of the methanator inert permeable barrier and its associated pathway to the operational parameters of the methanation cell and barriers,
where
τₘ is the permeable methanation catalyst layer pathway tortuosity in the chemical coolant reformate flow direction,
τ_{mb} is the methanator inert permeable barrier pathway tortuosity in the chemical coolant reformate flow direction,
εₘ is the permeable methanation catalyst layer porosity,
ε_{mb} is the methanator inert permeable barrier porosity,
dₘ is the permeable methanation catalyst layer depth in the chemical coolant reformate flow direction,
d_{mb} is the methanator inert permeable barrier depth in the chemical coolant reformate flow direction,
tₘ is the permeable methanation catalyst layer thickness,
fₘ is the ratio of permeable methanation catalyst layer pathway pore size to permeable methanation catalyst layer thickness, tₘ.

Examples of the relationship between the geometric parameters of the permeable methanation catalyst layer and its associated pathway to the operational parameters of the methanation cell are given in Table 4.

Examples of the relationship between the geometric parameters of the methanator inert permeable barrier and its associated pathway to the operational parameters of the methanation cell and barriers are given in Table 4.

Examples can be realised in which the methanation stack 1502 also comprises at least one, or more than one, of the following characteristics taken jointly and severally in any and all permutations:
the permeable methanation catalyst layer thickness, tₘ, is arranged to provide a balance between reaction time, contact via a catalyst or reaction contact surface and in-plane thermal conduction, which follows from increasing methanation catalyst layer thickness, with ensuring a compact design for increasing power density, which follows from decreasing permeable methanation catalyst layer thickness and providing effective or improved heat transfer to adjacent oxidant cells;
the permeable methanation catalyst layer thickness, tₘ, has a range of 5 μm to 5000 μm, optionally 10 μm to 800 μm, optionally 50 μm to 300 μm,
the ratio

$$\frac{{τ}_{m}^{2}}{{ε}_{m} {f}_{m}^{2}}$$

has influences the balance between an additional, preferably, smallest, flow resistance provided by the catalyst material while providing structural strength and in-plane thermal conduction;
the ratio

$$\frac{{τ}_{m}^{2}}{{ε}_{m} {f}_{m}^{2}}$$

has a range of 1 to 500, optionally, 2 to 50,
the permeable methanation catalyst layer depth, dₘ, is selected according to manufacturing capabilities to balance cell handling capabilities, since below a given lower depth limit handling cells would be difficult, and power density, which influences an upper limit of layer thickness since large layer depths would require layer thickness to increase dramatically to provide in-plane thermal conduction and manage pressure drops, which would adversely lead to lower heat transfer between the catalyst layer and the adjacent oxidant cells and a lower power density overall;
the permeable methanation catalyst layer depth, dₘ, has a range of 0.25 mm to 40 mm, optionally, 0.25 mm to 20 mm and, preferably, of 5 mm to 20 mm,
the ratio

$$\frac{{d}_{mb} {τ}_{mb}^{2}}{{ε}_{mb}}$$

is associated with a range of effective depths in the flow direction of the methanator inert permeable barrier pathway to influence, that is, limit, at least reduce, or eliminate, diffusion effects, as described in paragraphs [00209] to [00251];
the ratio

$$\frac{{d}_{mb} {τ}_{mb}^{2}}{{ε}_{mb}}$$

has a range of 4 mm to 500 mm, optionally, 20 mm to 100 mm, and preferably 5 mm to 50 mm, and more preferably less than 50 mm,
the ratio, fₘ, of permeable methanation catalyst layer pathway pore size to permeable methanation catalyst layer thickness, tₘ, is selected to balance flow resistance with providing structural strength and in-plane thermal conduction;
the ratio, fₘ, of permeable methanation catalyst layer pore size to permeable methanation catalyst layer thickness, tₘ, has a range of 0.02 to 1, and, preferably, 0.25 to 0.75.
the permeable methanation catalyst layer pathway tortuosity, τₘ, is selected to balance flow resistance and catalyst or reaction contact surface against structural strength and in-plane thermal conduction of the layer;
the permeable methanation catalyst layer pathway tortuosity, τₘ, has a range of 1 to 3, optionally, 1 to 2.5, and, preferably, 1 to 2,
the methanator inert permeable barrier pathway tortuosity, τ_{b}, is arranged to increase the effective depth of the methanator inert permeable barrier pathway to at least reduce, and, preferably, eliminate, diffusion;
the methanator inert permeable barrier pathway tortuosity, τ_{mb}, has a range of 1 to 10, and, optionally, 1 to 5,
the permeable methanation catalyst layer porosity, εₘ, is selected to balance flow resistance against structural strength and in-plane thermal conduction of the layer;
the permeable methanation catalyst layer porosity, εₘ, has a range of 0.1 to 0.9, and, preferably, 0.5 to 0.8,
the methanator inert permeable barrier porosity, ε_{mb}, has a lower bound to accommodate an orifice or foraminate plate example and an upper bound to accommodate higher tortuosity materials;
methanator inert permeable barrier porosity, ε_{mb}, has a range of 0.01 to 0.5, and, preferably, 0.05 to 0.5, and/or
the methanator inert permeable barrier depth, d_{mb}, can be set to achieve a balance, at a lower limit, between an increase in effective depth to limit diffusion, as described with reference to paragraphs [00209] to [00251], and so cannot be too thin, with, at an upper limit, constraining size of the methanator inert permeable barrier such that it has a volume smaller than an associated methanation cell;
the methanator inert permeable barrier depth, d_{mb}, is greater or equal to 0.01 mm, optionally 0.01 mm to 5 mm and, preferably, 0.1 mm to 2 mm.

The ratio

$$\frac{{τ}_{m}^{2}}{{ε}_{m}} \frac{{d}_{m}^{2}}{{f}_{m}^{2} {t}_{m}^{3}} ,$$

which relates the geometric parameters of the permeable methanation catalyst layer and its associated pathway to the operational parameters of the methanation cell has a range of 1e6/m to 5e12/m, optionally, 1e8/m to 5e11/m and, preferably 5e8/m to 1e11/m.

The ratio

$$\frac{{d}_{mb} {d}_{m} {τ}_{mb}^{2}}{{t}_{m} {ε}_{mb}} ,$$

which relates the geometric parameters of the methanator inert permeable barrier and its associated pathway to the operational parameters of the methanation cell and barriers has a range of 0.02 m to 100 m, optionally, 0.1 m to 20 m and, preferably 1 m to 10 m.

Although the methanator has been described above with a predetermined number of permeable methanation catalyst cells and a predetermined number of permeable oxidant cells, examples are not limited thereto. Examples can be realised in which the above methanator, or any other methanator described herein, uses at least one, or both, of: some other predetermined number of permeable methanation catalyst cells or some other predetermined number of permeable oxidant cells. Furthermore, the number of permeable methanation catalyst cells does not have to equal the number of permeable oxidant cells. Examples can be realised in which the methanation stack 1502 comprises more permeable methanation catalyst cells than permeable oxidant cells. Examples can be realised in which the methanation stack 1502 comprises fewer permeable methanation catalyst cells than permeable oxidant cells. Examples can be realised in which the upper and lower dense layers of one cell type are optional if the layer otherwise disposed therebetween is adjacent to one or more than one cell that comprises one or more than one such dense layer.

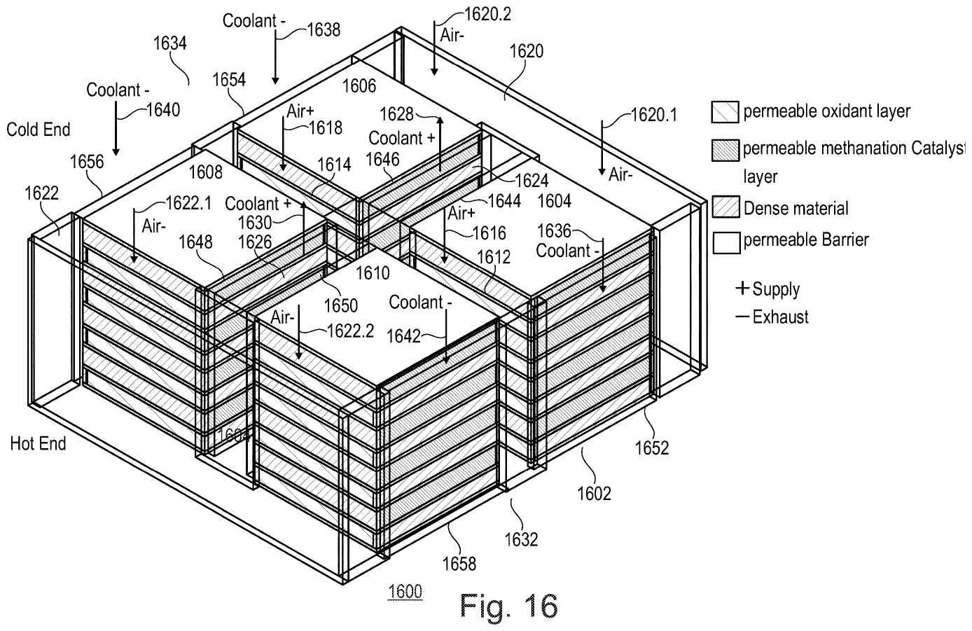

Referring to FIG. 16, there is shown a view 1600 of methanator assembly 1602. The methanator assembly 1602 comprises a set of at least one methanation stack, such as the methanation stack 1502 described above. The set of at least one methanation stack can comprise a number of methanation stacks. In the example depicted, the methanator assembly 1602 comprises a set of four methanation stacks 1604 to 1610.

The methanator assembly 1602 comprises a set of oxidant supply flow channels 1612 to 1614. The set of oxidant supply flow channels can comprise at least one oxidant supply flow channel. Examples can be realised in which the set of oxidant supply channels can comprise a plurality of oxidant supply channels. In the example shown in FIG. 16, the set of oxidant supply channels comprises two oxidant supply flow channels 1612 to 1614. The set of oxidant supply flow channels is arranged to carry respective oxidant supply flows 1616 to 1618. The above oxidant flows 1528 to 1534 are derived from the oxidant supply flows 1616 to 1618.

The methanator assembly 1602 comprises a set of oxidant exhaust flow channels 1620 to 1622. The set of oxidant exhaust flow channels can comprise at least one oxidant exhaust flow channel. Examples can be realised in which the set of oxidant exhaust channels can comprise a plurality of oxidant exhaust channels. In the example shown in FIG. 16, the set of oxidant exhaust channels comprises two oxidant exhaust flow channels 1620 to 1622. The set of oxidant exhaust flow channels is arranged to carry respective oxidant exhaust flows 1620.1 to 1620.2 and 1622.1 to 1622.2. The above oxidant exhaust flows 1528 to 1534 form the oxidant exhaust flows 1620.1 to 1620.2 to 1622.1 to 1622.2.

Therefore, the methanator assembly 1602 comprises a plurality of methanation stacks 1502. A methanation stack 1502 comprises set of methanation cells 1560 and a set of oxidant cells 1574. The set of methanation cells 1560 can comprise one methanation cell or a plurality of methanation cells. Similarly, the set of oxidant cells can comprise one oxidant cell or a number of oxidant cells. In the examples depicted in FIG. 15, the set of methanation cells comprises four methanation cells and the set of oxidant cells comprises four oxidant cells. The methanation cells 1560 and the oxidant cells 1574 can be arranged in an interleaved or interdigitated manner. The methanator assembly 1602 can be arranged such that adjacent stacks share a common oxidant (air) supply channel. Although examples have been described in which a shared or common oxidant (air) supply channel feeds multiple methanation stacks, examples are not limited to such an arrangement. Examples can be arranged in which a methanation stack 1502 has a respective oxidant supply flow channel that is not shared with one or more than one other methanation stack.

Furthermore, the methanator assembly 1602 comprises a plurality of methanation stacks. The plurality of methanation stacks are arranged such that adjacent stacks share a common oxidant (air) exhaust channel. Although examples have been described in which a shared or common oxidant (air) exhaust channel is fed from multiple methanation stacks, examples are not limited to such an arrangement. Examples can be arranged in which a methanation stack 1502 feeds a respective oxidant exhaust flow channel that is not shared with one or more than one other methanation stack.

The methanator assembly 1602 comprises a set of chemical coolant reformate supply flow channels 1624 to 1626. The set of chemical coolant reformate supply flow channels can comprise at least one chemical coolant reformate supply flow channel. Examples can be realised in which the set of chemical coolant supply channels can comprise a plurality of chemical coolant supply channels. In the example shown in FIG. 16, the set of chemical coolant supply channels comprises two chemical coolant reformate supply flow channels 1624 to 1626. The set of chemical coolant reformate supply flow channels 1624 to 1626 are arranged to carry respective chemical coolant supply flows 1628 to 1630. The chemical coolant supply flows 1628 to 1630 are examples of chemical coolant reformate supply flows. The above chemical coolant flows 1536 to 1542 are derived from the chemical coolant supply flows 1624 to 1626.

Therefore, the methanator assembly 1602 comprises a plurality of methanation stacks 1604 to 1610. Each methanation stack comprises a plurality of permeable methanation catalyst cells interleaved with a plurality of permeable oxidant cells. The plurality of methanation stacks can be arranged such that adjacent stacks share a common chemical coolant reformate supply flow channel 1624 to 1626. First 1604 and second 1606 methanation stacks share a chemical coolant supply channel 1624. Third 1608 and fourth 1610 methanation stacks share a chemical coolant supply channel 1626. Although examples have been described in which a shared or common chemical coolant reformate supply flow channel feds multiple methanation stacks, examples are not limited to such an arrangement. Examples can be arranged in which a methanation stack 1502 is fed by a respective chemical coolant reformate supply flow channel that is not shared with one or more than one other methanation stack. Furthermore, although the methanator assembly 1602 has been illustrated and described using two chemical coolant reformate supply flow channels 1624 to 1626, examples are not limited to such an arrangement. Examples can be realised in which the two chemical coolant reformate supply channels replaced with a unitary chemical coolant reformate supply channel.

The methanator assembly 1602 comprises a set of chemical coolant exhaust flow channels 1632 to 1634. The set of chemical coolant exhaust flow channels can comprise at least one chemical coolant exhaust flow channel. Examples can be realised in which the set of chemical coolant exhaust channels can comprise a plurality of chemical coolant exhaust channels. In the example shown in FIG. 16, the set of chemical coolant exhaust channels comprises two chemical coolant exhaust flow channels 1632 to 1634. The set of chemical coolant exhaust flow channels is arranged to carry respective chemical coolant exhaust flows 1636 to 1642. The above chemical coolant flows 1544 to 1550 form the chemical coolant exhaust flows 1636 to 1642.

Therefore, the methanator comprises a plurality of methanation stacks. Each stack 1604 to 1610 comprises a plurality of permeable methanation cells interleaved with a plurality of permeable oxidant cells 1574. The plurality of methanation stacks 1604 to 1610 can be arranged such that adjacent stacks share a common chemical coolant exhaust channel. First 1604 and fourth 1610 methanation stacks share a chemical coolant exhaust channel 1632. Second 1606 and third 1608 methanation stacks share a chemical coolant exhaust channel 1634. Although examples have been described in which a shared or common chemical coolant exhaust channel is fed from multiple methanation stacks, examples are not limited to such an arrangement. Examples can be arranged in which a methanation stack 1502 feeds a respective chemical coolant exhaust flow channel that is not shared with one or more than one other methanation stack. Furthermore, at least one, or both, of the chemical coolant exhaust channels 1632 to 1634 can be shared with, or form part of, respective chemical coolant exhaust channels of one or more than one adjacent methanator assembly.

Each methanation stack 1604 to 1610 has methanator inert permeable barriers 1644 to 1650 and 1652 to 1658 described above over the inlets and outlets respectively of the permeable methanation catalyst layers as described above in FIG. 15. The methanator inert permeable barriers 1644 to 1650 and 1652 to 1658 are examples of the methanator inert permeable barriers 1520 to 1522 described above.

The methanator assemblies 1602 can be arranged in the same plane adjacent to one another to form an array of methanator assemblies. An array can be an n×m array, where n is greater than or equal to one, and m is greater than or equal to one. Arrays of methanator assemblies can be stacked to form a methanator comprising a block of stacked arrays of methanator assemblies.

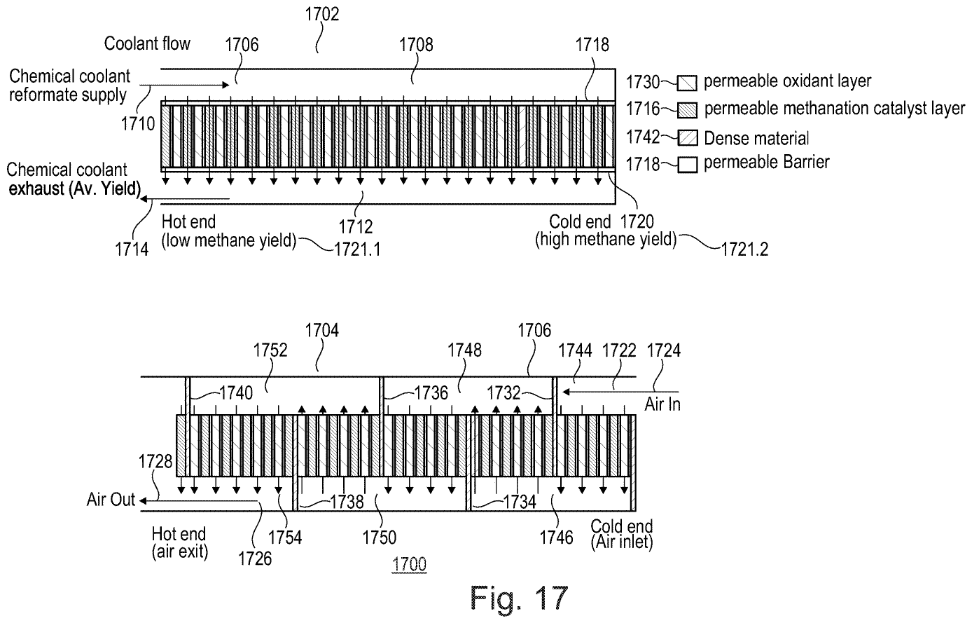

Referring to FIG. 17, there is shown a view 1700 of a pair of sectional views 1702 to 1704 through a methanator 1706. The methanator 1706 comprises a number of methanator assemblies 1602 as described above or herein. For clarity and ease of illustration and explanation, the separate methanation assemblies 1602 have not been shown entirely. Instead, a single column of multiple methanation stacks 1602 associated with a set of methanator assemblies comprising at least one methanator assembly have been shown. The set of methanator assemblies can comprise a number of methanator assemblies such as one or more than one methanator assembly 1602. The methanator 1706 depicted in FIG. 17 comprises a plurality of methanator assembles 1602 as described above arranged longitudinally relative to one another.

Referring to the first sectional view 1702, the methanator 1706 comprises a chemical coolant reformate supply flow channel 1708. The chemical coolant reformate supply flow channel 1708 is an example of either, or both, of the chemical coolant reformate supply channels 1624 and 1626 described above. The chemical coolant reformate supply flow channel 1708 is arranged to carry a chemical coolant reformate supply flow 1710. The chemical coolant reformate supply flow 1710 is an example of either, or both, of the chemical coolant reformate supply flows 1628 to 1630 described above.

The methanator 1706 comprises a chemical coolant exhaust flow channel 1712. The chemical coolant exhaust flow channel 1712 is an example of any of the chemical coolant exhaust channels 1632 to 1634 described above. The chemical coolant exhaust flow channel 1712 is arranged to carry a chemical coolant (exhaust) flow 1714. The chemical coolant exhaust flow 1714 comprises the chemical coolant recovered from the chemical coolant reformate 1710. The recovered chemical coolant comprises at least one, or both, of: methane and water; the latter in the form of steam. The chemical coolant exhaust flow 1714 is an example of any of the chemical coolant exhaust flows 1636 to 1642 described above.

The chemical coolant reformate supply flow 1710 is arranged to pass through permeable methanation catalyst layers of respective cells 1716 via respective permeable barriers 1718 to 1720 at the inlets and outlets of the permeable methanation catalyst layers 1716. The permeable methanation catalyst layers 1716 are examples of the methanation catalyst layers of the cells 1504 to 1510 described above. The methanation catalyst layers 1716 methanate the chemical coolant reformate to produce at least one, or both, of: methane and water; the latter can be in the form of steam. The inert permeable barriers 1718 to 1720 are examples of the methanator inert permeable barrier layers 1520 to 1522 described above.

The methanator comprises a relatively hotter end 1721.1 and a relatively cooler end 1721.2, where the equilibrium conversion of chemical coolant reformate to at least one, or both, of: methane or steam produces a higher conversion yield at the cooler end as compared to the hotter end. The chemical coolant reformate 1710 is fed into the methanator at the hot end 1721.1 where the thermal conditions offer a better match to those of the fuel cell. The arrangement results in most of the chemical coolant reformate having been progressively methanated or recovered into the reactant before the chemical coolant reformate encounters the far reaches of the methanator channel 1706 at the cooler end 1721.2 with the result that the temperature distribution along the length of the sectional view 1702 shown is more uniform.

Referring to the second sectional view 1704, the methanator 1706 comprises an oxidant supply flow channel 1722. The oxidant can be air. The oxidant supply flow channel 1722 is an example of either, or both, of the oxidant supply channels 1612 and 1614 described above. The oxidant supply flow channel 1722 is arranged to carry an oxidant supply flow 1724. The oxidant supply flow 1724 is an example of either, or both, of the oxidant supply flows 1616 to 1618 described above.

The methanator 1706 comprises an oxidant exhaust flow channel 1726. In practice, it can be appreciated that each section of the air flow channel seems to have the dual function of being an exhaust channel for one methanation stack simultaneously with being an oxidant supply channel for the next methanation stack. The oxidant exhaust flow channel 1726 is an example of any of the oxidant exhaust channels 1620 to 1622 described above. The oxidant exhaust flow channel 1726 is arranged to carry an oxidant exhaust flow 1728. The oxidant exhaust flow 1728 takes up and carries heat associated with methanating the reformate 1710 into the reactant. The oxidant exhaust flow 1728 is an example of any of the oxidant exhaust flows 1620.1 to 1620.2 and 1622.1 to 1622.2.

The oxidant supply flow 1724 is arranged to pass through permeable oxidant layers 1730 via the inlets and outlets of the permeable oxidant cells or layers 1730. The permeable oxidant layers 1730 are examples of the oxidant cells 1512 to 1518 described above.

The methanator 1702 can additionally comprise a set of baffles comprising at least one baffle. The set of baffles can comprise a number of baffles. In the example depicted in FIG. 17, the set of baffles comprises five baffles 1732 to 1740. The baffles 1732 to 1740 can be formed from a dense material 1742. The dense material is impermeable to at least one, or both of: any reactants and any oxidants used. The set of baffles 1732 to 1740 are arranged to direct the oxidant flow through multiple oxidant layers 1730 to accumulate heat associated with methanating the chemical coolant reformate 1710. Examples can be realised in which the set of baffles 1732 to 1740 form a non-linear oxidant flow. Examples can be realised in which the non-linear oxidant flow is an alternating flow that passes through multiple permeable oxidant layers 1730 in alternating directions accumulating heat from reactions associated with methanating the chemical coolant reformate in the permeable methanation catalyst layers 1716 into recovered reactant, which can comprise at least one, or both, of: methane or water; the latter can be in the form of steam. Examples can be realised in which the set of baffles comprises 0, 1 or more baffles.

Dividing the oxidant supply flow channel 1722 using such baffles results in a set of oxidant supply flow channel sections 1744 to 1754. Each section 1744 to 1754 performs the dual function of being an exhaust channel and a supply channel for longitudinally adjacent methanation stacks or methanation assemblies.

Therefore, examples can be realised in which any methanator described herein comprises a plurality of baffles arranged to form a plurality of sets of permeable oxidant (air) layers in which the plurality of sets of permeable (porous, tortuous) oxidant (air) layers provide, in use, differing or alternating oxidant (air) flow directions through respective permeable oxidant layers. Examples can be realised in which the plurality of baffles comprises first and second sets of interdigitated baffles. In the example depicted in FIG. 17, the first set of baffles comprises three baffles 1732, 1736, 1740 and the second set of baffles comprises two baffles 1734, 1738. It can be seen that a baffle can be provided at a repeating interval of a predetermined number of at least one, or both, of: methanation catalyst layers, or permeable oxidant layers, methanation stacks. For example, a baffle can be positioned every 5 methanation stacks, or at some other predetermined number of layers such as at least one, or more than one of, methanation catalyst layers, permeable oxidant layers, methanation stacks.

Having multiple transits of the oxidant through the permeable layers significantly increases the accumulating of heat by the oxidant. The increase can be of the order of several orders of magnitude such as, for example, 3 orders of magnitude better than the same oxidant merely flowing over the outer surfaces of the methanation stacks.

Table 4 below shows a summary of parameters associated with a methanation cell according to any of the examples described herein, in particular, the methanation catalyst layer and the inert permeable barrier layer. For each parameter, where appropriate, upper and lower bounds are given together with a typical or mid-point in the form of “Max”, “Min”, and “Mid”.

TABLE 4
Methanation Cell Parameters

| | Methanation Cell | | | | | |
|---|---|---|---|---|---|---|
| Component | Permeable methanation catalyst Layer | | | Methanator Inert Permeable Barrier | | |
| | and pathway (m) | | | and pathway (mb) | | |
| Notes | Assume each methanation cell receives | | | Required at inlet and outlet of | | |
| | the same flow rate of chemical coolant | | | methanation cell | | |
| | as flowing through a pair chemical | | | | | |
| | coolant cells (belonging to a single stack | | | | | |
| | of 20 anode cells and 20 cathode cells), | | | | | |
| | which is estimated as equivalent to fuel | | | | | |
| | flow through 40 anode cells. The flow | | | | | |
| | output of several pairs of chemical | | | | | |
| | coolant cells could be handled by a | | | | | |
| | single methanation cell, which would | | | | | |
| | further increase the thickness | | | | | |
| | requirements outlined below. Coolant | | | | | |
| | utilization U_{c} > 1 when coolant | | | | | |
| | requirement is less that the maximum. | | | | | |
| Ratio | $\frac{{p Δ pFU}_{c}}{40 RT 32 μ i} = \frac{{τ}_{m}^{2}}{{ε}_{m}} \frac{{d}_{m}^{2}}{{f}_{m}^{2} {t}_{m}^{2}} ( {m}^{- 1} )$ | | | $\frac{{Pe}_{m} {FpDU}_{c}}{40 RTi} = \frac{{d}_{mb} {d}_{m} {τ}_{mb}^{2}}{{τ}_{m} {ε}_{mb}} ( m )$ | | |
| Operational Point | Min | Mid | Max | Min | Mid | Max |
| Pressure p (bar) | 5 | 10 | 25 | 5 | 10 | 25 |
| Pressure Drop Δp | 20 | 50 | 300 | 2.9 | 3.0 | 1.7 |

| (mbar) | | | | |
|---|---|---|---|---|
| Dynamic Viscosity μ | 3e-05 | 2.3e-05 | 2e-05 | |
| (Pa.s) | | | | |
| Universal Gas | 8.3145 | | | 8.3145 |
| Constant R (J/mol/K) | | | | |
| Faraday's constant F | 96485 | | | 96485 |
| (C/mol) | | | | |

| | | | | | | |
|---|---|---|---|---|---|---|
| Current Density i | 0.3 | 0.2 | 0.1 | 0.3 | 0.2 | 0.1 |

(A/cm2)

| | | | | | | |
|---|---|---|---|---|---|---|
| Temperature T (°C) | 700 | 500 | 400 | 700 | 500 | 400 |
| Coolant Utilization U_{c} | 1 | 2 | 5 | 1 | 2 | 5 |
| Coolant flow rate per | 1.2e-04 | 4.2e-05 | 8.3e-06 | 1.2e-04 | 4.2e-05 | 8.3e-06 |

cm2 of methanation
cell area (mol/s/cm2)

| | | | |
|---|---|---|---|
| Mass Peclet Number | 5 | 20 | 50 |

Peₘ

| | | | |
|---|---|---|---|
| Diffusion Coefficient | 6e-04 | 2e-4 | 6e-5 |

D (m2/s)

| | | | | | | |
|---|---|---|---|---|---|---|
| Ratio Value | 1e8 (1/m) | 2.6e9 (1/m) | 3.0e11 (1/m) | 0.15 (m) | 1.53 (m) | 17.2 (m) |

| Ratio Range | $1 e 8 < \frac{{p Δ pFU}_{c}}{40 RT 32 μ i} < 5 e 11 ( 1 / m ) ,$ | | | $0.1 < \frac{{Pe}_{m} {FpDU}_{c}}{40 RTi} < 20 ( m ) ,$ | | | | | |
|---|---|---|---|---|---|---|---|---|---|
| | $optionally 5 e 8 < \frac{{p Δ pFU}_{c}}{40 RT 32 μ i} < 1 e 11 ( 1 / m )$ | | | $optionally 1 < \frac{{Pe}_{m} {FpDU}_{c}}{40 RTi} < 10 ( m )$ | | | | | |
| Pathway Tortuosity τ | 1 < τₘ < 2 | | | 1 < τ_{mb} < 5 | | | | | |
| Porosity ε | 0.5 < εₘ < 0.8 | | | 0.05 < ε_{mb} < 0.5 | | | | | |
| Depth d | 0.5 < dₘ < 2 (cm) | | | d_{mb} see below | | | | | |
| Pathway Pore size | 0.25 < fₘ < 0.75 | | | | | | | | |
| ratio fₘ | | | | | | | | | |
| Non-dimensional terms | $1 < \frac{{τ}_{m}^{2}}{{ε}_{m} {f}_{m}^{2}} < 500 ,$ | | | $20 < \frac{{τ}_{mb}^{2}}{{ε}_{mb}} < 500 ,$ | | | | | |
| | $optionally 2 < \frac{{τ}_{m}^{2}}{{ε}_{m} {f}_{m}^{2}} < 50$ | | | $optionally 20 < \frac{{τ}_{mb}^{2}}{{ε}_{mb}} < 200$ | | | | | |
| | $1.25 < \frac{{τ}_{m}^{2}}{{ε}_{m}} < 8 , optionally 5 < \frac{{τ}_{m}^{2}}{{ε}_{m}} < 8$ | | | | | | | | |
| | Permeable methanation catalyst layer | | | | | | | | |
| | Thickness tₘ (μm) | | | Barrier Depth d_{mb} (mm) | | | | | |
| Ratio Value | 1e8 (1/m) | 2.6e9 (1/m) | 3.0e11 (1/m) | 0.15 (m) | | 1.53 (m) | | 17.2 (m) | |
| Non-dimensional | | | | 20 | 500 | 20 | 500 | 20 | 50 [symbol] |
| $term \frac{{τ}_{mb}^{2}}{{ε}_{mb}}$ | | | | | | | | | |
| ${d}_{m} = 0.5 ( cm ) , \frac{{τ}_{m}^{2}}{{ε}_{m} {f}_{m}^{2}} = 2.22$ | 81 | 28 | 6 | 0.12 | 0.005 | 0.43 | 0.02 | 0.98 | 0.0 [symbol] |
| ${d}_{m} = 0.5 ( cm ) , \frac{{τ}_{m}^{2}}{{ε}_{m} {f}_{m}^{2}} = 128$ | 314 | 108 | 22 | 0.47 | 0.02 | 1.65 | 0.07 | 3.80 | 0.1 [symbol] |
| ${d}_{m} = 2 ( cm ) , \frac{{τ}_{m}^{2}}{{ε}_{m} {f}_{m}^{2}} = 2.22$ | 205 | 70 | 14 | 0.08 | 0.003 | 0.27 | 0.01 | 0.62 | 0.0 [symbol] |
| ${d}_{m} = 2 ( cm ) , \frac{{τ}_{m}^{2}}{{ε}_{m} {f}_{m}^{2}} = 128$ | 791 | 272 | 56 | 0.30 | 0.01 | 1.04 | 0.04 | 2.40 | 0.1 [symbol] |

| Range | 10 < tₘ < 800 (μm), | 0.01 < d_{mb} < 5 (mm), | | |
|---|---|---|---|---|
| | optionally 50 < tₘ < 300 (μm) | optionally 0.1 < d_{mb} < 2 (mm) | | |
| Effective Pathway Depth | $\frac{{d}_{m} {τ}_{m}^{2}}{{ε}_{m}} ( cm )$ | $\frac{{d}_{mb} {τ}_{mb}^{2}}{{ε}_{mb}} ( cm )$ | | |
| ${d}_{m} = 0.5 ( cm ) , \frac{{τ}_{m}^{2}}{{ε}_{m}} = 1.25$ | 0.625 | 0.2 | 0.9 | 2.0 |
| ${d}_{m} = 0.5 ( cm ) , \frac{{τ}_{m}^{2}}{{ε}_{m}} = 8$ | 4 | 0.9 | 3.3 | 7.6 |
| ${d}_{m} = 2 ( cm ) , \frac{{τ}_{m}^{2}}{{ε}_{m}} = 1.25$ | 2.5 | 0.2 | 0.5 | 1.2 |
| ${d}_{m} = 2 ( cm ) , \frac{{τ}_{m}^{2}}{{ε}_{m}} = 8$ | 16 | 0.6 | 2.1 | 4.8 |
| Range | $0 \text{.5} < \frac{{d}_{m} {τ}_{m}^{2}}{{ε}_{m}} < 15 ( cm ) ,$ | $0.2 < \frac{{d}_{mb} {τ}_{mb}^{2}}{{ε}_{mb}} < 10 ( cm ) ,$ | | |
| | $optionally 0.5 < \frac{{d}_{m} {τ}_{m}^{2}}{{ε}_{m}} < 10 ( cm ) ,$ | $optionally 0.5 < \frac{{d}_{mb} {τ}_{mb}^{2}}{{ε}_{mb}} < 5 ( cm )$ | | |
| Effective Barrier to Cell Pathway Depth Ratio | $\frac{{d}_{mb} {τ}_{mb}^{2}}{{ε}_{mb}} / \frac{{d}_{m} {τ}_{m}^{2}}{{ε}_{m}}$ | | | |
| ${d}_{m} = 0.5 ( cm ) , \frac{{τ}_{m}^{2}}{{ε}_{m}} = 1.25$ | | 0.4 | 1.4 | 3.2 |
| ${d}_{m} = 0.5 ( cm ) , \frac{{τ}_{m}^{2}}{{ε}_{m}} = 8$ | | 0.2 | 0.8 | 1.9 |
| ${d}_{m} = 2 ( cm ) , \frac{{τ}_{m}^{2}}{{ε}_{m}} = 1.25$ | | 0.1 | 0.2 | 0.5 |
| ${d}_{m} = 2 ( cm ) , \frac{{τ}_{m}^{2}}{{ε}_{m}} = 8$ | | 0.0 | 0.1 | 0.3 |

| | |
|---|---|
| Range | $0.1 < \frac{{d}_{mb} {τ}_{mb}^{2}}{{ε}_{mb}} / \frac{{d}_{m} {τ}_{m}^{2}}{{ε}_{m}} < 5 , optionally 0.5 < \frac{{d}_{mb} {τ}_{mb}^{2}}{{ε}_{mb}} / \frac{{d}_{m} {τ}_{m}^{2}}{{ε}_{m}} < 2$ |

[symbol]

indicates data missing or illegible when filed

The parameter values given in table 4 described herein are preferred parameter values and/or parameter value ranges. Examples can be realised in which wider parameter value ranges can be used, as described below with respect to the methods of operation and operating parameter spaces.

Table 5 below shows a summary of parameters associated with a methanator oxidant cell according to any of the examples methanator oxidant cells described herein. For each parameter, where appropriate, upper and lower bounds are given together with a typical or mid-point in the form of “Max”, “Min”, and “Mid”.

TABLE 5
Methanation Oxidant Cell Parameters

| Component | Permeable Methanation Oxidant Layer and | | |
|---|---|---|---|
| | pathway | | |
| Notes | Assuming each methanator oxidant cell receives the | | |
| | same flow rate of air as flowing through a stack | | |
| | containing 20 anode cells and 20 cathode cells. The | | |
| | flow output of several stacks could be handled by a | | |
| | single methanator oxidant cell, which would further | | |
| | increase the thickness requirements outlined below. | | |
| Ratio | $\frac{{p Δ pFU}_{a}}{50 RT 32 μ i} = \frac{{τ}_{mo}^{2}}{{ε}_{mo}} \frac{{w}_{mo}^{2}}{{f}_{mo}^{2} {t}_{mo}^{2}} ( {m}^{- 1} )$ | | |
| Operational Point | Min | Mid | Max |
| Pressure p (bar) | 5 | 10 | 25 |
| Pressure Drop Δp (mbar) | 20 | 50 | 300 |
| Dynamic Viscosity μ (Pa.s) | 4e-05 | 3.5e-05 | 3e-05 |
| Universal Gas Constant R | 8.3145 | | |
| (J/mol/K) | | | |
| Faraday's constant F (C/mol) | 96485 | | |
| Current Density i (A/cm2) | 0.3 | 0.2 | 0.1 |
| Temperature T (°C) | 700 | 500 | 400 |
| Air Utilization Uₐ | 0.25 | 0.5 | 0.75 |
| Air flow rate per cm2 of oxidant | 6.2e-04 | 2.1e-04 | 6.9e-05 |
| cell area (mol/s/cm2) | | | |
| Ratio Value | 1.6e7 (1/m) | 3.4e8 (1/m) | 2e10 (1/m) |
| Ratio Range | $1 e 7 < \frac{{p Δ pFU}_{a}}{50 RT 32 μ i} < 5 e 10 ( 1 / m ) ,$ | | |
| | $optionally 5 e 7 < \frac{{p Δ pFU}_{a}}{50 RT 32 μ i} < 1 e 10 ( 1 / m )$ | | |
| Pathway Tortuosity τₘₒ | 1< τₘₒ < 2 | | |
| Porosity εₘₒ | 0.5 < εₘₒ < 0.8 | | |
| Width wₘₒ | 0.5 < wₘₒ < 2 (cm) | | |
| Pathway Pore size ratio fₘₒ | 0.25 < fₘₒ < 0.75 | | |
| Non-dimensional terms | $1 < \frac{{τ}_{mo}^{2}}{{ε}_{mo} {f}_{mo}^{2}} < 500 , optionally 2 < \frac{{τ}_{mo}^{2}}{{ε}_{mo} {f}_{mo}^{2}} < 50$ | | |
| | $1.25 < \frac{{τ}_{mo}^{2}}{{ε}_{mo}} < 8 , optionally 5 < \frac{{τ}_{mo}^{2}}{{ε}_{mo}} < 8$ | | |
| | Permeable oxidant layer Thickness tₘₒ (μm) | | |
| Ratio Value | 1.6e7 (1/m) | 3.4e8 (1/m) | 2e10 (1/m) |
| ${w}_{mo} = 0.5 ( cm ) , \frac{{τ}_{mo}^{2}}{{ε}_{mo} {f}_{mo}^{2}} = 2.22$ | 153 | 55 | 14 |
| ${w}_{mo} = 0.5 ( cm ) , \frac{{τ}_{mo}^{2}}{{ε}_{mo} {f}_{mo}^{2}} = 128$ | 591 | 212 | 54 |
| ${w}_{mo} = 2 ( cm ) , \frac{{τ}_{mo}^{2}}{{ε}_{mo} {f}_{mo}^{2}} = 2.22$ | 386 | 139 | 35 |
| ${w}_{mo} = 2 ( cm ) , \frac{{τ}_{mo}^{2}}{{ε}_{mo} {f}_{mo}^{2}} = 128$ | 1489 | 535 | 136 |

| | |
|---|---|
| Range | 20 < tₘₒ < 1600 (μm), |
| | optionally 50 < tₘₒ < 600 (μm) |

The parameter values given in table 5 described herein are preferred parameter values and/or parameter value ranges. Examples can be realised in which wider parameter value ranges can be used, as described below with respect to the methods of operation and operating parameter spaces.

Referring to FIG. 18, there is shown a view 1800 of a combustor assembly 1802. The combustor assembly 1802 is arranged to thermally condition the oxidant, preferably, to heat the oxidant to a temperature within a predetermined temperature range. The combustor assembly 1802 comprises a set of combustor stacks 1804 to 1810. The set of combustor stacks can comprise at least one combustor stack or a plurality of combustor stacks. In the example shown, the set of combustor stacks comprises four combustor stacks 1804 to 1810. Each stack of the set of combustor stacks 1804 to 1810 comprises a set of combustion cells 1817.1 and a set of permeable oxidant cells 1817.6.

Also shown in FIG. 18 is a set of axes, or coordinate directions, 1876. The coordinate directions 1876 comprise three axes. A first axis 1878 shows cell depth, or a fuel flow direction. A second axis 1880 shows cell width, or an oxidant or air flow direction. A third axis 1882 shows a cell thickness, or a longitudinal direction. It will be appreciated that the flow directions of the combustion and oxidant cells are perpendicular within respective parallel planes.

A combustion cell 1817.1 is formed from a central permeable combustion cell catalyst layer 1812.1 positioned between upper and lower dense material layers 1816.1 and 1816.2 formed from the same material as the dense material 1816. The combustion cell 1817.1 layers are shaped as described above with reference to FIG. 4. The combustion cell 1817.1 also comprises side dense material layers 1816.3 and 1816.4 formed from the same material as the dense material 1816. The combustion cell 1817.1 comprises a set of reactant inlets. The set of reactant inlets comprises at least one reactant inlet. In the example depicted in FIG. 18, the set of reactant inlets comprises two reactant inlets presented by the faces 1817.2 and 1817.3, which correspond to facets 406 and 408 of FIG. 4. The combustion cell 1817.1 also comprises a set of oxidant inlets. The set of oxidant inlets can comprise at least one, or more than one, oxidant inlet. In the example shown in FIG. 18, the set of oxidant inlets comprises a single oxidant inlet 1817.4. The combustion cell 1817.1 also comprises a set of exhaust outlets. The set of exhaust outlets can comprise at least one, or more than one, exhaust outlet. In the example shown in FIG. 18, the set of exhaust outlets comprises a single exhaust outlet 1817.5, which is provided on the rear face of the combustion cell 1817.1. The reactants and oxidants are fed into the combustion cell, where the reactant is hydrogen and the reaction is 2H₂+O₂→2H₂O.

FIG. 18 also shows an oxidant or air cell 1817.6. An oxidant cell 1817.6 is formed from a central permeable air or oxidant layer 1814.1 positioned between upper and lower dense material layers 1816.5 and 1816.6 formed from the same material as the dense material 1816. The oxidant cell 1817.6 layers are shaped as described above with reference to FIG. 4. The oxidant cell 1817.6 also comprises side dense material layers 1816.7 to 1816.10 formed from the same material as the dense material 1816. The oxidant cell 1817.6 comprises a set of oxidant inlets. The set of oxidant inlets comprises at least one oxidant inlet. In the example depicted in FIG. 18, the set of oxidant inlets comprises one oxidant inlet 1817.7. The oxidant cell 1817.6 also comprises a set of oxidant outlets. The set of oxidant outlets can comprise at least one, or more than one, oxidant outlet. In the example shown in FIG. 18, the set of oxidant outlets comprises a single oxidant outlet 1817.8, which corresponds to face 403 shown in FIG. 4. The oxidant to be thermally conditioned, as will be described below, enters the oxidant inlet 1817.7, where it accumulates heat from the reaction occurring in adjacent combustion cells, and leaves via oxidant outlet 1817.8.

Each combustor stack is shaped in a manner similar to the laminated sheets described above with reference to FIG. 4. The combustor stacks 1804 to 1810 are positioned adjacent to one another and oriented so that respective combustion cell reactant inlets are fed by respective reactant or fuel supply flow channels 1818. The fuel supply flow channels 1818 are arranged to carry respective fuel supply flows 1820 that feed a fuel to the combustion catalyst layers 1812.1 of the combustion cells 1817.1 via the fuel inlets 1817.2 and 1817.3. The permeable walls of the fuel supply channels 1818 can act as an inert permeable barrier disposed over the fuel inlets 1817.2 and 1817.3

Each stack 1804 to 1810 further comprises a respective permeable barrier 1822. Such an inert permeable barrier 1822 is disposed over a second combustion cell oxidant inlet 1817.4. The second combustion cell oxidant inlet 1817.4 receives a combustion oxidant supply flow 1824 and 1826 carried by at least one, or more, combustion oxidant supply flow channels 1828 and 1830.

Each combustion cell 1817.1 exhaust outlet 1817.5 is arranged to feed respective combustion exhaust flows 1834. The combustion exhaust flows 1834 are carried by or fed into respective combustion exhaust flow channels 1836 to 1842. A combustion exhaust flow 1834 can be fed into a shared or common combustion exhaust flow channel or into a respective combustion exhaust flow channel that is not shared by any combustion exhaust flows from another combustor stack. In the example depicted in FIG. 18, four such channels 1836 to 1842 are provided. Alternatively, the combustion exhaust channels can be realised as common channels such as are formed by channels 1838 and 1840, and channels 1836 and 1842.

The notation used for flows depicted in FIG. 18 is a flow name followed by a ‘+’ or ‘−’ sign. The name indicates the type of flow and the ‘+’ or ‘−’ sign indicates whether the flow is a supply flow or an exhaust flow. For example, ‘combustor air+’ indicates a combustion oxidant (air) supply flow, ‘Exhaust−’ indicates a combustion exhaust flow, ‘fuel+’ indicates a fuel supply flow, ‘air+’ indicates an air supply flow and ‘air−’ indicates air exhaust flow.

Sets of adjacent combustor stacks share oxidant (air) supply flow channels 1844 to 1846. The oxidant (air) supply flow channels 1844 to 1846 supply at least one oxidant (air) supply flow, ‘air+’, 1856 to 1858 to inlets 1817.7 of the permeable oxidant (air) cells 1817.6. In the example shown in FIG. 18, two such oxidant (air) supply flow channels 1844 to 1846 are provided that carry respective oxidant (air) supply flows 1856 to 1858. In the example shown in FIG. 18, the first 1804 and fourth 1810 adjacent combustor stacks share an ‘air+’ channel 1844 and, therefore, share the ‘air+’ supply flow 1856. Similarly, the second 1806 and third 1808 adjacent combustor stacks share an ‘air+’ channel 1846 and, therefore, share the ‘air+’ supply flow 1858.

As indicated, the set of adjacent stacks 1804 to 1810 share the common fuel supply channel 1818.

The permeable oxidant cells 1817.6 of the combustor stacks 1804 to 1810 comprise oxidant outlets such as oxidant outlets 1817.8 of the third combustor stack 1808. The oxidant outlets 1817.8 feed at least one common oxidant exhaust flow 1868 to 1874 carried by a respective oxidant exhaust flow channel 1875.1 to 1875.4. The stacks 1804 to 1810 have respective oxidant exhaust channels 1875.1 to 1875.4.

It can be seen from the above that the combustion reactant inlet is angularly offset relative to the combustion oxidant supply flows 1824 to 1826. Similarly, the combustion oxidant supply flow through the permeable combustion catalyst layer 1812.1 of each combustion cell 1817.1 is perpendicular, within respective parallel planes, to the oxidant or air supply flows through the permeable oxidant layer 1814.1 of each air or oxidant cell 1817.6.

The permeable combustion cells 1817.1 are interleaved or interdigitated with the permeable oxidant (air) cells 1817.6.

A set of such combustor assemblies 1802 can be grouped in substantially the same manner as the methanator assemblies 1602 as described above in relation to the methanator shown in and described with reference to FIGS. 16 and 17 respectively. The set of combustor assemblies can form an array of at least one, or both of: a combustor assembly array, as described above with reference to, and/or as shown in, FIG. 14, or an overall combustor by longitudinally grouping combustor assemblies in a manner similar to the overall methanator 1702 depicted in, and described with reference to, FIG. 17. Therefore, a combustor can be realised that also comprises at least one set, or multiple sets, of baffles for ensuring that the oxidant (air) flow 1856 to 1858 to be heated is passed through one or more than one set of permeable oxidant layers 1814.

The at least one, or each, permeable combustion cell catalyst layer, which is an example of a permeable combustion layer, can host a permeable combustion cell catalyst layer pathway that can be characterised by the following permeable combustion layer ratio:

$$\frac{{τ}_{cl}^{2}}{{ε}_{cl}} \frac{{d}_{cl}^{2}}{{f}_{cl}^{2} {t}_{cl}^{3}} ,$$

which relates the geometric parameters of the permeable combustion cell catalyst layer and its associated pathway to the operational parameters of the combustion cell, and
the combustion cell inert permeable barrier, over the permeable combustion cell catalyst layer reactant and oxidant inlet, hosts a combustion cell inert permeable barrier pathway, which can be defined, or characterised by the following combustion cell inert permeable barrier ratio:

$$\frac{{d}_{cb} {d}_{cl} {τ}_{cb}^{2}}{{t}_{cl} {ε}_{cb}} ,$$

which relates the geometric parameters of the combustion cell inert permeable barrier and its associated pathway to the operational parameters of the combustion cell and associated barriers,
where
τ_{cl} is the permeable combustion cell catalyst layer pathway tortuosity in the reactant flow direction,
τ_{cb} is the combustion cell inert permeable barrier pathway tortuosity in the reactant flow direction,
ε_{cl} is the permeable combustion cell catalyst layer porosity,
ε_{cb} is the combustion cell inert permeable barrier porosity,
d_{cb} is the combustion cell inert permeable barrier depth in the reactant flow direction,
d_{cl} is the permeable combustion cell catalyst layer depth in the reactant flow direction,
t_{cl} is the permeable combustion cell catalyst layer thickness,
f_{cl} is the ratio of permeable combustion cell catalyst layer pathway pore size to permeable combustion cell catalyst layer thickness, t_{cl}.

The combustor bears one or more than one of the following characteristics taken jointly and severally in any and all permutations:
the permeable combustion cell catalyst layer thickness, t_{cl}, is arranged to provide a balance between reaction time, contact via a catalyst or reaction contact surface and in-plane thermal conduction, which follows from increasing permeable combustion cell catalyst layer thickness, with ensuring a compact design for increasing power density and improving heat transfer between the catalyst layer and any adjacent air or oxidant cells, which follows from decreasing combustion cell catalyst layer thickness;
the permeable combustion cell catalyst layer thickness, t_{cl}, has a range of 5 μm to 5000 μm, preferably, 5 μm to 1000 μm, optionally 10 μm to 500 μm,
the ratio

$$\frac{{τ}_{cl}^{2}}{{ε}_{cl} {f}_{cl}^{2}}$$

influences the balance between an additional, preferably, smallest, flow resistance provided by the permeable combustion cell catalyst layer pathway while providing structural strength and in-plane thermal conduction;
the ratio

$$\frac{{τ}_{cl}^{2}}{{ε}_{cl} {f}_{cl}^{2}}$$

has a range of 1 to 500, optionally, 2 to 50,
the permeable combustion cell catalyst layer depth, d_{cl}, is selected according to manufacturing capabilities to balance cell handling capabilities, since below a given lower depth limit handling cells would be difficult, and power density, which influences an upper limit of cell thickness since large cell depths would require cell thickness to increase dramatically to account for in-plane thermal conduction and pressure drops, which would otherwise adversely lead to a less compact design with reduced heat transfer between the catalyst layer and any adjacent oxidant cells;
the permeable combustion cell catalyst layer depth, d_{cl}, has a range of 0.25 mm to 40 mm, optionally 0.25 mm to 20 mm and, preferably, of 5 mm to 20 mm,
the ratio

$$\frac{{d}_{cb} {τ}_{cb}^{2}}{{ε}_{cb}}$$

is associated with a range of effective depths in the flow direction of the combustion cell inert permeable barrier pathway to influence, that is, limit, at least reduce, or eliminate, diffusion effects, as described in paragraphs [00209] to [00251];
the ratio

$$\frac{{d}_{cb} {τ}_{cb}^{2}}{{ε}_{cb}}$$

has a range of 0.4 to 500 mm, optionally, 2 to 100 mm and, preferably 5 to 50 mm, and more preferably less than 50 mm,
the ratio, f_{cl}, of permeable combustion cell catalyst layer pathway pore size to permeable combustion cell catalyst layer thickness, t_{cl}, is selected to balance flow resistance with providing structural strength and in-plane thermal conduction;
the ratio, f_{cl}, of permeable combustion cell catalyst layer pathway pore size to permeable combustion cell catalyst layer thickness, t_{cl}, has a range of 0.02 to 1, and, preferably, 0.25 to 0.75,
the permeable combustion cell catalyst layer pathway tortuosity, τ_{cl}, is selected to balance flow resistance and catalyst or reaction contact surface against structural strength and in-plane thermal conduction of at least the combustion catalyst;
the permeable combustion cell catalyst layer pathway tortuosity, τ_{cl}, has a range of 1 to 3, optionally, 1 to 2.5, and, preferably, 1 to 2,
the combustion cell inert permeable barrier pathway tortuosity, τ_{cb}, is arranged to increase the effective depth of the combustion cell inert permeable barrier pathway to at least reduce, and, preferably, eliminate, diffusion;
the combustion cell inert permeable barrier pathway tortuosity, τ_{cb}, has a range of 1 to 10, and, optionally, 1 to 5;
the permeable combustion cell catalyst layer porosity, ε_{cl}, is selected balance flow resistance against structural strength and in-plane thermal conduction of the permeable combustion cell catalyst layer;
the permeable combustion cell catalyst layer porosity, ε_{cl}, has a range of 0.1 to 0.9, and, preferably, 0.5 to 0.8,
the combustion cell inert permeable barrier porosity, ε_{cb}, has a lower bound to accommodate an orifice or foraminate plate example and an upper bound to accommodate higher tortuosity materials;
the combustion cell inert permeable barrier porosity, ε_{cb}, has a range of 0.01 to 0.5, and, preferably, 0.05 to 0.5, and/or
the combustion cell inert permeable barrier depth, d_{cb}, can be set to achieve a balance, at a lower limit, between an increase in effective depth to limit diffusion, as described with reference to paragraphs [00209] to [00251], and so cannot be too thin, with, at an upper limit, constraining size of the inert permeable barrier such that it has a volume smaller than an associated combustion cell;
the combustion cell inert permeable barrier depth, d_{cb}, is greater or equal to 0.01 mm, optionally 0.01 mm to 5 mm and, preferably, 0.1 mm to 2 mm.

Examples of the relationship between the geometric parameters of the permeable combustion cell catalyst layer and its associated pathway to the operational parameters of the combustion cell are given in Table 6.

Examples of the relationship between the geometric parameters of the combustion cell inert permeable barrier and its associated pathway to the operational parameters of the combustion cell and associated barriers are given in Table 6.

The ratio

$$\frac{{τ}_{cl}^{2}}{{ε}_{cl}} \frac{{d}_{cl}^{2}}{{f}_{cl}^{2} {t}_{cl}^{3}} ,$$

which relates the geometric parameters of the permeable combustion cell catalyst layer and its associated pathway to the operational parameters of the combustion cell, has a range of 1e5/m to 1e12/m, optionally, 1e7/m to 1e11/m and, preferably 5e8/m to 5e10/m.

The ratio

$$\frac{{d}_{cb} {d}_{cl} {τ}_{cb}^{2}}{{t}_{cl} {ε}_{cb}} ,$$

which relates the geometric parameters of the combustion cell inert permeable barrier and its associated pathway to the operational parameters of the combustion cell and associated barriers, has a range of 0.02 m to 50 m, optionally, 0.1 m to 10 m and, preferably 0.5 m to 10 m.

The combustor assemblies 1802 can be arranged in the same plane adjacent to one another to form an array of combustor assemblies. An array can be an n×m array, where n is greater than or equal to one, and m is greater than or equal to one. Arrays of combustor assemblies can be stacked to form a combustor comprising a block of stacked arrays of combustor assemblies.

In operation, the fuel or reactant 1820 supplied to the permeable combustion catalyst layers 1812.1 of the combustion cells 1817.1 is burnt in a reaction using the combustion oxidant supply flow 1824 to 1826 that is also supplied to the combustion cells 1817.1. The reaction generates heat. The heat is transferred to the oxidant or air supply flows 1856 to 1858 thereby thermally conditioning the oxidant or air exhaust flows 1868 to 1874. For example, the heat is used to increase the temperature of the oxidant or air exhaust flows 1868 to 1874.

Although the combustor 1802 has been described as a combustor, it performs the function of also thermally conditioning the oxidant (air) used within a fuel cell or within a fuel cell system. Examples of fuel cell systems will be described below.

Table 6 below shows a summary of parameters associated with a combustion cell and associated barrier layer according to any of the example combustion cell and associated barrier layers described herein. Foreach parameter, where appropriate, upper and lower bounds are given together with a typical or mid-point in the form of “Max”, “Min”, and “Mid”.

TABLE 6
Combustion Cell Parameters

| | Combustion Cell | |
|---|---|---|
| Component | Permeable combustion cell catalyst | Combustion cell Inert Permeable |
| | layer and pathway (cl) | Barrier and pathway (cb) |
| Notes | Assume a single stack (20 anode cells) | Required at inlet to combustion cell |
| | worth of fuel flow bundled together. | |
| | (Ignoring small amount of air required to | |
| | combust remaining fuel) The flow output | |
| | of several stacks could be handled by a | |
| | single combustion cell, which would | |
| | further increase the thickness | |
| | requirements outlined below | |

| Ratio | $\frac{p Δ {pFU}_{f}}{20 RT 32 μ i} = \frac{{τ}_{cl}^{2}}{{ε}_{cl}} \frac{{d}_{cl}^{2}}{{f}_{cl}^{2} {t}_{cl}^{3}} ( {m}^{- 1} )$ | | | $\frac{{Pe}_{m} {FpDU}_{f}}{20 RTi} = \frac{{d}_{cb} {d}_{cl} {τ}_{cb}^{2}}{{t}_{cl} {ε}_{cb}} ( m )$ | | | | | |
|---|---|---|---|---|---|---|---|---|---|
| Operational Point | Min | Mid | Max | Min | | Mid | | Max | |
| Pressure p (bar) | 5 | 10 | 25 | 5 | | 10 | | 25 | |
| Pressure Drop Δp (mbar) | 20 | 50 | 300 | 5.4 | | 5.8 | | 2.6 | |
| Dynamic Viscosity μ (Pa.s) | 4e-05 | 3e-05 | 2e-05 | | | | | | |
| Universal Gas Constant R | 8.3145 | | | 8.3145 | | | | | |
| (J/mol/K) | | | | | | | | | |
| Faraday's constant F | 96485 | | | 96485 | | | | | |
| (C/mol) | | | | | | | | | |
| Current Density i (A/cm2) | 0.3 | 0.2 | 0.1 | 0.3 | | 0.2 | | 0.1 | |
| Temperature T (°C) | 900 | 700 | 500 | 900 | | 700 | | 500 | |
| Fuel Utilization U | 0.33 | 0.9 | 0.95 | 0.33 | | 0.9 | | 0.95 | |
| Fuel flow rate per cm2 of | 1.9e-04 | 4.6e-05 | 2.2e-05 | 1.9e-04 | | 4.6e-05 | | 2.2e-05 | |
| combustion cell area | | | | | | | | | |
| (mol/s/cm2) | | | | | | | | | |
| Mass Peclet Number Peₘ | | | | 5 | | 20 | | 50 | |
| Diffusion Coefficient D | | | | 8e-04 | | 3e-04 | | 1e-04 | |
| (m2/s) | | | | | | | | | |
| Ratio Value | 4.3e7 (1/m) | 1.4e9 (1/m) | 8.4e10 (1/m) | 0.1 (m) | | 1.6 (m) | | 7.3 (m) | |
| Ratio Range | $1 e 7 < \frac{p Δ {pFU}_{f}}{20 RT 32 μ i} < 1 e 11 ( 1 / m )$ | | | $0.1 < \frac{{Pe}_{m} {FpDU}_{f}}{20 RTi} < 10 ( m ) ,$ | | | | | |
| | $optionally 5 e 8 < \frac{p Δ p F {U}_{f}}{20 RT 32 μ i} < 5 e 10 ( 1 / m )$ | | | $optionally 0.5 < \frac{P {e}_{m} {FpDU}_{f}}{20 RTi} < 10 ( m )$ | | | | | |
| Pathway Tortuosity τ | 1 < τ_{cl} < 2 | | | 1 < τ_{cb} < 5 | | | | | |
| Porosity ε | 0.5 < ε_{cl} < 0.8 | | | 0.05 < ε_{cb} < 0.5 | | | | | |
| Depth d | 0.5 < d_{cl} < 2 (cm) | | | d_{cb} see below | | | | | |
| Pathway Pore size ratio f_{cl} | 0.25 < f_{cl} < 0.75 | | | | | | | | |
| Non-dimensional terms | $1 < \frac{{τ}_{c l}^{2}}{{ε}_{c l} {f}_{c l}^{2}} < 500 ,$ | | | $20 < \frac{{τ}_{c b}^{2}}{{ε}_{c b}} < 500 ,$ | | | | | |
| | $optionally 2 < \frac{{τ}_{c l}^{2}}{{ε}_{c l} {f}_{c l}^{2}} < 50$ | | | $optionally 20 < \frac{{τ}_{c b}^{2}}{{ε}_{c b}} < 200$ | | | | | |
| | $1.25 < \frac{{τ}_{c l}^{2}}{{ε}_{c l}} < 8 , optionally 5 < \frac{{τ}_{c l}^{2}}{{ε}_{c l}} < 8$ | | | | | | | | |
| | Permeable combustion cell catalyst layer | | | | | | | | |
| | thickness t_{cl} (μm) | | | Barrier Depth d_{cb} (mm) | | | | | |
| Ratio Value | 4.3e7 (1/m) | 1.4e9 (1/m) | 8.4e10 (1/m) | 0.1 (m) | | 1.6 (m) | | 7.3 (m) | |
| $Non - dimensational term \frac{{τ}_{cb}^{2}}{{ε}_{cb}}$ | | | | 20 | 500 | 20 | 500 | 20 | 500 |
| ${d}_{c l} = 0.5 ( cm ) , \frac{{τ}_{c l}^{2}}{{ε}_{cl} {f}_{c l}^{2}} = 2.22$ | 109 | 34 | 9 | 0.13 | 0.005 | 0.56 | 0.02 | 0.63 | 0.03 |
| ${d}_{c l} = 0.5 ( cm ) , \frac{{τ}_{c l}^{2}}{{ε}_{cl} {f}_{c l}^{2}} = 128$ | 423 | 132 | 34 | 0.49 | 0.02 | 2.15 | 0.09 | 2.45 | 0.10 |
| ${d}_{c l} = 2 ( cm ) , \frac{{τ}_{c l}^{2}}{{ε}_{cl} {f}_{c l}^{2}} = 2.22$ | 276 | 86 | 22 | 0.08 | 0.003 | 0.35 | 0.01 | 0.40 | 0.02 |
| ${d}_{c l} = 2 ( cm ) , \frac{{τ}_{c l}^{2}}{{ε}_{cl} {f}_{c l}^{2}} = 128$ | 1065 | 332 | 85 | 0.31 | 0.01 | 1.36 | 0.05 | 1.54 | 0.06 |

| Range | 5 < t_{cl} < 1000 (μm), | 0.01< d_{cb} <5 (mm), | | |
|---|---|---|---|---|
| | optionally 10 < t_{cl} < 500 (μm) | optionally 0.1 < d_{cb} <2 (mm) | | |
| Effective Pathway Depth | $\frac{{d}_{cl} {τ}_{cl}^{2}}{{ε}_{cl}} ( cm )$ | $\frac{{d}_{c b} {τ}_{c b}^{z}}{{ε}_{c b}} ( cm )$ | | |
| ${d}_{c l} = 0.5 ( cm ) , \frac{{τ}_{c l}^{2}}{{ε}_{cl}} = 1.25$ | 0.625 | 0.3 | 1.1 | 1.3 |
| ${d}_{c l} = 0.5 ( cm ) , \frac{{τ}_{c l}^{2}}{{ε}_{cl}} = 8$ | 4 | 1.0 | 4.3 | 4.9 |
| ${d}_{c l} = 2 ( cm ) , \frac{{τ}_{c l}^{2}}{{ε}_{cl}} = 1.25$ | 2.5 | 0.2 | 0.7 | 0.8 |
| ${d}_{c l} = 2 ( cm ) , \frac{{τ}_{c l}^{2}}{{ε}_{cl}} = 8$ | 16 | 0.6 | 2.7 | 3.1 |
| Range | $0.5 < \frac{{d}_{c l} {τ}_{c l}^{2}}{{ε}_{c l}} 15 ( cm ) ,$ | $0.2 \frac{{d}_{c b} {τ}_{c b}^{2}}{{ε}_{c b}} 10 ( cm ) ,$ | | |
| | $optionally 0.5 < \frac{{d}_{c l} {τ}_{c l}^{2}}{ε} 10 ( cm ) ,$ | $optionally 0.5 < \frac{{d}_{c b} {τ}_{c b}^{2}}{{ε}_{cb}} 5 ( cm )$ | | |
| Barrier to Cell pathway depth ratio | $\frac{{d}_{c b} {τ}_{c b}^{z}}{{ε}_{c b}} / \frac{{d}_{cl} {τ}_{cl}^{2}}{{ε}_{cl}}$ | | | |
| ${d}_{c l} = 0.5 ( cm ) , \frac{{τ}_{c l}^{2}}{{ε}_{cl}} = 1.25$ | | 0.4 | 1.8 | 2.0 |
| ${d}_{c l} = 0.5 ( cm ) , \frac{{τ}_{c l}^{2}}{{ε}_{cl}} = 8$ | | 0.2 | 1.1 | 1.2 |
| ${d}_{c l} = 2 ( cm ) , \frac{{τ}_{c l}^{2}}{{ε}_{c l}} = 1.25$ | | 0.1 | 0.3 | 0.3 |
| ${d}_{c l} = 2 ( cm ) , \frac{{τ}_{c l}^{2}}{{ε}_{cl}} = 8$ | | 0.04 | 0.2 | 0.2 |

| | |
|---|---|
| Range | $0.1 < \frac{{d}_{cb} {τ}_{cb}^{2}}{{ε}_{cb}} / \frac{{d}_{cl} {τ}_{cl}^{2}}{{ε}_{cl}} < 5 , optionally 0.25 < \frac{{d}_{cb} {τ}_{cb}^{2}}{{ε}_{cb}} / \frac{{d}_{cl} {τ}_{cl}^{2}}{{ε}_{cl}} < 2$ |

The parameter values given in table 6 described herein are preferred parameter values and/or parameter value ranges. Examples can be realised in which wider parameter value ranges can be used, as described below with respect to the methods of operation and operating parameter spaces.

Table 7 below shows a summary of parameters associated with a combustor oxidant cell according to any of the example combustor oxidant cells described herein. For each parameter, where appropriate, upper and lower bounds are given together with a typical or mid-point in the form of “Max”, “Min”, and “Mid”.

TABLE 7
Combustor Oxidant Cell

| Component | Permeable Oxidant Layer and pathway (co) | | |
|---|---|---|---|
| Notes | Assume each combustor oxidant cell receives the | | |
| | same flow rate of air as flowing through a stack of 20 | | |
| | anode cells and 20 cathode cells. The flow output of | | |
| | several stacks could be handled by a single combustor | | |
| | oxidant cell, which would further increase the thickness | | |
| | requirements outlined below. | | |
| Ratio | $\frac{p Δ {pFU}_{a}}{50 RT 32 μ i} = \frac{{τ}_{c o}^{2}}{{ε}_{c o} {f}_{c o}^{2}} \frac{{w}_{c o}^{2}}{{f}_{c o}^{2} {t}_{c o}^{3}} ( {m}^{- 1} )$ | | |
| Operational Point | Min | Mid | Max |
| Pressure p (bar) | 5 | 10 | 25 |
| Pressure Drop Δp (mbar) | 20 | 50 | 300 |
| Dynamic Viscosity μ (Pa.s) | 4.5e-05 | 4.25e-05 | 4e-05 |
| Universal Gas Constant R | 8.3145 | | |
| (J/mol/K) | | | |
| Faraday's constant F (C/mol) | 96485 | | |
| Current Density i (A/cm2) | 0.3 | 0.2 | 0.1 |
| Temperature T (°C) | 900 | 700 | 500 |
| Air Utilization Uₐ | 0.25 | 0.5 | 0.75 |
| Air flow rate per cm2 of oxidant | 6.2e-04 | 2.1e-04 | 6.9e-05 |
| cell area (mol/s/cm2) | | | |
| Ratio Value | 1.2e7 (1/m) | 2.2e8 (1/m) | 1.3e10 (1/m) |
| Ratio Range | $1 e 7 < \frac{p Δ {pFU}_{a}}{50 RT 32 μ i} < 5 e 10 ( 1 / m ) ,$ | | |
| | $optionally 5 e 7 < \frac{p Δ {pFU}_{a}}{50 RT 32 μ i} < 1 e 10 ( 1 / m )$ | | |
| Pathway Tortuosity τ_{co} | 1 < τ_{co} < 2 | | |
| Porosity ε_{co} | 0.5 < ε_{co} < 0.8 | | |
| Width w_{co} | 0.5 < w_{co} < 2 (cm) | | |
| Pathway Pore size ratio f_{co} | 0.25 < f_{co} < 0.75 | | |
| Non-dimensional terms | $1 < \frac{{τ}_{c o}^{2}}{{ε}_{c o} {f}_{c o}^{2}} < 500 , optionally 2 < \frac{{τ}_{c o}^{2}}{{ε}_{c o} {f}_{c o}^{2}} < 50$ | | |
| | $125 < \frac{{τ}_{c o}^{2}}{{ε}_{co}} < 8 , optionally 5 < \frac{{τ}_{c o}^{2}}{{ε}_{co}} < 8$ | | |
| | Oxidant Layer Thickness t_{co} (μm) | | |
| Ratio Value | 1.2e7 (1/m) | 2.2e8 (1/m) | 1.3e10 (1/m) |
| ${w}_{m o} = 0.5 ( cm ) , \frac{{τ}_{c o}^{2}}{{ε}_{c o} {f}_{c o}^{2}} = 2.22$ | 169 | 63 | 16 |
| ${w}_{m o} = 0.5 ( cm ) , \frac{{τ}_{c o}^{2}}{{ε}_{c o} {f}_{c o}^{2}} = 128$ | 654 | 245 | 62 |
| ${w}_{m o} = 2 ( cm ) , \frac{{τ}_{c o}^{2}}{{ε}_{c o} {f}_{c o}^{2}} = 2.22$ | 427 | 160 | 41 |
| ${w}_{mo} = 2 ( cm ) , \frac{{τ}_{c o}^{2}}{{ε}_{c o} {f}_{c o}^{2}} = 128$ | 1649 | 616 | 157 |

| | |
|---|---|
| Range | 20 < t_{co} <1600 (μm), |
| | optionally 50 < t_{co} <600 (μm) |

The parameter values given in table 7 described herein are preferred parameter values and/or parameter value ranges. Examples can be realised in which wider parameter value ranges can be used, as described below with respect to the methods of operation and operating parameter spaces.

Referring to FIG. 19, there is shown a view 1900 of a fuel cell system 1902 for generating electricity to be supplied to a load 1901 via electrical connections 1901a, 1901b from a fuel cell block 1904 of fuel cell assemblies comprising fuel cells as described in any example here. The fuel cell block 1904 is an example of any fuel cell block described herein. The fuel cell system 1902 is described with reference to an example operating point that is related to the typical mid-point outlined in the preceding tables by “Mid”. Examples are not limited to one single operating point but can vary over the range of conditions highlighted in the tables.

The fuel cell block 1904 is supplied with a reactant 1906. In the example depicted, the reactant 1906 is ammonia. However, the reactant could alternatively be hydrogen. The reactant 1906 can be thermally conditioned by a heat exchanger 1908 to be within a predetermined temperature range, or to be a predetermined temperature. Examples can be realised in which the predetermined temperature range is between 775 °C to 825 °C. Examples can be realised in which the predetermined temperature is 800 °C. The reactant 1906 is supplied to the anodes of the fuel cell via the above-described reactant supply channels.

The fuel cell block 1904 is supplied with an oxidant 1910. The oxidant 1910 can be air or oxygen. The oxidant 1910 is supplied to the cathodes of the fuel cell block 1904 via the above-described oxidant supply channels. The oxidant 1910 can be thermally conditioned by a heat exchanger 1912. The heat exchanger 1912 can form part of a combustor 1914. The combustor 1914 is an example of the above-described combustor 1802 such that the oxidant 1910 forms part of one or both of the oxidant supply flows 1856 to 1858 and/or one or both of the oxidant exhaust flows 1868 to 1874.

The fuel cell block 1904 is supplied with a chemical coolant 1916. The chemical coolant is an example of any of the chemical coolants described herein. The chemical coolant 1916 is supplied, via a blower or pump 1917, to the chemical coolant supply flow channels described herein from where it is supplied to chemical coolant cells. The chemical coolant 1916 comprises at least methane and water, in the form of steam. The chemical reactions that take place within the chemical coolant cells transform the chemical coolant 1916 into hydrogen and carbon monoxide, or hydrogen and carbon dioxide, using heat generated by the fuel cells processing reactants and oxidants, which, in turn, influences the temperature of the fuel cell. The temperature difference across the fuel cell is limited to a predetermined temperature difference. Examples can be realised in which the predetermined temperature difference is 50 °C or less.

The chemical coolant 1916 leaves the chemical coolant cell and is fed to a heat exchanger 1918 where it is thermally conditioned. Examples can be realised in which such thermal conditioning cools the chemical coolant. Examples can be realised in which the chemical coolant is cooled from about 850 °C to 800 °C. Following thermal conditioning, the chemical coolant 1916 is fed to a methanator 1920 for recovery before then being supplied to the blower 1917 from where it is recirculated into the chemical coolant supply channel again. The methanator 1920 is an example of the methanator 1602 or any other methanator described, and/or claimed, herein. The chemical coolant 1916 enters the blower 1917 at a temperature that is within a predetermined temperature range of predetermined temperature 600 °C to 800 °C. Examples can be realised in which the chemical coolant 1916 enters the blower 1917 at a predetermined temperature of 750 °C.

The methanator 1920 can be realised as any of the methanators described herein. The methanator 1920 is used to perform at least one, or both, of: recovering the chemical coolant in a form that can be reused for chemical cooling and thermally conditioning, that is, transferring heat to, for example, a compressor oxidant flow 1922 output by a compressor 1924 or some other means for removing heat. The compressor 1924 draws on an air supply 1926.

Although the example system depicted in FIG. 19 shows the methanator 1920 as thermally conditioning an oxidant flow 1922, examples are not limited to such arrangements. Examples can be realised in which the methanator 1920 is arranged to thermally condition some other medium such as, for example, a further gas or liquid. The further gas or liquid could be used to transfer heat to other entities or other parts of the system.

The fuel cell system can further comprise a turbine 1928. The turbine 1928 is responsive to an oxidant flow 1930 output by the heat exchanger 1912. The oxidant flow 1930 output by the heat exchanger 1912 has a predetermined temperature that is within a predetermined temperature range 775 °C to 825 °C. Examples can be realised in which the predetermined temperature is 800 °C. The turbine 1928 is used to drive the compressor 1924. The turbine 1928 can also be coupled to a generator 1942 for generating electricity that can be supplied to a load 1944.

In operation, the fuel cell system exhibits a predetermined temperature rise across each fuel cell from the inlets to the anodes and cathodes to the outlets of the anodes and cathodes. Examples can be realised in which the predetermined temperature rise is of the order of 50 °C or less.

In the example depicted in FIG. 19, the reactant is ammonia. The ammonia is circulated via a first reactant circuit 1932 through the anodes of the fuel cells via the heat exchanger 1908. The heat exchanger 1908 also diverts or feeds the spent fuel exiting the fuel cell to the combustor 1914. The chemical coolant 1916 is circulated via the blower 1917 around a first chemical coolant loop 1934 through the chemical coolant cells, then around a second chemical coolant loop 1936 in which the chemical coolant reformate, that is, the reformed chemical coolant, output from the chemical coolant cells is recovered in the methanator 1920 from where is it recirculated back to the heat exchanger 1918 where it is recoupled into the first chemical coolant circuit 1934 via the blower 1917 for re-use. The inlet flow 1916 essentially replaces coolant lost to leakage or unwanted side reactions that consume chemical coolant. Optionally, this replacement chemical coolant can be supplied in the form of a methanol water mixture that is easier to store than methane but will ultimately enable the same chemical processes to proceed as if the loop had been replenished with methane. The oxidant is circulated around a first oxidant loop 1938 through the cathodes 1940 of the fuel cells and the combustor 1914 and heat exchanger 1912, where it is thermally conditioned as described above. Although not shown in FIG. 19, examples can be realised in which the first chemical coolant loop can also comprise an exhaust to allow the chemical coolant within the first chemical coolant loop to be replenished if the chemical coolant has become degraded over time. Any exhausted chemical coolant can be applied for other uses such as, for example, being combusted or being stored within a pressurised tank for processing at a later time.

The chemical reactions taking place in the various elements of the fuel cell system 1902 shown in FIG. 19 are described in Table 8 below:

TABLE 8
Chemical Reactions - System 1: NH3 Fuel

| Material | Reaction |
|---|---|
| Anode/Electrolyte | H₂ + O²⁻ → H₂O + 2e⁻ |
| Interface | |
| Cathode/ Electrolyte Interface | $\frac{1}{2} {O}_{2} + 2 {e}^{-} \to {O}^{2 -}$ |
| Fuel Processing & | 2NH₃ → N₂ + 3H₂ |
| Polishing Catalysts | |
| Chemical Coolant | CH₄ + H₂O → 3H₂ + CO |
| Catalyst | CO + H₂O → H₂ + CO₂ |
| Methanation | 3H₂ + CO → CH₄ + H₂O |
| Catalyst | 4H₂ + CO₂ → CH₄ + 2H₂O |
| Combustor | 2H₂ + O₂ → 2H₂O |

Examples that are realised using ammonia as the reactant can benefit from having the fuel cell structure described above with reference to, and/or as depicted in, FIGS. 11 to 13, taken jointly and severally in any and all permutations. At least one, or both, of the fuel processing catalyst and fuel polishing catalyst help reduce, or prevent, adverse effects within the cells such as, for example, nitriding within the anode electrodes of the fuel cells by ensuring that all of the ammonia is decomposed into hydrogen and nitrogen.

Although the above example has been described with reference to a fuel cell system that uses ammonia as the reactant, examples are not limited to such an arrangement. Examples can be realised in which the reactant is hydrogen. Table 9 below shows the reactions that take place within the fuel cell system of FIG. 19 when the reactant is hydrogen.

TABLE 9
Chemical Reactions - System 1: H2 Fuel

| Material | Reaction |
|---|---|
| Anode/Electrolyte | H₂ + O²⁻ → H₂O + 2e⁻ |
| Interface | |
| Cathode/ Electrolyte Interface | $\frac{1}{2} {O}_{2} + 2 {e}^{-} \to {O}^{2 -}$ |
| Chemical Coolant | CH₄ + H₂O → 3H₂ + CO |
| Catalyst | CO + H₂O → H₂ + CO₂ |
| Methanation | 3H₂ + CO → CH₄ + H₂O |
| Catalyst | 4H₂ + CO₂ → CH₄ + 2H₂O |
| Combustor | 2H₂ + O₂ → 2H₂O |

The examples that use hydrogen as the reactant can omit at least one, or both, of: the fuel polishing catalyst layer 1148 and the fuel processing catalyst layer 1150.

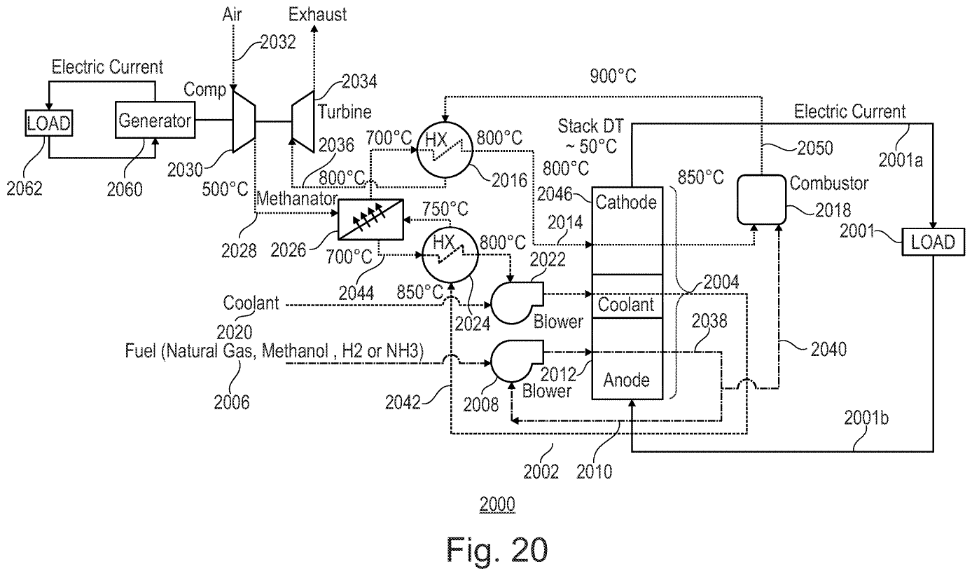

Referring to FIG. 20, there is shown a view 2000 of a fuel cell system 2002 for generating electricity to be supplied to a load 2001 via respective conductors 2001a and 2001b from a fuel cell block 2004 of fuel cell assemblies comprising fuel cells as described in any example here. The fuel cell block 2004 is an example of any fuel cell block described herein. The fuel cell system 2002 is described with reference to an example operating point that is related to the typical mid-point outlined in the preceding tables by “Mid”. Examples are not limited to one single operating point but can vary over the range of conditions highlighted in the tables.

The fuel cell block 2004 is supplied with a reactant 2006. In the example depicted, the reactant 2006 is natural gas. The reactant 2006 is supplied to a blower 2008, which feeds the reactant into a first reactant circuit 2010 that passes through, and feeds the reactant 2006 to, an anode channel that supplies the anodes, such as anode 2012, with reactant supply flows as described above. The reactant can be thermally conditioned by a blower 2008 by mixing the recycled reactant or fuel with newly supplied reactant or fuel to supply the thermally conditioned reactant to the anode 2012 at a temperature that is within a predetermined temperature range. Examples can be realised in which the predetermined temperature range is between 775 °C to 825 °C. Examples can be realised in which the predetermined temperature is 800 °C. The reactant 2006 is supplied to the anodes of the fuel cell via the above-described reactant supply channels.

The fuel cell block 2004 is supplied with an oxidant 2014. The oxidant 2014 can be air or oxygen. The oxidant 2014 is supplied to the cathodes of the fuel cell block 2004 via the above-described oxidant supply channels. The oxidant 2014 can be thermally conditioned by a heat exchanger 2016. The heat exchanger 2016 can form part of a combustor 2018. The combustor 2018 is an example of the above-described combustor 1802 such that the oxidant 2014 forms part of one or both of the oxidant supply flows 1856 to 1858 and/or the oxidant exhaust flows 1868 to 1874.

The fuel cell block 2004 is supplied with a chemical coolant 2020. The chemical coolant is an example of any of the chemical coolants described herein. The chemical coolant 2020 is supplied, via blower 2022, to the chemical coolant supply flow channels described herein from where it is supplied to chemical coolant cells. The chemical coolant 2020 comprises at least methane and water, in the form of steam. The chemical reactions that take place within the chemical coolant cells transform the chemical coolant 2020 into hydrogen and carbon monoxide, or hydrogen and carbon dioxide, using heat generated by the fuel cells processing reactants and oxidants, which, in turn, influences the temperature of the fuel cell. The temperature difference across the fuel cell is limited to a predetermined temperature difference. Examples can be realised in which the predetermined temperature difference is 50 °C or less.

The chemical coolant 2020 leaves the chemical coolant cell and is fed to a heat exchanger 2024 where it is thermally conditioned. Examples can be realised in which such thermal conditioning cools the chemical coolant. Examples can be realised in which the chemical coolant from the stack 2004 entering the heat exchanger 2024 is cooled from 850 °C to 800 °C. The cooling is realised by transferring heat from the chemical coolant 2020, contained within a respective chemical coolant circuit 2042, leaving the stack to the chemical coolant 2044 leaving a methanator 2026. The chemical coolant 2044 leaving the methanator has a predetermined temperature that is lower than the temperature of the chemical coolant leaving the stack. Examples can be realised in which the temperature of the chemical coolant leaving the methanator 2026 is within a predetermined temperature range of 650 °C to 725 °C. Examples can be realised in which the temperature of the chemical coolant leaving the methanator 2026 is 700 °C. Following thermal conditioning, the chemical coolant 2020 is fed to the blower 2022 from where it is recirculated into the chemical coolant supply channel again for re-use. Although not shown in FIG. 20, examples can be realised in which the chemical coolant circuit 2042 can also comprise an exhaust to allow the chemical coolant 2020 within the chemical coolant circuit 2042 to be replenished if the chemical coolant has become degraded over time. Any exhausted chemical coolant can be applied for other uses such as, for example, being combusted or being stored within a pressurised tank for processing at a later time. The chemical coolant 2020 enters the blower 2016 at a temperature that is within a predetermined temperature range of 725 °C to 800 °C. Examples can be realised in which the chemical coolant 2020 from the heat exchanger 2024 enters the blower 2022 at a predetermined temperature of 800 °C.

The methanator 2026 can be realised as any of the methanators described herein. The methanator 2026 is used to perform at least one, or both, of: recovering the chemical coolant in a form that can be reused for chemical cooling and thermally conditioning, that is, transferring heat to, for example, a compressor oxidant flow 2028 output by a compressor 2030 or some other means for removing heat. The compressor 2030 draws on an air supply 2032.

Although the example system depicted in FIG. 20 shows the methanator 2026 as thermally conditioning an oxidant flow 2028, examples are not limited to such arrangements. Examples can be realised in which the methanator 2026 is arranged to thermally condition some other medium such as, for example, a further gas or liquid. The further gas or liquid could be used to transfer heat to other entities or other parts of the system.

The fuel cell system further comprises a turbine 2034. The turbine 2034 is responsive to an oxidant flow 2036 output by the heat exchanger 2016. The oxidant flow 2036 output by the heat exchanger 2016 has a predetermined temperature that is within a predetermined temperature range of 800 °C to 850 °C. Examples can be realised in which the predetermined temperature is 800 °C. The turbine 2034 is used to drive the compressor 2030.

The turbine 2034 can also be coupled to a generator 2060 for generating electricity that can be supplied to a load 2062.

In operation, the fuel cell system exhibits a predetermined temperature rise across each fuel cell from the inlets to the anodes and cathodes to the outlets of the anodes and cathodes. Examples can be realised in which the predetermined temperature rise is of the order of 50 °C.

In the example depicted in FIG. 20, the reactant is natural gas. The natural gas is circulated via a first reactant circuit 2038 through the anodes of the fuel cells via the blower 2008. A combustion reactant supply flow feed 2040 is used to supply a combustion reactant supply flow to the combustor 2018, where is it burnt to supply or create heat for the heat exchanger 2016. The chemical coolant 2020 is circulated via the blower 2022 around a first chemical coolant loop 2042 through the chemical coolant cells, then around a second chemical coolant loop 2044 in which the reformate, that is, the cracked chemical coolant, output from the chemical coolant cells is recovered or methanated in the methanator 2026 from where it is recirculated back to the heat exchanger 2024 were it is recoupled into the first chemical coolant circuit via the blower 2022. The oxidant is circulated around a first oxidant loop 2050 through the cathodes 2046 of the fuel cells and the combustor 2018 and heat exchanger 2016, where it is thermally conditioned as described above.

The chemical reactions taking place in the various elements of the fuel cell system 2002 shown in FIG. 20 are described in Table 10 below:

TABLE 10
Chemical Reactions - System 2: Natural Gas Fuel

| Material | Reaction |
|---|---|
| Anode/ Electrolyte | H₂ + O²⁻ → H₂O + 2e⁻ |
| Interface | CO + O²⁻ → CO₂ + 2e⁻ |
| Cathode/ Electrolyte Interface | $\frac{1}{2} {O}_{2} + 2 {e}^{-} \to {O}^{2 -}$ |
| Fuel Processing & | CH₄ + H₂O → 3H₂ + CO |
| Polishing Catalysts | CO + H₂O → H₂ + CO₂ |
| Chemical Coolant | CH₄ + H₂O → 3H₂ + CO |
| Catalyst | CO + H₂O → H₂ + CO₂ |
| Methanation | 3H₂ + CO → CH₄ + H₂O |
| Catalyst | 4H₂ + CO → CH₄ + 2H₂O |
| Combustor | 2H₂ + O₂ → 2H₂O |

Although examples have been described with reference to FIG. 20 that use natural gas as the reactant, examples are not limited thereto. Examples can be realised in which other reactants can be used such as, for example, methanol, hydrogen or ammonia. Examples that are realised using reactants other than hydrogen gas as the reactant can benefit from having the fuel cell structure described above with reference to, and/or as depicted in, FIGS. 11 to 13, taken jointly and severally in any and all permutations. At least one, or both, of: the fuel processing catalyst and fuel polishing catalyst help reduce, or prevent, nitriding, in the case where the reactant is ammonia, within the anode electrodes of the fuel cells by ensuring that all of the ammonia is decomposed into hydrogen and nitrogen or that use polishing to at least reduce, and preferably remove, higher hydrocarbons such as, for example, ethene, ethane, propene, propane, etc.

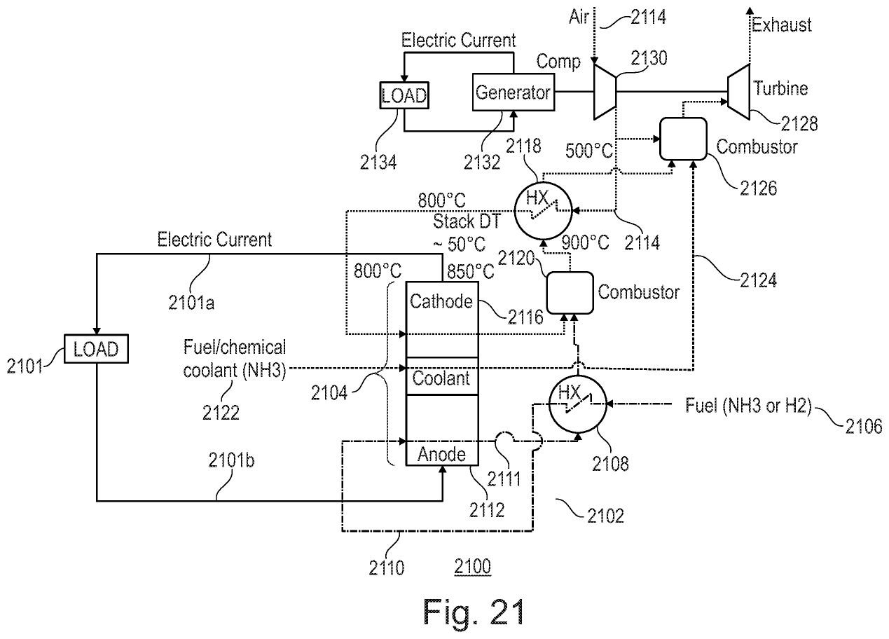

Referring to FIG. 21, there is shown a view 2100 of a fuel cell system 2102 for generating electricity to be supplied to a load 2101 via respective conductors 2101a and 2101b from a fuel cell block 2104 of fuel cell assemblies comprising fuel cells as described in any example herein. The fuel cell block 2104 is an example of any fuel cell block described herein. The fuel cell system 2102 is described with reference to an example operating point that is related to the typical mid-point outlined in the preceding tables by “Mid”. Examples are not limited to one single operating point and but can vary over the range of conditions highlighted in the tables.

The fuel cell block 2104 is supplied with a reactant 2106. In the example depicted, the reactant 2106 is ammonia. Alternatively, examples can be realised in which the reactant is hydrogen. The reactant 2106 is supplied to a heat exchanger 2108, which feeds the reactant into a first reactant circuit 2110 that passes through, and feeds the reactant 2106 to, an anode channel that supplies the anodes, such as anode 2112, with reactant supply flows as described above. The reactant can be thermally conditioned by the heat exchanger 2108 to be within a predetermined temperature range, or to be a predetermined temperature. Examples can be realised in which the predetermined temperature range is between 750 °C to 825 °C. Examples can be realised in which the predetermined temperature is 800 °C The reactant 2106 is supplied to the anodes of the fuel cell via the above-described reactant supply channels.

The fuel cell block 2104 is supplied with an oxidant 2114. The oxidant 2114 can be a gas comprising oxygen such as, for example, air or oxygen. The oxidant 2114 is supplied to the cathodes 2116 of the fuel cell block 2104 via the above-described oxidant supply channels. The oxidant 2114 can be thermally conditioned by a heat exchanger 2118. The heat exchanger 2118 can form part of a combustor 2120. The combustor 2120 is an example of the above-described combustor 1802 such that the oxidant 2114 forms part of one or both of the oxidant supply flows 1856 to 1858 and/or the oxidant exhaust flows 1868 to 1874.

The fuel cell block 2104 is supplied with a chemical coolant 2122. The chemical coolant is an example of any of the chemical coolants described herein. The chemical coolant 2122 is supplied to the chemical coolant supply flow channels described herein from where it is supplied to chemical coolant cells. The chemical coolant 2122 comprises at least ammonia. The chemical reactions that take place within the chemical coolant cells transform or crack the chemical coolant 2122 into hydrogen and nitrogen using heat generated by the fuel cells processing reactants and oxidants, which, in turn, influences the temperature of the fuel cell. The temperature difference across the fuel cell is limited to a predetermined temperature difference. Examples can be realised in which the predetermined temperature difference is 50 °C or less.

The reaction products 2124 from cracking the chemical coolant 2122 leave the chemical coolant cells and are fed to a combustor 2126. The combustor 2126 burns the reaction products 2124 in the presence of the oxidant 2114 where it can be used to drive a turbine 2128 of the fuel cell system 2102.

The turbine 2128 is used to drive the compressor 2130. The compressor 2130 ensures that the oxidant has a pressure that is within a predetermined pressure range of 500,000 Pascals (5 bar) to 2,500,000 Pascals (25 bar), such as, for example, 1,000,000 Pascals (10 bar). The turbine 2128 can also drive a generator 2132 that can generate and supply electricity to a load 2134.

In operation, the fuel cell system 2102 exhibits a predetermined temperature rise across each fuel cell from the inlets to the anodes and cathodes to the outlets of the anodes and cathodes. Examples can be realised in which the predetermined temperature rise is of the order of 50 °C.

In the example depicted in FIG. 21, the reactant is ammonia. The ammonia is circulated via a first reactant circuit 2110 through the anodes of the fuel cells. The exhaust 2111 from the anode cells comprises at least one, or both, of: unused cracked ammonia, that is, hydrogen and nitrogen, and water, in the form of steam. The exhaust 2111 is supplied to the heat exchanger 2108. The heat exchanger 2108 uses the heat of the exhaust 2111 to thermally condition the reactant 2108.

The output 2124 from the chemical coolant cells, that is, the hydrogen and nitrogen, form a combustion reactant supply flow feed that supplies a combustion reactant supply flow to the combustor 2126, where is it burnt to drive the turbine 2128.

The chemical reactions taking place in the various elements of the fuel cell system 2102 shown in FIG. 21 are described in Table 11 below:

TABLE 11
Chemical Reactions - System 3: NH3 Fuel

| Material | Reaction |
|---|---|
| Anode/Electrolyte | H₂ + O²⁻ → H₂O + 2e⁻ |
| Interface | |
| Cathode/ Electrolyte Interface | $\frac{1}{2} {O}_{2} + 2 {e}^{-} \to {O}^{2 -}$ |
| Fuel Processing & | 2NH₃ → N₂ + 3H₂ |
| Polishing Catalysts | |
| Chemical Coolant | 2NH₃ → N₂ + 3H₂ |
| Catalyst | |
| Combustor | 2H₂ + O₂ → 2H₂O |

Examples that are realised using ammonia as the reactant can benefit from having the fuel cell structure described above with reference to, and/or as depicted in, FIGS. 11 to 13, taken jointly and severally in any and all permutations. At least one, or both, of the fuel processing catalyst and fuel polishing catalyst help reduce, or prevent, nitriding within the anode electrodes of the fuel cells by ensuring that all of the ammonia is decomposed into hydrogen and nitrogen.

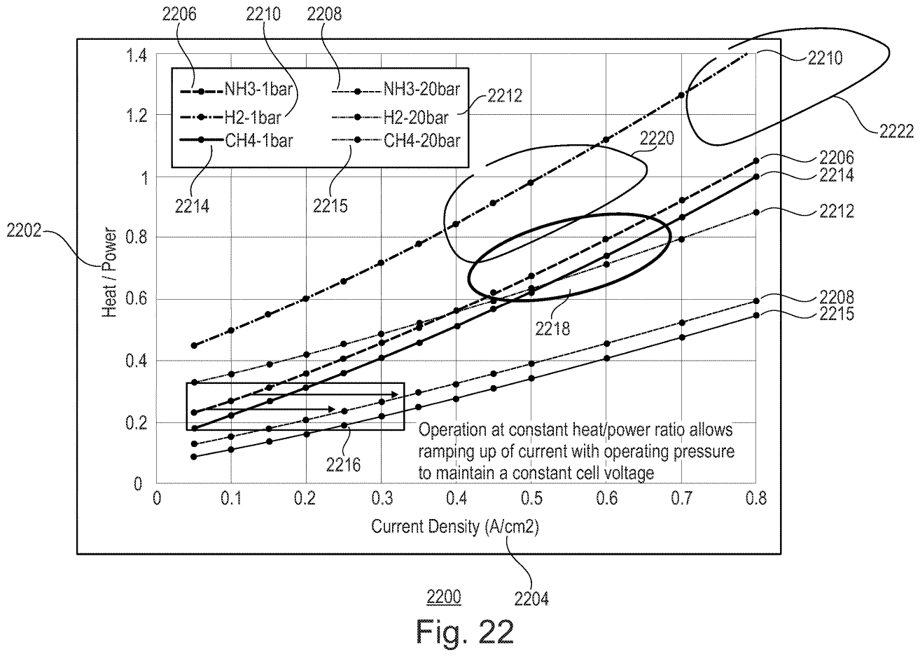

Referring to FIG. 22, there is shown a graph 2200 of the variation of a heat-to-power ratio 2202 generated by a fuel cell with current density (A/cm2) 2204 generated by a fuel cell using various reactants at respective pressures, that is, the performance or operation of a stack comprising set of chemical coolant cells. The stack is an example of any of the stacks described or claimed herein. The set of chemical coolant cells is arranged to provide a respective number of chemical coolant cells for a corresponding set of interdigitated anode and cathode cells of respective fuel cells. The stack corresponding to the performance or operation data given in FIG. 22 comprises a set of chemical coolant cells comprising two chemical coolant cells for every 20 anode cells and every 20 cathode cells, that is, 40 fuel cells. Examples can be realised in which the ratio of chemical coolant cells to fuel cells is other than 2:40, or 1:20.

In the graphs, six plots 2206 to 2215 are depicted. A first plot 2206 shows the variation in the heat/power ratio with current density when using ammonia as the reactant at a pressure of 1 bar. A second plot 2208 shows the variation in the heat/power ratio with current density when using ammonia as the reactant at a pressure of 20 bar. A third plot 2210 shows the variation in the heat/power ratio with current density when using hydrogen as the reactant at a pressure of 1 bar. A fourth plot 2212 shows the variation in the heat/power ratio with current density when using hydrogen as the reactant at a pressure of 20 bar. A fifth plot 2214 shows the variation in the heat/power ratio with current density when using methane as the reactant at a pressure of 1 bar. A sixth plot 2215 shows the variation in the heat/power ratio with current density when using methane as the reactant at a pressure of 20 bar.

The efficiency of the stack meaning the amount of useful electrical work that can be generated as a proportion of the lower heating value of the supplied fuel is correlated to the output voltage of the fuel cells within, which is, in turn, a function of the operating current density. Cell voltage and, hence, cell efficiency decreases with increasing current density. The efficiency reduces with increasing current and decreasing voltage. Therefore, the efficiency of a stack is minimum at a highest fuel cell current density and a lowest fuel cell voltage. The heat to power ratio is related to the inverse of efficiency such that it is at a maximum when efficiency is at a minimum, i.e. it increases with applied cell current density as shown in FIG. 22. The example fuel cells described herein can be operated at current densities in the range of 0.1 A/cm2 to 0.4 A/cm2 and a cell voltage in the range of 0.95 Volts to 0.75 Volts, which yields a power density (W/cm2) in the range of 0.095 W/cm2 to 0.3 W/cm2 for the reaction interface and stack thermal efficiencies in the range of 83% to 77%. For instance, examples can be arranged to provide a current density of 0.3 A/cm2 and a cell voltage of 0.83 Volts that gives 0.25 W of electrical power at each 1 cm2 reaction interface. In the example stack, the output would be approximately 10 W of electrical power per stack due to there being 20×2 reaction interfaces each with an area of 1 cm2 (derived from a cell depth of 1 cm and a cell width of 1 cm).

Examples can be realised in which the total reactant flow rate in the above-described stack is between 2×10⁻⁵ mol/s and 2×10⁻⁴ mol/s. For instance, using hydrogen as a reactant in the above stack, the reactant flow rate would be 6.9×10⁻⁵ mol/s.

Therefore, it can be appreciated from FIG. 22 that the worst case produces around 60% heat or 6 W per micro-stack using hydrogen as the reactant with a fuel cell operating at 0.3 A/cm2 and approximately 10 bar.

Assume, for example, that 4 W out of the 6 W should be removed from the stack to maintain stack temperature within acceptable limits, which results in 2 W of heat to be absorbed by each of the two chemical coolant cells, and assume that each chemical coolant supply flow comprises 20% methane that can all be converted to reformate in the two chemical coolant cells. Assume also that when 1 mol/s of methane is reformed, the reforming reaction absorbs ~2e5 J/mol/s of heat. Therefore, 1 mol/s of a such a chemical coolant comprising 20% methane absorbs 4×10⁴ J/mol/s of heat. Accordingly, to the chemical coolant supply flow rate to each coolant cell will be

$$\frac{2}{4 \times {10}^{4}} mol / s = 5 \times {10}^{- 5} mol / s$$

of chemical coolant, which is approximately the same as the fuel flow rate for the whole stack.

The graph 2200 also shows various regions of interest 2216 to 2222. A first region of interest 2216 represents operational performance or parameters associated with the example fuel cells described herein. It can be appreciated that the performance of the fuel cells described herein span a range of heat to power ratios of from about 0.18 to 0.34 along with a corresponding range of current densities from 0.05 A/cm2 to 0.33 A/cm2.

The first region of interest or operation 2216 is very distinct from and greatly separated from the other regions of interest of operation 2218 to 2222. The other regions of interest 2218 to 2222 are associated with prior art regions of interest or operation in which much larger heat/power ratios and much larger current densities are encountered, which creates very significant problems in managing or controlling heat generated during operation. The prior art regions of interest of operation follow from the trend in the art towards larger current densities.

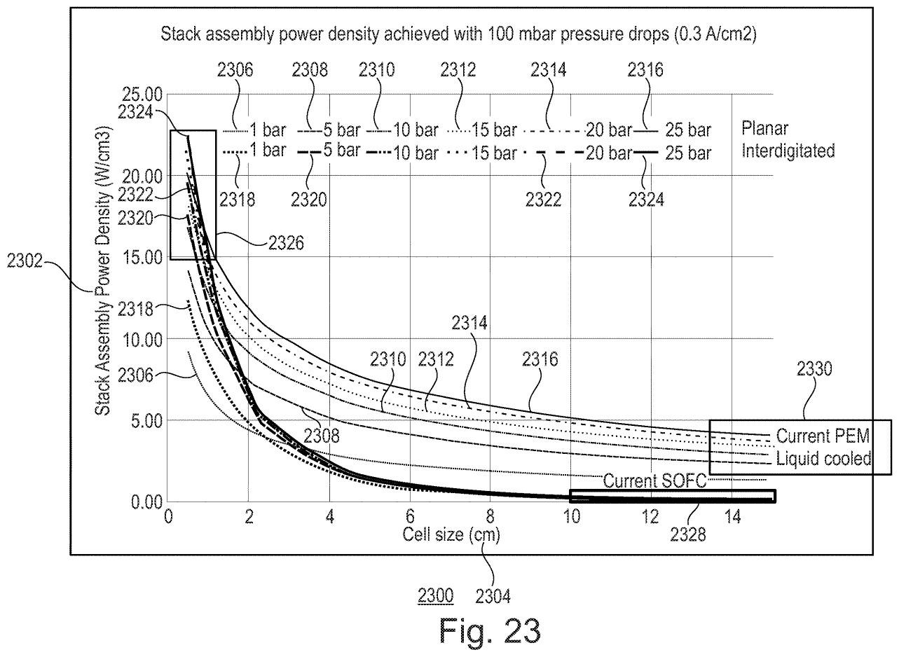

FIG. 23 shows a graph 2300 of variations in stack assembly power density (W/cm3) 2302 with cell size (cm) 2304 for a number of plots at corresponding operating pressures at the inlets to the cells for two types of structure; namely, interdigitated fuel cells according to the examples described herein and planar fuel cells at 100 mbar pressure drops across the fuel cell anodes and cathodes at a current density of 0.3 A/cm2.

A first set of plots relate to planar fuel cells. The first set of plots comprises six plots. A first plot 2306 shows a rapid fall off in power density from almost 10 W/cm3 at about 0.5 cm cell size to almost 1.0 W/cm3 for cell sizes of about 10 cm to 14 cm and beyond for a planar fuel cell. A second plot 2308 shows a rapid fall off in power density from almost 15 W/cm3 at about 0.5 cm cell size to almost 2.5 W/cm3 for cell sizes at, and beyond, about 10 cm for a planar fuel cell. A third plot 2310 shows a rapid fall off in power density from almost 17 W/cm3 at about 0.5 cm cell size to almost 4 W/cm3 for cell sizes at, and beyond, about 10 cm for a planar fuel cell. A fourth plot 2312 shows a rapid fall off in power density from almost 18 W/cm3 at about 0.5 cm cell size to almost 4.5 W/cm3 for cell sizes at, and beyond, about 10 cm for a planar fuel cell. A fifth plot 2314 shows a rapid fall off in power density from almost 20 W/cm3 at about 0.5 cm cell size to almost 5 W/cm3 for cell sizes at, and beyond, about 10 cm for a planar fuel cell. A sixth plot 2316 shows a rapid fall off in power density from just over 20 W/cm3 at about 0.5 cm cell size to just over 5 W/cm3 for cell sizes at, and beyond, about 10 cm for a planar fuel cell.

A second set of plots relate to interdigitated fuel cells. The second set of plots comprises four plots 2318 to 2324. A first plot 2318 of the second set shows a rapid fall off in power density from almost 12-13 W/cm3 at about 0.5 cm cell size to <1 W/cm3 for cell sizes of about 10 cm to 14 cm and beyond for an interdigitated fuel cell. A second plot 2320 of the second set shows a rapid fall off in power density from almost 18 W/cm3 at about 0.5 cm cell size to <1 W/cm3 for cell sizes at, and beyond, about 10 cm for an interdigitated fuel cell. A third plot 2322 of the second set shows a rapid fall off in power density from almost 22 W/cm3 at about 0.5 cm cell size to <1 W/cm3 for cell sizes at, and beyond, about 10 cm for an interdigitated fuel cell. A fourth plot 2324 of the second set shows a rapid fall off in power density from almost 22.5 W/cm3 at about 0.5 cm cell size to <1 W/cm3 for cell sizes at, and beyond, about 10 cm for an interdigitated fuel cell.

The graph 2300 of FIG. 23 also depicts a number of regions of interest 2326 to 2330. A first region of interest 2326 is associated with the performance of the example fuel cells described herein. It can be appreciated that very high stack assembly power densities can be realised for a range of cells sizes spanning about 0.5 cm to 2 cm, preferably, 0.5 cm to 1 cm. A second region of interest 2328 is associated with the performance of currently known commercially available solid oxide fuel stacks. It can be appreciated that very low power densities are realised for a range of cells sizes from about 10 cm upwards. Therefore, the performance of examples described herein is significantly better than prior art solid oxide fuel cells, which are pursuing a strategy of improving performance such as, for example, improving power density, by operating large fuel cells (>10 cm) at higher current densities. A third region of interest 2330 is associated with the second set of fuel cells and is associated with prior art Proton-Exchange Membrane (PEM), liquid cooled, fuel cells. Again, although the power densities are marginally better than those associated with the prior art solid oxide fuel cells, the power densities are a small percentage of the power densities achievable with the example fuel cells described herein, as depicted by the first region of interest. It will be appreciated that the cell size described with reference to FIG. 23 is interchangeable with the cell width and depth described with reference to examples herein.

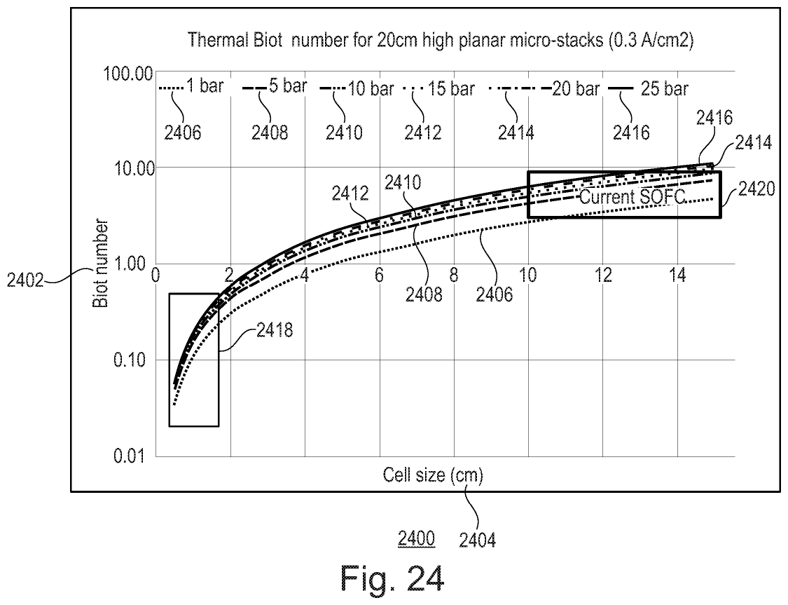

Referring to FIG. 24, there is shown a graph 2400 showing a set of plots of variation of thermal Biot number 2402 with cell size 2404 for a single anode cell within an assembly operated over a range of pressures from 1 bar to 25 bar. The fuel cell assembly comprises a set of fuel cell stacks 20 cm high delivering 0.3 A/cm2. The set of fuel cells comprises a single anode cell with sufficient fuel flowing over the inlet and outlet edges to supply a stack of cells that is 20 cm in height.

The thermal Biot number (Bi) describes the ratio of convective heat transfer (at the surface of a body) to internal heat transfer by conduction (within the volume of the body) and is defined for the example of an anode cell described herein by

$$Bi = \frac{h}{k} {d}_{e}$$

where
h is the heat transfer coefficient at the inlet or outlet of an anode cell (from gases flowing in the gas supply and exhaust plenums or channels)
k is the effective thermal conductivity of the anode cell (accounting for solid and gaseous portions)
dₑ is the anode cell depth in the reactant flow direction.

When the thermal Biot number (Bi)<<1 solid thermal conduction is dominant over the heat transfer processes at the cell inlet and outlet and the temperature variations within the cell are minimized.

The set of plots comprises six plots 2406 to 2416. All plots 2406 to 2416 of the set of plots show an initially rapidly increasing thermal Biot number with cell size that progressively becomes relatively insensitive to increasing cell size beyond a cell size of about 10 cm. FIG. 24 shows a set of regions of interest or operation 2418 and 2420. A first region of interest or operation 2418 is associated with example fuel cells described and claimed herein. The thermal Biot numbers are substantially confined to between about 0.04 and 0.8 for corresponding cell sizes of 0.5 cm to 2 cm. A second region of interest or operation 2420 is an estimate of the performance associated with prior art solid oxide fuel cells. The respective thermal Biot numbers are substantially greater than 1 and are almost or are over 10 for prior art SOFC cell sizes of 10 cm and greater. It will be appreciated that the cell size described with reference to FIG. 24 is interchangeable with the cell depth described with reference to examples herein and a plot showing the same relationship for cell width would have similar characteristics.

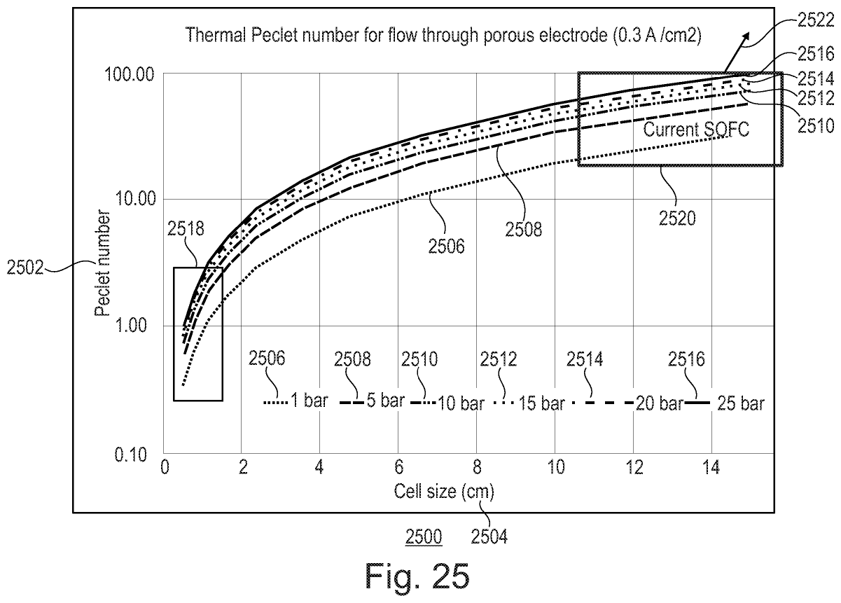

Referring to FIG. 25, there is shown a graph 2500 showing a set of plots of variation of thermal Peclet number, Peₜ, 2502 with cell size 2504 for a single anode cell operated over a range of pressures from 1 bar to 25 bar and at 0.3 A/cm2.

The thermal Peclet number, Peₜ, describes the ratio of thermal convective transport to conductive transport in the direction of a gas flow. For the example of a permeable anode cell described herein the thermal Peclet number is defined by

$${Pe}_{t} = \frac{{d}_{e} u ρ Cp}{k}$$

where:
dₑ is the anode cell depth in the reactant flow direction.
u is the averaged gas velocity
ρ is the gas density
Cp is the gas specific heat capacity
k is the effective thermal conductivity of the permeable anode cell (accounting for solid and gaseous portions)

When the thermal Peclet number Peₜ<<1, solid thermal conduction is dominant over thermal convection within the cell and the temperature variations within the cell are minimized.

The set of plots comprises six plots 2506 to 2516. All plots 2506 to 2516 of the set of plots show an initially rapidly increasing Peclet number with cell size that progressively becomes relatively insensitive to increasing cell size beyond a cell size of about 10 cm. FIG. 25 shows a set of regions of interest or operation 2518 and 2520. A first region of interest or operation 2518 is associated with example fuel cells described and claimed herein. The Peclet numbers are substantially confined to between about 0.4 and 2 for corresponding cell sizes of 0.5 cm to 2 cm. A second region of interest 2520 is shown in FIG. 25 that is associated with prior art fuel cells. The trend in the art is to increase output by increasing the fuel cell size and, consequently, the Peclet number, as depicted by the arrow 2522. It will be appreciated that the cell size described with reference to FIG. 25 is interchangeable with the cell depth described with reference to examples herein and a plot showing the same relationship for cell width would have similar characteristics.

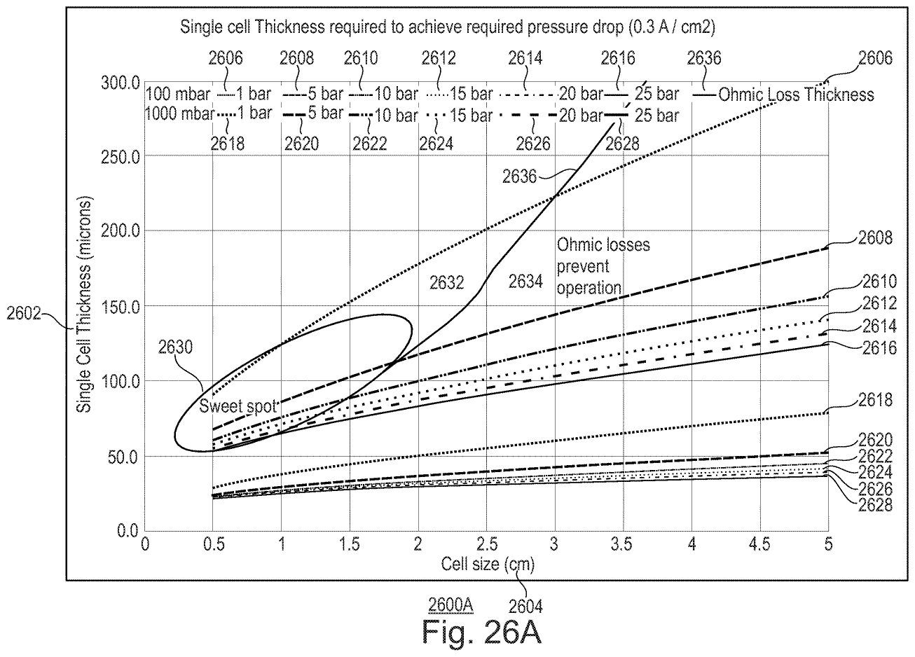

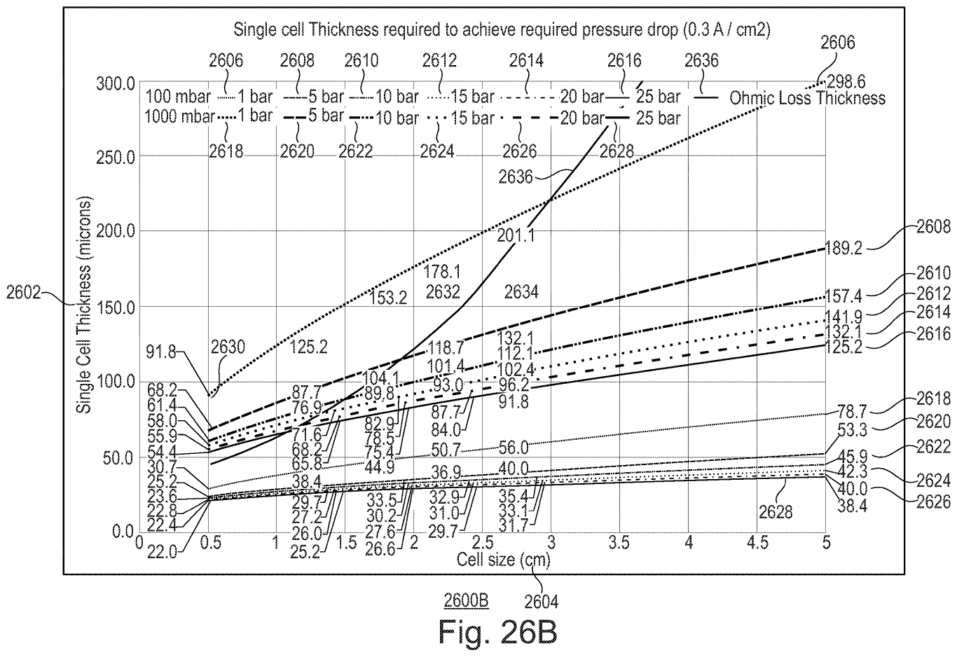

FIG. 26A shows a graph 2600A of the variations in single fuel cell thickness (one anode half-cell and one cathode half-cell) (microns) 2602 with cell size (cm) 2604 for two sets of plots at respective pressure drops across the fuel cells; namely, 100 mbar and 1000 mbar at a current density of 0.3 A/cm2.

A first set of plots relate to a pressure drop of 100 mbar. The first set of plots comprises six plots. A first plot 2606 shows a rapid rise in required single cell thickness to maintain a required pressure drop of 100 mbar across the fuel cell from about 90 microns to 300 microns as cell size increases over a range of 0.5 cm to 5 cm at a reactant supply flow pressure of 1 bar. A second plot 2608 shows a rapid rise in required single cell thickness to maintain a required pressure drop of 100 mbar across the fuel cell from about 70 microns to 190 microns as cell size increases over a range of 0.5 cm to 5 cm at a reactant supply flow pressure of 5 bar. A third plot 2610 shows a rapid rise in required single cell thickness to maintain a required pressure drop of 100 mbar across the fuel cell from about 60 microns to 160 microns as cell size increases over a range of 0.5 cm to 5 cm at a reactant supply flow pressure of 10 bar. A fourth plot 2612 shows a rapid rise in required single cell thickness to maintain a required pressure drop of 100 mbar across the fuel cell from about 58 microns to 140 microns as cell size increases over a range of 0.5 cm to 5 cm at a reactant supply flow pressure of 15 bar. A fifth plot 2614 shows a rapid rise in required single cell thickness to maintain a required pressure drop of 100 mbar across the fuel cell from about 56 microns to 130 microns as cell size increases over a range of 0.5 cm to 5 cm at a reactant supply flow pressure of 20 bar. A sixth plot 2616 shows a rapid rise in required single cell thickness to maintain a required pressure drop of 100 mbar across the fuel cell from about 54 microns to 125 microns as cell size increases over a range of 0.5 cm to 5 cm at a reactant supply flow pressure of 25 bar.

A second set of plots relate to a pressure drop of 1000 mbar. The second set of plots comprises six plots 2618 to 2624, modelled using the same single fuel cell as the first set of plots. A first plot 2618 of the second set of plots shows a very slow rise in required single cell thickness to maintain a required pressure drop of 1000 mbar across the fuel cell from about 31 microns to 75 microns as cell size increases over a range of 0.5 cm to 5 cm at a reactant supply flow pressure of 1 bar. A second plot 2620 of the second set of plots shows a very slow rise in required single cell thickness to maintain a required pressure drop of 1000 mbar across the fuel cell from about 25 microns to 55 microns as cell size increases over a range of 0.5 cm to 5 cm at a reactant supply flow pressure of 5 bar. A third plot 2622 of the second set of plots shows a very slow rise in required single cell thickness to maintain a required pressure drop of 1000 mbar across the fuel cell from about 24 microns to 46 microns as cell size increases over a range of 0.5 cm to 5 cm at a reactant supply flow pressure of 10 bar. A fourth plot 2624 of the second set of plots shows a very slow rise in required single cell thickness to maintain a required pressure drop of 1000 mbar across the fuel cell from about 24 microns to 45 microns as cell size increases over a range of 0.5 cm to 5 cm at a reactant supply flow pressure of 15 bar. A fifth plot 2626 of the second set of plots shows a very slow rise in required single cell thickness to maintain a required pressure drop of 1000 mbar across the fuel cell from about 22 microns to 42 microns as cell size increases over a range of 0.5 cm to 5 cm at a reactant supply flow pressure of 20 bar. A sixth plot 2628 of the second set of plots shows a very slow rise in required single cell thickness to maintain a required pressure drop of 1000 mbar across the fuel cell from about 22 microns to 40 microns as cell size increases over a range of 0.5 cm to 5 cm at a reactant supply flow pressure of 25 bar. FIG. 26B depicts sets of data points associated with the graphs of FIG. 26A.

The graph 2600 of FIG. 26A also depicts a number of regions of interest 2630 to 2634.

A first region of interest 2630 is associated with the performance of the example fuel cells described herein. It can be appreciated that relatively low cell thicknesses can be used for cell sizes spanning about 0.5 cm to 2 cm, to meet pressure drop requirements without incurring unacceptable in-plane ohmic losses, which are described below for an interdigitated cell. It will be appreciated that the cell size described with reference to FIG. 23 is interchangeable with the cell width and depth described with reference to examples herein.

A second region of interest 2632 is associated with a region where the Ohmic losses associated with a single interdigitated cell having a respective single cell thickness and a respective cell size are tolerable or acceptable. The aforementioned ohmic losses are inversely proportional to the cell thickness (which reduces electrical resistance by increasing the in-plane cross-sectional area available to conduct electricity) and proportional to the cell size squared (which firstly acts to increase electrical resistance by increasing the in-plane conduction flow path length and secondly acts to increase the total magnitude of the in-plane current flow). Thus, increasing cell size requires a corresponding quadratic increase in cell thickness to maintain ohmic losses. As outlined above by the first region of interest 2630, the examples described herein are designed to operate in the part of the second region of interest 2632 where cell size is sufficiently small that ohmic loss considerations do not require cell thicknesses to be increased significantly beyond those required to meet pressure drop requirements.

A third region of interest or performance 2634 is associated with a region where the Ohmic losses associated with a single cell having a respective single cell thickness and a respective cell size are intolerable or unacceptable. The in-plane ohmic losses in the third region 2634 are too great to sustain acceptable performance for interdigitated cells such as those described herein.

The division between the second and third regions of interest or performance is defined by an Ohmic loss transition line 2636.

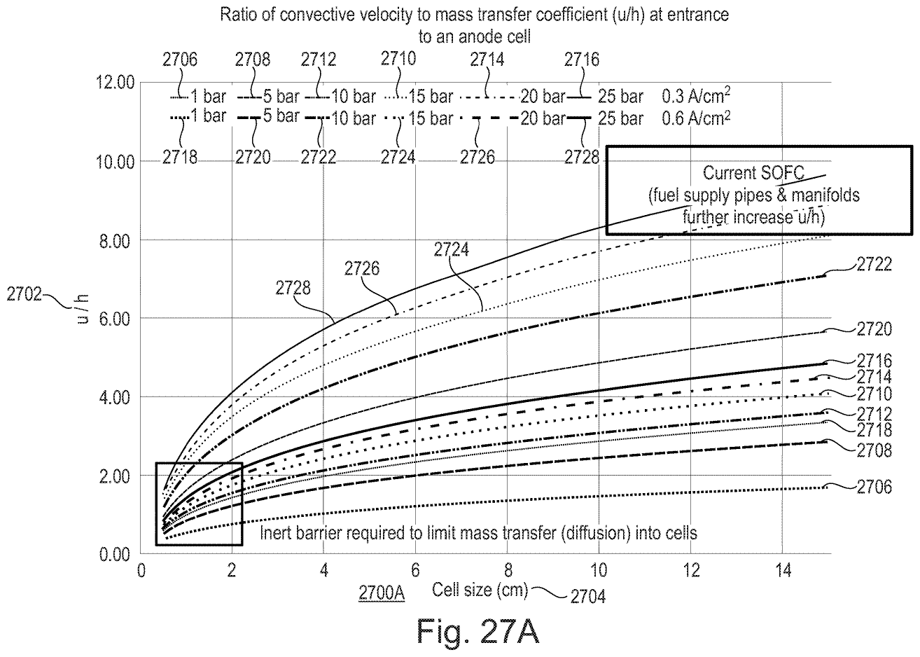

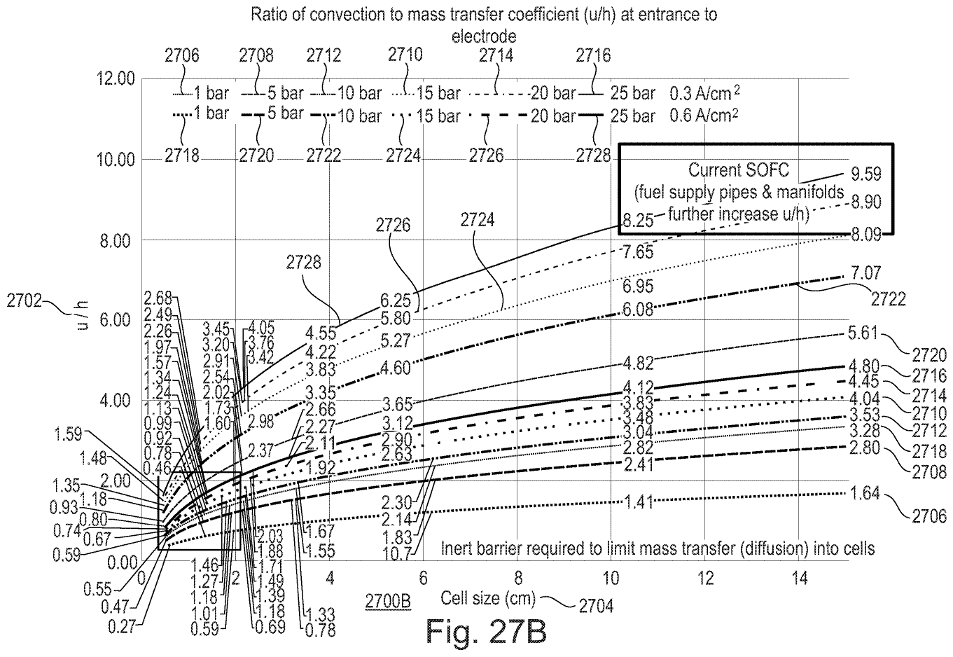

Referring to FIG. 27A, there is shown a view 2700A of a graph of the variation in the ratio of convective velocity to mass transfer coefficient (u/h) at entrance to the anode cell 2702 with cell size (anode cell depth) 2704 for an anode cell described herein in the absence of the inert permeable barrier. The modelling or simulation results depicted in FIG. 27A were derived for a single anode cell with flow over the inlet and outlet edges sufficient for supplying a set of stacks 20 cm high. The mass transfer coefficient h describes the enhanced diffusion that can occur at a cell or layer wall/interface due to concentration gradients and boundary layer effects. Therefore, in this example, u/h is used to describe the ratio of convective mass transport to diffusive mass transport at the entrance to an anode cell in the absence of an inert permeable barrier and is similar to the mass Peclet number, Peₘ, defined for the inert permeable barrier itself. As mentioned earlier, it is desirable that this ratio u/h>>1 such that convection is the dominant transport mechanism at the inlet to a cell.

A first set of plots is established for a current density of 0.3 A/cm2. The first set of plots comprises six 2706 to 2716.

A first plot 2706 depicts the variation in the ratio of convective velocity to mass transfer coefficient (u/h) at entrance to an anode cell with cell size at a pressure of 1 bar for a current density of 0.3 A/cm2. It can be seen that the ratio of convective velocity to mass transfer coefficient (u/h) at entrance to an anode cell varies from circa 0.27 to 1.64. However, example cells size range from 0.5 cm to 2 cm for the fuel cells described and claimed herein. Therefore, at 1 bar, the ratio of convective velocity to mass transfer coefficient (u/h) at entrance to an anode cell 2702 varies from 0.27 to circa 0.69 according to examples.

A second plot 2708 the variation in the ratio of convective velocity to mass transfer coefficient (u/h) at entrance to the anode cell with cell size at a pressure of 5 bar for a current density of 0.3 A/cm2. It can be seen that the ratio of convective velocity to mass transfer coefficient (u/h) at entrance to the anode cell varies from circa 0.47 to 2.80. However, example cells size range from 0.5 cm to 2 cm for the fuel cells described and claimed herein. Therefore, at 5 bar, the ratio of convective velocity to mass transfer coefficient (u/h) at entrance to the anode cell 2708 varies from 0.47 to circa 1.18.

A third plot 2710 shows the variation in the ratio of convective velocity to mass transfer coefficient (u/h) at entrance to the anode cell with cell size at a pressure of 15 bar for a current density of 0.3 A/cm2. It can be seen that the ratio of convective velocity to mass transfer coefficient (u/h) at entrance to the anode cell varies from circa 0.67 to 4.04. However, example cells size range from 0.5 cm to 2 cm for the fuel cells described and claimed herein. Therefore, at 15 bar, the ratio of convective velocity to mass transfer coefficient (u/h) at entrance to the anode cell 2710 varies from 0.67 to circa 1.71.

A fourth plot 2712 illustrates the variation in the ratio of convective velocity to mass transfer coefficient (u/h) at entrance to the anode cell with cell size at a pressure of 10 bar for a current density of 0.3 A/cm2. It can be seen that the ratio of convective velocity to mass transfer coefficient (u/h) at entrance to the anode cell varies from circa 0.59 to 3.53. However, example cells size range from 0.5 cm to 2 cm for the fuel cells described and claimed herein. Therefore, at 10 bar, the ratio of convective velocity to mass transfer coefficient (u/h) at entrance to the anode cell 2712 varies from 0.59 to circa 1.49.

A fifth plot 2714 depicts the variation in the ratio of convective velocity to mass transfer coefficient (u/h) at entrance to the anode cell with cell size at a pressure of 20 bar for a current density of 0.3 A/cm2. It can be seen that the ratio of convective velocity to mass transfer coefficient (u/h) at entrance to the anode cell varies from circa 0.74 to 4.45. However, example cells size range from 0.5 cm to 2 cm for the fuel cells described and claimed herein. Therefore, at 20 bar, the ratio of convective velocity to mass transfer coefficient (u/h) at entrance to the anode cell 2714 varies from 0.74 to circa 1.88.

A sixth plot 2716 illustrates the variation in the ratio of convective velocity to mass transfer coefficient (u/h) at entrance to the anode cell with cell size at a pressure of 25 bar for a current density of 0.3 A/cm2. It can be seen that the ratio of convective velocity to mass transfer coefficient (u/h) at entrance to the anode cell varies from circa 0.8 to 4.80. However, example cells size range from 0.5 cm to 2 cm for the fuel cells described and claimed herein. Therefore, at 25 bar, the ratio of convective velocity to mass transfer coefficient (u/h) at entrance to the anode cell 2716 varies from 0.8 to circa 2.03.

A second set of plots is established for a current density of 0.6 A/cm2. The second set of plots comprises five 2718 to 2726.

A first plot 2718 depicts the variation in the ratio of convective velocity to mass transfer coefficient (u/h) at entrance to the anode cell with cell size at a pressure of 1 bar for a current density of 0.6 A/cm2. It can be seen that the ratio of convective velocity to mass transfer coefficient (u/h) at entrance to the anode cell varies from circa 0.55 to 3.28. However, example cells size range from 0.5 cm to 2 cm for the fuel cells described and claimed herein. Therefore, at 1 bar, the ratio of convective velocity to mass transfer coefficient (u/h) at entrance to the anode cell 2718 varies from 0.55 to circa 1.39. Therefore, it will be appreciated that the ratio u/h is only an issue at small current densities and small cell sizes where the small value of the ratio u/h means that diffusive mass transport processes are significant and that an inert permeable barrier is required to have the desired effect of at least reducing, and, preferably, minimising diffusion effects and, thereby, facilitating a convectively dominant flow regime. This convective flow regime enables uniform supply of substantially identical mixtures across different cells and prevents position of a cell within the stack influencing the composition received when working with attractively small supply plenums.

A second plot 2720 the variation in the ratio of convective velocity to mass transfer coefficient (u/h) at entrance to the anode cell with cell size at a pressure of 5 bar for a current density of 0.6 A/cm2. It can be seen that the ratio of convective velocity to mass transfer coefficient (u/h) at entrance to the anode cell varies from circa 0.93 to 5.61. However, example cells size range from 0.5 cm to 2 cm for the fuel cells described and claimed herein. Therefore, at 5 bar, the ratio of convective velocity to mass transfer coefficient (u/h) at entrance to the anode cell 2720 varies from 0.93 to circa 2.37.

A third plot 2722 shows the variation in the ratio of convective velocity to mass transfer coefficient (u/h) at entrance to the anode cell with cell size at a pressure of 10 bar for a current density of 0.6 A/cm2. It can be seen that the ratio of convective velocity to mass transfer coefficient (u/h) at entrance to the anode cell varies from circa 1.18 to 7.07. However, example cells size range from 0.5 cm to 2 cm for the fuel cells described and claimed herein. Therefore, at 10 bar, the ratio of convective velocity to mass transfer coefficient (u/h) at entrance to the anode cell 2722 varies from 1.18 to circa 2.98.

A fourth plot 2724 illustrates the variation in the ratio of convective velocity to mass transfer coefficient (u/h) at entrance to the anode cell with cell size at a pressure of 15 bar for a current density of 0.6 A/cm2. It can be seen that the ratio of convective velocity to mass transfer coefficient (u/h) at entrance to the anode cell varies from circa 1.35 to 8.09. However, example cells size range from 0.5 cm to 2 cm for the fuel cells described and claimed herein. Therefore, at 15 bar, the ratio of convective velocity to mass transfer coefficient (u/h) at entrance to the anode cell 2724 varies from 1.35 to circa 3.42.

A fifth plot 2726 depicts the variation in the ratio of convective velocity to mass transfer coefficient (u/h) at entrance to the anode cell with cell size at a pressure of 20 bar for a current density of 0.6 A/cm2. It can be seen that the ratio of convective velocity to mass transfer coefficient (u/h) at entrance to the anode cell varies from circa 1.48 to 8.90. However, example cells size range from 0.5 cm to 2 cm for the fuel cells described and claimed herein. Therefore, at 20 bar, the ratio of convective velocity to mass transfer coefficient (u/h) at entrance to the anode cell 2726 varies from 1.48 to circa 3.76.

A sixth plot 2728 illustrates the variation in the ratio of convective velocity to mass transfer coefficient (u/h) at entrance to the anode cell with cell size at a pressure of 25 bar for a current density of 0.6 A/cm2. It can be seen that the ratio of convective velocity to mass transfer coefficient (u/h) at entrance to the anode cell varies from circa 1.59 to 9.59. However, example cells size range from 0.5 cm to 2 cm for the fuel cells described and claimed herein. Therefore, at 25 bar, the ratio of convective velocity to mass transfer coefficient (u/h) at entrance to the anode cell 2728 varies from 1.59 to circa 4.05.

FIG. 27B depicts the graph of variation in the ratio of convective velocity to mass transfer coefficient (u/h) with cell size of FIG. 27A together with graph end point values.

Although the above examples have been described with reference to using inks and dipping processes to deposit such inks, examples are not limited to such arrangements. Examples can be realised in which such layers are deposited or formed using some other techniques such as, for example, ink jet printing, additive manufacturing, spraying or some other deposition technique. For example, the inert permeable barrier can be deposited or created using ink jet printing technologies. Furthermore, although the above examples have been described with referencing to dipping the stack in inks to create the inert permeable barriers, examples can be realised in which the inert permeable barrier is fabricated separately from the remainder of the stack and assembled into the desired configuration. Therefore, a prefabricated permeable barrier such as, for example, barrier 802 can be used realise the above examples, subject to there being a gas-tight seal that prevents gas circumventing the inert permeable barrier. For example, if the inert permeable barrier is fabricated from a material having a high sintering temperature that could be problematical to one or more other aspects of a stack, such a barrier can be fabricated separately and assembled with the stack at a later stage.

Referring to FIGS. 7 to 9, and FIG. 11, although the stacks have been described and shown with current collector layers deposited on the side of the stacks that have particular dimensions and positions, examples are not limited to such arrangements. Examples can be realised in which the positions and widths of the current collector layers deposited on the side of the stacks are different to those presently depicted. Varying at least one, or both, of the widths and positions of the cathode current collectors and the anode current collectors can be realised to influence the respective electrical resistances of those layers. For example, the current collector layers can be dimensioned to balance the resistances of those layers, or to achieve relative respective conductivities according to performance requirements. Examples can, therefore, be realised in which the anode current collector layers are relatively elongate and centrally positioned on a face of the stack. Examples can be realised in which the current collectors have a width that is commensurate with the width of a side face of the stack, subject to current leakage or shorting to an adjacent layer at the corners of a stack. Therefore, examples can be realised in which the cathode current collector has a width that is commensurate with the full width of the side face of the stack bearing the cathode cell inlets and the anode current collector is a centrally disposed significantly narrower width strip, which would allow the electrical resistances of the cathode current collector and the anode current collector to be balanced such that there was no bias towards the anode or cathode.

### MATERIAL DEFINITIONS

The above examples can be realised using the following materials:
YSZ Yttria Stabilized Zirconia
ScSZ Scandia doped zirconia
Ni Nickel
LSM Lanthanum Strontium Manganate
LSCF Lanthanum Strontium Cobalt Ferrite
LSTNC Lanthanum doped Strontium Titanate
NCAL Lithiated transition metal oxide
MgAl₂O₄ Spinel
Al₂O₃ Alumina
Rh Rhodium
BCY Barium Cerium-Yttria (Proton conductor)
Pt Platinum
Pd Palladium
SDC Samarium doped ceria
GDC Gadolinium doped ceria

### Material Selections: Micro-Stack

| Component | Material-Preferred | Material-Alternative |
|---|---|---|
| Anode | Permeable YSZ-Ni | Permeable Pt-YSZ, |
| | | Permeable Ni-NCAL, |
| | | Permeable Ni-SDC |
| Anode Current | Permeable Ni | |
| Collector | | |
| Cathode | Permeable YSZ-LSM | Permeable YSZ-LSCF, |
| | | Permeable LSCF-GDC |
| Cathode Current | Permeable LSM | Permeable LSCF |
| Collector | | |
| Electrolyte | Dense YSZ | Dense SDC |
| | | Dense ScSZ |
| | | Dense SDC/NCAL |
| Chemical | Permeable Al₂O₃—Ni | Permeable Al₂O₃—Rh |
| Coolant Catalyst | | |
| Permeable or | Permeable Ni | |
| Non-permeable | | |
| Conductor | | |
| Interconnect | Pt/Pd | |
| Permeable | Permeable MgAl₂O₄ | |
| Barrier | | |
| Fuel processing | H2 Fuel: N/A | |
| catalyst | NG Fuel: Permeable | |
| (optional) | Al₂O₃—Rh | |
| | NH3 Fuel: Permeable | |
| | Al₂O₃—Ni | |
| Fuel polishing | H2 Fuel: N/A | |
| catalyst | NG Fuel: N/A | |
| (optional) | NH3 Fuel: Permeable | |
| | BCY | |
| Dense Insulator | Dense MgAl₂O₄ | |
| | (possibly laminated | |
| | with YSZ to prevent | |
| | reactions with Ni) | |
| Pipes | Permeable MgAl₂O₄ | |
| | (sealed with glass to | |
| | prevent leaks) | |
| Dense Barrier | Dense MgAl₂O₄ | |

Although the above conductor has been listed as being permeable, examples are not limited to such an arrangement. Examples can be realised in which the conductor is not permeable such as, for example, a solid conductor.

### Material Selections: Methanator

| Component | Material-Preferred | Material-Alternative |
|---|---|---|
| Methanation | Permeable Al₂O₃—Rh | Permeable Al₂O₃—Ni |
| Catalyst Layer | | |
| Permeable | Permeable MgAl₂O₄ | Permeable YSZ |
| Oxidant Layer | | |
| Dense Barrier | Dense MgAl₂O₄ | Dense YSZ |

### Material Selections: Combustor HX

| Component | Material-Preferred | Material-Alternative |
|---|---|---|
| Combustion | Permeable Al₂O₃—Rh | Permeable Al₂O₃—Pd |
| Catalyst Layer | | |
| Permeable | Permeable MgAl₂O₄ | Permeable YSZ |
| Oxidant Layer | | |
| Dense Barrier | Dense MgAl₂O₄ | Dense YSZ |
| Pipes | Permeable MgAl₂O₄ | Permeable YSZ (sealed |
| | (sealed with glass to | with glass to prevent |
| | prevent leaks) | leaks) |

Accordingly, the examples described herein provide solid oxide fuel cells that are fabricated using solid oxide materials or using materials that become solid oxide materials. Therefore, the multi-layered structures and materials, multi-layered fuel cells, cells, electrodes, cathodes, half-cells, stacks, stack assemblies, systems, coolant cells, methanation cells, methanation oxidant cells, combustion cells, combustor oxidant cells, methanator, combustor, thermal conditioning systems described and claimed are solid oxide multi-layered structures and materials, multi-layered fuel cells, cells, electrodes, cathodes, half-cells, stacks, stack assemblies, systems, coolant cells, methanation cells, methanation oxidant cells, combustion cells, combustor oxidant cells, methanator, combustor, thermal conditioning systems.

The above examples, and the claims below, refer to a reactant. As used herein a reactant can comprise any gas species such that an oxidant can be classified as a reactant. For example, fuel cells can be realised, as above, that can use hydrogen and oxygen, that is, the reactants are: hydrogen and oxygen. Throughout the specification and claims, the term oxidant has been used to refer to any oxidant species and the term reactant can be used to refer specifically to fuel species. Nevertheless, the term reactant can cover both fuel species and oxidant species. The term reactant can also comprise a dilutant.

Although the examples of cathode cells have been described without reference to having an accompanying inert permeable barrier layer, examples are not limited to such arrangements. Examples can be realised in which the cathode cells have one or more than one inert permeable cathode cell barrier. The one or more than one inert permeable cathode cell barrier can be disposed over, or positioned in relation to, at least one, or both, of: a permeable reactant pathway inlet or a permeable reactant pathway outlet. Examples of such a permeable reactant pathway inlet or a permeable reactant pathway outlet are the above-described permeable reactant pathway inlet 304.16 and permeable reactant pathway outlet 304.24. The inert permeable cathode cell barriers can have the dimensions and characteristics of any of the inert permeable barriers described herein.

The examples described herein have used oxygen as an oxidant. However, examples are not limited to such arrangements. Examples can be realised in which other oxidants that comprise oxygen can be used in addition to, or as alternatives to, oxygen such as, for example, nitrogen dioxide. Examples that use alternative oxidants can be realised that use the above-described inert permeable cathode cell barrier.

Although the above examples have been described with reference to using inks or dips in the manufacturing process, examples are not limited to such arrangements. Examples can be realised in which one or more than one feature or layer of the cells and multi-layered structures described herein are manufactured in some other way such as, for example, using additive manufacturing techniques like 3D printing.

The examples have been described with reference to cells having layers and, in particular, with reference to cells comprising a layer or layers; each of which is formed as a single or unitary layer such as, for example, the methanation catalyst layer, an electrolyte layer, a dense layer, an insulating layer, the electrical conductors, and the like. However, examples are not limited to such single or unitary layers. Examples can be realised in which a layer is realised using a plurality of layers. The plurality of layers can comprise two or more layers. The benefit of using such a plurality of layers is that a layer can develop a pin hole or through vias that effectively provides a short circuit or direct path for a gas species or current. A way to mitigate against adverse effects of such unintended pins holes or through vias is to use multiple layers since the probability that such multiple layers comprise pin holes or through vias that are aligned with pinholes or through vias of an immediately adjacent layer is so small as to be almost zero.

In the examples described herein, layers that do not have a defined thickness range for hosting a permeable pathway, such as, for example, electrolyte layers, anode electrodes, cathode electrodes, dense layer, and sealing inks or dips, taken jointly and severally in any and all permutations, are relatively thin so as not to unnecessarily increase unneeded volume or bulk. Examples can be realised in which such relatively thin layers have a thickness of 20 μm or less, preferably, 10 μm or less. Current collectors deposited on the outside of the stack could, however, be thicker such as, for example, being 500 μm or less such as, for example, being 100 μm or less.

The thicknesses of the anode cell and cathode cell are governed by their operating current density, which dictates the magnitude of the in-plane gas and current flows. The cells are designed to balance being sufficiently thick to provide sufficient sheet electrical conductance to reduce ohmic losses with having a large enough pore size to reduce pressure drops whilst also being thin enough to ensure a high power density.

The thickness of the chemical coolant cells is governed by similar requirements to above. However, the magnitude of the gas and current flows associated with the chemical coolant cell operation depends on how many fuel cells are grouped together in a stack. Within a stack, the cells are electrically connected in parallel. Therefore, increasing the number of fuel cells increases the overall current flow, that is, current varies as a function of the number of fuel cells connected in parallel. The stacks are connected together in series. Therefore, increasing the number of stacks, increases the overall voltage, that is, voltage varies with the number of stacks connected in series.

The thickness of the methanator and combustor are not restricted by the limitations described above in the preceding two paragraphs. Therefore, there is no need to have a methanation cell or a combustion cell per stack. Examples can be realised in which a methanation cell or a combustion cell is provided according to the number of stacks in a set of stacks. The set of stacks can comprise a single stack, or a plurality of stacks. For instance, examples can be provided in which a set of stacks comprises 10 to 100 stacks. Grouping stacks reduces the number of methanators or combustors that are needed in the overall system. However, a cell within the set of methanation cells or the set of combustion cells would need to have a sufficient gas flow rates and, therefore, would need to be thicker to give the gases sufficient contact with catalyst and manage pressure drops, while coping with the output of the set of stacks. A thicker methanation cell or combustion cell would also be supporting larger heat generation rates by a larger number of fuel cells or stacks.

The heat transfer between cells, that is, the methanation cells to air cells or combustion cells to air cells) is limited by conducting heat through the solid component of the permeable layers, which typically do not have high thermal conductivities. Heat conduction per unit area q is defined by

$$q = - k \frac{Δ T}{L} ,$$

where ΔT is the temperature difference, k is the thermal conductivity and L is the cell thickness over which the conduction is occurring.

Therefore, thermal conduction per unit area, q, varies with distance, L. Accordingly, increasing cell thickness (as described above to accommodate larger gas flows), results in transferring more heat (larger q) between cells over the greater thickness, L, with the result that the ΔT within the cells increases quadratically, which the examples described and claimed herein avoid. It will be appreciated that controlling the temperature differentials, in any direction, assist in mitigating or reducing the effects of thermally induced stresses.

Accordingly, examples can be realised in which the maximum cell thickness for the methanation cells, combustion cells and adjacent air cells is limited to 5 mm (5000 microns).

Historically depth in the flow direction for fuel cells and compact reactors such as reformers has been kept high to allow manufacturers to make larger areas of fuel cell in a single operation and at times to increase flow rates to improve reactant supply and mass transfer at interfaces.

Large depth in the flow direction, however, creates both the need for more reactant supply as a larger area is being serviced as well as increasing the distance over which wall friction must be overcome. Consequently, extending depth in the flow direction has a significant impact on the need for passage thickness to avoid excessive pressure drop. Increased thickness directly reduces the number of active surface areas that can be packed into a unit volume and consequently developers have sought to increase current density within the cell to compensate for lost packing density. Such an approach, however, exacerbates the problem as increasing current density further increases the need for reactant supply and lowers efficiency with a consequent increase in the amount of heat that must be removed.

The examples described and claimed here take a completely opposite approach by giving effect to at least one, or more, of the following taken jointly and severally in any and all permutations:
depth in the flow direction being reduced,
thickness of flow passages being reduced, that is, lowered, and
allowing tighter packing of fuel cell active areas.

The foregoing alleviates the need for high current densities and this, in turn, improves stack efficiency and reduces cooling need while improving choice of materials. The examples described and claimed herein are counter to the technological direction of the art.

A still further benefit of reducing depth in flow direction in fuel cells is in plane current collection, which encounters greater resistances when cell depth is increased that, in turn, decreases voltage and efficiency, and increases the heat removal challenge when fuel cell density is maximised.

It will be appreciated that the various entities of the examples described above are symmetrical. For example, the cells are symmetrical. Also, the stacks are symmetrical, as well as the arrangements of stacks being symmetrical. For example, referring to any and all of the above figures, there are multiple lines of symmetry, which have been marked using a dashed line together with SS or SS with a number of superscripts such as, for example, S¹S¹, S¹S², S³S³, etc. It will be appreciated that only some of the symmetries have been identified to preserve the clarity of the drawings. Other symmetries are self-evident even though those additional symmetries have not been specifically identified.

The symmetrical nature of various aspects of the examples facilitates manufacturing by reducing the tendency of the layers or structures tending to bend or otherwise deform in the absence of symmetries. Furthermore, the layers can be fabricated using carefully matched co-sinterable materials that will also contribute to reducing stresses and strains within the layers and structures to at least reduce, or preferably, prevent, the tendency to bend.

Still further, it will be appreciated that the diagrams are schematical for the purposes of illustrations. For example, while FIG. 9 depicts a ‘stack’, the dimensions of the layers involved are such that a stack might have a width of 1 cm and a depth of 1 cm and have a height of 2 mm, even in examples that use multiple layers such as, for example 20 layers.

Referring, for example, to FIG. 10, it can be appreciated that the channels such as, for example, the chemical coolant supply flow channels 126/1012 and coolant exhaust flow channels 128.1/1014 to 128.2/1016 are realised as external manifolds, that is, the manifolds are external to the fuel cells and fuel cell stacks. However, examples are not limited to such arrangements. Examples can be realised in which such manifolds are internal manifolds, that is, the manifolds are formed within, or as an integral part of, the fuel cell or fuel cell stack. Any of the above-described supply and exhaust channels are examples of manifolds. Accordingly, example multi-layered structures, cells, stacks, half-cells, arrays, and system comprise at least one, or both, of: one or more than one external manifold and one or more than one internal manifold. Examples can be realised that use a combination of: one or more than one external manifold and one or more than one internal manifold.

### Methods of Operation and Operating Parameter Spaces

The above-described cells, structures and systems can be operated across, or within, a defined operating space comprising a plurality of variables. There now follows a description of the operating parameters for each of the foregoing.

### Anode Cells

Referring to the anode cells, examples can be realised that provide a method of operating a fuel cell, the method comprising
maintaining an operating environment within the fuel cell having an operating parameter space defined by:

$$\frac{Δ {pU}_{f}}{i} \frac{p}{T} \frac{F}{32 μ R} = c ,$$

where
p is the absolute pressure,
Δp is pressure drop across the fuel cell (in the reactant flow direction)
F is Faraday's constant,
U_{f} is a utilisation factor indicating the proportion of the supplied reactant consumed by the fuel cell,
R is the gas constant,
T is the temperature,
μ is the reactant gas dynamic viscosity,
i is the current density

$$( \frac{A}{{m}^{2}} ) ,$$

and
c is a constant.

The operating parameter space of the foregoing method of operation can be defined by, or comprises, any one or more than one of the following taken jointly and severally in any and all permutations:
c has a value in the range 5e6/m to 5e13/m, optionally, 5e8/m to 5e12/m and, preferably 1e10/m to 1e12/m,
p, the absolute pressure, has a range of 1 bar to 50 bar, preferably 5 bar to 25 bar,
Δp, the pressure drop, has a range of 10 mbar to 1000 mbar, preferably 20 mbar to 300 mbar,
U_{f}, the utilisation factor, has a value in the range of 0.1 to 1.0, preferably 0.33 to 0.95,
T, the temperature, has a value in the range of 930 °C to 450 °C, preferably 900 °C to 580 °C,
μ the reactant gas dynamic viscosity, has a value in the range 5e-5 Pa·s to 1e-5 Pa·s, preferably, 4e-5 Pa·s to 2e-5 Pa·s,
i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².

Examples can be realised in which the above methods of operation, and operating parameter space, are related to the geometric parameters in which

$$\frac{Δ {pU}_{f}}{i} \frac{p}{T} \frac{F}{32 μ R} = c = \frac{{τ}_{e}^{2}}{{ε}_{e}} \frac{{d}_{e}^{2}}{{f}_{e}^{2} {t}_{e}^{3}} ( {m}^{- 1} ) ,$$

where the geometric parameters comprise:
τₑ is the permeable anode reactant pathway tortuosity in the reactant flow direction,
εₑ is permeable anode reactant pathway structure porosity,
dₑ is the permeable anode reactant pathway structure depth in the reactant flow direction,
tₑ is the permeable anode reactant pathway structure thickness,
fₑ is the ratio of permeable anode reactant pathway pore size to permeable anode reactant pathway structure thickness, tₑ.

Examples can be realised in which one or more than one of the above geometric parameters are defined by the following taken jointly and severally in any and all permutations:
τₑ, the permeable anode reactant pathway tortuosity in the reactant flow direction, has a range of 1<τₑ<3, optionally, 1<τₑ<2.5, and, preferably, 1<τₑ<2,
εₑ, the permeable anode reactant pathway structure porosity, has a range of 0.1<εₑ<0.9 and preferably 0.5<εₑ<0.8,
dₑ, the permeable anode reactant pathway structure depth in the reactant flow direction, has a range of 0.25<dₑ<40 (mm), optionally, 0.25<dₑ<20 (mm), and, preferably 5<dₑ<20 (mm),
tₑ, the permeable anode reactant pathway structure thickness, has a range of 5<tₑ<1000 (μm), optionally, 5<tₑ<500 (μm) and, preferably, 10<tₑ<150 (μm),
fₑ, the ratio of permeable anode reactant pathway pore size to permeable anode reactant pathway structure thickness, tₑ, has a range of 0.02<fₑ<1.0, and, preferably, 0.25<fₑ<0.75, and/or
in which

$$\frac{p Δ {p F U}_{f}}{R T 32 μ i} = c = \frac{{τ}_{e}^{2}}{{ε}_{e}} \frac{{d}_{e}^{2}}{{f}_{e}^{2} {t}_{e}^{3}} ( {m}^{- 1} )$$

has a range of 5e6/m to 5e13/m, optionally, 5e8/m to 5e12/m and, preferably 1e10/m to 1e12/m.

The foregoing methods of operation can additionally comprise maintaining an operating environment within an inert permeable barrier having a parameter space defined by

$$\frac{{Pe}_{m} {F pDU}_{f}}{R Ti} = {c}_{1}$$

where
Peₘ is the mass Peclet number,
F is Faraday's constant,
p is the absolute pressure,
D is a mass diffusion coefficient of a reactant gas species,
U_{f} is the utilisation factor indicating the proportion of the supplied reactant consumed by the fuel cell,
R is the gas constant,
T is the temperature, and
i is the current density

$$( \frac{A}{{m}^{2}} ) .$$

The expression

$$\frac{{Pe}_{m} {F pDU}_{f}}{R Ti} = {c}_{1}$$

describes the effectiveness of the barrier to achieve a desired mass Peclet number.

Examples can be realised which the parameter space for maintaining an operating environment within an inert permeable barrier comprises one or more than one of the following taken jointly and severally in any and all permutations:

$$\frac{{Pe}_{m} {F pDU}_{f}}{R Ti} = {c}_{1} ( m ) ,$$

has a range of 0.2 m to 1000 m, optionally, 1 m to 200 m and, preferably, 10 m to 100 m,
Peₘ, the mass Peclet number, has a value in the range of 2 to 500, preferably, 5 to 50,
p, the absolute pressure, has a value of in the range of 1 bar to 50 bar, preferably, 5 bar to 25 bar,
D, the mass diffusion coefficient of a reactant gas species, has a value in the range of 1e-3 m²/s to 1e-4 m²/s, preferably 8e-4 m²/s to 1e-4 m²/s,
U_{f}, the utilisation factor, has a value in the range of 0.1 to 1.0, preferably 0.33 to 0.95,
T, the temperature, has a value in the range of 930 °C to 450 °C, preferably 900 °C to 580 °C,
i, the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m²,

Examples can be realised in which the above methods of operation, and operating parameter space, associated with the inert permeable barrier are related to geometric parameters by

$$\frac{{Pe}_{m} {F pDU}_{f}}{R Ti} = {c}_{1} = \frac{{d}_{b} {d}_{e} {τ}_{b}^{2}}{{t}_{e} {ε}_{b}} ( m ) ,$$

wherein
d_{b} is the inert permeable barrier depth in the reactant flow direction,
τ_{b} is the inert permeable barrier reactant pathway tortuosity in the reactant flow direction,
ε_{b} is the inert permeable barrier porosity,
dₑ is the permeable anode reactant pathway structure depth in the reactant flow direction, and
tₑ is the permeable anode reactant pathway structure thickness.

Examples can be realised in which the geometric parameters associated with the inert permeable barrier are defined by one or more than one of the following taken jointly and severally in any and all permutations:
d_{b}, the inert permeable barrier depth in the reactant flow direction, has a value in the range of d_{b}>0.01 (mm), optionally, 0.01<d_{b}<5 (mm) and, preferably, 0.1<d_{b}<2 (mm),
τ_{b}, the inert permeable barrier reactant pathway tortuosity in the reactant flow direction, has a value in the range of 1<τ_{b}<10, optionally, 1<τ_{b}<5
ε_{b}, the inert permeable barrier porosity, has a value in the range of 0.01<ε_{b}<0.5, preferably, 0.05<ε_{b}<0.5,
dₑ, the permeable anode reactant pathway structure depth in the reactant flow direction, has a range of 0.25<dₑ<40 (mm), optionally, 0.25<dₑ<20 (mm), and, preferably 5<dₑ<20 (mm),
tₑ, the permeable anode reactant pathway structure thickness, has a value in the range of 5<tₑ<1000 (μm), optionally, 5<tₑ<500 (μm) and, preferably, 10<tₑ<150 (μm).

As indicated above, the parameter values given in Table 1: Anode Cell Parameters described herein are preferred parameter values and/or parameter value ranges. However, examples can be realised in which the above-described wider parameter value ranges can be used jointly and severally in any and all permutations.

### Cathode Cells

Referring to the cathode cells, examples provide a method of operating a fuel cell, the method comprising maintaining an operating environment within the fuel cell having an operating parameter space defined by:

$$\frac{Δ {pU}_{a}}{i} \frac{p}{T} \frac{F}{2.5 R 32 μ} = {c}_{ca}$$

where
p is the absolute pressure,
Δp is the pressure drop across the fuel cell (in the oxidant flow direction)
F is Faraday's constant,
Uₐ is a utilisation factor indicating the proportion of a supplied oxidant consumed by the fuel cell,
R is the gas constant,
T is the temperature,
μ is the oxidant gas dynamic viscosity,
i is the current density

$$( \frac{A}{{m}^{2}} ) ,$$

and
c_{ca} is a constant.

### Cathode Operating Parameters

The operating parameter space of the foregoing method of operation can be defined by, or comprises, any one or more than one of the following taken jointly and severally in any and all permutations:
c_{ca} has a value in the range 1e6/m to 5e12/m, optionally, 1e8/m to 5e11/m and, preferably 1e9/m to 2e11/m,
p, the absolute pressure, has a range of 1 bar to 50 bar, preferably 5 bar to 25 bar,
Δp, the pressure drop, has a range of 10 mbar to 1000 mbar, preferably 20 mbar to 300 mbar,
Uₐ, the utilization factor, has a value in the range of 0.1 to 1.0, preferably 0.25 to 0.75,
T the temperature, has a value in the range of 930 °C to 450 °C, preferably 900 °C to 580 °C,
μ, the oxidant gas dynamic viscosity, has a value in the range 5e-5 Pa·s to 1e-5 Pa·s, preferably, 5e-5 Pa·s to 4e-5 Pa·s,
i the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m².

Examples can be realised in which the above methods of operation, and operating parameter space, are related to cathode geometric parameters in which

$$\frac{Δ {pU}_{a}}{i} \frac{p}{T} \frac{F}{2.5 R 32 μ} = {c}_{ca} = \frac{{τ}_{c}^{2}}{{ε}_{c}} \frac{{w}_{c}^{2}}{{f}_{c}^{2} {t}_{c}^{3}} ( {m}^{- 1} ) ,$$

where
τ_{c} is the permeable cathode reactant pathway tortuosity in the oxidant flow direction,
ε_{c} is permeable cathode reactant pathway structure porosity,
w_{c} is the permeable cathode reactant pathway structure width in the oxidant flow direction,
t_{c} is the permeable cathode reactant pathway structure thickness,
f_{c} is the ratio of permeable cathode reactant pathway pore size to permeable cathode reactant pathway structure thickness, t_{c}.

Examples can be realised in which one or more than one of the above cathode geometric parameters are defined by the following taken jointly and severally in any and all permutations:
τ_{c}, the permeable cathode reactant pathway tortuosity in the oxidant flow direction, has a range of 1<τ_{c}<3, optionally, 1<τ_{c}<2.5, and, preferably, 1<τ_{c}<2,
ε_{c}, the permeable cathode reactant pathway structure porosity, has a range of 0.1<ε_{c}<0.9 and preferably 0.5<ε_{c}<0.8,
w_{c}, the permeable cathode reactant pathway structure width in the oxidant flow direction, has a range of 0.25<w_{c}<40 (mm), optionally, 0.25<w_{c}<20 (mm), and, preferably 5<w_{c}<20 (mm),
t_{c}, the permeable cathode reactant pathway structure thickness, has a range of 10<t_{c}<1000 (μm), optionally, 10<t_{c}<600 (μm) and, preferably, 20<t_{c}<250 (μm), and/or
f_{c}, the ratio of permeable cathode reactant pathway pore size to permeable cathode reactant pathway structure thickness, t_{c}, has a range of 0.02<f_{c}<1.0, and, preferably, 0.25<f_{c}<0.75.

As indicated above, the parameter values given in table 2 described herein are preferred parameter values and/or parameter value ranges. However, examples can be realised in which the above-described wider parameter value ranges can be used jointly and severally in any and all permutations.

### Chemical Coolant Cell

Referring to the chemical coolant cells, examples can be realised in that provide a method of operating a chemical coolant cell, the method comprising maintaining an operating environment within the chemical coolant cell having an operating parameter space defined by:

$$\frac{p}{T} \frac{Δ {pU}_{c}}{i} \frac{F}{2.5 R 32 μ} = {c}_{cc} ,$$

where
p is the absolute pressure,
Δp is pressure drop across the chemical coolant cell in the reactant flow direction
F is Faraday's constant,
U_{c} is a utilisation factor describing the supplied flow rate of reactant (chemical coolant) as a proportion of the fuel cell stack fuel supply (where U_{c}>1 indicates a reactant undersupply when a low level of cooling is required),
R is the gas constant,
T is the temperature,
μ is the reactant gas dynamic viscosity,
i is the adjacent fuel cell stack current density

$$( \frac{A}{{m}^{2}} ) ,$$

and
c_{cc} is a constant.

The operating parameter space of the foregoing method of operating a chemical coolant cell can be defined by, or comprises, any one or more than one of the following taken jointly and severally in any and all permutations:
c_{cc} has a value in the range 1e6/m to 5e12/m, optionally, 1e8/m to 5e11/m and, preferably 1e9/m to 1e11/m,
p, the absolute pressure, has a range of 1 bar to 50 bar, preferably 5 bar to 25 bar,
Δp, the pressure drop, has a range of 10 mbar to 1000 mbar, preferably 20 mbar to 300 mbar,
U_{c}, the utilisation factor, has a value in the range of 0.5 to 10, preferably 1 to 5,
T, the temperature, has a value in the range of 930 °C to 450 °C, preferably 900 °C to 580 °C,
μ, the chemical coolant gas dynamic viscosity, has a value in the range 5e-5 Pa·s to 1e-5 Pa·s, preferably, 4e-5 Pa·s to 2e-5 Pa·s, and/or
i, the adjacent fuel cell stack current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².

Examples can be realised in which the above methods of operating a chemical coolant cell, and chemical coolant cell operating parameter space, are related to geometric parameters of the chemical coolant cell in which

$$\frac{p}{T} \frac{Δ {pU}_{c}}{i} \frac{F}{20 R 32 μ} = \frac{{τ}_{cc}^{2}}{{ε}_{cc}} \frac{{d}_{cc}^{2}}{{f}_{cc}^{2} {t}_{cc}^{3}} ( {m}^{- 1} )$$

where
τ_{cc} is the permeable chemical coolant catalyst layer pathway tortuosity in the reactant flow direction,
ε_{cc} is permeable chemical coolant catalyst layer porosity,
d_{cc} is the permeable chemical coolant catalyst layer depth in the reactant flow direction,
t_{cc} is the permeable chemical coolant catalyst layer thickness,
f_{cc} is the ratio of permeable chemical coolant catalyst layer pathway pore size to permeable chemical coolant catalyst layer thickness, t_{cc}.

Examples can be realised in which one or more than one of the above chemical coolant cell geometric parameters are defined by the following taken jointly and severally in any and all permutations:
τ_{cc}, the permeable chemical coolant catalyst layer pathway tortuosity in the reactant flow direction, has a range of 1<τ_{cc}<3, optionally, 1<τ_{cc}<2.5, and, preferably, 1<τ_{cc}<2,
ε_{cc}, the permeable chemical coolant catalyst layer porosity, has a range of 0.1<ε_{cc}<0.9 and preferably 0.5<ε_{cc}<0.8,
d_{cc}, the permeable chemical coolant catalyst layer depth in the reactant flow direction, has a range of 0.25<d_{cc}<40 (mm), optionally, 0.25<d_{cc}<20 (mm), and, preferably 5<d_{cc}<20 (mm),
t_{cc}, the permeable chemical coolant catalyst layer thickness, has a range of 5<t_{cc}<1000 (μm), optionally 5<t_{cc}<700 (μm), and, preferably 10<t_{cc}<300 (μm),
f_{cc}, the ratio of permeable chemical coolant catalyst layer pathway pore size to permeable chemical coolant catalyst layer thickness, t_{cc}, has a range of 0.02<f_{cc}<1.0, and, preferably, 0.25<f_{cc}<0.75, and/or

$$\frac{p}{T} \frac{Δ {pU}_{c}}{i} \frac{F}{20 R 32 μ} = {c}_{cc} = \frac{{τ}_{cc}^{2}}{{ε}_{cc}} \frac{{d}_{cc}^{2}}{{f}_{cc}^{2} {t}_{cc}^{3}} ( {m}^{- 1} )$$

has a range of 1e6/m to 5e12/m, optionally, 1e8/m to 5e11/m and, preferably 1e9/m to 1e11/m.

The foregoing methods of operating a chemical coolant cell can additionally comprise: maintaining an operating environment within a chemical coolant cell inert permeable barrier having a chemical coolant cell parameter space defined by

$$\frac{{Pe}_{m} {FpDU}_{c}}{20 RTi} = {c}_{ccb}$$

where
Peₘ is the mass Peclet number,
F is Faraday's constant,
p is the absolute pressure,
D is a mass diffusion coefficient of a reactant gas species,
U_{c} is a utilisation factor describing the supplied flow rate of reactant (chemical coolant) as a proportion of the fuel cell stack fuel supply,
R is the gas constant,
T is the temperature, and
i is the adjacent fuel cell stack current density

$$( \frac{A}{{m}^{2}} ) .$$

Examples can be realised which the chemical coolant cell inert permeable barrier parameter space for maintaining an operating environment within the chemical coolant cell inert permeable barrier comprises one or more than one of the following taken jointly and severally in any and all permutations:

$$\frac{{Pe}_{m} {FpDU}_{c}}{20 RTi} = {c}_{ccb} ( m ) ,$$

has a range of 0.1 m to 250 m, optionally, 0.5 m to 50 m and, preferably, 1 m to 25 m,
Peₘ, the mass Peclet number, has a value in the range of 2 to 500, preferably, 5 to 50,
p, the absolute pressure, has a value of in the range of 1 bar to 50 bar, preferably, 5 bar to 25 bar,
D, the mass diffusion coefficient of a reactant gas species, has a value in the range of 1e-3 m²/s to 1e-4 m²/s, preferably 8e-4 m²/s to 1e-4 m²/s,
U_{c}, the utilisation factor, has a value in the range of 0.5 to 10, preferably 1 to 5,
T, the temperature, has a value in the range of 930 °C to 450 °C, preferably 900 °C to 580 °C,
i, the adjacent fuel cell stack current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².

Examples can be realised in which the above methods of operating a chemical coolant cell inert permeable barrier, and chemical coolant cell inert permeable barrier operating parameter space, associated with the chemical coolant cell inert permeable barrier are related to geometric parameters by

$$\frac{{Pe}_{m} {FpDU}_{c}}{20 RTi} = {c}_{ccb} = \frac{{d}_{ccb} {d}_{cc} {τ}_{ccb}^{2}}{{t}_{cc} {ε}_{ccb}} ( m ) ,$$

wherein
d_{ccb} is the chemical coolant cell inert permeable barrier depth in the reactant flow direction,
τ_{ccb} is the chemical coolant cell inert permeable barrier pathway tortuosity in the reactant flow direction,
ε_{ccb} is the chemical coolant cell inert permeable barrier porosity,
d_{cc} is the permeable chemical coolant catalyst layer depth in the reactant flow direction, and
t_{cc} is the permeable chemical coolant catalyst layer thickness.

Examples can be realised in which the chemical coolant cell inert permeable barrier geometric parameters associated with the chemical coolant cell inert permeable barrier are defined by one or more than one of the following taken jointly and severally in any and all permutations:
d_{ccb}, the inert permeable barrier depth in the reactant flow direction, has a value in the range of d_{ccb}>0.01 (mm), optionally, 0.01<d_{ccb}<5 (mm) and, preferably, 0.1<d_{ccb}<2 (mm).

τ_{ccb}, the inert permeable barrier pathway tortuosity in the reactant flow direction, has a value in the range of 1<τ_{ccb}<10, optionally, 1<τ_{ccb}<5,
ε_{ccb}, the inert permeable barrier porosity, has a value in the range of 0.01<ε_{ccb}<0.5, preferably, 0.05<ε_{ccb}<0.5,
d_{cc}, the permeable chemical coolant catalyst layer depth in the reactant flow direction, has a value in the range of 0.25<d_{cc}<40 (mm), optionally, 0.25<d_{cc}<20 (mm), and, preferably 5<d_{cc}<20 (mm),
t_{cc}, the permeable chemical coolant catalyst layer thickness, has a value in the range of 5<t_{cc}<1000 (μm), optionally 5<t_{cc}<700 (μm), and, preferably 10<t_{cc}<300 (μm).

As indicated above, the parameter values given in Table 3: Chemical Coolant Cell Parameters described herein are preferred parameter values and/or parameter value ranges. However, examples can be realised in which the above-described wider parameter value ranges can be used jointly and severally in any and all permutations.

### Combustion Cell Method Claims

Referring to the combustion cells, examples can be realised in that provide a method of operating a combustion cell, the method comprising: maintaining an operating environment within the combustion cell having an operating parameter space defined by:

$$\frac{Δ {pU}_{f}}{i} \frac{p}{T} \frac{F}{20 R 32 μ} = {c}_{cl} ,$$

where
p is the absolute pressure,
Δp is pressure drop across the combustion cell (in the reactant flow direction),
F is Faraday's constant,
U_{f} is a utilisation factor indicating the proportion of fuel consumption having occurred in the associated fuel cell stack (the remainder being consumed within the combustion cell),
R is the gas constant,
T is the temperature,
μ is the reactant gas dynamic viscosity,
i is the associated fuel cell stack current density

$$( \frac{A}{{m}^{2}} ) ,$$

and
c_{cl} is a constant.

The operating parameter space of the foregoing method of operating a combustion cell can be defined by, or comprises, any one or more than one of the following taken jointly and severally in any and all permutations:
c_{cl} has a value in the range 1e5/m to 1e12/m, optionally, 1e7/m to 1e11/m and, preferably 5e8/m to 5e10/m,
p, the absolute pressure, has a range of 1 bar to 50 bar, preferably 5 bar to 25 bar,
Δp the pressure drop, has a range of 10 mbar to 1000 mbar, preferably 20 mbar to 300 mbar,
U_{f} the utilisation factor, has a value in the range of 0.1 to 1.0, preferably 0.33 to 0.95,
T, the temperature, has a value in the range of 1000 °C to 400 °C, preferably 900 °C to 500 °C,
μ the reactant gas dynamic viscosity, has a value in the range 5e-5 Pa·s to 1e-5 Pa·s, preferably, 4e-5 Pa·s to 2e-5 Pa·s, and/or
i, the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m².

Examples can be realised in which the above methods of operating a combustion cell, and combustion cell operating parameter space, are related to combustion cell geometric parameters in which

$$\frac{Δ {pU}_{f}}{i} \frac{p}{T} \frac{F}{20 R 32 μ} = {c}_{cl} = \frac{{τ}_{cl}^{2}}{{ε}_{cl}} \frac{{d}_{cl}^{2}}{{f}_{cl}^{2} {t}_{cl}^{3}} ( {m}^{- 1} ) ,$$

where
τ_{cl} is the permeable combustion cell catalyst layer pathway tortuosity in the reactant flow direction,
ε_{cl} is permeable combustion cell catalyst layer porosity,
d_{cl} is the permeable combustion cell catalyst layer depth in the reactant flow direction,
t_{cl} is the permeable combustion cell catalyst layer thickness,
f_{cl} is the ratio of permeable combustion cell catalyst layer pathway pore size to permeable combustion cell catalyst layer thickness, t_{cl}.

Examples can be realised in which one or more than one of the above combustion cell geometric parameters are defined by the following taken jointly and severally in any and all permutations:
τ_{cl}, the permeable combustion cell catalyst layer pathway tortuosity in the reactant flow direction, has a range of 1<τ_{cl}<3, optionally, 1<τ_{cl}<2.5, and, preferably, 1<τ_{cl}<2,
ε_{cl}, the permeable combustion cell catalyst layer porosity, has a range of 0.1<ε_{cl}<0.9 and preferably 0.5<ε_{cl}<0.8,
d_{cl}, the permeable combustion cell catalyst layer depth in the reactant flow direction, has a range of 0.25<d_{cl}<40 (mm), optionally 0.25<d_{cl}<20 (mm), and, preferably 5<d_{cl}<20 (mm),
t_{cl}, the permeable combustion cell catalyst layer thickness, has a range of 5 μm<t_{cl}<5000 μm, optionally 5 μm<t_{cl}<1000 μm, and, preferably, 10 μm<t_{cl}<500 μm,
f_{cl}, the ratio of permeable combustion cell catalyst layer pathway pore size to permeable combustion cell catalyst layer thickness, t_{cl}, has a range of 0.02<f_{cl}<1.0, and, preferably, 0.25<f_{cl}<0.75, and/or
in which

$$\frac{p Δ {pFU}_{f}}{20 RT 32 μ i} = {c}_{cl} = \frac{{τ}_{cl}^{2}}{{ε}_{cl}} \frac{{d}_{cl}^{2}}{{f}_{cl}^{2} {t}_{cl}^{3}} ( {m}^{- 1} )$$

has a range of 1e5/m to 1e12/m, optionally, 1e7/m to 1e11/m and, preferably 5e8/m to 5e10/m.

The foregoing methods of operating a combustion cell can additionally, or independently comprise: maintaining an operating environment within a combustion cell inert permeable barrier having a parameter space defined by

$$\frac{{Pe}_{m} {FpDU}_{f}}{20 RTi} = {c}_{cb}$$

where
Peₘ is the mass Peclet number,
F is Faraday's constant,
p is the absolute pressure,
D is a mass diffusion coefficient of a reactant gas species,
U_{f} is a utilisation factor indicating the proportion of fuel consumption having occurred in the associated fuel cell stack (the remainder being consumed within the combustion cell),
R is the gas constant,
T is the temperature, and
i is the associated fuel cell stack current density

$$( \frac{A}{{m}^{2}} ) .$$

Examples can be realised which the combustion cell inert permeable barrier parameter space for maintaining an operating environment within the combustion cell inert permeable barrier comprises one or more than one of the following taken jointly and severally in any and all permutations:

$$\frac{{Pe}_{m} {FpDU}_{f}}{20 RTi} = {c}_{cb} ( m ) ,$$

has a range of 0.02 m to 50 m, optionally, 0.1 m to 10 m and, preferably, 0.5 m to 10 m,
Peₘ, the mass Peclet number, has a value in the range of 2 to 500, preferably, 5 to 50,
p, the absolute pressure, has a value of in the range of 1 bar to 50 bar, preferably, 5 bar to 25 bar,
D, the mass diffusion coefficient of a reactant gas species, has a value in the range of 1e-3 m²/s to 1e-4 m²/s, preferably 8e-4 m²/s to 1e-4 m²/s,
U_{f}, the utilisation factor, has a value in the range of 0.1 to 1.0, preferably 0.33 to 0.95,
T, the temperature, has a value in the range of 1000 °C to 400 °C, preferably 900 °C to 500 °C,
i, the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m².

Examples can be realised in which the above methods of operating a combustion cell inert permeable barrier, and combustion cell inert permeable barrier operating parameter space, associated with the combustion cell inert permeable barrier are related to geometric parameters by

$$\frac{{Pe}_{m} {FpDU}_{f}}{20 RTi} = \frac{{d}_{cb} {d}_{cl} {τ}_{cb}^{2}}{{t}_{cl} {ε}_{cb}} ( m ) ,$$

wherein
d_{cb} is the combustion cell inert permeable barrier depth in the reactant flow direction,
τ_{cb} is the combustion cell inert permeable barrier pathway tortuosity in the reactant flow direction,
ε_{cb} is the combustion cell inert permeable barrier porosity,
d_{cl} is the permeable combustion cell catalyst layer depth in the reactant flow direction, and
t_{cl} is the permeable combustion cell catalyst layer thickness.

Examples can be realised in which the combustion cell inert permeable barrier geometric parameters associated with the combustion cell inert permeable barrier are defined by one or more than one of the following taken jointly and severally in any and all permutations:
d_{cb}, the combustion cell inert permeable barrier depth in the reactant flow direction, has a value in the range of d_{cb}>0.01 (mm), optionally, 0.01<d_{cb}<5 (mm) and, preferably, 0.1<d_{cb}<2 (mm),
τ_{cb}, the combustion cell inert permeable barrier pathway tortuosity in the reactant flow direction, has a value in the range of 1<τ_{cb}<10, optionally, 1<τ_{cb}<5,
ε_{cb}, the combustion cell inert permeable barrier porosity, has a value in the range of 0.01<ε_{cb}<0.5, preferably, 0.05<ε_{cb}<0.5,
d_{cl} the permeable combustion cell catalyst layer depth in the reactant flow direction, has a value in the range of 0.25<d_{cl}<40 (mm), optionally 0.25<d_{cl}<20 (mm), and, preferably 5<d_{cl}<20 (mm), and/or
t_{cl}, the permeable combustion cell catalyst layer thickness, has a value in the range 5 μm<t_{cl}<5000 μm, optionally 5 μm<t_{cl}<1000 μm, and, preferably, 10 μm<t_{cl}<500 μm.

As indicated above, the parameter values given in Table 6: Combustion Parameters described herein are preferred parameter values and/or parameter value ranges. However, examples can be realised in which the above-described wider parameter value ranges can be used jointly and severally in any and all permutations.

### Combustor Oxidant Cell

Referring to the combustor oxidant cells, examples can be realised in that provide a method of operating a combustor oxidant cell, the method comprising maintaining an operating environment within the combustor oxidant cell having an operating parameter space defined by:

$$\frac{Δ {pU}_{a}}{i} \frac{p}{T} \frac{F}{50 R 32 μ} = {c}_{co} ,$$

where
p is the absolute pressure,
Δp is pressure drop across the combustor oxidant cell in the oxidant flow direction,
F is Faraday's constant,
Uₐ is a utilisation factor indicating the proportion of oxidant consumption intended in the associated fuel cell stack with the oxidant being first supplied to the combustor oxidant cell,
R is the gas constant,
T is the temperature,
μ is the oxidant gas species dynamic viscosity,
i is the associated fuel cell stack current density

$$( \frac{A}{{m}^{2}} ) ,$$

and
c_{co} is a constant.

The operating parameter space of the foregoing method of operating a combustor oxidant cell can be defined by, or comprises, any one or more than one of the following taken jointly and severally in any and all permutations:
c_{co} has a value in the range 1e5/m to 5e11/m, optionally, 1e7/m to 5e10/m and, preferably 5e7/m to 1e10/m,
p, the absolute pressure, has a range of 1 bar to 50 bar, preferably 5 bar to 25 bar,
Δp, the pressure drop, has a range of 10 mbar to 1000 mbar, preferably 20 mbar to 300 mbar,
Uₐ, the utilization factor, has a value in the range of 0.1 to 1.0, preferably 0.25 to 0.75,
T, the temperature, has a value in the range of 1000 °C to 400 °C, preferably 900 °C to 500 °C,
μ the oxidant gas dynamic viscosity, has a value in the range 5e-5 Pa·s to 1e-5 Pa·s, preferably, 5e-5 Pa·s to 4e-5 Pa·s, and/or
i, the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m².

Examples can be realised in which the above methods of operating a combustor oxidant cell, and combustor oxidant cell operating parameter space, are related to combustor oxidant cell geometric parameters in which

$$\frac{Δ {pU}_{a}}{i} \frac{p}{T} \frac{F}{50 R 32 μ} = \frac{{τ}_{co}^{2}}{{ε}_{co}} \frac{{w}_{co}^{2}}{{f}_{co}^{2} {t}_{co}^{3}} ( {m}^{- 1} ) ,$$

where
τ_{co} is the permeable combustor oxidant cell oxidant layer pathway tortuosity in the oxidant flow direction,
ε_{co} is permeable combustor oxidant cell oxidant layer porosity,
w_{co} is the permeable combustor oxidant cell oxidant layer width in the oxidant flow direction,
t_{co} is the permeable combustor oxidant cell oxidant layer thickness,
f_{co} is the ratio of permeable combustor oxidant cell oxidant layer pathway pore size to permeable combustion oxidant cell oxidant layer thickness, t_{co}.

Examples can be realised in which one or more than one of the above combustor oxidant cell geometric parameters are defined by the following taken jointly and severally in any and all permutations:
τ_{co}, the permeable combustor oxidant cell oxidant layer pathway tortuosity in the oxidant flow direction, has a range of 1<τ_{co}<3, optionally, 1<τ_{co}<2.5, and, preferably, 1<τ_{co}<2,
ε_{co}, the permeable combustor oxidant cell oxidant layer porosity, has a range of 0.1<ε_{co}<0.9 and preferably 0.5<ε_{co}<0.8,
w_{co}, the permeable combustor oxidant cell oxidant layer width in the oxidant flow direction, has a range of 0.25<w_{co}<40 (mm), optionally 0.25<w_{co}<20 (mm), and, preferably 5<w_{co}<20 (mm),
t_{co}, the permeable combustor oxidant cell oxidant layer thickness, has a range of 20<t_{co}<5000 (μm), optionally 20<t_{co}<1600 (μm), preferably 50<t_{co}<600 (μm),
f_{co}, the ratio of permeable combustor oxidant cell oxidant layer pathway pore size to permeable combustor oxidant cell oxidant layer thickness, t_{co}, has a range of 0.02<f_{co}<1.0, and, preferably, 0.25<f_{co}<0.75, and/or
in which

$$\frac{p Δ {pFU}_{a}}{50 R T 32 μ i} = \frac{{τ}_{co}^{2}}{{ε}_{co}} \frac{{w}_{co}^{2}}{{f}_{co}^{2} {t}_{co}^{3}} ( {m}^{- 1} )$$

has a range of 1e5/m to 5e11/m, optionally, 1e7/m to 5e10/m and, preferably 5e7/m to 1e10/m.

As indicated above, the parameter values given in Table 7: Combustor Oxidant Cell described herein are preferred parameter values and/or parameter value ranges. However, examples can be realised in which the above-described wider parameter value ranges can be used jointly and severally in any and all permutations.

### Methanation Cell

Referring to the methanation cells, examples can be realised that provide a method of operating a methanation cell, the method comprising maintaining an operating environment within the methanation cell having an operating parameter space defined by:

$$\frac{Δ {pU}_{c}}{i} \frac{p}{T} \frac{F}{40 R 32 μ} = {c}_{m} ,$$

where
p is the absolute pressure,
Δp is pressure drop across the methanation cell (in the reactant flow direction)
F is Faraday's constant,
U_{c} is a utilisation factor describing the supplied flow rate of reactant (chemical coolant reformate) as a proportion of the fuel cell stack fuel supply (where U_{c}>1 indicates a reactant undersupply when a low level of cooling is required),
R is the gas constant,
T is the temperature,
μ is the reactant gas dynamic viscosity,
i is the associated fuel cell stack current density

$$( \frac{A}{{m}^{2}} ) ,$$

and
cₘ is a constant.

The operating parameter space of the foregoing method of operating a methanation cell can be defined by, or comprises, any one or more than one of the following taken jointly and severally in any and all permutations:
cₘ has a value in the range 1e6/m to 5e12/m, optionally, 1e8/m to 5e11/m and, preferably 5e8/m to 1e11/m,
p the absolute pressure, has a range of 1 bar to 50 bar, preferably 5 bar to 25 bar,
Δp the pressure drop, has a range of 10 mbar to 1000 mbar, preferably 20 mbar to 300 mbar,
U_{c}, the utilisation factor, has a value in the range of 0.5 to 10, preferably 1 to 5,
T, the temperature, has a value in the range of 800 °C to 300 °C, preferably 700 °C to 400 °C,
μ the reactant gas dynamic viscosity, has a value in the range 5e-5 Pa·s to 1e-5 Pa·s, preferably, 4e-5 Pa·s to 2e-5 Pa·s, and/or
i, the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m².

Examples can be realised in which the above methods of operating a methanation cell, and methanation cell operating parameter space, are related to the methanation cell geometric parameters by

$$\frac{p Δ {pFU}_{c}}{40 R T 32 μ i} = \frac{{τ}_{m}^{2}}{{ε}_{m}} \frac{{d}_{m}^{2}}{{f}_{m}^{2} {t}_{m}^{3}} ( {m}^{- 1} ) ,$$

where

τₘ is the permeable methanation catalyst layer pathway tortuosity in the reactant flow direction,
εₘ is permeable methanation catalyst layer porosity,
dₘ is the permeable methanation catalyst layer depth in the reactant flow direction,
tₘ is the permeable methanation catalyst layer thickness,
fₘ is the ratio of permeable methanation catalyst layer pathway pore size to permeable methanation catalyst layer thickness, tₘ.

Examples can be realised in which one or more than one of the above methanation cell geometric parameters are defined by the following taken jointly and severally in any and all permutations:
τₘ, the permeable methanation catalyst layer pathway tortuosity in the reactant flow direction, has a range of 1<τₘ<3, optionally, 1<τₘ<2.5, and, preferably, 1<τₘ<2,
εₘ, the permeable methanation catalyst layer porosity, has a range of 0.1<εₘ<0.9 and preferably 0.5<εₘ<0.8,
dₘ, the permeable methanation catalyst layer depth in the reactant flow direction, has a range of 0.25<dₘ<40 (mm), optionally 0.25<dₘ<20 (mm), and, preferably 5<dₘ<20 (mm),
tₘ, the permeable methanation catalyst layer thickness, has a range of 5 μm<tₘ<5000 μm, optionally, 10 μm<tₘ<800 μm, optionally, 50 μm<tₘ<300 μm,
fₘ, the ratio of permeable methanation catalyst layer pathway pore size to permeable methanation catalyst layer thickness, tₘ, has a range of 0.02<fₘ<1.0, and, preferably, 0.25<fₘ<0.75, and/or
in which

$$\frac{p Δ {pFU}_{c}}{40 R T 32 μ i} = {c}_{m} = \frac{{τ}_{m}^{2}}{{ε}_{m}} \frac{{d}_{m}^{2}}{{f}_{m}^{2} {t}_{m}^{3}} ( {m}^{- 1} )$$

has a range of 1e6/m to 5e12/m, optionally, 1e8/m to 5e11/m and, preferably 5e8/m to 1e11/m.

The foregoing methods of operating a methanation cell can additionally, or independently, comprise maintaining an operating environment within a methanator inert permeable barrier having a methanation cell parameter space defined by

$$\frac{{Pe}_{m} {FpDU}_{c}}{40 RTi} = {c}_{mb}$$

where

Peₘ is the mass Peclet number,
F is Faraday's constant,
p is the absolute pressure,
D is a mass diffusion coefficient of a reactant gas species,
U_{c} is a utilisation factor describing the supplied flow rate of reactant (chemical coolant reformate) as a proportion of the fuel cell stack fuel supply (where U_{c}>1 indicates a reactant undersupply when a low level of cooling is required),
R is the gas constant,
T is the temperature, and
i is the associated fuel cell stack current density

$$( \frac{A}{{m}^{2}} ) .$$

Examples can be realised which the methanation cell parameter space for maintaining an operating environment within a methanator inert permeable barrier comprises one or more than one of the following taken jointly and severally in any and all permutations:

$$\frac{{Pe}_{m} {FpDU}_{c}}{40 RTi} = {c}_{mb} ( m ) ,$$

has a range of 0.02 m to 100 m, optionally, 0.1 m to 20 m and, preferably, 1 m to 10 m,
Peₘ, the mass Peclet number, has a value in the range of 2 to 500, preferably, 5 to 50,
p, the absolute pressure, has a value of in the range of 1 bar to 50 bar, preferably, 5 bar to 25 bar,
D, the mass diffusion coefficient of a reactant gas species, has a value in the range of 1e-3 m²/s to 1e-5 m²/s, preferably 6e-4 m²/s to 6e-5 m²/s,
U_{c}, the utilisation factor, has a value in the range of 0.5 to 10, preferably 1 to 5,
T, the temperature, has a value in the range of 800 °C to 300 °C, preferably 700 °C to 400 °C, and/or
i, the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m².

Examples can be realised in which the above methods of operating a methanation cell, and methanation cell operating parameter space, associated with the methanator inert permeable barrier are related to geometric parameters by

$$\frac{{Pe}_{m} {FpDU}_{c}}{40 RTi} = \frac{{d}_{mb} {d}_{m} {τ}_{mb}^{2}}{{t}_{m} {ε}_{mb}} ( m )$$

wherein
d_{mb} is the methanator inert permeable barrier depth in the reactant flow direction,
τ_{mb} is the methanator inert permeable barrier pathway tortuosity in the reactant flow direction,
ε_{mb} is the methanator inert permeable barrier porosity,
dₘ is the permeable methanation cell catalyst layer depth in the reactant flow direction, and
tₘ is the permeable methanation cell catalyst layer thickness.

Examples can be realised in which the methanation cell geometric parameters associated with the methanator inert permeable barrier are defined by one or more than one of the following taken jointly and severally in any and all permutations:
d_{mb}, the methanator inert permeable barrier depth in the reactant flow direction, has a value in the range of d_{mb}>0.01 (mm), optionally, 0.01<d_{mb}<5 (mm) and, preferably, 0.1<d_{mb}<2 (mm),
τ_{mb}, the methanator inert permeable barrier pathway tortuosity in the reactant flow direction, has a value in the range of 1<τ_{mb}<10, optionally, 1<τ_{mb}<5,
ε_{mb}, the methanator inert permeable barrier porosity, has a value in the range of 0.01<ε_{mb}<0.5, preferably, 0.05<ε_{mb}<0.5,
dₘ, the permeable methanation cell catalyst layer depth in the reactant flow direction, has a value in the range of 0.25<dₘ<40 (mm), optionally 0.25<dₘ<20 (mm), and, preferably 5<dₘ<20 (mm), and/or
tₘ, the permeable methanation catalyst layer thickness, has a range of 5 μm<tₘ<5000 μm, optionally, 10 μm<tₘ<800 μm, optionally, 50 μm<tₘ<300 μm.

As indicated above, the parameter values given in Table 4: Methanation Cell Parameters herein are preferred parameter values and/or parameter value ranges. However, examples can be realised in which the above-described wider parameter value ranges can be used jointly and severally in any and all permutations.

### Methanation Oxidant Cell

Referring to the methanation oxidant cells, examples can be realised that provide a method of operating a methanation oxidant cell, the method comprising maintaining an operating environment within the methanation oxidant cell having an operating parameter space defined by:

$$\frac{Δ {pU}_{a}}{i} \frac{p}{T} \frac{F}{50 R 32 μ} = {c}_{mo} ,$$

where
p is the absolute pressure,
Δp is pressure drop the methanation oxidant cell in the oxidant flow direction,
F is Faraday's constant,
Uₐ is a utilisation factor indicating the proportion of oxidant consumption intended in the associated fuel cell stack with the oxidant being first supplied to the methanation oxidant cell, R is the gas constant,
T is the temperature,
μ is the oxidant gas species dynamic viscosity,
i is the associated fuel cell stack current density

$$( \frac{A}{{m}^{2}} ) ,$$

and
cₘₒ is a constant.

The methanation oxidant cell operating parameter space of the foregoing method of operating a methanation oxidant cell can be defined by, or comprises, any one or more than one of the following taken jointly and severally in any and all permutations:
cₘₒ has a value in the range 1e5/m to 5e11/m, optionally, 1e7/m to 5e10/m and, preferably 5e7/m to 1e10/m,
p the absolute pressure, has a range of 1 bar to 50 bar, preferably 5 bar to 25 bar,
Δp, the pressure drop, has a range of 10 mbar to 1000 mbar, preferably 20 mbar to 300 mbar,
Uₐ the utilization factor, has a value in the range of 0.1 to 1.0, preferably 0.25 to 0.75,
T, the temperature, has a value in the range of 800 °C to 300 °C, preferably 700 °C to 400 °C,
μ, the oxidant gas dynamic viscosity, has a value in the range 5e-5 Pa·s to 1e-5 Pa·s, preferably, 4e-5 Pa·s to 3e-5 Pa·s, and/or
i, the current density

$$( \frac{A}{{m}^{2}} ) ,$$

has a value in the range 100000 A/m² to 300 A/m² optionally, 6000 A/m² to 300 A/m² and, preferably, 3000 A/m² to 1000 A/m².

Examples can be realised in which the above methods of operating a methanation oxidant cell, and methanation oxidant cell operating parameter space, are related to the methanation oxidant cell geometric parameters by

$$\frac{Δ {pU}_{a}}{i} \frac{p}{T} \frac{F}{50 R 32 μ} = {c}_{mo} = \frac{{τ}_{mo}^{2}}{{ε}_{mo}} \frac{{w}_{mo}^{2}}{{f}_{mo}^{2} {t}_{mo}^{3}} ( {m}^{- 1} ) ,$$

where

τₘₒ is the permeable methanation oxidant cell oxidant layer pathway tortuosity in the oxidant flow direction,
εₘₒ is permeable methanation oxidant cell oxidant layer porosity,
wₘₒ is the permeable methanation oxidant cell oxidant layer width in the oxidant flow direction,
tₘₒ is the permeable methanation oxidant cell oxidant layer thickness,
fₘₒ is the ratio of permeable methanation oxidant cell oxidant layer pathway pore size to permeable methanation oxidant cell oxidant layer thickness, tₘₒ.

Examples can be realised in which one or more than one of the above methanation cell geometric parameters are defined by the following taken jointly and severally in any and all permutations:
τₘₒ, the permeable methanation oxidant cell oxidant layer pathway tortuosity in the oxidant flow direction, has a range of 1<τₘₒ<3, optionally, 1<τₘₒ<2.5, and, preferably, 1<τₘₒ<2,
εₘₒ, the permeable methanation oxidant cell oxidant layer porosity, has a range of 0.1<εₘₒ<0.9 and preferably 0.5<εₘₒ<0.8,
wₘₒ, the permeable methanation oxidant cell oxidant layer width in the oxidant flow direction, has a range 0.25<wₘₒ<40 (mm), optionally 0.25<wₘₒ<20 (mm), and, preferably 5<wₘₒ<20 (mm),
tₘₒ, the permeable methanation oxidant cell oxidant layer thickness, has a range of 20<tₘₒ<5000 (μm), optionally 20<tₘₒ<1600 (μm), preferably 50<tₘₒ<600 (μm),
fₘₒ, the ratio of permeable methanation oxidant cell oxidant layer pathway pore size to permeable methanation oxidant cell oxidant layer thickness, tₘₒ, has a range of 0.02<fₘₒ<1.0, and, preferably, 0.25<fₘₒ<0.75, and/or
in which

$$\frac{p Δ {pFU}_{a}}{50 R T 32 μ i} = \frac{{τ}_{mo}^{2}}{{ε}_{mo}} \frac{{w}_{mo}^{2}}{{f}_{mo}^{2} {t}_{mo}^{3}} ( {m}^{- 1} )$$

has a range of 1e5/m to 5e11/m, optionally, 1e7/m to 5e10/m and, preferably 5e7/m to 1e10/m

As indicated above, the parameter values given in Table 5: Methanation Oxidant Cell Parameters herein are preferred parameter values and/or parameter value ranges. However, examples can be realised in which the above-described wider parameter value ranges can be used jointly and severally in any and all permutations.

Examples can be realised in which a stack could be built with the inert barrier layer being formed from other components of the stack such as, for example, the walls of a partially sealed porous tube forming part of the flow distribution network, which could also serve as a structural support.

Examples could also be created in which there is no porous barrier on the fuel side of the cells. However, it should be borne in mind that the fuel cells described and claimed herein operate at a scale where diffusion is significant so that ensuring uniformity of supply from cell to cell requires more than just consideration of pressures and geometry. Compositions and diffusional effects must also be considered. Examples with no porous barrier layer would suffer a significant compromise in performance arising from variations in composition due to significant diffusion between the cells and the supply manifold even where pressure drops and overall gas flow rates are uniform.

For examples of stack that have a cracking or reforming reaction ahead of the fuel cell electrochemistry, there would be significant diffusion of reactant into the cell and product out of the cell and into the manifold supplying the cells and this would differ between cells close to fuel supply and those further away, which would cause significant variations in the at least one or more of: supplied fuel composition, limiting cell performance and increasing temperature variations taken jointly and severally in any and all permutations.

Even in stacks where there is no cracking or fuel preparation reaction within the anode cells, the absence of a porous barrier layer would allow products of electrochemical reactions within the current collector and fuel electrodes to diffuse significantly back into the manifolds feeding the cells. Since these manifolds feed the cells sequentially, there will be significant variations in fuel composition at the inlet to each cell even if there was excellent uniformity of at least one of: current density, catalytic material activity and channel dimensions cell to cell taken jointly and severally in any and all permutations. This would make it very challenging to accurately match current density to fuel supply to allow maximisation of fuel utilisation. However, such sub-optimal examples without the porous barrier could nevertheless be realised subject to accepting a reduction in achievable efficiency, power density and more challenging stress distributions.

The following section of the description relates to further examples. The numbered paragraphs in this section are not claims. The claims are set forth below in the later section headed “claims”.

### Clauses

1. A multi-layered structure for a fuel cell comprising:
   a. an electrolyte;
   b. a permeable electrode;
   c. an inert permeable barrier;
   d. the permeable electrode and electrolyte having a common interface to form a reaction region;
   e. the permeable electrode providing a permeable electrode reactant pathway through the electrode to present a reactant at the common interface; the permeable electrode reactant pathway being fed by a permeable reactant pathway hosted by a permeable reactant pathway structure, and
   f. the inert permeable barrier comprises an inert permeable barrier reactant pathway to at least one, or both, of:
      i. provide an effective depth greater than a physical depth of the inert permeable barrier to at least reduce, preferably, eliminate, diffusion of any gas species within the inert permeable barrier reactant pathway to form a convectively dominant reactant flow regime within the inert permeable barrier; or
      ii. host a convectively dominant reactant flow regime within the inert permeable barrier,
   g. wherein the inert permeable barrier reactant pathway feeds the permeable reactant pathway.
2. The multi-layered structure of clause 1, in which
   a. the permeable reactant pathway and the permeable reactant pathway structure are related, or defined, by
      i.

$$\frac{{τ}_{p}^{2}}{{ε}_{p}} \frac{{d}_{p}^{2}}{{f}_{p}^{2} {t}_{p}^{3}} ,$$

which relates the geometric parameters of the permeable reactant pathway and its associated pathway structure to the fuel cell operating parameters,
and
   b. the inert permeable barrier reactant pathway and inert permeable barrier are related, or defined, by
      i.

$$\frac{{d}_{b} {d}_{p} {τ}_{b}^{2}}{{t}_{p} {ε}_{b}} ,$$

which relates the geometric parameters of the inert permeable barrier and its associated pathway to the fuel cell and barrier operating parameters,
c. where
   i. τₚ is the permeable reactant pathway tortuosity in the reactant flow direction,
   ii. τ_{b} is the inert permeable barrier reactant pathway tortuosity in the reactant flow direction,
   iii. εₚ is the permeable reactant pathway structure porosity,
   iv. ε_{b} is the inert permeable barrier porosity,
   v. dₚ is the permeable reactant pathway structure depth in the reactant flow direction,
   vi. d_{b} is the inert permeable barrier depth in the reactant flow direction,
   vii. tₚ is the permeable reactant pathway structure thickness,
   viii. fₚ is the ratio of permeable reactant pathway pore size to permeable reactant pathway structure thickness, tₚ.
3. The multi-layered structure of any preceding clause, in which the permeable reactant pathway structure thickness, tₚ, has a predetermined thickness arranged to balance cell packing density, or power density, following from a relatively smaller permeable reactant pathway structure thickness, and in-plane electrical sheet conductance, following from a relatively larger permeable reactant pathway structure thickness, to reduce resistive losses, and/or
   in which the electrode is an anode electrode and in which the permeable reactant pathway structure thickness, tₚ, has a range of 5 μm to 1000 μm, optionally, 5 μm to 500 μm and, preferably, 10 μm to 150 μm.
4. The multi-layered structure of any preceding clause, in which the ratio

$$\frac{{τ}_{p}^{2}}{{ε}_{p} {f}_{p}^{2}}$$

is arranged to influence the balance between an additional flow resistance provided by the permeable reactant pathway while providing structural strength and in-plane electrical sheet conductance to balance resistive losses, and/or
   in which the electrode is an anode electrode and in which the ratio

$$\frac{{τ}_{p}^{2}}{{ε}_{p} {f}_{p}^{2}}$$

has a range of 1 to 500, optionally, 2 to 50.
5. The multi-layered structure of any preceding clause, in which the permeable reactant pathway structure depth, dₚ, is selected to balance cell handling capabilities and power density, and/or
   in which the electrode is an anode electrode and in which the permeable reactant pathway structure depth, dₚ, has a range of 0.25 mm to 40 mm, optionally, 0.25 mm to 20 mm and, preferably, of 5 mm to 20 mm.
6. The multi-layered structure of any preceding clause, in which the ratio

$$\frac{{d}_{b} {τ}_{b}^{2}}{{ε}_{b}} ,$$

associated with a range of effective depths in the flow direction of the inert permeable barrier pathway, is selected to at least to reduce, or to eliminate, diffusion effects of any gas species, and/or in which the electrode is an anode electrode and in which the ratio

$$\frac{{d}_{b} {τ}_{b}^{2}}{{ε}_{b}}$$

has a range of 2 to 2500 mm, optionally, 10 to 500 mm and, preferably 50 to 250 mm, and more preferably less than 250 mm.
7. The multi-layered structure of any preceding clause, in which the ratio, fₚ, of permeable reactant pathway pore size to permeable reactant pathway structure thickness, tₚ, is selected to balance flow resistance with providing structural strength and in-plane electrical sheet conductance to influence or constrain electrical resistive losses, and/or
   in which the electrode is an anode electrode and the ratio, fₚ, of permeable reactant pathway pore size to permeable reactant pathway structure thickness, tₚ, has a range of 0.02 to 1, and, preferably, 0.25 to 0.75.
8. The multi-layered structure of any preceding clause, in which the permeable reactant pathway tortuosity, τₚ, is arranged to at least reduce, preferably minimise, at least one, or both, of: flow resistance and pressure drop across the permeable reactant pathway, and/or
   in which the electrode is an anode electrode and in which the permeable reactant pathway tortuosity, τₚ, has a range of 1 to 3, optionally, 1 to 2.5, and, preferably, 1 to 2.
9. The multi-layered structure of any clauses, in which the inert permeable barrier pathway tortuosity, τ_{b}, is arranged to at least reduce, and, preferably, minimize, diffusion effects of any gas species by increasing an effective diffusion depth, and/or
   in which the electrode is an anode electrode and in which the inert permeable barrier pathway tortuosity, τ_{b}, has a range of 1 to 10, optionally, 1 to 5.
10. The multi-layered structure of any preceding clause, in which the permeable reactant pathway structure porosity, εₚ, is selected to balance flow resistance against structural strength and in-plane sheet electrical conductance of the permeable reactant pathway structure, and/or
   in which the electrode is an anode electrode and in which the permeable reactant pathway structure porosity, εₚ, has a range of 0.1 to 0.9, preferably, 0.5 to 0.8.
11. The multi-layered structure fuel cell of any preceding clause, in which the inert permeable barrier porosity, ε_{b}, has a lower bound to accommodate an orifice or foraminate plate example and an upper bound to accommodate higher tortuosity materials, and/or
   in which the electrode is an anode electrode and in which the inert permeable barrier porosity, ε_{b}, has a range of 0.01 to 0.5, preferably, 0.05 to 0.5.
12. The multi-layered structure fuel cell of any preceding clause, in which the inert permeable barrier depth, d_{b}, is selected to achieve a balance, at a lower limit, between an increase in effective depth to limit diffusion of any gas species, with, at an upper limit, constraining size of the inert permeable barrier such that it has a volume smaller than an associated fuel cell, and/or
   in which the electrode is an anode electrode and in which the inert permeable barrier depth, d_{b}, is greater or equal 0.01 mm, optionally 0.01 mm to 5 mm and, preferably, 0.1 mm to 2 mm.
13. The multi-layered structure fuel cell of any preceding clause in which the electrode is an anode and the ratio

$$\frac{{τ}_{p}^{2}}{{ε}_{p}} \frac{{d}_{p}^{2}}{{f}_{p}^{2} {t}_{p}^{3}} ,$$

which relates the geometric parameters of the permeable anode reactant pathway and its associated pathway structure to the fuel cell operating parameters has a range of 5e6/m to 5e13/m, optionally, 5e8/m to 5e12/m and, preferably 1e10/m to 1e12/m.
14. The multi-layered structure fuel cell of any preceding clause in which the electrode is an anode and the ratio

$$\frac{{d}_{b} {d}_{p} {τ}_{b}^{2}}{{t}_{p} {ε}_{b}} ,$$

which relates the geometric parameters of the inert permeable barrier and its associated pathway to the fuel cell and barrier operating parameters has a range of 0.2 m to 1000 m, optionally, 1 m to 200 m and, preferably 10 m to 100 m.
15. A multi-layered structure fuel cell for a fuel cell; the multi-layered structure fuel cell comprising:
   a. an electrolyte;
   b. a permeable electrode having an electrode inlet and an electrode outlet;
   c. an inert permeable barrier;
   d. the electrode and electrolyte having a common interface to form a reaction region;
   e. the permeable electrode to provide a permeable electrode reactant pathway through the electrode to present a reactant at the common interface; the permeable electrode reactant pathway being fed by a permeable reactant pathway hosted by a permeable reactant pathway structure, and
   f. the inert permeable barrier providing an inert permeable barrier reactant pathway to host a convectively dominant reactant flow regime,
   g. wherein the inert permeable barrier reactant pathway is coupled to the permeable reactant pathway,
wherein:
   h. the permeable reactant pathway and the permeable reactant pathway structure being related, or defined, by
      i.

$$\frac{{τ}_{p}^{2}}{{ε}_{p}} \frac{{d}_{p}^{2}}{{f}_{p}^{2} {t}_{p}^{3}} ,$$

which relates the geometric parameters of the permeable reactant pathway and its associated pathway structure to the fuel cell operating parameters,
and
   i. the inert barrier permeable reactant pathway and the inert permeable barrier being related, or defined, by
      i.

$$\frac{{d}_{b} {d}_{p} {τ}_{b}^{2}}{{t}_{p} {ε}_{b}} ,$$

which relates the geometric parameters of the inert permeable barrier and its associated pathway to the fuel cell and barrier operating parameters,
j. where
   i. τₚ is the permeable reactant pathway tortuosity in the reactant flow direction,
   ii. τ_{b} is the inert permeable barrier pathway tortuosity in the reactant flow direction,
   iii. εₚ is the permeable reactant pathway structure porosity,
   iv. ε_{b} is the inert permeable barrier porosity,
   v. dₚ is the permeable reactant pathway structure depth in the reactant flow direction,
   vi. d_{b} is the inert permeable barrier depth in the reactant flow direction,
   vii. tₚ is the permeable reactant pathway structure thickness,
   viii. fₚ is the ratio of permeable reactant pathway pore size to permeable reactant pathway structure thickness, tₚ.
16. The multi-layered structure fuel cell of any preceding clause, further comprising a permeable electrode current collector to conduct current from the electrode; optionally, the permeable electrode current collector forms the permeable reactant pathway structure to host the permeable reactant pathway.

### Anode Half-Cell—“Half-Cell”

17. An anode multi-layered structure fuel cell; the anode multi-layered structure fuel cell comprising a multi-layered structure fuel cell of any preceding clause in which:
   a. the electrode forms a permeable anode electrode,
   b. the reactant is a fuel species, and
   c. further comprises a permeable anode current collector to form a respective permeable anode reactant pathway structure, as the permeable reactant pathway structure, to host a respective permeable reactant pathway.
      Cathode half-Cell—“Half-Cell”
18. A cathode multi-layered structure fuel cell; the cathode multi-layered structure fuel cell comprising a multi-layered structure fuel cell of any preceding clause but for the inert permeable barrier in which:
   d. the electrode forms a permeable cathode electrode,
   e. the reactant is an oxidant species, and
   f. further comprising a permeable cathode current collector to form a respective permeable cathode oxidant pathway structure, as the permeable oxidant pathway structure, to host a respective permeable oxidant pathway.

### A Single Cell Comprising the Anode Half-Cell and the Cathode Half-Cell—FIG. 3

19. A fuel cell for a fuel cell system; the fuel cell comprising:
   g. a set of anode multi-layered structures comprising at least one anode multi-layered structure as claimed in clause 17, and
   h. a set of cathode multi-layered structures comprising at least one cathode multi-layered structure as claimed in clause 18.
20. The fuel cell of clause 19, in which
   i. the sets of anode and cathode multi-layered structures are arranged to form a cell having an ordered arrangement of layers comprising:
      i. an anode current collector layer to host the permeable anode reactant pathway,
      ii. an anode electrode layer comprising the planar permeable anode electrode,
      iii. an electrolyte layer comprising at least one, or both, of the planar electrolytes;
      iv. a cathode electrode layer comprising the planar permeable cathode electrode;
      v. a cathode current collector layer comprising the cathode current collector to host the permeable cathode reactant pathway.
21. The fuel cell of either of clauses 19 and 20, in which the anode and cathode electrode inlets and outlets are orientated to provide respective reactant and oxidant pathways through the anode and cathode electrodes having one of:
   j. differently orientated pathways relative to one another, such as
      i. a substantially perpendicular orientation relative to one another within respective parallel planes.

### A Stack/Set of Fuel Cells—FIG. 6 “Stack” and FIG. 3

22. A stack or set of fuel cells comprising plurality of fuel cells as claimed in any of clauses 19 to 21, in which a number, or all, of the reactant pathways are aligned in the same direction and a number, or all, of the oxidant pathways are aligned in the same direction.

### A Stack—Interdigitated Sets of Cells—FIG. 6 “Stack” and FIG. 3

23. The stack of clause 22, in which the plurality of set of fuel cells are arranged in an interdigitated manner with adjacent sets of cells having at least one, or both, of oppositely oriented reactant species pathways or oppositely oriented oxidant species pathways.

### A Stack Arranged in Group/Stack Assembly—FIG. 1 and FIG. 13

24. A stack assembly comprising a plurality of stacks as claimed in any of clauses 22 to 23.
25. The stack assembly of clause 24, in which pairs of (transversely or longitudinally) adjacent stacks share a common fuel supply channel that is arranged to supply fuel to fuel pathways via respective permeable barriers and inlets of the permeable anode reactant pathways.
26. The stack assembly of clause 25, in which each stack of the pair of adjacent stacks comprises a respective exhaust channel.
27. The stack assembly of clause 26, in which the respective exhaust channel is arranged to carry at least one, or both, of: excess fuel or at least one or more than one reaction product.
28. The stack assembly of any of clauses 24 to 27, in which pairs of adjacent stacks share a common oxidant supply channel that is arranged to supply an oxidant to oxidant pathways via respective inlets of the permeable cathode cells or permeable cathode reactant pathways.
29. The stack assembly of clause 28, in which each stack of the pair of adjacent stacks comprises a further respective exhaust channel.
30. The stack assembly of clause 29, in which the further respective exhaust channel is arranged to carry excess oxidant.
31. The stack assembly of any of clauses 24 to 30, comprising an anode current electrical interconnect spanning a set of anode current collectors; the set of anode current collectors comprising one or more than one anode current collector.
32. The stack assembly of any of clauses 24 to 31, comprising a cathode current electrical interconnect spanning a set of cathode current collectors; the set of cathode current collectors comprising one or more than one cathode current collector.

### Coolant Cell, Coolant Supply and Exhaust Channels

33. The stack assembly as claimed in any of clauses 24 to 32, further comprising a chemical coolant cell; the chemical coolant cell comprising at least one permeable chemical coolant catalyst layer to host a permeable chemical coolant catalyst layer pathway for carrying a chemical coolant (for example, at least methane and steam, or ammonia) to thermally condition (cool) the stack assembly.
34. The stack assembly as claimed in clause 33, in which the permeable chemical coolant catalyst layer is disposed between a pair of layers, such as, for example, at least one, or both, of: interconnect layers or permeable or solid electrical conductor layers.
35. The stack assembly as claimed in either of clauses 32 and 34, in which the chemical coolant cell is disposed at least adjacent to one fuel cell, or disposed between a pair of adjacent fuel cells, optionally with a insulating dense layer being disposed between the chemical coolant cell and said at least one fuel cell or pair of adjacent fuel cells.
36. The stack assembly as claimed in any of clauses 33 to 35, comprising at least one chemical coolant supply channel (coolant+) and at least one chemical coolant exhaust channel (coolant−); the at least one chemical coolant supply channel and the at least one chemical coolant exhaust channel being coupled via a set of chemical coolant cells comprising the chemical coolant cell.
37. The stack assembly of any of clauses 33 to 36, in which the set of chemical coolant cells comprises a plurality of said chemical coolant cells, optionally, at least one, or both, of: transversely or longitudinally disposed relative to the chemical coolant supply channel.

### Methanator—FIG. 15, 16, 17

38. A methanator (1600) for use in a fuel cell system comprising a stack assembly comprising at least one methanation stack; the at least one methanation stack comprising:
   k. at least one methanation cell (1560) comprising:
      i. at least one permeable methanation catalyst layer (1562) having a first methanation catalyst layer inlet (1568) and a first methanation catalyst layer outlet (1570); the at least one permeable methanation catalyst layer (1562), comprising a permeable methanation catalyst to host a permeable methanation catalyst layer pathway, for reacting a chemical coolant reformate to recover a chemical coolant from the chemical coolant reformate,
      ii. a first methanator inert permeable barrier (1520), disposed over the first methanation catalyst layer inlet (1568), to host a first methanator inert permeable barrier pathway and a second methanator inert permeable barrier (1522), disposed over the first methanation catalyst layer outlet (1570), to host a second methanator inert permeable barrier pathway;
   l. at least one oxidant cell (1574) comprising;
      i. at least one permeable oxidant layer (1576) having a first oxidant inlet (1582) and a first oxidant outlet (1584),
   m. the methanator (1600) being arranged to at least one, or both, of:
      i. recover, within the at least one permeable methanation catalyst layer (1562), and output, at the first methanation catalyst layer outlet (1570), through the second methanator inert permeable barrier (1522), the chemical coolant from a reformate, associated with the chemical coolant, having a reformate flow direction, derived from a stack assembly of any of clauses 6 to 35, supplied to the first methanation catalyst layer inlet (1568), though the first methanator inert permeable barrier (1520), via the at least one permeable methanation catalyst layer (1562), and
      ii. output, at the first oxidant outlet (1584), a thermally conditioned (heated) oxidant derived from the oxidant (1528 to 1534) supplied to the first oxidant inlet (1582) via an oxidant supply channel (1612 to 1614).
39. The methanator (1600) of clause 38, in which:
   n. the at least one permeable methanation catalyst layer (1562) having the first methanation catalyst layer inlet (1568) and the first methanation catalyst layer outlet (1570) define a permeable methanation catalyst layer chemical coolant reformate pathway,
   o. the at least one permeable oxidant layer (1576) having the first oxidant inlet (1582) and the first oxidant outlet (1584) define a permeable oxidant layer oxidant pathway, and
   p. the permeable methanation catalyst layer chemical coolant reformate pathway and the permeable oxidant layer oxidant pathway lie in respective parallel planes and are perpendicularly orientated relative to one another.
40. The methanator (1600) of any of clauses 38 to 39, in which the at least one permeable methanation catalyst layer (1562) comprises a plurality of permeable methanation catalyst layers.
41. The methanator (1600) of any of clauses 38 to 40, in which the at least one permeable oxidant layer (1576) comprises a plurality of permeable oxidant layers.
42. The methanator (1600) of clause 41, in which the permeable methanation catalyst layers (1562) of the plurality of permeable methanation catalyst layers are interleaved with the plurality of permeable oxidant layers of the plurality of permeable oxidant layers.
43. The methanator (1600) of any of clauses 38 to 42, comprising a plurality of baffles (1732 to 1740) arranged to form a plurality of sets of permeable oxidant layers (1730), supplied by a plurality of air channels (1744 to 1754); the plurality of sets of permeable oxidant layers providing, in use, differing or alternating oxidant flow directions.
44. The methanator (1600) of clause 43, in which the plurality of baffles (1732 to 1740) comprises first (1732, 1736, 1740) and second (1734, 1738) sets of interdigitated baffles.
45. The methanator of any of clauses 38 to 44, comprising a plurality of methanation stacks; each stack comprising a plurality of permeable methanation catalyst cells interleaved with a plurality of permeable oxidant cells; the plurality of methanation stacks being arranged such that adjacent methanation stacks share a common air supply channel/share the oxidant supply channel.
46. The methanator of any of clauses 38 to 45, comprising a plurality of methanation stacks; each methanation stack comprising a plurality of permeable methanation catalyst cells interleaved with a plurality of permeable oxidant cells; the plurality of stacks of methanation stacks being arranged such that adjacent stacks share a common air/oxidant exhaust channel.
47. The methanator of any of clauses 38 to 46, comprising a plurality of methanation stacks; each methanation stack comprising a plurality of permeable methanation catalyst cells interleaved with a plurality of permeable oxidant cells; the plurality of methanation stacks being arranged such that adjacent stacks share a common chemical coolant supply channel.
48. The methanator of any of clauses 38 to 47 comprising a plurality of methanation stacks; each methanation stack comprising a plurality of permeable methanation catalyst cells interleaved with a plurality of permeable oxidant cells; the plurality of methanation stacks being arranged such that adjacent stacks share a common chemical coolant exhaust channel.

### Methanator Dimensions, Porosities, Tortuosities

49. The methanator of any of clauses 38 to 48, in which
   a. the at least one permeable methanation catalyst layer pathway and the at least one permeable methanation catalyst layer are related, or defined, by
      i.

$$\frac{{τ}_{m}^{2}}{{ε}_{m}} \frac{{d}_{m}^{2}}{{f}_{m}^{2} {t}_{m}^{3}} ,$$

which relates the geometric parameters of the permeable methanation catalyst layer and its associated pathway to the operational parameters of the methanation cell,
and
b. the first and second methanator inert permeable barrier pathways at the first methanation catalyst layer inlet and the first methanation catalyst layer outlet and the first and second methanator inert permeable barriers are related, or defined, by
   i.

$$\frac{{d}_{mb} {d}_{m} {τ}_{m b}^{2}}{{t}_{m} {ε}_{m b}} ,$$

which relates the geometric parameters of the methanator inert permeable barrier and its associated pathway to the operational parameters of the methanation cell and barriers,
c. where
   i. τₘ is the permeable methanation catalyst layer pathway tortuosity in the chemical coolant reformate flow direction,
   ii. τ_{mb} is the methanator inert permeable barrier pathway tortuosity in the chemical coolant reformate flow direction,
   iii. εₘ is the permeable methanation catalyst layer porosity,
   iv. ε_{mb} is the methanator inert permeable barrier porosity,
   v. dₘ is the permeable methanation catalyst layer depth in the chemical coolant reformate flow direction,
   vi. d_{mb} is the methanator inert permeable barrier depth in the chemical coolant reformate flow direction,
   vii. tₘ is the permeable methanation catalyst layer thickness,
   viii. fₘ is the ratio of the at least one permeable methanation catalyst layer pathway pore size to the at least one permeable methanation catalyst layer thickness, tₘ.
50. The methanator of any clause 49, in which the permeable methanation catalyst layer thickness, tₘ, is arranged to provide a balance between reaction time, contact via a catalyst or reaction contact surface and in-plane thermal conduction, which follows from increasing permeable methanation catalyst layer thickness, with increasing power density, which follows from decreasing permeable methanation catalyst layer thickness and providing effective or improved heat transfer to adjacent oxidant cells, and/or
   in which the permeable methanation catalyst layer thickness, tₘ, has a range of 5 μm to 5000 μm, optionally, 10 μm to 800 μm, optionally, 50 μm to 300 μm.
51. The methanator of any either of clauses 49 and 50, in which the ratio

$$\frac{{τ}_{m}^{2}}{{ε}_{m} {f}_{m}^{2}}$$

influences the balance between an additional flow resistance provided by the permeable methanation catalyst layer pathway while providing structural strength, and/or
in which the ratio

$$\frac{{τ}_{m}^{2}}{{ε}_{m} {f}_{m}^{2}}$$

has a range of 1 to 500, optionally, 2 to 50.
52. The methanator of any of clauses 49 to 51, in which the permeable methanation catalyst layer depth dₘ, is selected to balance cell handling capabilities and power density, and/or in which the permeable methanation catalyst layer depth, dₘ, has a range of 0.25 mm to 40 mm, optionally, 0.25 mm to 20 mm and, preferably, 5 mm to 20 mm.
53. The methanator of any of clauses 49 to 52, in which the ratio

$$\frac{{d}_{m b} {τ}_{m b}^{2}}{{ε}_{m b}}$$

is associated with a range of effective depths in the flow direction of the methanator inert permeable barrier pathway to at least reduce, or eliminate, diffusion effects of any gas species, and/or
   in which the ratio

$$\frac{{d}_{m b} {τ}_{m b}^{2}}{{ε}_{m b}}$$

has a range of 0.4 to 500 mm, optionally, 2 to 100 mm and, preferably 5 to 50 mm, and more preferably less than 50 mm.
54. The methanator of any of clauses 49 to 53, in which the ratio, fₘ, of permeable methanation catalyst layer pathway pore size to permeable methanation catalyst layer thickness, tₘ, is selected to balance flow resistance with providing structural strength and in-plane thermal conduction, and/or
   in which the ratio, fₘ, of permeable methanation catalyst layer pathway pore size to permeable methanation catalyst layer thickness, tₘ, has a range of 0.02 to 1, and, preferably, 0.25 to 0.75.
55. The methanator of any of clauses 49 to 54, in which the permeable methanation catalyst layer pathway tortuosity, τₘ, is selected to balance flow resistance and catalyst or reaction contact surface against structural strength and in-plane thermal conduction of the layer, and/or
   in which the permeable methanation catalyst layer pathway tortuosity, τₘ, has a range of 1 to 3, optionally, 1 to 2.5, and, preferably, 1 to 2.
56. The methanator of any of clauses 49 to 55, in which the first and second methanator inert permeable barrier pathway tortuosities, τ_{mb}, are arranged to increase the effective depth of the methanator inert permeable barrier pathway to at least reduce, and, preferably, eliminate, diffusion, and/or
   in which the first and second methanator inert permeable barrier pathway tortuosities, τ_{mb}, have a range of 1 to 10, optionally, 1 to 5.
57. The methanator of any of clauses 49 to 56, in which the permeable methanation catalyst layer porosity, εₘ, is selected to balance flow resistance against structural strength and in-plane thermal conduction of the layer, and/or
   in which the permeable methanation catalyst layer porosity, εₘ, has a range of 0.1 to 0.9, and, preferably, 0.5 to 0.8.
58. The methanator of any of clauses 49 to 57, in which the first and second methanator inert permeable barrier porosities, ε_{mb}, have a lower bound to accommodate an orifice or foraminate plate barrier and an upper bound to accommodate higher tortuosity materials, and/or
   in which the first and second methanator inert permeable barrier porosities, ε_{mb}, have a range of 0.01 to 0.5, and, preferably, 0.05 to 0.5.
59. The methanator of any of clauses 49 to 58, in which the first and second methanator inert permeable barrier depths, d_{mb}, are set to achieve a balance, at a lower limit, between an increase in effective depth to limit diffusion of any gas species with, at an upper limit, constraining size of the methanator inert permeable barrier such that it has a volume smaller than an associated methanation cell, and/or
   in which the first and second methanator inert permeable barrier depths, d_{mb}, are greater or equal to 0.01 mm, optionally 0.01 mm to 5 mm and, preferably, in the range 0.1 to 2 mm inclusive.
60. The methanator of any of clauses 49 to 59, in which the ratio

$$\frac{{τ}_{m}^{2}}{{ε}_{m}} \frac{{d}_{m}^{2}}{{f}_{m}^{2} {t}_{m}^{3}} ,$$

which relates the geometric parameters of the permeable methanation catalyst layer and its associated pathway to the operational parameters of the methanation cell, has a range of 1e6/m to 5e12/m, optionally, 1e8/m to 5e11/m and, preferably 5e8/m to 1e11/m.
61. The methanator of any of clauses 49 to 60, in which the ratio

$$\frac{{d}_{mb} {d}_{m} {τ}_{m b}^{2}}{{t}_{m} {ε}_{m b}} ,$$

which relates the geometric parameters of the methanator inert permeable barrier and its associated pathway to the operational parameters of the methanation cell and barriers, has a range of 0.02 m to 100 m, optionally, 0.1 m to 20 m and, preferably 1 m to 10 m.

### Combustion Cell

62. A combustion cell for a combustor; the combustion cell comprising a plurality of layers, the plurality of layers comprising:
   a. at least one permeable combustion layer, comprising a permeable combustion cell catalyst layer, to host a permeable combustion cell catalyst layer pathway; the at least one permeable combustion cell catalyst layer having a respective combustion layer reactant inlet, a combustion layer oxidant inlet and a combustion layer exhaust outlet;
   b. at least one dense layer disposed adjacent to the at least one permeable combustion layer, and
   c. a combustion cell inert permeable barrier, to host a combustion cell inert permeable barrier pathway, over at least one, or both, of: the combustion layer reactant inlet and the combustion layer oxidant inlet.
63. The combustion cell of clause 62, in which the at least one permeable combustion layer comprises a plurality of permeable combustion layers.

### A Combustion Cell-Oxidant Cell Assembly

64. A combustion cell-oxidant cell assembly; the assembly comprising a combustion cell of either of clauses 62 and 63 and at least one permeable oxidant cell comprising at least one permeable oxidant layer having a respective oxidant inlet and a respective oxidant outlet; in which at least one, or more than one, of the following taken jointly and severally in any and all permutations:
   q. the respective combustion reactant layer inlet,
   r. respective combustion layer oxidant inlet, and
   s. combustion layer exhaust outlet
   are offset relative to the respective oxidant inlet and the respective oxidant outlet of the oxidant cell.
65. The combustion cell-oxidant cell combination of clause 64, in which the at least one permeable oxidant layer comprises a plurality of permeable oxidant layers.
66. The combustion cell-oxidant cell combination of clause 65, in which the permeable combustion layers of the plurality of permeable combustion layers are interleaved with the permeable oxidant layers of the plurality of permeable oxidant layers.
67. The combustion cell-oxidant cell combination of any of clauses 64 to 66, comprising a plurality of baffles arranged to form a plurality of sets of permeable oxidant layers; the plurality of sets of permeable oxidant layers providing, in use, alternating oxidant flow directions.
68. The combustion cell-oxidant cell combination of clause 67, in which the plurality of baffles comprises first and second sets of interdigitated baffles.

### Dimensions and Characteristics

69. The combustion cell of any of clauses 62 to 68, in which
   d. the at least one permeable combustion cell catalyst layer pathway is hosted by a permeable combustion cell catalyst layer, which are related, or defined, by
      i.

$$\frac{{τ}_{cl}^{2}}{{ε}_{c l}} \frac{{d}_{cl}^{2}}{{f}_{cl}^{2} {t}_{cl}^{3}} ,$$

which relates the geometric parameters of the permeable combustion catalyst layer and its associated pathway to the operational parameters of the combustion cell,
and
e. the combustion cell inert permeable barrier over the permeable combustion cell reactant and oxidant inlet hosts a combustion cell inert permeable barrier pathway, which are related, defined, or characterised by, the following combustion cell inert permeable barrier layer ratio:
   i.

$$\frac{{d}_{cb} {d}_{c l} {τ}_{c b}^{2}}{{t}_{c l} {ε}_{c b}} ,$$

which relates the geometric parameters of the combustion cell inert-permeable barrier and its associated pathway to the operational parameters of the combustion cell and associated barriers,
f. where
   i. τ_{cl} is the permeable combustion cell catalyst layer pathway tortuosity in the reactant flow direction,
   ii. τ_{cb} is the combustion cell inert permeable barrier pathway tortuosity in the reactant flow direction,
   iii. ε_{cl} is the permeable combustion cell catalyst layer porosity,
   iv. ε_{cb} is the combustion cell inert permeable barrier porosity,
   v. d_{cb} is the combustion cell inert permeable barrier depth in the reactant flow direction,
   vi. d_{cl} is the permeable combustion cell catalyst layer depth in the reactant flow direction,
   vii. t_{cl} is the permeable combustion cell catalyst layer thickness,
   viii. f_{cl} is the ratio of permeable combustion cell catalyst layer pathway pore size to permeable combustion cell catalyst layer thickness, t_{cl}.
70. The combustion cell of clause 69, in which the permeable combustion cell catalyst layer thickness, t_{cl}, is arranged to provide a balance between reaction time, contact via a catalyst or reaction contact surface and in-plane thermal conduction, which follows from increasing permeable combustion cell catalyst layer thickness, with increasing power density and improving heat transfer between the catalyst layer and any adjacent air or oxidant cells, which follows from decreasing permeable combustion cell catalyst layer thickness, and/or in which the permeable combustion cell catalyst layer thickness, t_{cl}, has a range of 5 μm to 5000 μm, 5 μm to 1000 μm, optionally 10 μm to 500 μm.
71. The combustion cell of any either of clauses 69 and 70, in which the ratio

$$\frac{{τ}_{c l}^{2}}{{ε}_{c l} {f}_{c l}^{2}}$$

is selected to balance an additional flow resistance provided by the permeable combustion cell catalyst layer pathway with providing structural strength and in-plane thermal conduction, and/or in which the ratio

$$\frac{{τ}_{c l}^{2}}{{ε}_{c l} {f}_{c l}^{2}}$$

has a range of 1 to 500, optionally, 2 to 50.
72. The combustion cell of any of clauses 69 to 71, in which the permeable combustion cell catalyst layer depth, d_{cl}, is selected to balance cell handling capabilities and power density, and/or
   in which the permeable combustion cell catalyst layer depth, d_{cl}, has a range of 0.25 mm to 40 mm, optionally, 0.25 mm to 20 mm and, preferably, 5 mm to 20 mm.
73. The combustion cell of any of clauses 69 to 72, in which the ratio

$$\frac{{d}_{c b} {τ}_{c b}^{2}}{{ε}_{cb}}$$

is associated with a range of effective depths in the flow direction of the combustion cell inert permeable barrier pathway and is set to at least reduce, or eliminate, diffusion effects of any gas species, and/or
   in which the ratio

$$\frac{{d}_{cb} {τ}_{cb}^{2}}{{ε}_{cb}}$$

has a range of 0.4 to 500 mm, optionally, 2 to 100 mm and, preferably 5 to 50 mm, and more preferably less than 50 mm.
74. The combustion cell of any of clauses 69 to 73, in which the ratio, f_{cl}, of permeable combustion cell catalyst layer pathway pore size to permeable combustion cell catalyst layer thickness, t_{cl}, is selected to balance flow resistance with providing structural strength and in-plane thermal conduction, and/or in which the ratio, f_{cl}, of permeable combustion cell catalyst layer pathway pore size to permeable combustion cell catalyst layer thickness, t_{cl}, has a range of 0.02 to 1, and, preferably, 0.25 to 0.75.
75. The combustion cell of any of clauses 69 to 74, in which the permeable combustion cell catalyst layer pathway tortuosity, τ_{cl}, is selected to balance flow resistance and catalyst or reaction contact surface against structural strength and in-plane thermal conduction of at least the combustion catalyst, and/or
   in which the permeable combustion cell catalyst layer pathway tortuosity, τ_{cl}, has a range of 1 to 3, optionally, 1 to 2.5, and, preferably, 1 to 2.
76. The combustion cell of any of clauses 69 to 75, in which the combustion cell inert permeable barrier pathway tortuosity, τ_{cb}, is arranged to increase the effective depth of the combustion cell inert permeable barrier pathway to at least reduce, and, preferably, eliminate, diffusion of any gas species, and/or
   in which the combustion cell inert permeable barrier pathway tortuosity, τ_{cb}, has a range of 1 to 10, optionally, 1 to 5.
77. The combustion cell of any of clauses 69 to 76, in which the permeable combustion cell catalyst layer porosity, ε_{cl}, is selected to balance flow resistance against structural strength and in-plane thermal conduction of the combustion cell catalyst layer, and/or
   in which the permeable combustion cell catalyst layer porosity, ε_{cl}, has a range of 0.1 to 0.9, and, preferably, 0.5 to 0.8.
78. The combustion cell of any of clauses 69 to 77, in which the combustion cell inert permeable barrier porosity, ε_{cb}, has a lower bound to accommodate an orifice or foraminate plate barrier and an upper bound to accommodate higher tortuosity materials, and/or
   in which the combustion cell inert permeable barrier porosity, ε_{cb}, has a range of 0.01 to 0.5, and, preferably, 0.05 to 0.5.
79. The combustion cell of any of clauses 69 to 78, in which the combustion cell inert permeable barrier depth, d_{cb}, is set to achieve a balance, at a lower limit, between an increase in effective depth to limit diffusion of any gas species with, at an upper limit, constraining size of the combustion cell inert permeable barrier such that it has a volume smaller than an associated combustion cell, and/or
   in which the combustion cell inert permeable barrier depth, d_{cb}, is greater or equal to 0.01 mm, optionally 0.01 mm to 5 mm and, preferably, in the range 0.1 to 2 mm inclusive.
80. The combustion cell of any of clauses 69 to 79 in which The ratio

$$\frac{{τ}_{cl}^{2}}{{ε}_{cl}} \frac{{d}_{cl}^{2}}{{f}_{cl}^{2} {t}_{cl}^{3}} ,$$

which relates the geometric parameters of the permeable combustion catalyst layer and its associated pathway to the operational parameters of the combustion cell has a range of 1e5/m to 1e12/m, optionally, 1e7/m to 1e11/m and, preferably 5e8/m to 5e10/m.
81. The combustion cell of any of clauses 69 to 80 in which The ratio

$$\frac{{d}_{cb} {d}_{cl} {τ}_{cb}^{2}}{{t}_{cl} {ε}_{cb}} ,$$

which relates the geometric parameters of the combustion cell inert permeable barrier and its associated pathway to the operational parameters of the combustion cell and associated barriers has a range of 0.02 m to 50 m, optionally, of 0.1 m to 10 m and, preferably 0.5 m to 10 m.

### Combustor

82. A combustor comprising a plurality of stacks of combustion cells of any of clauses 62 to 81; each stack comprising a plurality of permeable combustion cells interleaved with a plurality of permeable oxidant cells; the plurality of stacks being arranged such that adjacent stacks share a common air supply channel.
83. The combustor of clause 82, in which the plurality of stacks of combustion cells are arranged such that adjacent stacks share a common air exhaust channel.
84. The combustor of any of clauses 82 to 83, in which adjacent stacks share a reactant supply channel.
85. The combustor of clause 84, in which the reactant supply channel is common to a plurality of adjacent stacks.
86. The combustor of clause 85, in which the reactant supply channel is common to a plurality of transversely disposed stacks.
87. The combustor of either of clauses 84 and 86, in which the reactant supply channel is common to a plurality of longitudinally arranged stacks.
88. The combustor of any of clauses 82 to 87, in which adjacent stacks share a common reactant exhaust channel.
89. The combustor of any of clauses 82 to 88, in which longitudinally or transversely disposed adjacent stacks share a common combustion air supply channel.
90. The combustor of any of clauses 82 to 89, in which longitudinally or transversely disposed adjacent stacks share a common combustion exhaust channel.

### A Thermal Conditioning System—Linked in Design

91. A thermal conditioning system for use with a fuel cell; the fuel cell, for example, comprising a stack or stack assembly of any of clauses 22 to 37; the thermal conditioning system comprising:
   g. the methanator of any of clauses 38 to 61 arranged to thermally condition the oxidant and to recover the chemical coolant from the chemical coolant reformate.
92. The thermal conditioning system of clause 91, comprising a first heat exchanger (1918) to thermally condition the chemical coolant reformate associated with the chemical coolant prior to being input to the methanator via the first methanation catalyst layer inlet.
93. The thermal conditioning system of clause 92, in which the first heat exchanger is arranged to thermally condition chemical coolant to a predetermined temperature.
94. The thermal conditioning system of any of clauses 91 to 93, comprising a second heat exchanger (1912); the second heat exchanger being arranged to thermally condition the oxidant prior to being fed to the stack assembly.
95. The thermal conditioning system of any of clauses 91 to 94, comprising a combustor or combustion cell of any of clauses 62 to 90 to thermally condition the oxidant.
96. The thermal conditioning system of any of clauses 91 to 95, comprising a reactant input and an oxidant input; the reactant input being coupled to receive at least one, or both, of the reactant and chemical coolant reformate from the stack assembly, and the oxidant input being arranged to receive the oxidant from the stack assembly.

### Compressor, Turbine and Combustor

97. A system comprising: a stack as claimed in any of clauses 22 to 37, a thermal conditioning system as claimed in any of clauses 91 to 96, a compressor arranged to supply compressed oxidant to the methanator, and a turbine arranged to drive the compressor in response to received oxidant.

### Chemical Coolant Catalyst Layer and Chemical Coolant Barrier Characteristics

98. The stack of any of clauses 22 to 37, further comprising a chemical coolant cell inert permeable barrier, to host a chemical coolant cell inert permeable barrier pathway, disposed at one, or both, of: an inlet or an outlet of the chemical coolant cell.
99. The stack of clause 98, in which the chemical coolant cell inert permeable barrier is a permeable wall of at least one, or both, of: a permeable chemical coolant supply channel or a permeable chemical coolant exhaust channel.
100. The stack of any of either of clauses 98 to 99, in which the permeable chemical coolant catalyst layer pathway and permeable chemical coolant catalyst layer are related, or defined, by

$$\frac{{τ}_{cc}^{2}}{{ε}_{cc}} \frac{{d}_{cc}^{2}}{{f}_{cc}^{2} {t}_{cc}^{3}} ,$$

which relates the geometric parameters of the permeable chemical coolant catalyst layer and associated pathway to the operational parameters of the chemical coolant cell,
   and
   in which the chemical coolant cell inert permeable barrier, which hosts a chemical coolant cell inert permeable barrier pathway, over a chemical coolant catalyst layer inlet or outlet, which are related, or defined, by

$$\frac{{d}_{ccb} {d}_{cc} {τ}_{ccb}^{2}}{{t}_{cc} {ε}_{ccb}} ,$$

which relates the geometric parameters of the chemical coolant cell inert permeable barrier and its associated pathway to the operational parameters of the chemical coolant cell and barriers,
where
τ_{cc} is the permeable chemical coolant catalyst layer pathway tortuosity in the chemical coolant flow direction,
τ_{ccb} is the chemical coolant cell inert permeable barrier pathway tortuosity in the chemical coolant flow direction,
ε_{cc} is the permeable chemical coolant catalyst layer porosity,
ε_{ccb} is the chemical coolant cell inert permeable barrier porosity,
d_{cc} is the permeable chemical coolant catalyst layer depth in the chemical coolant flow direction,
d_{ccb} is the permeable chemical coolant cell inert permeable barrier depth in the chemical coolant flow direction,
t_{cc} is the permeable chemical coolant catalyst layer thickness,
f_{cc} is the ratio of permeable chemical coolant catalyst layer pathway pore size to permeable chemical coolant catalyst layer thickness, t_{cc}.
101. The stack of clause 100, in which the permeable chemical coolant catalyst layer thickness, t_{cc}, is arranged to provide a balance between reaction time contact via a catalyst or reaction contact surface, in-plane sheet electrical conductance and in-plane thermal conduction, which follows from increasing the permeable chemical coolant catalyst layer (306.4) thickness, with ensuring a compact design providing power density, which follows from decreasing permeable chemical coolant catalyst layer 306.4 thickness; and/or in which the permeable chemical coolant catalyst layer thickness, t_{cc}, has a range of 5 μm to 1000 μm, optionally, 5 μm to 700 μm, optionally 10 μm to 300 μm.
102. The stack of any of clauses 100 to 101, in which the ratio

$$\frac{{τ}_{cc}^{2}}{{ε}_{cc} {f}_{cc}^{2}}$$

influences the balance between an additional, preferably, smaller, flow resistance provided by the permeable chemical coolant catalyst layer pathway while providing structural strength and in-plane sheet electrical conductance and in-plane thermal conduction; and/or in which the ratio

$$\frac{{τ}_{cc}^{2}}{{ε}_{cc} {f}_{cc}^{2}}$$

has a range of 1 to 500, optionally, 2 to 50.
103. The stack of any of clauses 100 to 102, in which the permeable chemical coolant catalyst layer depth, d_{cc}, is established to balance cell handling capabilities and power density, and/or
   in which the permeable chemical coolant catalyst layer depth, d_{cc}, has a range of 0.25 mm to 40 mm, optionally, 0.25 mm to 20 mm and, preferably, of 5 mm to 20 mm.
104. The stack of any of clauses 100 to 103, in which the ratio

$$\frac{{d}_{ccb} {τ}_{ccb}^{2}}{{ε}_{ccb}}$$

is associated with a range of effective pathway depths in the flow direction of the chemical coolant cell inert permeable barrier pathway to at least reduce, or eliminate, diffusion effects, and/or in which the ratio

$$\frac{{d}_{ccb} {τ}_{ccb}^{2}}{{ε}_{ccb}}$$

has a range of 1 to 1000 mm, optionally, 5 to 200 mm and, preferably 5 to 100 mm, and more preferably less than 100 mm.
105. The stack of any of clauses 100 to 104, in which the ratio, f_{cc}, of permeable chemical coolant catalyst layer pathway pore size to permeable chemical coolant catalyst layer thickness, t_{cc}, is selected to balance flow resistance with providing structural strength and in-plane sheet electrical conductance to influence or constrain electrical resistive losses, and/or
   in which the ratio, f_{cc}, of permeable chemical coolant catalyst layer pathway pore size to permeable chemical coolant catalyst layer thickness, t_{cc}, has a range of 0.02 to 1, and, preferably, 0.25 to 0.75.
106. The stack of any of clauses 100 to 105, in which the permeable chemical coolant catalyst layer pathway tortuosity, τ_{cc}, is selected to balance flow resistance and catalyst or reaction contact surface against structural strength and in-plane sheet electrical conductance of at least the permeable chemical coolant catalyst layer, and/or
   in which the permeable chemical coolant catalyst layer pathway tortuosity, τ_{cc}, has a range of 1 to 3, optionally, 1 to 2.5, and, preferably, 1 to 2.
107. The stack of any of clauses 100 to 106, in which the chemical coolant cell inert permeable barrier pathway tortuosity, τ_{ccb}, is arranged to increase the effective pathway depth of the chemical coolant cell inert permeable barrier to at least reduce, and, preferably, eliminate, diffusion of any gas species, and/or
   in which the chemical coolant cell inert permeable barrier pathway tortuosity, τ_{ccb}, has a range of 1 to 10, preferably, 1 to 5.
108. The stack of any of clauses 100 to 107, in which the permeable chemical coolant catalyst layer porosity, ε_{cc}, is selected balance flow resistance against structural strength and in-plane sheet electrical conductance of at least one, or both, of: the permeable chemical coolant catalyst layer and in-plane sheet electrical resistance of the permeable chemical coolant catalyst layer, and/or
   in which the permeable chemical coolant catalyst layer porosity, ε_{cc}, has a range of 0.1 to 0.9, and, preferably, 0.5 to 0.8.
109. The stack of any of clauses 100 to 108, in which the chemical coolant cell inert permeable barrier porosity, ε_{ccb}, has a lower bound to accommodate a barrier comprising an orifice plate or foraminate plate and an upper bound to accommodate higher tortuosity materials, and/or
   in which the chemical coolant cell inert permeable barrier porosity, ε_{ccb}, has a range of 0.01 to 0.5, and, preferably, 0.05 to 0.5.
110. The stack of any of clauses 100 to 109, in which the chemical coolant cell inert permeable barrier depth, d_{ccb}, can be set to achieve a balance, at a lower limit, between an increase in effective depth to limit diffusion of any gas species, with, at an upper limit, constraining the size of the chemical coolant cell inert permeable barrier such that it has a volume smaller than an associated fuel cell, and/or
   in which the chemical coolant cell inert permeable barrier depth, d_{ccb}, is greater or equal to 0.01 mm, optionally 0.01 mm to 5 mm and, preferably, in the range 0.1 to 2 mm inclusive.
111. The stack of any of clauses 100 to 110, in which the ratio

$$\frac{{τ}_{cc}^{2}}{{ε}_{cc}} \frac{{d}_{cc}^{2}}{{f}_{cc}^{2} {t}_{cc}^{3}} ,$$

which relates the geometric parameters of the permeable chemical coolant catalyst layer and its associated pathway to the operational parameters of the chemical coolant cell has a range of 1e6/m to 5e12/m, optionally, 1e8/m to 5e11/m and, preferably 1e9/m to 1e11/m.
112. The stack of any of clauses 100 to 111, in which the ratio

$$\frac{{d}_{ccb} {d}_{cc} {τ}_{ccb}^{2}}{{t}_{cc} {ε}_{ccb}} ,$$

which relates the geometric parameters of the chemical coolant cell inert permeable barrier and its associated pathway to the operational parameters of the chemical coolant cell and barriers has a range of 0.1 m to 250 m, optionally, 0.5 m to 50 m and, preferably 1 m to 25 m.

### Independent Chemical Cooling Cell

113. A chemical coolant cell for cooling a fuel cell; the chemical coolant cell comprising:
   a. a permeable chemical coolant catalyst layer for carrying a chemical coolant that undergoes endothermic reactions within the permeable chemical coolant catalyst layer using heat generated by the fuel cell;
   b. the permeable chemical coolant cell comprising a surface for thermally coupling the heat from the fuel cell to support the endothermic reactions.
114. The chemical coolant cell as claimed in clause 113, in which the permeable chemical coolant catalyst layer is for carrying the chemical coolant to thermally condition the fuel cell.
115. The chemical coolant cell as claimed in clause 114, in which the permeable chemical coolant catalyst layer is disposed between a pair of layers; optionally, at least one, or both, of: interconnect layers, or permeable or solid conductor layers.
116. The chemical coolant cell as claimed in either of clauses 114 and 115, further comprising at least one fuel cell; the chemical coolant cell being disposed at least adjacent to the at least one fuel cell, or disposed between a pair of adjacent fuel cells of the at least one fuel cell; optionally with a dense layer being disposed between the chemical coolant cell and said at least one fuel cell or pair of adjacent fuel cells.
117. The chemical coolant cell of any of clauses 114 to 116, further comprising a chemical coolant cell inert permeable barrier disposed at least one, or both, of: at an inlet or at an outlet of the chemical coolant cell.
118. The chemical coolant cell of any of clauses 113 to 117, in which the inert permeable barrier layer is a permeable wall of at least one, or both, of: a permeable chemical coolant supply channel or a permeable chemical coolant exhaust channel.
119. The chemical coolant cell of either of clauses 117 to 118, in which the permeable chemical coolant catalyst layer hosts a permeable chemical coolant catalyst layer reactant pathway, which are related, or defined, by

$$\frac{{τ}_{cc}^{2}}{{ε}_{cc}} \frac{{d}_{cc}^{2}}{{f}_{cc}^{2} {t}_{cc}^{3}} ,$$

which relates the geometric parameters of the chemical coolant catalyst layer and associated pathway to the operational parameters of the chemical coolant cell, and
   in which the chemical coolant cell inert permeable barrier hosts a chemical coolant cell inert permeable barrier pathway over a chemical coolant catalyst layer inlet or outlet; the chemical coolant cell inert permeable barrier and the chemical coolant cell inert permeable barrier pathway are related, or defined, by

$$\frac{{d}_{ccb} {d}_{cc} {τ}_{ccb}^{2}}{{t}_{cc} {ε}_{ccb}} ,$$

which relates the geometric parameters of the chemical coolant cell inert permeable barrier and its associated pathway to the operational parameters of the chemical coolant cell and barriers,
where
τ_{cc} is the permeable chemical coolant catalyst layer pathway tortuosity in the chemical coolant flow direction,
τ_{ccb} is the chemical coolant cell inert permeable barrier pathway tortuosity in the chemical coolant flow direction,
ε_{cc} is the permeable chemical coolant catalyst layer porosity,
ε_{ccb} is the chemical coolant cell inert permeable barrier porosity,
d_{cc} is the permeable chemical coolant catalyst layer depth in the chemical coolant flow direction,
d_{ccb} is the chemical coolant cell inert permeable barrier depth in the chemical coolant flow direction,
t_{cc} is the permeable chemical coolant catalyst layer thickness,
f_{cc} is the ratio of permeable chemical coolant catalyst layer pathway pore size to permeable chemical coolant catalyst layer thickness, t_{cc}.
120. The chemical coolant cell of clause 119, in which the permeable chemical coolant catalyst layer thickness, t_{cc}, has a range of 5 μm to 1000 μm, optionally, 5 μm to 700 μm, optionally 10 μm to 300 μm.
121. The chemical coolant cell of any of clauses 119 to 120, in which the ratio

$$\frac{{τ}_{cc}^{2}}{{ε}_{cc} {f}_{cc}^{2}}$$

has a range of 1 to 500, optionally, 2 to 50.
122. The chemical coolant cell of any of clauses 119 to 121, in which the permeable chemical coolant catalyst layer depth, d_{cc}, has a range of 0.25 mm to 40 mm, optionally, 0.25 mm to 20 mm, and optionally, or preferably, of 5 mm to 20 mm.
123. The chemical coolant cell of any of clauses 119 to 122, in which the ratio

$$\frac{{d}_{ccb} {τ}_{ccb}^{2}}{{ε}_{ccb}}$$

has a range of 1 to 1000 mm, optionally, 5 to 200 mm and, preferably 5 to 100 mm, and more preferably less than 100 mm.
124. The chemical coolant cell of any of clauses 119 to 123, in which the ratio, f_{cc}, of permeable chemical coolant catalyst layer pathway pore size to permeable chemical coolant catalyst layer thickness, t_{cc}, has a range of 0.02 to 1, and, preferably, 0.25 to 0.75.
125. The chemical coolant cell of any of clauses 119 to 124, in which the permeable chemical coolant catalyst layer pathway tortuosity, τ_{cc}, has a range of 1 to 3, optionally, 1 to 2.5, and, preferably, 1 to 2.
126. The chemical coolant cell of any of clauses 119 to 125, in which the chemical coolant cell inert permeable barrier pathway tortuosity, τ_{ccb}, has a range of 1 to 10, preferably, 1 to 5.
127. The chemical coolant cell of any of clauses 119 to 126, in which the permeable chemical coolant catalyst layer porosity, ε_{cc}, has a range of 0.1 to 0.9, and, preferably, 0.5 to 0.8.
128. The chemical coolant cell of any of clauses 119 to 127, in which the chemical coolant cell inert permeable barrier porosity, ε_{ccb}, has a range of 0.01 to 0.5, and, preferably, 0.05 to 0.5.
129. The chemical coolant cell of any of clauses 119 to 128, in which the chemical coolant cell inert permeable barrier depth, d_{ccb}, is greater or equal to 0.01 mm, optionally 0.01 mm to 5 mm and, preferably, in the range 0.1 to 2 mm inclusive.
130. The chemical coolant cell of any of clauses 119 to 129, in which the ratio

$$\frac{{τ}_{cc}^{2}}{{ε}_{cc}} \frac{{d}_{cc}^{2}}{{f}_{cc}^{2} {t}_{cc}^{3}}$$

has a range of 1e6/m to 5e12/m, optionally, 1e8/m to 5e11/m and, preferably 1e9/m to 1e11/m.
131. The chemical coolant cell of any of clauses 119 to 130, in which the ratio

$$\frac{{d}_{ccb} {d}_{cc} {τ}_{ccb}^{2}}{{t}_{cc} {ε}_{ccb}}$$

has a range of 0.1 m to 250 m, optionally, 0.5 m to 50 m and, preferably 1 m to 25 m.
132. A chemical coolant cell assembly comprising a set of chemical coolant cells comprising
   c. at least one chemical coolant cell as claimed in any of clauses 113 to 131,
   d. at least one coolant supply channel (coolant+) and at least one coolant exhaust channel (coolant−); the at least one coolant supply channel and the at least one coolant exhaust channel being coupled via the set of chemical coolant cells.
133. The chemical coolant cell assembly of clause 132, in which the set of chemical coolant cells comprises a plurality of said chemical coolant cells, optionally transversely or longitudinally disposed relative to the chemical coolant supply channel.
134. A multi-layered structure for a fuel cell comprising a
   a first cell for generating electricity, the first cell comprising
      i. reactant electrode for reacting a reactant,
      ii. an oxidant electrode for reacting an oxidant, and
      iii. an electrolyte disposed between the reactant electrode and the oxidant electrode,
      iv. wherein the first cell generates electricity using reaction processes associated with the reactant and oxidant; the reaction processes generate heat; and
   the chemical coolant cell or a chemical coolant cell assembly of any of clauses 113 to 133 that are thermally coupled to the first cell to receive the heat generated by the reaction processes and to use the received heat to support endothermic reactions involving the chemical coolant within the chemical coolant cell.

### Thermal Conditioning—Independent Cooling Loop

135. A thermal conditioning system for use with a fuel cell; the thermal conditioning system comprising:
   a cooling circuit thermally coupled to the fuel cell; the cooling circuit being arranged to remove heat from the fuel cell using an endothermic reaction associated with a chemical coolant that produces a chemical coolant reformate, and being independently operable of at least one, or both, of: a reactant supply/exhaust and an oxidant supply/exhaust associated with the fuel cell.
136. The thermal conditioning system as claimed in clause 135, in which the cooling circuit comprises a chemical cooling cell of any of clauses 113 to 131 or chemical coolant cell assembly of any of clauses 132 to 133.
137. The thermal conditioning system as claimed in either of clauses 135 and 136, in which the cooling circuit comprises a methanator to recover the reactant from the chemical coolant reformate associated with the chemical coolant and to thermally condition an oxidant or other heat transfer medium.
138. The thermal conditioning system of clause 137, comprising a first heat exchanger to thermally condition (such as cool) the reformate associated with the chemical coolant prior to being input to the methanator via a first methanation catalyst layer inlet.
139. The thermal conditioning system of clause 138, in which the first heat exchanger is arranged to thermally condition (such as heat) the chemical coolant.
140. The thermal conditioning system of any of clauses 137 to 139, comprising a second heat exchanger; the second heat exchanger being arranged to thermally condition (such as heat) the oxidant prior to being fed to the stack assembly.
141. The thermal conditioning system of any of clauses 135 to 140, comprising a combustor, combustion cell, or combustion cell-oxidant cell combination to thermally condition the oxidant.
142. The thermal conditioning system of clause 141, in which the combustor is a combustor, combustion cell, or combustion cell-oxidant cell combination of any of clauses 62 to 90.
143. The thermal conditioning system of either of clauses 135 and 142, comprising a reactant input and an oxidant input; the reactant input being coupled to receive the chemical coolant reformate from the stack assembly, and the oxidant input being arranged to receive the oxidant from the stack assembly.

### Methanator Cell Clauses: Methanation Catalyst Cell and Oxidant Cell

144. A methanation cell for a methanator; the methanation cell comprising
   e. a permeable methanation catalyst layer, to host a permeable methanation catalyst layer pathway, for reacting a chemical coolant reformate to recover a chemical coolant from the chemical coolant reformate; the permeable methanation catalyst layer comprising a methanation catalyst layer inlet to receive the chemical coolant reformate and a methanation catalyst layer outlet to output the chemical coolant derived from the chemical coolant reformate;
   f. at least one adjacent dense layer; the dense layer being impermeable to at least one, or both, of: the reformate and the chemical coolant.

### Methanation Catalyst Layer

145. The methanation cell of clause 144, in which the permeable methanation catalyst layer pathway and permeable methanation catalyst layer are related, or defined, by

$$\frac{{τ}_{m}^{2}}{{ε}_{m}} \frac{{d}_{m}^{2}}{{f}_{m}^{2} {t}_{m}^{3}} ,$$

which relates the geometric parameters of the permeable methanation catalyst layer and its associated pathway to the operational parameters of the methanation cell, where
   τₘ is the permeable methanation catalyst layer pathway tortuosity in the chemical coolant reformate flow direction,
   εₘ is the permeable methanation catalyst layer porosity,
   tₘ is the permeable methanation catalyst layer thickness,
   dₘ is the permeable methanation catalyst layer depth in the chemical coolant reformate flow direction,
   fₘ is the ratio of the permeable methanation catalyst layer pathway pore size to the permeable methanation catalyst layer thickness, tₘ.
146. The methanator of clause 145, in which the permeable methanation catalyst layer thickness, tₘ, has a range of 5 μm to 5000 μm, optionally, 10 μm to 800 μm, optionally, 50 μm to 300 μm.
147. The methanator of either of clauses 145 and 146, in which the ratio

$$\frac{{τ}_{m}^{2}}{{ε}_{m} {f}_{m}^{2}}$$

has a range of 1 to 500, optionally, 2 to 50.
148. The methanator of any of clauses 145 to 147, in which the permeable methanation catalyst layer depth, dₘ, has a range of 0.25 mm to 40 mm, optionally, 0.25 mm to 20 mm and, preferably, 5 mm to 20 mm.
149. The methanator of any of clauses 145 to 148, in which the ratio, fₘ, of the permeable methanation catalyst layer pathway pore size to the permeable methanation catalyst layer thickness, tₘ, has a range of 0.02 to 1, and, preferably, 0.25 to 0.75.
150. The methanator of any of clauses 145 to 149, in which the permeable methanation catalyst layer pathway tortuosity, τₘ, has a range of 1 to 3, optionally, 1 to 2.5, and, preferably, 1 to 2.
151. The methanator of any of clauses 145 to 150, in which the permeable methanation catalyst layer porosity, εₘ, has a range of 0.1 to 0.9, and, preferably, 0.5 to 0.8.
152. The methanator of any of clauses 145 to 151, in which the ratio

$$\frac{{τ}_{m}^{2}}{{ε}_{m}} \frac{{d}_{m}^{2}}{{f}_{m}^{2} {t}_{m}^{3}}$$

has a range of 1e6/m to 5e12/m, optionally, 1e8/m to 5e11/m and, preferably 5e8/m to 1e11/m.

### Methanator Barrier Layers

153. The methanator of any of clauses 145 to 152, further comprising at least one, or both, of: first and second methanator inert permeable barriers, at the methanation catalyst layer inlet and the first methanation catalyst layer outlet respectively, to host respective methanator inert permeable barrier pathways, which are related, or defined, by

$$\frac{{d}_{mb} {d}_{m} {τ}_{mb}^{2}}{{t}_{m} {ε}_{mb}} ,$$

which relates the geometric parameters of the methanator inert permeable barrier and its associated pathway to the operational parameters of the methanation cell and barriers,
   where
   τ_{mb} is the methanator inert permeable barrier pathway tortuosity in the chemical coolant reformate flow direction,
   ε_{mb} is the methanator inert permeable barrier porosity,
   d_{mb} is the methanator inert permeable barrier depth in the chemical coolant reformate flow direction.
154. The methanator of any of clauses 153 to 153, in which the ratio

$$\frac{{d}_{mb} {τ}_{mb}^{2}}{{ε}_{mb}}$$

has a range of 0.4 to 500 mm, optionally, 2 to 100 mm and, preferably 5 to 50 mm, and more preferably less than 50 mm.
155. The methanator of any of clauses 153 to 154, in which the methanator inert permeable barrier pathway tortuosity, τ_{mb}, has a range of 1 to 10, optionally, 1 to 5.
156. The methanator of any of clauses 153 to 155, in which the methanator inert permeable barrier porosity, ε_{mb}, has a range of 0.01 to 0.5, and, preferably, 0.05 to 0.5.
157. The methanator of any of clauses 153 to 156, in which the methanator inert permeable barrier depth, d_{mb}, is greater or equal to 0.01 mm, optionally 0.01 mm to 5 mm and, preferably, in the range 0.1 to 2 mm inclusive.
158. The methanator of any of clauses 153 to 157, in which the ratio

$$\frac{{d}_{mb} {d}_{m} {τ}_{mb}^{2}}{{t}_{m} {ε}_{mb}}$$

has a range of 0.02 m to 100 m, optionally, 0.1 m to 20 m and, preferably 1 m to 10 m.

### Dense Layer Either Side

159. The methanator of any of clauses 145 to 158, in which the at least one adjacent dense layer comprises two such dense layers having the permeable methanation catalyst layer disposed between the two dense layers.

### Oxidant Cells for Methanator

160. An oxidant cell (such as, for example, for a methanator or a combustor); the oxidant cell comprising
   g. a permeable oxidant layer for bearing an oxidant; the permeable oxidant layer comprising:
      i. a permeable oxidant layer inlet for oxidant ingress,
      ii. a permeable oxidant layer outlet for oxidant egress, and
      iii. a permeable oxidant layer oxidant pathway between the inlet and outlet,
   h. at least one adjacent dense layer thermally coupled to the permeable oxidant layer; the at least one adjacent dense layer being impermeable to at least the oxidant and presenting a heat transfer surface to transfer heat into the permeable oxidant layer.

### Oxidant Cell Characteristics

161. The oxidant cell of clause 160, in which the permeable oxidant layer oxidant pathway and the permeable oxidant layer are related, or defined, by

$$\frac{{τ}_{mo}^{2}}{{ε}_{mo}} \frac{{w}_{mo}^{2}}{{f}_{mo}^{2} {t}_{mo}^{3}} ( {m}^{- 1} ) ,$$

which relates the geometric parameters of the permeable oxidant layer and its associated pathway to the operational parameters of the oxidant cell,
   where
   τₘₒ is the permeable oxidant layer oxidant pathway tortuosity in the oxidant flow direction,
   εₘₒ is the permeable oxidant layer porosity,
   wₘₒ is the permeable oxidant layer width in the oxidant flow direction,
   tₘₒ is the permeable oxidant layer thickness,
   fₘₒ is the ratio of permeable oxidant layer pathway pore size to permeable oxidant layer thickness, tₘₒ.
162. The oxidant cell of clause 161, in which the permeable oxidant layer thickness, tₘₒ, has a range of 20 μm to 5000 μm, optionally, 20 μm to 1600 μm, and preferably, 50 μm to 600 μm.
163. The oxidant cell of either of clauses 161 and 162, in which the ratio

$$\frac{{τ}_{mo}^{2}}{{ε}_{mo} {f}_{mo}^{2}}$$

has a range 1 to 500, optionally, 2 to 50.
164. The oxidant cell of any of clauses 161 to 163, in which the permeable oxidant layer width, wₘₒ, has a range of 0.25 mm to 40 mm, optionally, 0.25 mm to 20 mm and, preferably, 5 mm to 20 mm.
165. The oxidant cell of any of clauses 161 to 164, in which the ratio, fₘₒ, of permeable oxidant layer pathway pore size to permeable oxidant layer thickness, tₘₒ, has a range of 0.02 to 1, and, preferably, a range of 0.25 to 0.75.
166. The oxidant cell of any of clauses 161 to 165, in which the permeable oxidant layer oxidant pathway tortuosity, τₘₒ, has a range of 1 to 3, optionally, 1 to 2.5, and, preferably, 1 to 2.
167. The oxidant cell of any of clauses 161 to 166, in which the permeable oxidant layer porosity, εₘₒ, has a range of 0.1 to 0.9, and, preferably, 0.5 to 0.8.
168. The oxidant cell of any of clauses 161 to 167 in which the ratio

$$\frac{{τ}_{mo}^{2}}{{ε}_{mo}} \frac{{w}_{mo}^{2}}{{f}_{mo}^{2} {t}_{mo}^{3}}$$

has a range of 1e5/m to 5e11/m, optionally, 1e7/m to 5e10/m and, preferably 5e7/m to 1e10/m.
169. A multi-layered structure fuel cell comprising:
   an electrolyte;
   a permeable cathode electrode;
   an inert permeable barrier;
   the permeable cathode electrode and electrolyte having a common interface to form a reaction region;
   the permeable cathode electrode providing a permeable cathode electrode reactant pathway through the electrode to present a reactant at the common interface; the permeable cathode electrode reactant pathway being fed by a permeable cathode reactant pathway hosted by a permeable cathode reactant pathway structure.
170. The multi-layered structure of clause 169, in which the permeable cathode reactant pathway and the permeable cathode reactant pathway structure are related, or defined, by

$$\frac{{τ}_{c}^{2}}{{ε}_{c}} \frac{{w}_{c}^{2}}{{f}_{c}^{2} {t}_{c}^{3}} ,$$

which relates the geometric parameters of the permeable cathode reactant pathway and its associated pathway structure to respective operating parameters,
   where
   τ_{c} is the permeable cathode reactant pathway tortuosity in an oxidant flow direction,
   ε_{c} is the permeable cathode reactant pathway structure porosity,
   w_{c} is the permeable cathode reactant pathway structure width in the oxidant flow direction,
   t_{c} is the permeable cathode reactant pathway structure thickness,
   f_{c} is the ratio of permeable cathode reactant pathway pore size to permeable cathode reactant pathway structure thickness, t_{c}.
171. The multi-layered structure of clause 170, in which the ratio

$$\frac{{τ}_{c}^{2}}{{ε}_{c}} \frac{{w}_{c}^{2}}{{f}_{c}^{2} {t}_{c}^{3}}$$

has a range of 1e6/m to 5e12/m, optionally, 1e8/m to 5e11/m and, preferably 1e9/m to 2e11/m.
172. The multi-layered structure of any of clauses 169 and 171, in which the permeable cathode reactant pathway structure thickness, t_{c}, has a predetermined thickness arranged to balance cell packing density, or power density, following from a relatively smaller structure thickness, and in-plane sheet electrical conductance, following from a relatively larger structure thickness to reduce electrical resistive losses.
173. The multi-layered structure of any of clauses 169 to 172, in which the permeable cathode reactant pathway structure thickness, t_{c}, has a range of 10 μm to 1000 μm, optionally, 10 μm to 600 μm and, preferably, 20 μm to 250 μm;
174. The multi-layered structure of any of clauses 169 to 173, in which the range of permeable cathode reactant pathway structure thickness, t_{c}, is greater than the range of the permeable anode reactant pathway thickness, tₚ, since the cathode provides a greater gas flow capacity and lower material electrical and thermal conductivity.
175. The multi-layered structure of any of clauses 169 to 174, in which the ratio

$$\frac{{τ}_{c}^{2}}{{ε}_{c} {f}_{c}^{2}}$$

influences the balance between an additional, preferably, smallest, flow resistance provided by the permeable cathode reactant pathway structure while providing structural strength and in-plane electrical sheet conductance to balance electrical resistive losses;
176. The multi-layered structure of any of clauses 169 to 175, the ratio

$$\frac{{τ}_{c}^{2}}{{ε}_{c} {f}_{c}^{2}}$$

has a range of 1 to 500, optionally, 2 to 50.
177. The multi-layered structure of any of clauses 169 to 176, in which the permeable cathode reactant pathway structure width, w_{c}, is selected to balance cell handling capabilities and power density; and/or
   in which the permeable cathode reactant pathway structure width, w_{c}, has a range of 0.25 mm to 40 mm, optionally, 0.25 mm to 20 mm and, preferably, 5 mm to 20 mm.
178. The multi-layered structure of any of clauses 169 to 177, in which the ratio, f_{c}, of permeable cathode reactant pathway pore size to permeable cathode reactant pathway structure thickness, t_{c}, is selected to balance flow resistance with providing structural strength and in-plane electrical sheet conductance to influence or constrain electrical resistive losses.
179. The multi-layered structure of any of clauses 169 to 178, in which the ratio, f_{c}, of permeable cathode reactant pathway pore size to permeable cathode reactant pathway structure thickness, t_{c}, has a range of 0.02 to 1, and, preferably, 0.25 to 0.75.
180. The multi-layered structure of any of clauses 169 to 179, in which the permeable cathode reactant pathway tortuosity, τ_{c}, is arranged to at least reduce, preferably minimise, flow resistance, and, therefore, pressure drops across the permeable cathode reactant pathway.
181. The multi-layered structure of any of clauses 169 to 180, in which the permeable cathode reactant pathway tortuosity, τ_{c}, has a range of 1 to 3, optionally, 1 to 2.5 and, preferably, 1 to 2.
182. The multi-layered structure of any of clauses 169 to 181, in which the permeable cathode reactant pathway structure porosity, ε_{c}, is selected balance flow resistance against structural strength and in-plane sheet electrical conductance of the permeable cathode reactant pathway structure.
183. The multi-layered structure of any of clauses 169 to 182, in which the permeable cathode reactant pathway structure porosity, ε_{c}, has a range of 0.1 to 0.9, and, preferably, 0.5 to 0.8.
184. A multi-layered structure, cell, stack, half-cell, array of any preceding clause, wherein the multi-layered structure, cell, stack, half-cell, array, has at least one, or more than one, line of symmetry.
185. A multi-layered structure, cell, stack, half-cell, array of any preceding clause, wherein the multi-layered structure, cell, stack, half-cell, array has at least one, or more than one, of: internal manifolds and external manifolds.

### Method Clauses—A Set for Each Structure.

### Anode Clauses

186. A method of operating a fuel cell, the method comprising
   a. maintaining an operating environment within the fuel cell having an operating parameter space defined by:

$$\frac{Δ {pU}_{f}}{i} \frac{p}{T} \frac{F}{32 μ R} = c ,$$

b. where
   i. p is the absolute pressure,
   ii. Δp is pressure drop across the fuel cell (in the reactant flow direction)
   iii. F is Faraday's constant,
   iv. U_{f} is a utilisation factor indicating the proportion of the supplied reactant consumed by the fuel cell,
   v. R is the gas constant,
   vi. T is the temperature,
   vii. p is the reactant gas dynamic viscosity,
   viii. i is the current density

$$( \frac{A}{{m}^{2}} ) ,$$

and
ix. c is a constant.

### Anode Operating Parameters

187. The method of clause 186, in which
   c. c has a value in the range 5e6/m to 5e13/m, optionally, 5e8/m to 5e12/m and, preferably 1e10/m to 1e12/m.
188. The method of either of clauses 186 and 187, in which
   d. p, the absolute pressure, has a range of 1 bar to 50 bar, preferably 5 bar to 25 bar.
189. The method of any of clauses 186 to 188, in which
   e. Δp, the pressure drop, has a range of 10 mbar to 1000 mbar, preferably 20 mbar to 300 mbar.
190. The method of any of clauses 186 to 189, in which
   f. U_{f}, the utilisation factor, has a value in the range of 0.1 to 1.0, preferably 0.33 to 0.95.
191. The method of any of clauses 186 to 190, in which
   g. T, the temperature, has a value in the range of 930 °C to 450 °C, preferably 900 °C to 580 °C.
192. The method of any of clauses 186 to 191, in which
   h. μ the reactant gas dynamic viscosity, has a value in the range 5e-5 Pa·s to 1e-5 Pa·s, preferably, 4e-5 Pa·s to 2e-5 Pa·s.
193. The method of any of clauses 186 to 192, in which
   i. i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
194. The method of any of clauses 186 to 193, in which

$$\frac{Δ {pU}_{f}}{i} \frac{p}{T} \frac{F}{32 μ R} = c = \frac{{τ}_{e}^{2}}{{ε}_{e}} \frac{{d}_{e}^{2}}{{f}_{e}^{2} {t}_{e}^{3}} ( {m}^{- 1} ) ,$$

where
   j. τₑ is the permeable anode reactant pathway tortuosity in the reactant flow direction,
   k. εₑ is permeable anode reactant pathway structure porosity,
   l. dₑ is the permeable anode reactant pathway structure depth in the reactant flow direction,
   m. tₑ is the permeable anode reactant pathway structure thickness,
   n. fₑ is the ratio of permeable anode reactant pathway pore size to permeable anode reactant pathway structure thickness, tₑ.

### Geometric Parameters

195. The method of clause 194 in which,
   o. τₑ, the permeable anode reactant pathway tortuosity in the reactant flow direction, has a range of 1<τₑ<3, optionally, 1<τₑ<2.5, and, preferably, 1<τₑ<2.
196. The method of either of clauses 194 and 195, in which
   p. εₑ, the permeable anode reactant pathway structure porosity, has a range of 0.1<εₑ<0.9 and preferably 0.5<εₑ<0.8.
197. The method of any of clauses 194 to 196, in which
   q. dₑ, the permeable anode reactant pathway structure depth in the reactant flow direction, has a range of 0.25<dₑ<40 (mm), optionally, 0.25<dₑ<20 (mm), and, preferably 5<dₑ<20 (mm).
198. The method of any of clauses 194 to 197, in which
   r. tₑ, the permeable anode reactant pathway structure thickness, has a range of 5<tₑ<1000 (μm), optionally, 5<tₑ<500 (μm) and, preferably 10<tₑ<150 (μm).
199. The method of any of clauses 194 to 198, in which
   s. fₑ, the ratio of permeable anode reactant pathway pore size to permeable anode reactant pathway structure thickness, tₑ, has a range of 0.02<fₑ<1.0, and, preferably, 0.25<fₑ<0.75.
200. The method of any of clauses 186 to 199, in which

$$\frac{p Δ {pFU}_{f}}{RT 32 μ i} = c = \frac{{τ}_{e}^{2}}{{ε}_{e}} \frac{{d}_{e}^{2}}{{f}_{e}^{2} {t}_{e}^{3}} ( {m}^{- 1} )$$

has a range of 5e6/m to 5e13/m, optionally, 5e8/m to 5e12/m and, preferably 1e10/m to 1e12/m.

### Barrier Clauses

201. The method of any of clauses 186 to 200, comprising
   t. maintaining an operating environment within an inert permeable barrier having a parameter space defined by

$$\frac{{Pe}_{m} {FpDU}_{f}}{RTi} = {c}_{1} . \qquad i$$

u. where
   i. Peₘ is the mass Peclet number,
   ii. F is Faraday's constant,
   iii. p is the absolute pressure,
   iv. D is a mass diffusion coefficient of a reactant gas species,
   v. U_{f} is the utilisation factor indicating the proportion of the supplied reactant consumed by the fuel cell,
   vi. R is the gas constant,
   vii. T is the temperature, and
   viii. i is the current density

$$( \frac{A}{{m}^{2}} ) .$$

202. The method of clause 201, in which

$$\frac{{Pe}_{m} {FpDU}_{f}}{RTi} = {c}_{1} ( m ) ,$$

has a range of 0.2 m to 1000 m, optionally, 1 m to 200 m and preferably, 10 m to 100 m.
203. The method of either of clauses 201 and 202, in which
   Peₘ, the mass Peclet number, has a value in the range of 2 to 500, preferably, 5 to 50.
204. The method of any of clauses 201 to 203, in which
   p, the absolute pressure, has a value of in the range of 1 bar to 50 bar, preferably, 5 bar to 25 bar.
205. The method of any of clauses 201 to 204, in which
   D, the mass diffusion coefficient of a reactant gas species, has a value in the range of 1e-3 m²/s to 1e-4 m²/s, preferably 8e-4 m²/s to 1e-4 m²/s.
206. The method of any of clauses 201 to 205, in which
   U_{f}, the utilisation factor, has a value in the range of 0.1 to 1.0, preferably 0.33 to 0.95.
207. The method of any of clauses 201 to 206, in which
   T, the temperature, has a value in the range of 930 °C to 450 °C, preferably 900 °C to 580 °C.
208. The method of any of clauses 201 to 207 in which
   i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
209. The method of any of clauses 201 to 208, in which

$$\frac{{Pe}_{m} {FpDU}_{f}}{RTi} = {c}_{1} = \frac{{d}_{b} {d}_{e} {τ}_{b}^{2}}{{t}_{e} {ε}_{b}} ( m ) ,$$

wherein
   d_{b} is the inert permeable barrier depth in the reactant flow direction,
   τ_{b} is the inert permeable barrier reactant pathway tortuosity in the reactant flow direction,
   ε_{b} is the inert permeable barrier porosity,
   dₑ is the permeable anode reactant pathway structure depth in the reactant flow direction, and
   tₑ is the permeable anode reactant pathway structure thickness.
210. The method of clause 209, in which
   d_{b}, the inert permeable barrier depth in the reactant flow direction, has a value in the range of d_{b}>0.01 (mm), optionally, 0.01<d_{b}<5 (mm) and, preferably 0.1<d_{b}<2 (mm).
211. The method of either of clauses 209 and 210, in which
   τ_{b}, the inert permeable barrier reactant pathway tortuosity in the reactant flow direction, has a value in the range of 1<τ_{b}<10, optionally, 1<τ_{b}<5
212. The method of any of clauses 209 to 211, in which
   ε_{b}, the inert permeable barrier porosity, has a value in the range of 0.01<ε_{b}<0.5, preferably, 0.05<ε_{b}<0.5.
213. The method of any of clauses 209 to 212, in which
   dₑ, the permeable anode reactant pathway structure depth in the reactant flow direction, has a range of 0.25<dₑ<40 (mm), optionally, 0.25<dₑ<20 (mm), and, preferably 5<dₑ<20 (mm).
214. The method of any of clauses 209 to 213, in which
   tₑ, the permeable anode reactant pathway structure thickness, has a value in the range of 5<tₑ<1000 (μm), optionally, 5<tₑ<500 (μm) and, preferably 10<tₑ<150 (μm).

### Cathode Clauses

215. A method of operating a fuel cell, the method comprising
   maintaining an operating environment within the fuel cell having an operating parameter space defined by:

$$\frac{Δ {pU}_{a}}{i} \frac{p}{T} \frac{F}{2.5 R 32 μ} = {c}_{ca} . \qquad ix$$

where
   x. p is the absolute pressure,
   xi. Δp is the pressure drop across the fuel cell (in the oxidant flow direction)
   xii. F is Faraday's constant,
   xiii. Uₐ is a utilisation factor indicating the proportion of a supplied oxidant consumed by the fuel cell
   xiv. R is the gas constant,
   xv. T is the temperature,
   xvi. μ is the oxidant gas dynamic viscosity,
   xvii. i is the current density

$$( \frac{A}{{m}^{2}} ) ,$$

and
xviii. c_{ca} is a constant.

### Cathode Operating Parameters

216. The method of clause 215, in which
   c_{ca} has a value in the range 1e6/m to 5e12/m, optionally, 1e8/m to 5e11/m and, preferably 1e9/m to 2e11/m.
217. The method of either of clauses 215 and 216, in which
   p, the absolute pressure, has a range of 1 bar to 50 bar, preferably 5 bar to 25 bar.
218. The method of any of clauses 215 to 217, in which
   Δp, the pressure drop, has a range of 10 mbar to 1000 mbar, preferably 20 mbar to 300 mbar.
219. The method of any of clauses 215 to 218, in which
   Uₐ, the utilization factor, has a value in the range of 0.1 to 1.0, preferably 0.25 to 0.75.
220. The method of any of clauses 215 to 219, in which
   T the temperature, has a value in the range of 930 °C to 450 °C, preferably 900 °C to 580 °C.
221. The method of any of clauses 215 to 220, in which
   μ, the oxidant gas dynamic viscosity, has a value in the range 5e-5 Pa·s to 1e-5 Pa·s, preferably, 5e-5 Pa·s to 4e-5 Pa·s.
222. The method of any of clauses 215 to 221, in which
   i the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
223. The method of any of clauses 215 to 222, in which

$$\frac{Δ {pU}_{a}}{i} \frac{p}{T} \frac{F}{2.5 R 32 μ} = {c}_{ca} = \frac{{τ}_{c}^{2}}{{ε}_{c}} \frac{{w}_{c}^{2}}{{f}_{c}^{2} {t}_{c}^{3}} ( {m}^{- 1} ) ,$$

where
   τ_{c} is the permeable cathode reactant pathway tortuosity in the oxidant flow direction,
   ε_{c} is permeable cathode reactant pathway structure porosity,
   w_{c} is the permeable cathode reactant pathway structure width in the oxidant flow direction,
   t_{c} is the permeable cathode reactant pathway structure thickness,
   f_{c} is the ratio of permeable cathode reactant pathway pore size to permeable cathode reactant pathway structure thickness, t_{c}.

### Geometric Parameters

224. The method of clause 223 in which,
   τ_{c}, the permeable cathode reactant pathway tortuosity in the oxidant flow direction, has a range of 1<τ_{c}<3, optionally, 1<τ_{c}<2.5, and, preferably, 1<τ_{c}<2.
225. The method of either of clauses 223 and 224, in which
   ε_{c}, the permeable cathode reactant pathway structure porosity, has a range of 0.1<ε_{c}<0.9 and preferably 0.5<ε_{c}<0.8.
226. The method of any of clauses 223 to 225, in which
   w_{c}, the permeable cathode reactant pathway structure width in the oxidant flow direction, has a range of 0.25<w_{c}<40 (mm), optionally, 0.25<w_{c}<20 (mm), and, preferably 5<w_{c}<20 (mm)
227. The method of any of clause 223 to 226, in which
   t_{c}, the permeable cathode reactant pathway structure thickness, has a range of 10<t_{c}<1000 (μm), optionally, 10<t_{c}<600 (μm) and, preferably, 20<t_{c}<250 (μm).
228. The method of any of clauses 223 to 227, in which
   f_{c}, the ratio of permeable cathode reactant pathway pore size to permeable cathode reactant pathway structure thickness, t_{c}, has a range of 0.02<f_{c}<1.0, and, preferably, 0.25<f_{c}<0.75.

### Chemical Coolant Cell Method Clauses

229. A method of operating a chemical coolant cell, the method comprising
   a. maintaining an operating environment within the chemical coolant cell having an operating parameter space defined by:

$$\frac{p}{T} \frac{Δ {pU}_{c}}{i} \frac{F}{20 R 32 μ} = {c}_{cc} , \qquad i .$$

b. where
   i. p is the absolute pressure,
   ii. Δp is pressure drop across the chemical coolant cell in the reactant flow direction
   iii. F is Faraday's constant,
   iv. U_{c} is a utilisation factor describing the supplied flow rate of reactant (chemical coolant) as a proportion of the fuel cell stack fuel supply (where U_{c}>1 indicates a reactant undersupply when a low level of cooling is required),
   v. R is the gas constant,
   vi. T is the temperature,
   vii. μ is the reactant gas dynamic viscosity,
   viii. i is the adjacent fuel cell stack current density

$$( \frac{A}{{m}^{2}} ) ,$$

and
ix. c_{c}, is a constant.

### Chemical Coolant Cell Operating Parameters

230. The method of clause 229, in which
   c_{cc} has a value in the range 1e6/m to 5e12/m, optionally, 1e8/m to 5e11/m and, preferably 1e9/m to 1e11/m.
231. The method of either of clauses 229 and 230, in which
   p, the absolute pressure, has a range of 1 bar to 50 bar, preferably 5 bar to 25 bar.
232. The method of any of clauses 229 to 231, in which
   Δp, the pressure drop, has a range of 10 mbar to 1000 mbar, preferably 20 mbar to 300 mbar.
233. The method of any of clause 229 to 232, in which
   U_{c}, the utilisation factor, has a value in the range of 0.5 to 10, preferably 1 to 5.
234. The method of any of clauses 229 to 233, in which
   T, the temperature, has a value in the range of 930 °C to 450 °C, preferably 900 °C to 580 °C.
235. The method of any of clauses 229 to 234, in which
   μ, the chemical coolant gas dynamic viscosity, has a value in the range 5e-5 Pa·s to 1e-5 Pa·s, preferably, 4e-5 Pa·s to 2e-5 Pa·s.
236. The method of any of clauses 229 to 235, in which
   i, the adjacent fuel cell stack current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
237. The method of any of clauses 229 to 236, in which

$$\frac{p}{T} \frac{Δ p {U}_{c}}{i} \frac{F}{20 R 32 μ} = \frac{{τ}_{c c}^{2}}{{ε}_{c c}} \frac{{d}_{c c}^{2}}{{f}_{c c}^{2} {t}_{c c}^{3}} ( {m}^{- 1} )$$

where
   τ_{cc} is the permeable chemical coolant catalyst layer pathway tortuosity in the reactant flow direction,
   ε_{cc} is permeable chemical coolant catalyst layer porosity,
   d_{cc} is the permeable chemical coolant catalyst layer depth in the reactant flow direction,
   t_{cc} is the permeable chemical coolant catalyst layer thickness,
   f_{cc} is the ratio of permeable chemical coolant catalyst layer pathway pore size to permeable chemical coolant catalyst layer thickness, t_{cc}.

### Geometric Parameters

238. The method of clause 237 in which,
   τ_{cc}, the permeable chemical coolant catalyst layer pathway tortuosity in the reactant flow direction, has a range of 1<τ_{cc}<3, optionally, 1<τ_{cc}<2.5, and, preferably, 1<τ_{cc}<2.
239. The method of either of clauses 237 and 238, in which
   ε_{cc}, the permeable chemical coolant catalyst layer porosity, has a range of 0.1<ε_{cc}<0.9 and preferably 0.5<ε_{cc}<0.8.
240. The method of any of clauses 237 to 239, in which
   d_{cc}, the permeable chemical coolant catalyst layer depth in the reactant flow direction, has a range of 0.25<d_{cc}<40 (mm), optionally, 0.25<d_{cc}<20 (mm), and, preferably 5<d_{cc}<20 (mm).
241. The method of any of clause 237 to 240, in which
   t_{cc}, the permeable chemical coolant catalyst layer thickness, has a range of 5<t_{cc}<1000 (μm), optionally 5<t_{cc}<700 (μm), and, preferably 10<t_{cc}<300 (μm).
242. The method of any of clauses 237 to 241, in which
   f_{cc} the ratio of permeable chemical coolant catalyst layer pathway pore size to permeable chemical coolant catalyst layer thickness, t_{cc}, has a range of 0.02<f_{cc}<1.0, and, preferably, 0.25<f_{cc}<0.75.
243. The method of any of clause 237 to 242, in which

$$\frac{p}{T} \frac{Δ p {U}_{c}}{i} \frac{F}{20 R 32 μ} = {c}_{cc} = \frac{{τ}_{c c}^{2}}{{ε}_{c c}} \frac{{d}_{c c}^{2}}{{f}_{c c}^{2} {t}_{c c}^{3}} ( {m}^{- 1} )$$

has a range of 1e6/m to 5e12/m, optionally, 1e8/m to 5e11/m and, preferably 1e9/m to 1e11/m.

### Barrier Clauses

244. The method of any of clauses 229 to 243, comprising
   c. maintaining an operating environment within a chemical coolant cell inert permeable barrier having a parameter space defined by

$$i . \frac{P {e}_{m} F p D {U}_{c}}{20 R T i} = {c}_{c c b}$$

d. where
   i. Peₘ is the mass Peclet number,
   ii. F is Faraday's constant,
   iii. p is the absolute pressure,
   iv. D is a mass diffusion coefficient of a reactant gas species,
   v. U_{c} is a utilisation factor describing the supplied flow rate of reactant (chemical coolant) as a proportion of the fuel cell stack fuel supply,
   vi. R is the gas constant,
   vii. T is the temperature, and
   viii. i is the adjacent fuel cell stack current density

$$( \frac{A}{{m}^{2}} ) .$$

245. The method of clause 244, in which

$$\frac{P {e}_{m} {FpDU}_{c}}{20 R T i} = {c}_{c c b} ( m ) ,$$

has a range of 0.1 m to 250 m, optionally, 0.5 m to 50 m and, preferably, 1 m to 25 m.
246. The method of either of clauses 244 and 245, in which Peₘ, the mass Peclet number, has a value in the range of 2 to 500, preferably, 5 to 50.
247. The method of any of clauses 244 to 246, in which p, the absolute pressure, has a value of in the range of 1 bar to 50 bar, preferably, 5 bar to 25 bar.
248. The method of any of clauses 244 to 247, in which D, the mass diffusion coefficient of a reactant gas species, has a value in the range of 1e-3 m²/s to 1e-4 m²/s, preferably 8e-4 m²/s to 1e-4 m²/s.
249. The method of any of clauses 244 to 248, in which U_{c}, the utilisation factor, has a value in the range of 0.5 to 10, preferably 1 to 5.
250. The method of any of clauses 244 to 249, in which T, the temperature, has a value in the range of 930 °C to 450 °C, preferably 900 °C to 580 °C.
251. The method of any of clauses 244 to 250, in which i, the adjacent fuel cell stack current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
252. The method of any of clauses 244 to 251, in which

$$\frac{P {e}_{m} {FpDU}_{c}}{20 R T i} = {c}_{c c b} = \frac{{d}_{ccb} {d}_{c c} {τ}_{c c b}^{2}}{{t}_{c c} {ε}_{c c b}} ( m ) ,$$

wherein
   d_{ccb} is the chemical coolant cell inert permeable barrier depth in the reactant flow direction,
   τ_{ccb} is the chemical coolant cell inert permeable barrier pathway tortuosity in the reactant flow direction,
   ε_{ccb} is the chemical coolant cell inert permeable barrier porosity,
   d_{cc} is the permeable chemical coolant catalyst layer depth in the reactant flow direction, and
   t_{cc} is the permeable chemical coolant catalyst layer thickness.
253. The method of clause 252, in which
   d_{ccb}, the chemical coolant cell inert permeable barrier depth in the reactant flow direction, has a value in the range of d_{ccb}>0.01 (mm), optionally, 0.01<d_{ccb}<5 (mm) and, preferably, 0.1<d_{ccb}<2 (mm).
254. The method of either of clauses 252 and 253, in which
   τ_{ccb}, the chemical coolant cell inert permeable barrier pathway tortuosity in the reactant flow direction, has a value in the range of 1<τ_{ccb}<10, optionally, 1<τ_{ccb}<5.
255. The method of any of clauses 252 to 254, in which
   ε_{ccb}, the chemical coolant cell inert permeable barrier porosity, has a value in the range of 0.01<ε_{ccb}<0.5, preferably, 0.05<ε_{ccb}<0.5.
256. The method of any of clauses 252 to 255, in which
   d_{cc}, the permeable chemical coolant catalyst layer depth in the reactant flow direction, has a value in the range of 0.25<d_{cc}<40 (mm), optionally, 0.25<d_{cc}<20 (mm), and, preferably 5<d_{cc}<20 (mm).
257. The method of any of clauses 252 to 256, in which
   t_{cc}, the permeable chemical coolant catalyst layer thickness, has a value in the range of 5<t_{cc}<1000 (μm), optionally 5<t_{cc}<700 (μm), and, preferably 10<t_{cc}<300 (μm).

### Combustion Cell Method Clauses

258. A method of operating a combustion cell, the method comprising
   maintaining an operating environment within the combustion cell having an operating parameter space defined by:

$$xix . \frac{Δ {pU}_{f}}{i} \frac{p}{T} \frac{F}{20 R 32 μ} = {c}_{c l} ,$$

where
   xx. p is the absolute pressure,
   xxi. Δp is pressure drop across the combustion cell (in the reactant flow direction)
   xxii. F is Faraday's constant,
   xxiii. U_{f} is a utilisation factor indicating the proportion of fuel consumption having occurred in the associated fuel cell stack (the remainder being consumed within the combustion cell)
   xxiv. R is the gas constant,
   xxv. T is the temperature,
   xxvi. μ is the reactant gas dynamic viscosity,
   xxvii. i is the associated fuel cell stack current density

$$( \frac{A}{{m}^{2}} ) ,$$

and
xxviii. c_{cl} is a constant.

### Combustion Cell Operating Parameters

259. The method of clause 258, in which
   c_{cl} has a value in the range 1e5/m to 1e12/m, optionally, 1e7/m to 1e11/m and, preferably 5e8/m to 5e10/m.
260. The method of either of clauses 258 and 259, in which
   p, the absolute pressure, has a range of 1 bar to 50 bar, preferably 5 bar to 25 bar.
261. The method of any of clauses 258 to 260, in which
   Δp the pressure drop, has a range of 10 mbar to 1000 mbar, preferably 20 mbar to 300 mbar.
262. The method of any of clauses 258 to 261, in which
   U_{f} the utilisation factor, has a value in the range of 0.1 to 1.0, preferably 0.33 to 0.95.
263. The method of any of clauses 258 to 262, in which
   T, the temperature, has a value in the range of 1000 °C to 400 °C, preferably 900 °C to 500 °C
264. The method of any of clauses 258 to 263, in which
   μ the reactant gas dynamic viscosity, has a value in the range 5e-5 Pa·s to 1e-5 Pa·s, preferably, 4e-5 Pa·s to 2e-5 Pa·s.
265. The method of any of clauses 258 to 264, in which
   i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
266. The method of any of clauses 258 to 265, in which

$$\frac{Δ {pU}_{f}}{i} \frac{p}{T} \frac{F}{20 R 32 μ} = {c}_{c l} = \frac{{τ}_{c l}^{2}}{{ε}_{c l}} \frac{{d}_{c l}^{2}}{{f}_{c l}^{2} {t}_{c l}^{3}} ( {m}^{- 1} ) ,$$

where
   τ_{cl} is the permeable combustion cell catalyst layer pathway tortuosity in the reactant flow direction,
   ε_{cl} is permeable combustion cell catalyst layer porosity,
   d_{cl} is the permeable combustion cell catalyst layer depth in the reactant flow direction,
   t_{cl} is the permeable combustion cell catalyst layer thickness,
   f_{cl} is the ratio of permeable combustion cell catalyst layer pathway pore size to permeable combustion cell catalyst layer thickness, t_{cl}.

### Geometric Parameters

267. The method of clause 266 in which,
   τ_{cl}, the permeable combustion cell catalyst layer pathway tortuosity in the reactant flow direction, has a range of 1<τ_{cl}<3, optionally, 1<τ_{cl}<2.5, and, preferably, 1<τ_{cl}<2.
268. The method of either of clauses 266 and 267, in which
   ε_{cc}, the permeable combustion cell catalyst layer porosity, has a range of 0.1<ε_{cl}<0.9 and preferably 0.5<ε_{cl}<0.8.
269. The method of any of clauses 266 to 268, in which
   d_{cl}, the permeable combustion cell catalyst layer depth in the reactant flow direction, has a range of 0.25<d_{cl}<40 (mm), optionally, 0.25<d_{cl}<20 (mm), and, preferably 5<d_{cl}<20 (mm).
270. The method of any of clauses 266 to 269, in which
   t_{cl}, the permeable combustion cell catalyst layer thickness, has a range of 5 μm<t_{cl}<5000 μm, optionally 5 μm<t_{cl}<1000 μm, and, preferably, 10 μm<t_{cl}<500 μm.
271. The method of any of clauses 266 to 270, in which
   f_{cl}, the ratio of permeable combustion cell catalyst layer pathway pore size to permeable combustion cell catalyst layer thickness, t_{cl}, has a range of 0.02<f_{cl}<1.0, and, preferably, 0.25<f_{cl}<0.75.
272. The method of any of clauses 266 to 271, in which

$$\frac{p Δ {pU}_{f}}{20 RT 32 μ i} = {c}_{cl} = \frac{{τ}_{c l}^{2}}{{ε}_{c l}} \frac{{d}_{c l}^{2}}{{f}_{c l}^{2} {t}_{c l}^{3}} ( {m}^{- 1} )$$

has a range of 1e5/m to 1e12/m, optionally, 1e7/m to 1e11/m and, preferably 5e8/m to 5e10/m.
   Barrier clauses for Combustion Cell Method Clauses
273. The method of any of clauses 258 to 272, comprising
   maintaining an operating environment within a combustion cell inert permeable barrier having a parameter space defined by

$$xxix . \frac{P {e}_{m} {FpDU}_{f}}{20 R T i} = {c}_{c b}$$

where
   xxx. Peₘ is the mass Peclet number,
   xxxi. F is Faraday's constant,
   xxxii. p is the absolute pressure,
   xxxiii. D is a mass diffusion coefficient of a reactant gas species,
   xxxiv. U_{f} is a utilisation factor indicating the proportion of fuel consumption having occurred in the associated fuel cell stack (the remainder being consumed within the combustion cell),
   xxxv. R is the gas constant,
   xxxvi. T is the temperature, and
   xxxvii. i is the associated fuel cell stack current density

$$( \frac{A}{{m}^{2}} ) .$$

274. The method of clause 273, in which

$$\frac{P {e}_{m} F p D {U}_{f}}{20 RTi} = {c}_{c b} ( m ) ,$$

has a range of 0.02 m to 50 m, optionally, 0.1 m to 10 m and, preferably, 0.5 m to 1 m.
275. The method of either of clauses 273 and 274, in which
   Peₘ, the mass Peclet number, has a value in the range of 2 to 500, preferably, 5 to 50.
276. The method of any of clauses 273 to 275, in which
   p, the absolute pressure, has a value of in the range of 1 bar to 50 bar, preferably, 5 bar to 25 bar.
277. The method of any of clauses 273 to 276, in which
   D, the mass diffusion coefficient of a reactant gas species, has a value in the range of 1e-3 m²/s to 1e-4 m²/s, preferably 8e-4 m²/s to 1e-4 m²/s.
278. The method of any of clauses 273 to 277, in which
   U_{f}, the utilisation factor, has a value in the range of 0.1 to 1.0, preferably 0.33 to 0.95.
279. The method of any of clauses 273 to 278, in which
   T, the temperature, has a value in the range of 1000 °C to 400 °C, preferably 900 °C to 500 °C.
280. The method of any of clauses 273 to 279, in which
   i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
281. The method of any of clauses 273 to 280, in which

$$\frac{P {e}_{m} F p D {U}_{f}}{20 R T i} = \frac{{d}_{cb} {d}_{cl} {τ}_{c b}^{2}}{{t}_{c l} {ε}_{c b}} ( m ) ,$$

wherein
   d_{cb} is the combustion cell inert permeable barrier depth in the reactant flow direction,
   τ_{cb} is the combustion cell inert permeable barrier pathway tortuosity in the reactant flow direction,
   ε_{cb} is the combustion cell inert permeable barrier porosity,
   d_{cl} is the permeable combustion cell catalyst layer depth in the reactant flow direction, and
   t_{cl} is the permeable combustion cell catalyst layer thickness.
282. The method of clause 281, in which
   d_{cb}, the combustion cell inert permeable barrier depth in the reactant flow direction, has a value in the range of d_{cb}>0.01 (mm), optionally, 0.01<d_{cb}<5 (mm) and, preferably, 0.1<d_{cb}<2 (mm).
283. The method of either of clauses 281 and 282, in which
   τ_{cb}, the combustion cell inert permeable barrier pathway tortuosity in the reactant flow direction, has a value in the range of 1<τ_{cb}<10, optionally, 1<τ_{cb}<5.
284. The method of any of clauses 281 to 283, in which
   ε_{cb}, the combustion cell inert permeable barrier porosity, has a value in the range of 0.01<ε_{cb}<0.5, preferably, 0.05<ε_{cb}<0.5.
285. The method of any of clauses 281 to 284, in which
   d_{cl} the permeable combustion cell catalyst layer depth in the reactant flow direction, has a value in the range of 0.25<d_{cl}<40 (mm), optionally, 0.25<d_{cl}<20 (mm), and, preferably 5<d_{cl}<20 (mm).
286. The method of any of clauses 281 to 285, in which
   t_{cl}, the permeable combustion cell catalyst layer thickness, has a value in the range of 5 μm<t_{cl}<5000 μm, optionally 5 μm<t_{cl}<1000 μm, and, preferably, 10 μm<t_{cl}<500 μm.

### Combustor Oxidant Cell Method Clauses

287. A method of operating a combustor oxidant cell, the method comprising
   maintaining an operating environment within the combustor oxidant cell having an operating parameter space defined by:

$$\frac{Δ p {U}_{a}}{i} \frac{p}{T} \frac{F}{50 R 32 μ} = {c}_{c o} ,$$

where
   p is the absolute pressure,
   Δp is pressure drop across the combustor oxidant cell in the oxidant flow direction
   F is Faraday's constant,
   Uₐ is a utilisation factor indicating the proportion of oxidant consumption intended in the associated fuel cell stack with the oxidant being first supplied to the combustor oxidant cell.
   R is the gas constant,
   T is the temperature,
   μ is the oxidant gas species dynamic viscosity,
   i is the associated fuel cell stack current density

$$( \frac{A}{{m}^{2}} ) ,$$

and
c_{co} is a constant.

### Combustor Oxidant Cell Operating Parameters

288. The method of clause 287, in which
   c_{coo} has a value in the range 1e5/m to 5e11/m, optionally, 1e7/m to 5e10/m and, preferably 5e7/m to 1e10/m.
289. The method of either of clauses 287 and 288, in which
   p, the absolute pressure, has a range of 1 bar to 50 bar, preferably 5 bar to 25 bar.
290. The method of any of clauses 287 to 289, in which
   Δp, the pressure drop, has a range of 10 mbar to 1000 mbar, preferably 20 mbar to 300 mbar.
291. The method of any of clauses 287 to 290, in which
   Uₐ, the utilization factor, has a value in the range of 0.1 to 1.0, preferably 0.25 to 0.75.
292. The method of any of clauses 287 to 291, in which
   T, the temperature, has a value in the range of 1000 °C to 400 °C, preferably 900 °C to 500 °C.
293. The method of any of clauses 287 to 292, in which
   μ the oxidant gas dynamic viscosity, has a value in the range 5e-5 Pa·s to 1e-5 Pa·s, preferably, 5e-5 Pa·s to 4e-5 Pa·s.
294. The method of any of clauses 287 to 293, in which
   i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
295. The method of any of clauses 287 to 294, in which

$$\frac{Δ p {U}_{a}}{i} \frac{p}{T} \frac{F}{50 R 32 μ} = \frac{{τ}_{c o}^{2}}{{ε}_{c o}} \frac{{w}_{c o}^{2}}{{f}_{c o}^{2} {t}_{c o}^{3}} ( {m}^{- 1} ) ,$$

where
   τ_{co} is the permeable combustor oxidant cell oxidant layer pathway tortuosity in the oxidant flow direction,
   ε_{co} is permeable combustor oxidant cell oxidant layer porosity,
   w_{co} is the permeable combustor oxidant cell oxidant layer width in the oxidant flow direction,
   t_{co} is the permeable combustor oxidant cell oxidant layer thickness,
   f_{co} is the ratio of permeable combustor oxidant cell oxidant layer pathway pore size to permeable combustor oxidant cell oxidant layer thickness, t_{co}.

### Geometric Parameters

296. The method of clause 295 in which,
   τ_{co}, the permeable combustor oxidant cell oxidant layer pathway tortuosity in the oxidant flow direction, has a range of 1<τ_{co}<3, optionally, 1<τ_{co}<2.5, and, preferably, 1<τ_{co}<2.
297. The method of either of clauses 295 and 296, in which
   ε_{co}, the permeable combustor oxidant cell oxidant layer porosity, has a range of 0.1<ε_{co}<0.9 and preferably 0.5<ε_{co}<0.8.
298. The method of any of clauses 295 to 297, in which
   w_{co}, the permeable combustor oxidant cell oxidant layer width in the oxidant flow direction, has a range of 0.25<w_{co}<40 (mm), optionally 0.25<w_{co}<20 (mm), and, preferably 5<w_{co}<20 (mm).
299. The method of any of clause 295 to 298, in which
   t_{co}, the permeable combustor oxidant cell oxidant layer thickness, has a range of 20<t_{co}<5000 (μm), optionally 20<t_{co}<1600 (μm), preferably 50<t_{co}<600 (μm).
300. The method of any of clauses 295 to 299, in which
   f_{co}, the ratio of permeable combustor oxidant cell oxidant layer pathway pore size to permeable combustor oxidant cell oxidant layer thickness, t_{co}, has a range of 0.02<f_{co}<1.0, and, preferably, 0.25<f_{co}<0.75.
301. The method of any of clauses 287 to 300, in which

$$\frac{p Δ {pFU}_{a}}{50 RT 32 μ i} = \frac{{τ}_{c o}^{2}}{{ε}_{c o}} \frac{{w}_{c o}^{2}}{{f}_{c o}^{2} {t}_{c o}^{3}} ( {m}^{- 1} )$$

has a range of 1e5/m to 5e11/m, optionally, 1e7/m to 5e10/m and, preferably 5e7/m to 1e10/m.

### Methanation Cell Method Clauses

302. A method of operating a methanation cell, the method comprising
   a. maintaining an operating environment within the methanation cell having an operating parameter space defined by:

$$i . \frac{Δ p {U}_{c}}{i} \frac{p}{T} \frac{F}{40 R 32 μ} = {c}_{m} ,$$

b. where
   i. p is the absolute pressure,
   ii. Δp is pressure drop across the methanation cell (in the reactant flow direction)
   iii. F is Faraday's constant,
   iv. U_{c} is a utilisation factor describing the supplied flow rate of reactant (chemical coolant reformate) as a proportion of the fuel cell stack fuel supply (optionally, where U_{c}>1 indicates a reactant undersupply when a low level of cooling is required).
   v. R is the gas constant,
   vi. T is the temperature,
   vii. μ is the reactant gas dynamic viscosity,
   viii. i is the associated fuel cell stack current density

$$( \frac{A}{{m}^{2}} ) ,$$

and
ix. cₘ is a constant.

### Methanation Cell Operating Parameters

303. The method of clause 302, in which
   c. cₘ has a value in the range 1e6/m to 5e12/m, optionally, 1e8/m to 5e11/m and, preferably 5e8/m to 1e11/m.
304. The method of either of clauses 302 and 303, in which
   d. p the absolute pressure, has a range of 1 bar to 50 bar, preferably 5 bar to 25 bar.
305. The method of any of clauses 302 to 304, in which
   e. Δp the pressure drop, has a range of 10 mbar to 1000 mbar, preferably 20 mbar to 300 mbar.
306. The method of any of clauses 302 to 305, in which
   f. U_{c}, the utilisation factor, has a value in the range of 0.5 to 10, preferably 1 to 5.
307. The method of any of clauses 302 to 306, in which
   g. T, the temperature, has a value in the range of 800 °C to 300 °C, preferably 700 °C to 400 °C.
308. The method of any of clause 302 to 307, in which
   h. μ the reactant gas dynamic viscosity, has a value in the range 5e-5 Pa·s to 1e-5 Pa·s, preferably, 4e-5 Pa·s to 2e-5 Pa·s.
309. The method of any of clauses 302 to 308, in which
   i. i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
310. The method of any of clauses 302 to 309, in which

$$\frac{p Δ {pFU}_{c}}{40 RT 32 μ i} = \frac{{τ}_{m}^{2}}{{ε}_{m}} \frac{{d}_{m}^{2}}{{f}_{m}^{2} {t}_{m}^{3}} ( {m}^{- 1} ) ,$$

where
   j. τₘ is the permeable methanation catalyst layer pathway tortuosity in the reactant flow direction,
   k. εₘ is the permeable methanation catalyst layer porosity,
   l. dₘ is the permeable methanation catalyst layer depth in the reactant flow direction,
   m. tₘ is the permeable methanation catalyst layer thickness,
   n. fₘ is the ratio of permeable methanation catalyst layer pathway pore size to permeable methanation catalyst layer thickness, tₘ.

### Geometric Parameters

311. The method of clause 310 in which,
   o. τₘ, the permeable methanation catalyst layer pathway tortuosity in the reactant flow direction, has a range of 1<τₘ<3, optionally, 1<τₘ<2.5, and, preferably, 1<τₘ<2.
312. The method of either of clauses 310 and 311, in which
   p. εₘ, the permeable methanation catalyst layer porosity, has a range of 0.1<εₘ<0.9 and preferably 0.5<εₘ<0.8.
313. The method of any of clauses 310 to 312, in which
   q. dₘ, the permeable methanation catalyst layer depth in the reactant flow direction, has a range of 0.25<dₘ<40 (mm), optionally, 0.25<dₘ<20 (mm), and, preferably 5<dₘ<20 (mm).
314. The method of any of clauses 310 to 313, in which
   r. tₘ, the permeable methanation catalyst layer thickness, has a range of 5 μm<tₘ<5000 μm, optionally, 10 μm<tₘ<800 μm, optionally, 50 μm<tₘ<300 μm.
315. The method of any of clauses 310 to 314, in which
   s. fₘ, the ratio of permeable methanation catalyst layer pathway pore size to permeable methanation catalyst layer thickness, tₘ, has a range of 0.02<fₘ<1.0, and, preferably, 0.25<fₘ<0.75.
316. The method of any of clauses 302 to 315, in which

$$\frac{p Δ {pFU}_{c}}{40 RT 32 μ i} = {c}_{m} = \frac{{τ}_{m}^{2}}{{ε}_{m}} \frac{{d}_{m}^{2}}{{f}_{m}^{2} {t}_{m}^{3}} ( {m}^{- 1} )$$

has a range of 1e6/m to 5e12/m, optionally, 1e8/m to 5e11/m and, preferably 5e8/m to 1e11/m.

### Barrier Clauses Methanation Cell Method Clauses

317. The method of any of clauses 302 to 316, comprising
   t. maintaining an operating environment within a methanator inert permeable barrier having a parameter space defined by

$$i . \frac{P {e}_{m} F p D {U}_{c}}{40 R T i} = {c}_{mb}$$

u. where
   i. Peₘ is the mass Peclet number,
   ii. F is Faraday's constant,
   iii. p is the absolute pressure,
   iv. D is a mass diffusion coefficient of a reactant gas species,
   v. U_{c} is a utilisation factor describing the supplied flow rate of reactant (chemical coolant reformate) as a proportion of the fuel cell stack fuel supply (where U_{c}>1 indicates a reactant undersupply when a low level of cooling is required).
   vi. R is the gas constant,
   vii. T is the temperature, and
   viii. i is the associated fuel cell stack current density

$$( \frac{A}{{m}^{2}} ) .$$

318. The method of clause 317, in which

$$\frac{{Pe}_{m} {FpDU}_{c}}{40 RTi} = {c}_{mb} ( m ) ,$$

has a range of 0.02 m to 100 m, optionally, 0.1 m to 20 m and, preferably, 1 m to 10 m.
319. The method of either of clauses 317 and 318, in which
   v. Peₘ, the mass Peclet number, has a value in the range of 2 to 500, preferably, 5 to 50.
320. The method of any of clauses 317 to 319, in which
   w. p, the absolute pressure, has a value of in the range of 1 bar to 50 bar, preferably, 5 bar to 25 bar.
321. The method of any of clauses 317 to 320, in which
   x. D, the mass diffusion coefficient of a reactant gas species, has a value in the range of 1e-3 m²/s to 1e-5 m²/s, preferably 6e-4 m²/s to 6e-5 m²/s.
322. The method of any of clauses 317 to 321, in which
   y. U_{c}, the utilisation factor, has a value in the range of 0.5 to 10, preferably 1 to 5.
323. The method of any of clauses 317 to 322, in which
   T, the temperature, has a value in the range of 800 °C to 300 °C, preferably 700 °C to 400 °C.
324. The method of any of clauses 317 to 323, in which
   i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
325. The method of any of clauses 302 to 324, in which

$$\frac{{Pe}_{m} {FpDU}_{c}}{40 RTi} = \frac{{d}_{mb} {d}_{m} {τ}_{mb}^{2}}{{t}_{m} {ε}_{mb}} ( m )$$

wherein
   d_{mb} is the methanator inert permeable barrier depth in the reactant flow direction,
   τ_{mb} is the methanator inert permeable barrier pathway tortuosity in the reactant flow direction,
   ε_{mb} is the methanator inert permeable barrier porosity,
   dₘ is the permeable methanation catalyst layer pathway structure depth in the reactant flow direction, and
   tₘ is the permeable methanation catalyst layer thickness.
326. The method of clause 325, in which
   d_{mb}, the methanator inert permeable barrier depth in the reactant flow direction, has a value in the range of d_{mb}>0.01 (mm), optionally, 0.01<d_{mb}<5 (mm) and, preferably, 0.1<d_{mb}<2 (mm).
327. The method of either of clauses 325 and 326, in which
   τ_{mb}, the methanator inert permeable barrier pathway tortuosity in the reactant flow direction, has a value in the range of 1<τ_{mb}<10, optionally, 1<τ_{mb}<5.
328. The method of any of clauses 325 to 327, in which
   ε_{mb}, the methanator inert permeable barrier porosity, has a value in the range of 0.01<ε_{mb}<0.5, preferably, 0.05<ε_{mb}<0.5.
329. The method of any of clauses 325 to 328, in which
   dₘ, the permeable methanation catalyst layer depth in the reactant flow direction, has a value in the range of 0.25<dₘ<40 (mm), optionally, 0.25<dₘ<20 (mm), and, preferably 5<dₘ<20 (mm).
330. The method of any of clauses 325 to 329, in which
   tₘ, the permeable methanation catalyst layer thickness, has a value in the range of 5 μm<tₘ<5000 μm, optionally, 10 μm<tₘ<800 μm, optionally, 50 μm<tₘ<300 μm.

### Methanation Oxidant Cell Method Clauses

331. A method of operating a methanation oxidant cell, the method comprising maintaining an operating environment within the methanation oxidant cell having an operating parameter space defined by:

$$\frac{Δ {pU}_{a}}{i} \frac{p}{T} \frac{F}{50 R 32 μ} = {c}_{mo} , \qquad xxxviii$$

where
xxxix. p is the absolute pressure,
xl. Δp is pressure drop the methanation oxidant cell in the oxidant flow direction
xli. F is Faraday's constant,
xlii. Uₐ is a utilisation factor indicating the proportion of oxidant consumption intended in the associated fuel cell stack with the oxidant being first supplied to the methanation oxidant cell,
xliii. R is the gas constant,
xliv. T is the temperature,
xlv. p is the oxidant gas species dynamic viscosity,
xlvi. i is the associated fuel cell stack current density

$$( \frac{A}{{m}^{2}} ) ,$$

and
xlvii. cₘₒ is a constant.

### Methanation Oxidant Cell Operating Parameters

332. The method of clause 331, in which
   cₘₒ has a value in the range 1e5/m to 5e11/m, optionally, 1e7/m to 5e10/m and, preferably 5e7/m to 1e10/m.
333. The method of either of clauses 331 and 332, in which
   p the absolute pressure, has a range of 1 bar to 50 bar, preferably 5 bar to 25 bar.
334. The method of any of clauses 331 to 333, in which
   Δp, the pressure drop, has a range of 10 mbar to 1000 mbar, preferably 20 mbar to 300 mbar.
335. The method of any of clauses 331 to 334, in which
   Uₐ the utilization factor, has a value in the range of 0.1 to 1.0, preferably 0.25 to 0.75.
336. The method of any of clauses 331 to 335, in which
   T, the temperature, has a value in the range of 800 °C to 300 °C, preferably 700 °C to 400 °C.
337. The method of any of clauses 331 to 336, in which
   μ, the oxidant gas dynamic viscosity, has a value in the range 5e-5 Pa·s to 1e-5 Pa·s, preferably, 4e-5 Pa·s to 3e-5 Pa·s.
338. The method of any of clauses 331 to 337 in which
   i, the current density

$$( \frac{A}{{m}^{2}} ) ,$$

has a value in the range 100000 A/m² to 300 A/m², optionally, 6000 A/m² to 300 A/m² and, preferably, 3000 A/m² to 1000 A/m².
339. The method of any of clauses 331 to 338, in which

$$\frac{Δ {pU}_{a}}{i} \frac{p}{T} \frac{F}{50 R 32 μ} = {c}_{mo} = \frac{{τ}_{mo}^{2}}{{ε}_{mo}} \frac{{w}_{mo}^{2}}{{f}_{mo}^{2} {t}_{mo}^{3}} ( {m}^{- 1} ) ,$$

where
   τₘₒ is the permeable methanation oxidant cell oxidant layer pathway tortuosity in the oxidant flow direction,
   εₘₒ is permeable methanation oxidant cell oxidant layer porosity,
   wₘₒ is the permeable methanation oxidant cell oxidant layer width in the oxidant flow direction,
   tₘₒ is the permeable methanation oxidant cell oxidant layer thickness,
   fₘₒ is the ratio of permeable methanation oxidant cell oxidant layer pathway pore size to permeable methanation oxidant cell oxidant layer thickness, tₘₒ.

### Geometric Parameters

340. The method of clause 339 in which,
   τₘₒ, the permeable methanation oxidant cell oxidant layer pathway tortuosity in the oxidant flow direction, has a range of 1<τₘₒ<3, optionally, 1<τₘₒ<2.5, and, preferably, 1<τₘₒ<2.
341. The method of either of clauses 339 and 340, in which
   εₘₒ, the permeable methanation oxidant cell oxidant layer porosity, has a range of 0.1<εₘₒ<0.9 and preferably 0.5<εₘₒ<0.8.
342. The method of any of clauses 339 to 341, in which
   wₘₒ, the permeable methanation oxidant cell oxidant layer width in the oxidant flow direction, has a range of 0.25<wₘₒ<40 (mm), optionally 0.25<wₘₒ<20 (mm), and, preferably 5<wₘₒ<20 (mm).
343. The method of any of clauses 339 to 342, in which
   tₘₒ, the permeable methanation oxidant cell oxidant layer thickness, has a range of 20<tₘₒ<5000 (μm), optionally 20<tₘₒ<1600 (μm), preferably 50<tₘₒ<600 (μm).
344. The method of any of clauses 339 to 343, in which
   fₘ the ratio of permeable methanation oxidant cell oxidant layer pathway pore size to permeable methanation oxidant cell oxidant layer thickness, tₘₒ, has a range of 0.02<fₘₒ<1.0, and, preferably, 0.25<fₘₒ<0.75.
345. The method of any of clauses 331 to 344, in which

$$\frac{p Δ {pFU}_{a}}{50 RT 32 μ i} = \frac{{τ}_{mo}^{2}}{{ε}_{mo}} \frac{{w}_{mo}^{2}}{{f}_{mo}^{2} {t}_{mo}^{3}} ( {m}^{- 1} )$$

has a range of 1e5/m to 5e11/in, optionally, 1e7/m to 5e10/m and, preferably 5e7/m to 1e10/m.

1.-28. (canceled)

29. A multi-layered structure for a fuel cell, comprising:
a. an electrolyte;
b. a permeable electrode;
c. an inert permeable barrier;
d. the permeable electrode and electrolyte having a common interface to form a reaction region;
e. the permeable electrode providing a permeable electrode reactant pathway through the electrode to present a reactant at the common interface; the permeable electrode reactant pathway being fed by a permeable reactant pathway hosted by a permeable reactant pathway structure; and
f. the inert permeable barrier comprises an inert permeable barrier reactant pathway to host a convectively dominant reactant flow regime within the inert permeable barrier, wherein the inert permeable barrier reactant pathway feeds the permeable reactant pathway.

30. The multi-layered structure of claim 29, wherein:
a. the permeable reactant pathway and the permeable reactant pathway structure are related, or defined, by
i.
$$\frac{{τ}_{p}^{2}}{{ε}_{p}} \frac{{d}_{p}^{2}}{{f}_{p}^{2} {t}_{p}^{3}} ,$$
which relates geometric parameters of the permeable reactant pathway and its associated pathway structure to the fuel cell operating parameters, and
b. the inert permeable barrier reactant pathway and the inert permeable barrier are related, or defined, by
i.
$$\frac{{d}_{b} {d}_{p} {τ}_{b}^{2}}{{t}_{p} {ε}_{b}} ,$$
which relates the geometric parameters of the inert permeable barrier and its associated pathway to the fuel cell and barrier operating parameters,
c. wherein:
iii. τₚ is a permeable reactant pathway tortuosity in the reactant flow direction,
iv. τ_{b} is an inert permeable barrier reactant pathway tortuosity in the reactant flow direction,
v. εₚ is a permeable reactant pathway structure porosity,
vi. ε_{b} is an inert permeable barrier porosity,
vii. dₚ is a permeable reactant pathway structure depth in the reactant flow direction,
viii. d_{b} is an inert permeable barrier depth in the reactant flow direction,
ix. tₚ is a permeable reactant pathway structure thickness, and
x. fₚ is a ratio of permeable reactant pathway pore size to permeable reactant pathway structure thickness, tₚ.

31. The multi-layered structure of claim 30, wherein the electrode is an anode electrode and wherein the permeable reactant pathway structure thickness, tₚ, has a range of 5 μm to 1000 μm.

32. The multi-layered structure of claim 30, wherein the electrode is an anode electrode and wherein a ratio
$$\frac{{τ}_{p}^{2}}{{ε}_{p} {f}_{p}^{2}}$$
has a range of 1 to 500.

33. The multi-layered structure of claim 30, wherein the electrode is an anode electrode and wherein the permeable reactant pathway structure depth, dₚ, has a range of 0.25 mm to 40 mm.

34. The multi-layered structure of claim 30, wherein the electrode is an anode electrode and wherein a ratio
$$\frac{{d}_{p} {τ}_{b}^{2}}{{ε}_{b}}$$
has a range of 2 to 2500 mm.

35. The multi-layered structure of claim 30, wherein the electrode is an anode electrode and the ratio, fₚ, of permeable reactant pathway pore size to permeable reactant pathway structure thickness, tₚ, has a range of 0.02 to 1.

36. The multi-layered structure of 29 claim 30, wherein the electrode is an anode electrode and wherein the permeable reactant pathway tortuosity, τₚ has a range of 1 to 3.

37. The multi-layered structure of claim 30, wherein the electrode is an anode electrode and wherein the inert permeable barrier pathway tortuosity, τ_{b}, has a range of 1 to 10.

38. The multi-layered structure of claim 30, wherein the electrode is an anode electrode and wherein the permeable reactant pathway structure porosity, εₚ, has a range of 0.1 to 0.9.

39. The multi-layered structure of claim 30, wherein the electrode is an anode electrode, and wherein the inert permeable barrier porosity, ε_{b}, has a range of 0.01 to 0.5.

40. The multi-layered structure of claim 30, wherein the electrode is an anode electrode, and wherein the inert permeable barrier depth, d_{b}, is greater than or equal to 0.01 mm.

41. The multi-layered structure of claim 30, wherein the electrode is an anode and a ratio
$$\frac{{τ}_{p}^{2}}{{ε}_{p}} \frac{{d}_{p}^{2}}{{f}_{p}^{2} {t}_{p}^{3}} ,$$
which relates the geometric parameters of a permeable anode reactant pathway and its associated pathway structure to the fuel cell operating parameters, has a range of 5e6/m to 5e13/m.

42. The multi-layered structure of claim 30, wherein the electrode is an anode and a ratio
$$\frac{{d}_{b} {d}_{p} {τ}_{b}^{2}}{{t}_{p} {ε}_{b}} ,$$
which relates the geometric parameters of the inert permeable barrier and its associated pathway to the fuel cell and barrier operating parameters, has a range of 0.2 m to 1000 m.

43. The multi-layered structure of claim 29, further comprising a permeable electrode current collector to conduct current from the electrode.

44. An anode multi-layered fuel cell structure; the anode multi-layered fuel cell structure comprising a multi-layered structure of claim 29 wherein:
t. the electrode forms a permeable anode electrode,
u. the reactant is a fuel species, and
v. further comprises a permeable anode current collector to form a respective permeable anode reactant pathway structure, as the permeable reactant pathway structure, to host a respective permeable reactant pathway.

45. A cathode multi-layered fuel cell structure; the cathode multi-layered fuel cell structure comprising a multi-layered structure of claim 29 but for the inert permeable barrier wherein:
w. the electrode forms a permeable cathode electrode,
x. the reactant is an oxidant species, and
y. further comprising a permeable cathode current collector to form a respective permeable cathode oxidant pathway structure, as the permeable oxidant pathway structure, to host a respective permeable oxidant pathway.

46. A fuel cell for a fuel cell system, the fuel cell comprising:
a set of anode multi-layered fuel cell structures comprising at least one anode multi-layered structure as claimed in claim 16, and
a set of cathode multi-layered fuel cell structures comprising at least one cathode multi-layered structure as claimed in claim 45.

47. The fuel cell of claim 46, wherein:
z. the sets of anode and cathode multi-layered structures are arranged to form a cell having an ordered arrangement of layers comprising:
i. an anode current collector layer to host a permeable anode reactant pathway,
ii. an anode electrode layer comprising a permeable anode electrode,
iii. an electrolyte layer comprising at least one, or both, of the electrolytes,
iv. a cathode electrode layer comprising a permeable cathode electrode, and
v. a cathode current collector layer comprising the cathode current collector to host a permeable cathode reactant pathway.

48. A stack of fuel cells comprising a plurality of fuel cells as claimed in claim 46, wherein a number of reactant pathways are aligned in the same direction and a number of oxidant pathways are aligned in the same direction.

49. The stack as claimed in claim 48, further comprising a chemical coolant cell comprising at least one permeable chemical coolant catalyst layer to host a permeable chemical coolant catalyst layer pathway for carrying a chemical coolant to thermally condition the stack.

50. The stack as claimed in claim 49, further comprising at least one chemical coolant supply channel and at least one chemical coolant exhaust channel, the at least one chemical coolant supply channel and the at least one chemical coolant exhaust channel being coupled via a set of chemical coolant cells comprising the chemical coolant cell.

51. The multi-layered structure of claim 29, wherein the inert permeable barrier comprises an inert permeable barrier reactant pathway to provide an effective depth greater than a physical depth of the inert permeable barrier to at least reduce diffusion of any gas species within the inert permeable barrier reactant pathway to form a convectively dominant reactant flow regime within the inert permeable barrier.
